(19) United States
(12) Patent Application Publication
(10) Pub. No.: US 2026/0141782 A1
(43) Pub. Date: May 21, 2026

(54) GRAND PARADISE JACKPOT TECHNIQUES IMPLEMENTED AT BACCARAT LIVE DEALER GAME TABLES (LDGTS) AND AT LIVE DEALER-CONTROLLED ELECTRONIC TABLE GAME SYSTEMS (DETGS) COMPRISING MULTIPLE ELECTRONIC TABLE GAME TERMINALS (ETGTS)

(71) Applicant: Tech (Macau) Limited, Macau (MO)

(72) Inventors: Jay Chun, Hong Kong (HK); Hon Man Au, Coloane (MO); David Y. So, Macau (MO)

(73) Assignee: Tech (Macau) Limited, Macau, MO (MO)

(21) Appl. No.: 19/393,150

(22) Filed: Nov. 18, 2025

Related U.S. Application Data
(60) Provisional application No. 63/722,026, filed on Nov. 18, 2024.

(51) Int. Cl. G07F 17/32

(52) U.S. Cl. CPC G07F 17/3258

(57) ABSTRACT

A comprehensive technological framework for a dynamic, probability-based jackpot system designed primarily for wager-based card games such as Baccarat, implemented within live dealer game table (LDGT) and dealer-controlled electronic table game (DETG) environments. One aspect relates to a live, dynamic market of jackpot multipliers that are directly and continuously synchronized with the mathematical probability of winning events as the game state changes. The system functions as a real-time analysis engine centered on a Came Management System (GMS) that interfaces with a Real-Time Card Recognition System. This architecture allows the system to identify each physical card dealt from a shoe, maintain a precise in-memory dataset of the remaining card composition, and utilize a specialized Probability Calculation Engine to continuously recalculate combinatorial probabilities for a plurality of defined jackpot tiers after every single card is dealt. The system is designed to broadcast these dynamically adjusted multipliers to player terminals in real-time.

### RELATED APPLICATION DATA

The present application claims benefit, pursuant to the provisions of 35 U.S.C. § 119, of U.S. Provisional Application Ser. No. 63/722,026 (Attorney Docket No. LTG1P013P), titled “GRAND PARADISE JACKPOT TECHNIQUES IMPLEMENTED AT BACCARAT LIVE DEALER GAME TABLES (LDGTS) AND AT LIVE DEALER-CONTROLLED ELECTRONIC TABLE GAME SYSTEMS (DETGS) COMPRISING MULTIPLE ELECTRONIC TABLE GAME TERMINALS (ETGTS)”, naming Chun et al. as inventors, and filed 18 Nov. 2024, the entirety of which is incorporated herein by reference for all purposes.

### BACKGROUND

The present invention is generally directed to a method of play and apparatus for playing a live baccarat game. In particular, the present invention relates to a method for playing a live baccarat game which includes jackpot bonus payouts.

Baccarat is one of the more popular gambling games played in casinos or gaming establishments. As is well known, the game is played on an elongated table having a game board displayed along the upper surface of the table. The game board displays certain wagering areas, and the elongated table allows for the seating of multiple players or bettors and the positioning of the multiple dealers necessary for operating the casino game. Bettor locations are typically numbered on the table and each bettor location has an area designated for a wager on the banker's hand and an area designated for a wager on the player's hand. Baccarat uses a standard deck of 52 playing cards and is usually dealt from a shoe having multiple decks that have been shuffled together prior to the beginning of play.

A feature of conventional baccarat games is that they have relatively simple rules. However, the simplicity of the rules has led to a corresponding simplicity in the relatively few types of wagers which may be placed during the play of the game, which may limit interest on the part of the player(s) and thus further limit the casino in terms of profit and payout. Various embodiments described herein address the above-described issues.

### BRIEF DESCRIPTION OF THE DRAWINGS

FIG. 1 is a schematic block diagram illustrating an example of a network configuration for a plurality of gaming devices according to some embodiments;

FIGS. 2A-E are diagrams illustrating examples of gaming devices, systems, and networks according to various embodiments.

FIG. 3A is a block diagram depicting various functional elements of an EGD in an example embodiment.

FIG. 3B depicts a casino gaming environment in an example embodiment.

FIG. 4 is a diagram of components of a system for providing online gaming in an example embodiment.

FIG. 5 illustrates, in block diagram form, an implementation of a game processing architecture algorithm that implements a game processing pipeline for the play of a game in accordance with various implementations described herein.

FIG. 6 illustrates an example embodiment of a Gaming Network 600 which may be configured or designed to implement various automated money laundering detection and reporting techniques described and/or referenced herein.

FIG. 7 shows an example block diagram of an electronic gaming system 700 in accordance with a specific embodiment.

FIG. 8 shows electronic gaming table 760 with various features, in accordance with a specific embodiment.

FIG. 9 shows a block diagram of electronic gaming device 900, in accordance with a specific embodiment.

FIG. 10 is a simplified block diagram of an exemplary intelligent electronic gaming system 1000 in accordance with a specific embodiment.

FIG. 11 is a simplified block diagram of an exemplary mobile gaming device 1100 in accordance with a specific embodiment.

FIG. 12 illustrates an example of a functional block diagram of a Casino Gaming Server System in accordance with a specific embodiment.

FIG. 13 illustrates an alternate example embodiment of a Gaming Network 1300 which may be configured or designed to implement various automated money laundering detection and reporting techniques described and/or referenced herein.

FIG. 14 shows a block diagram illustrating components of a gaming system which may be used for implementing various aspects of example embodiments.

FIG. 15 shows an embodiment of the overall design of a baccarat Dealer-controlled Electronic Table Game (“DETG” or betting terminal).

FIG. 16 shows a wager-based gaming system embodying live baccarat jackpot.

FIG. 17 shows an embodiment of the design of the dealing table of a DETG system.

FIG. 18 shows an embodiment of one design of a Live Baccarat DETG.

FIG. 19 shows an embodiment of another design of the Live Baccarat DETG.

Additional Figures depict various system diagrams, flow diagrams, and screenshots of graphical user interfaces which have been configured or designed to facilitate, enable, initiate, and/or perform one or more operation(s), action(s), and/or feature(s) of the GPJ techniques described herein.

### DETAILED DESCRIPTION OF EXAMPLE EMBODIMENTS

### Overview

Various aspects described or referenced herein are directed to different techniques for facilitating managing dynamic, longitudinal, dealer-assisted, and personalized jackpots for live Baccarat games conducted at live dealer game tables (LDGTS) and at live dealer-controlled electronic table game systems (DETGS).

One aspect disclosed herein is directed to a first server system for managing a dynamic jackpot for a live Baccarat game utilizing a physical shoe containing a plurality of playing cards. The system comprises a network interface, a non-transient memory storing a stateful shoe composition dataset representing a quantity of cards remaining in the physical shoe, and a processor communicatively coupled to the network interface and the memory. The processor is operable for receiving, via the network interface, real-time card data from a card recognition system, the real-time card data identifying a rank and a suit of a physical card dealt from the physical shoe; atomically updating the stateful shoe composition dataset in the non-transient memory by decrementing a count associated with the identified rank and suit of the physical card; executing a combinatorial probability calculation algorithm against the updated stateful shoe composition dataset to calculate a real-time probability of a specific, predefined rare card combination occurring in a finite remaining population of the physical shoe; generating a dynamically adjusted jackpot multiplier for a jackpot tier corresponding to the specific, predefined rare card combination based on the calculated real-time probability, wherein the jackpot multiplier is inversely proportional to the calculated real-time probability; and broadcasting, via the network interface, the dynamically adjusted jackpot multiplier to a plurality of electronic table game terminals to update a graphical user interface of the electronic table game terminals in real-time.

In at least one embodiment, the at least one processor is adapted to execute additional instructions wherein executing the combinatorial probability calculation algorithm comprises calculating a hypergeometric distribution for at least thirty-six distinct jackpot tiers simultaneously upon receipt of the real-time card data.

In at least one embodiment, the at least thirty-six distinct jackpot tiers comprise a first subset of tiers requiring cards of a same suit and a second subset of tiers requiring cards of mixed suits.

In at least one embodiment, the at least one processor is adapted to execute additional instructions wherein generating the dynamically adjusted jackpot multiplier further comprises applying a configurable weighting factor to the calculated real-time probability, wherein the weighting factor is defined by a perceived card value associated with the rank of the cards in the specific, predefined rare card combination.

In at least one embodiment, the at least one processor is adapted to execute additional instructions for detecting that the real-time probability of the specific, predefined rare card combination has decreased based on the updating of the stateful shoe composition dataset and programmatically increasing the jackpot multiplier in response to the decrease in the real-time probability.

In at least one embodiment, the at least one processor is adapted to execute additional instructions for receiving a jackpot wager data packet from a specific electronic table game terminal; storing a timestamp associated with the jackpot wager data packet; identifying an occurrence of the specific, predefined rare card combination; retrieving the dynamically adjusted jackpot multiplier that was active at the timestamp of the jackpot wager data packet; and calculating a jackpot payout amount by applying the retrieved dynamically adjusted jackpot multiplier to the jackpot wager.

In at least one embodiment, the at least one processor is adapted to execute additional instructions for allocating a portion of a received side bet wager to a progressive jackpot pool and calculating a payout amount by multiplying a current value of the progressive jackpot pool by the dynamically adjusted jackpot multiplier.

In at least one embodiment, the at least one processor is adapted to execute additional instructions for comparing the updated stateful shoe composition dataset against a set of near-miss criteria; detecting a near-miss combination corresponding to the specific, predefined rare card combination; and authorizing a partial jackpot award to the plurality of electronic table game terminals in response to detecting the near-miss combination.

Another aspect disclosed herein is directed to a first server system for managing a longitudinal jackpot for a live Baccarat game played in a series of discrete game hands. The system comprises a network interface, a non-transient memory configured to store a First-In-First-Out (FIFO) rolling data buffer having a fixed capacity of data objects, and a processor communicatively coupled to the network interface and the memory. The processor is operable for receiving, via the network interface, a continuous stream of card data packets from a card recognition system, each card data packet corresponding to a physical card dealt consecutively from a shoe; executing a push operation to add a new card data packet to the FIFO rolling data buffer and a pop operation to remove an oldest card data packet from the FIFO rolling data buffer to maintain a stateful history of a predefined number of last consecutive cards dealt, wherein the predefined number is six; executing the push and pop operations continuously across the series of discrete game hands such that the FIFO rolling data buffer comprises card data packets dealt in different game hands; executing a pattern-matching algorithm after each push operation to compare the six card data packets in the FIFO rolling data buffer against a predefined jackpot combination; and transmitting, via the network interface, a jackpot trigger signal to an electronic table game terminal in response to the pattern-matching algorithm identifying a match, thereby enabling a jackpot event spanning multiple discrete game hands.

In at least one embodiment, the at least one processor is adapted to execute additional instructions for receiving a new shoe signal indicating a start of a new physical shoe and executing a purge command to clear all data objects from the FIFO rolling data buffer in response to the new shoe signal.

In at least one embodiment, the processor is operable for analyzing the FIFO rolling data buffer independent of whether the card data packets contained therein were assigned to a Player hand or a Banker hand in the live Baccarat game.

In at least one embodiment, the predefined jackpot combination is selected from a set of thirty-six distinct jackpot tiers defined by a specific rank and a specific color of the six cards.

In at least one embodiment, the at least one processor is adapted to execute additional instructions for receiving a single jackpot side bet transaction from a player terminal at a beginning of a new shoe; logging a bet active status for the player terminal; and maintaining the bet active status for all executions of the pattern-matching algorithm for a duration of the new shoe.

In at least one embodiment, the at least one processor is adapted to execute additional instructions for querying a probability engine to determine a real-time probability of the predefined jackpot combination occurring based on a set of cards remaining in the shoe and adjusting a payout multiplier associated with the predefined jackpot combination based on the determined real-time probability.

In at least one embodiment, the at least one processor is adapted to execute additional instructions for detecting a partial match within the FIFO rolling data buffer, wherein the partial match comprises five of the six card data packets matching the predefined jackpot combination and transmitting a partial win signal to the electronic table game terminal in response to the partial match.

Another aspect disclosed herein is directed to a first server system for managing a jackpot for a live Baccarat game administered by a live dealer. The system comprises a secure network interface, a dealer console interface configured to communicate with a secure, authenticated dealer console located at a live dealer station, and a processor communicatively coupled to the secure network interface and the dealer console interface. The processor is operable for analyzing real-time game data to detect a near-miss jackpot condition; transmitting an alert signal via the dealer console interface to the secure, authenticated dealer console to display a notification of the near-miss jackpot condition; receiving, via the dealer console interface, a secure manual activation signal initiated by a physical input on the secure, authenticated dealer console; validating the secure manual activation signal against an authentication credential associated with the live dealer; changing a state of the first server system to enable a special jackpot eligibility period for a predefined duration in response to validating the secure manual activation signal; and processing jackpot wagers received from a plurality of electronic table game terminals according to an enhanced payout rule set during the special jackpot eligibility period.

In at least one embodiment, the predefined duration is defined as a predetermined quantity of subsequent game hands dealt by the live dealer. In at least one embodiment, the predefined duration is defined as a timer initiated upon validation of the secure manual activation signal. In at least one embodiment, the enhanced payout rule set comprises applying a temporary multiplier to all winning jackpot combinations during the special jackpot eligibility period.

In at least one embodiment, detecting the near-miss jackpot condition comprises identifying that a rolling card buffer contains five out of six cards required for a jackpot combination. In at least one embodiment, enabling the special jackpot eligibility period comprises transmitting a start bonus command to the plurality of electronic table game terminals, the start bonus command causing the terminals to display an interactive mini-game.

In at least one embodiment, the at least one processor is adapted to execute additional instructions for receiving a manual bonus selection signal from the secure, authenticated dealer console, the manual bonus selection signal identifying a specific card trend observed by the live dealer and modifying the enhanced payout rule set to increase multipliers specifically for jackpot combinations matching the observed trend.

Another aspect disclosed herein is directed to a first server system for managing a personalized jackpot for a Baccarat game. The system comprises a network interface, an Application Programming Interface (API) configured to communicate with an external player tracking database, an active session memory cache, and a processor communicatively coupled to the network interface, the API, and the active session memory cache. The processor is operable for receiving a player login request comprising a player identifier from an electronic table game terminal (ETGT); executing an API query to the external player tracking database using the player identifier to retrieve a historical player profile comprising loyalty tier data; generating a specific in-game personalization rule object based on the retrieved historical player profile, the rule object defining a personalized multiplier value for a specific jackpot tier; storing the generated in-game personalization rule object in the active session memory cache associated with the player identifier; detecting a jackpot-triggering event corresponding to the specific jackpot tier for the ETGT; retrieving the in-game personalization rule object from the active session memory cache; and executing a modified payout calculation algorithm that applies the personalized multiplier value from the retrieved rule object to a base jackpot amount to determine a final payout for the ETGT.

In at least one embodiment, the at least one processor is adapted to execute additional instructions for transmitting a personalized user interface data packet to the ETGT, the data packet causing the ETGT to render a graphical indicator of the personalized multiplier value unique to the player.

In at least one embodiment, the historical player profile further comprises a preferred wager history, and wherein generating the specific in-game personalization rule object comprises selecting a target jackpot tier that matches the preferred wager history.

In at least one embodiment, generating the specific in-game personalization rule object comprises generating a personalized challenge object defining a specific gameplay goal, and wherein the at least one processor is adapted to execute additional instructions for tracking gameplay data from the ETGT against the specific gameplay goal and triggering a jackpot award in response to the gameplay data satisfying the specific gameplay goal.

In at least one embodiment, the at least one processor is adapted to execute additional instructions for monitoring a sequence of game outcomes for the ETGT; identifying a consecutive winning streak; and dynamically updating the personalized multiplier value in the active session memory cache based on a length of the consecutive winning streak.

In at least one embodiment, the at least one processor is adapted to execute additional instructions for tracking a sequence of wager amounts received from the ETGT; identifying a progressive betting pattern wherein the wager amounts increase in a predefined sequence; and applying the personalized multiplier value only upon confirmation of the progressive betting pattern.

In at least one embodiment, the at least one processor is adapted to execute additional instructions for analyzing betting decisions received from the ETGT against a set of optimal strategy rules; calculating a skill score for the player based on the analysis; and adjusting the personalized multiplier value stored in the active session memory cache based on the calculated skill score.

Additional method(s), system(s) and/or computer program product(s) may be further operable to cause at least one processor to execute additional instructions to:

Various aspects and features disclosed herein provide a comprehensive technological framework for a dynamic, probability-based jackpot system, primarily designed for wager-based card games such as Baccarat. One of the system's specific purposes is to replace conventional, static jackpot payouts with a live, dynamic market of jackpot multipliers that are directly and continuously tied to the true mathematical probability of the winning events. This is achieved through a novel architecture centered on a Game Management System (GMS), which functions as a real-time analysis engine. The GMS is communicatively coupled with a Real-Time Card Recognition System that identifies each physical card dealt from a shoe. This data is used to maintain a precise, in-memory dataset of the shoe's remaining card composition. This dataset is fed to a specialized Probability Calculation Engine, which continuously recalculates the combinatorial probability for a plurality of defined jackpot tiers after every single card is dealt. The GMS uses this real-time probability data to dynamically adjust the jackpot multipliers, which are then broadcast to all player terminals.

This system is designed to solve the significant technical problem of static jackpots in the prior art. In conventional systems, a jackpot prize is a fixed value, which becomes mathematically disconnected from the true, real-time rarity of the event as the game's state (the composition of the shoe) changes. This is an inflexible, inefficient, and potentially unfair computer architecture, as the fixed prize may be overvalued or undervalued at different points in the shoe. The invention's technical solution is the creation of a specific, high-speed feedback loop (scan->update dataset->recalculate probability->adjust multiplier->display) that transforms the GMS from a simple, passive lookup table into an active, stateful, and computational engine. This ensures the jackpot value is always proportionally aligned with its mathematical rarity, a tangible improvement in the computer's functionality.

The specific innovations extend beyond this dynamic engine. The system also introduces a novel Rolling Window Consecutive Card Trigger, which uses a stateful data buffer (a FIFO queue) within the GMS to track the last N consecutive cards dealt, independent of any game or hand boundaries. This allows a single jackpot bet to be active for an entire shoe, creating a sustained meta-game and solving the problem of discrete, fleeting player engagement. Further innovations include an Integrated Dealer and Player Agency Interface, which provides a secure console for dealers to receive system-generated near-miss alerts and manually trigger electronic bonuses, as well as a player-facing interface for selecting a custom subset of jackpot tiers to wager on. Finally, a Real-Time Personalized Jackpot Engine integrates with the casino's player tracking system, using AI and machine learning models to analyze a player's profile and apply unique, in-game modifications, such as personalized multipliers for VIPs or long-term, AI-driven jackpot journeys, representing a non-obvious solution to generic, one-size-fits-all bonusing.

In at least one embodiment, the system architecture is centered on the Game Management System (GMS), a high-availability server that functions as the central processing hub. This GMS is implemented on high-performance hardware, such as a multi-specific server with a large amount of high-speed RAM (e.g., 256 GB or more), enabling it to maintain entire shoe composition datasets and active player session data in-memory for real-time access. The GMS coordinates several notable physical and logical components. The primary data input source is the Real-Time Card Recognition System, a hardware component integrated with the Live Dealer Station (LDGT/DETG). This system may be embodied as an optical scanner integrated into the dealing shoe, an overhead image recognition camera, or a more advanced system using RFID-embedded physical playing cards and an RFID reader within the shoe. This component provides an accurate, low-latency data feed of each card's rank and suit to the GMS. Player interaction is managed through Electronic Table Game Terminals (ETGTs), which are the player-facing client interfaces (e.g., touchscreens) that accept wagers and display the dynamically changing jackpot information. The architecture also includes a Secure Dealer Console, a dedicated, authenticated touchscreen terminal that allows the dealer to receive alerts from the GMS and send manual, secure activation signals to it. Internally, the GMS integrates with or hosts specialized software modules, including the Probability Calculation Engine, a microservice responsible for executing complex combinatorial mathematics, and a potential AI/ML Personalization Engine for player-customized rules. The GMS also maintains an important, secure interface with the broader Casino Management System (CMS) and Player Tracking System for player authentication, financial processing, and retrieving player profile data.

The operational flow of the system is a continuous, sub-second processing loop. When a physical card is dealt, the Real-Time Card Recognition System identifies it and transmits the card's identity (e.g., King of Hearts) to the GMS. The GMS immediately updates its in-memory Shoe Composition Dataset by decrementing the count for that specific card. The GMS then queries the Probability Calculation Engine, providing it with this newly updated dataset. The Probability Engine iterates through all defined jackpot tiers (e.g., 36 tiers) and calculates the new combinatorial probability for each one. This list of probabilities is returned to the GMS. The GMS applies a final layer of configurable business logic, such as a perceived card value weighting, to generate the final multipliers. These new, adjusted multipliers are then broadcast by the GMS over a low-latency network (e.g., using a persistent WebSocket protocol) to all connected ETGTs, which update their displays in near real-time. This entire loop executes for every single card dealt, ensuring the jackpot values are always synchronized with the true, physical state of the game. Other features, like the rolling window, are processed in parallel, with the GMS also pushing each new card into its FIFO queue and performing a pattern match with each update.

The technical specifications of the system are important to its function. The specific mathematical algorithm for the Probability Calculation Engine is the hypergeometric distribution, which calculates the probability of drawing a specific number of successes (e.g., 6 Red Aces) in a set number of draws from a finite population (the remaining cards in the shoe). The network architecture is a segregated, high-priority LAN, preferably 10 GbE wired Ethernet, with persistent WebSocket or gRPC protocols to enable the GMS to push data to clients, rather than relying on slower HTTP polling. The entire data loop, from card scan to multiplier display, is specified to execute in under 500 milliseconds. All network communication is secured with end-to-end TLS 1.3 encryption. The AI/NIL Personalization Engine may be implemented using models such as Q-learning (a reinforcement learning model) to generate optimal, adaptive challenges, or predictive classifiers (like Random Forest) to assign players to long-term narrative journeys based on their historical archetype. Data integrity is ensured by a comprehensive, immutable audit trail, implemented as an append-only relational ledger.

Various objects, features and advantages of the various aspects described or referenced herein will become apparent from the following descriptions of its example embodiments, which descriptions should be taken in conjunction with the accompanying drawings.

### SPECIFIC EXAMPLE EMBODIMENTS

Various techniques will now be described in detail with reference to a few example embodiments thereof as illustrated in the accompanying drawings. In the following description, numerous specific details are set forth in order to provide a thorough understanding of one or more aspects and/or features described or reference herein. It will be apparent, however, to one skilled in the art, that one or more aspects and/or features described or reference herein may be practiced without some or all of these specific details. In other instances, well known process steps and/or structures have not been described in detail in order to not obscure some of the aspects and/or features described or reference herein.

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. To the contrary, a variety of optional components are described to illustrate the wide variety of possible embodiments of one or more of the invention(s).

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate) may be used in place of a single device/article. Similarly, where more than one device or article is described (whether or not they cooperate), it will be readily apparent that a single device/article may be used in place of the more than one device or article.

The functionality and/or the features of a device may be alternatively embodied by one or more other devices that are not explicitly described as having such functionality/features. Thus, other embodiments of one or more of the invention(s) need not include the device itself.

Techniques and mechanisms described or reference herein will sometimes be described in singular form for clarity. However, it should be noted that particular embodiments include multiple iterations of a technique or multiple instantiations of a mechanism unless noted otherwise.

### Jackpot Techniques Implemented at Baccarat Live Dealer Game Tables (Ldgts) and at Live Dealer-Controlled Electronic Table Game Systems (Detgs) Comprising Multiple Electronic Table Game Terminals (Etgts).

Various aspects are disclosed herein for implementing jackpot techniques at live dealer game tables (LDGTS) and at live dealer-controlled electronic table game systems (DETGS) comprising multiple electronic table game terminals (ETGTS). Examples of such jackpot techniques include “Paradise Jackpot™” techniques and “Grand Paradise Jackpot™” techniques (also referred to herein as “GPJ” or “GPJ techniques”).

Also provided herein are methods and systems therefore for playing a modified live baccarat game. The methods allow the wagering on the live baccarat games according to conventional rules. According to different embodiments, the players of the live baccarat game can make a separate bet for jackpot. The jackpot bet can be placed with a bet for live baccarat or without a bet for the same live baccarat.

In addition, the methods provided herein allow betting on a site bet or wager for jackpot with an option for insurance betting. The present application also provides a jackpot gaming method that allows the banker to make initial contributions for the jackpot game. As used herein, a zero-point card refers to any of the 10, J, Q, or K, and the banker refers to one who owns or operates the live baccarat establishment.

### Overview of Example Innovative Elements, Aspects, Features

### Dynamic Probability-Based Jackpot Engine

This innovative element provides a foundational technical framework for various aspects of the invention, solving the problem of static jackpots in prior art. Its technical essence lies in the creation of a high-speed, closed feedback loop that mathematically links a physical game's state to its electronic payout rules in real-time. The system is architected around a Game Management System (GMS) that receives a data feed from a Real-Time Card Recognition System (e.g., an RFID shoe). The GMS is technically improved to maintain a stateful, in-memory dataset of the exact composition of cards remaining in the shoe, decrementing the count for each card as it is dealt. After every single card deal, this updated dataset is sent to a specialized Probability Calculation Engine. This engine, which is a non-trivial improvement over static lookup tables, executes complex combinatorial probability algorithms, such as the hypergeometric distribution, to continuously recalculate the true mathematical odds for all defined jackpot tiers. The GMS then uses this probability output to dynamically adjust the jackpot multipliers, which are broadcast to all player terminals. This transforms the GMS from a passive data storage device into an active, real-time computational engine, which is a tangible improvement to the computer's functionality and provides the practical application of a live, fair, and engaging jackpot market.

### Rolling Window Consecutive Card Trigger

This innovative element is a novel jackpot trigger mechanism that is technically distinct from the discrete, per-hand jackpots of the prior art. It solves the technical problem of fleeting player engagement by creating a sustained, longitudinal meta-game. The technical implementation involves a specific software component within the Game Management System (GMS) that maintains a stateful data buffer, specifically a First-In, First-Out (FIFO) queue, in its active memory. This buffer is defined with a fixed size, such as six elements. As the Real-Time Card Recognition System identifies each new card, the GMS pushes the card's data onto this queue and simultaneously discards the oldest element. This ensures the buffer always contains only the last six consecutive cards dealt from the shoe. Crucially, this operation is independent of Baccarat game or hand boundaries; a winning combination may be formed by cards dealt across multiple, separate hands. After each card is added, the GMS executes a pattern-matching algorithm to compare the buffer's current state against all defined jackpot triggers. This specific, continuous, per-card evaluation logic, which is a clear improvement in the computer's functionality, allows a single jackpot side bet (placed at the start of the shoe) to remain active for hundreds of trigger events, providing sustained excitement and anticipation.

### Integrated Dealer and Player Agency Interface

This innovative element introduces a novel human-computer interaction framework by integrating active control layers for both the dealer and the player. The first component is a Secure Dealer Console, an authenticated, dedicated touchscreen at the dealer's station. The GMS is technically improved to analyze the game state for near-miss events (e.g., 5 of 6 required cards for a jackpot) and send a real-time alert to this console. This empowers the dealer to act as a showman by providing a manual activation button (e.g., Initiate Bonus Round) on the console, which sends a secure signal to the GMS to trigger a system-wide electronic event, thus creating a novel human-in-the-loop trigger. The second component is the Player-Selectable Jackpot Interface, a software module on the Electronic Table Game Terminal (ETGT). This interface presents the player with a menu of all available jackpot tiers (e.g., 36 tiers) and allows them to select a subset of tiers they wish to wager on. This is a significant improvement in the GMS's functionality, as it may be architected to receive, store, and manage a unique, individualized per-player eligibility map for every active player, and then use this map as an additional layer in its win-verification logic.

### Real-Time Personalized Jackpot Engine

This innovative element describes a sophisticated technical solution for personalizing the gaming experience, moving beyond abstract loyalty rewards. The technical implementation involves the Game Management System (GMS) initiating a real-time API call to the external Casino Management System (CMS) or Player Tracking System when a player logs in with their loyalty card. The GMS retrieves the player's historical profile and loyalty status, which is then fed as input to an integrated AI/ML Personalization Engine. This engine, which may use reinforcement learning models (like Q-learning) or predictive classifiers, analyzes the profile and generates a specific, actionable, in-game personalization rule. This rule is then stored in the player's active session data. The GMS's specific logic is thereby improved to manage unique, one-to-one jackpot rules. For example, its payout algorithm may be modified to apply a personalized multiplier (e.g., VIP Gold members receive 2× on all Ace-based jackpots) or its win-checking logic may be enhanced to track progress against a unique, AI-generated challenge (e.g., Win a hand with a Natural 8 for a $50 bonus). This transforms the GMS from a one-to-many game host into an intelligent, one-to-one player engagement and retention engine.

### Other Noteworthy Features

The Grand Paradise Jackpot™ features and techniques implemented at Baccarat live dealer game tables (LDGTs) and Baccarat live dealer-controlled electronic table game systems (DETGs) introduce a revolutionary approach to jackpot calculation and distribution in live baccarat games. This innovative system enhances the traditional baccarat experience by incorporating dynamic jackpot multipliers, real-time probability calculations, and a tiered jackpot structure that adapts to the rarity of specific card combinations.

The Grand Paradise Jackpot™ features and techniques represent a significant leap forward in live baccarat gaming. By combining dynamic multipliers, real-time probability calculations, and a tiered jackpot structure with advanced technology and seamless integration across platforms, this system offers an unparalleled gaming experience. It successfully enhances the excitement of baccarat without compromising its specific gameplay, appealing to both traditional players and those seeking more dynamic gaming options. The system's flexibility, personalization capabilities, and robust security measures make it a valuable addition to any casino's baccarat offering, promising increased player engagement and potentially higher revenues.

A notable feature of the Grand Paradise Jackpot™ system is its Dynamic Multiplier System, which increases multipliers based on the rarity of six-card combinations dealt during gameplay. This feature adds an unprecedented level of excitement to each hand, as players anticipate the possibility of triggering high multipliers for rare combinations. For example, a combination of Six Red Aces of the same suit represents the pinnacle of rarity and corresponds to the highest multiplier. This dynamic approach ensures that the jackpot remains enticing throughout the gaming session, with multipliers adjusting in real-time to reflect the changing odds of specific combinations occurring.

The system's Probability-Based Adjustments feature sets it apart from traditional static jackpot systems. The Grand Paradise Jackpot™ continuously calculates the probability of each combination occurring and adjusts the multipliers accordingly. This real-time calculation ensures that payouts remain proportional to the combination's rarity, maintaining fairness while preserving the excitement of potentially massive wins. The sophisticated algorithms driving these calculations take into account factors such as the number of decks in play, cards already dealt, and the current state of the shoe, providing a level of precision and adaptability previously unseen in live baccarat jackpot systems.

One of the more significant advantages of the Grand Paradise Jackpot™ system is its versatile Implementation Across Platforms. The technique seamlessly integrates into both physical live dealer tables and electronic table game systems, enhancing the game's thrill without altering its fundamental rules. This flexibility allows casinos to implement the Grand Paradise Jackpot™ across their entire baccarat offering, providing a consistent and exciting experience for players regardless of their preferred playing environment.

The system's Dynamic Multiplier Adjustments feature is a cornerstone of its innovative approach. As cards are dealt and the probability of specific combinations changes, the multipliers increase or decrease accordingly. This real-time adjustment creates a dynamic and engaging atmosphere, where players may see the potential payouts evolving with each card dealt. The system may display these changing multipliers on large screens visible to all players, as well as on individual Electronic Table Game Terminals (ETGTs), fostering a sense of shared excitement and anticipation among players.

Real-Time Probability Calculations form the backbone of the Grand Paradise Jackpot™ system. Sophisticated algorithms continuously analyze the cards dealt, updating the probabilities of each possible combination. This feature not only ensures the accuracy of the multipliers but also adds an element of strategy for knowledgeable players who may track these changing probabilities. The system's ability to perform these complex calculations instantaneously demonstrates the advanced technology underpinning the Grand Paradise Jackpot™, setting it apart from simpler jackpot systems.

The Enhanced Player Experience offered by the Grand Paradise Jackpot™ is a notable differentiator in the competitive casino market. By offering potentially massive payouts for rare combinations, the game becomes more thrilling without altering its fundamental rules. This balance is notable, as it maintains the integrity of baccarat while introducing an additional layer of excitement. Players enjoy the familiar gameplay of baccarat with the added thrill of chasing significant jackpot wins, creating a best-of-both-worlds scenario that appeals to both traditional baccarat enthusiasts and those seeking more dynamic gaming experiences.

The implementation of the Grand Paradise Jackpot™ system includes several innovative features designed to seamlessly integrate the jackpot into the baccarat gameplay. Each ETGT is equipped with a Dedicated Jackpot Betting Area, providing a clear and intuitive interface for players to place their jackpot bets. This dedicated area ensures that jackpot bets are easily distinguishable from standard baccarat wagers, simplifying bet placement and payout processes.

The system's Real-Time Card Recognition technology is a notable component that enables the dynamic nature of the Grand Paradise Jackpot™. The live dealer station utilizes advanced card recognition technology to read and transmit card values instantly to the Game Management System (GMS). This rapid and accurate card identification allows for immediate updates to probabilities and multipliers, ensuring that the jackpot system responds in real-time to the unfolding game.

Continuous Probability Monitoring is achieved through the collaboration of the GMS and the Probability Calculation Engine. These components work in tandem to monitor dealt cards, updating probabilities and corresponding multipliers for each possible combination. This constant vigilance ensures that the jackpot system remains accurate and fair throughout the gaming session, adapting to the changing composition of the shoe as cards are dealt.

The Tiered Jackpot Structure is a novel feature that adds depth and variety to the Grand Paradise Jackpot™. The jackpot is divided into distinct tiers, each corresponding to unique six-card combinations. These tiers are further categorized into Same Suit and Mixed Suit categories, offering a range of winning possibilities. This tiered approach allows for more frequent, smaller payouts while still maintaining the allure of massive jackpots for the rarest combinations.

The Grand Paradise Jackpot™ system's ability to operate across multiple LDGTs and DETGs simultaneously is a significant advancement in jackpot management. This networked approach allows for larger, more enticing jackpot pools that accumulate across multiple tables or even multiple casino properties. The system's robust networking capabilities ensure that all connected tables and terminals remain synchronized, providing a seamless and consistent jackpot experience regardless of where a player chooses to play.

The integration of the Grand Paradise Jackpot™ with player tracking systems opens up new possibilities for personalized gaming experiences. The system may offer tailored jackpot multipliers or bonus features based on a player's history and preferences, enhancing player loyalty and engagement. This level of personalization is made possible by the system's sophisticated data analysis capabilities, which may process vast amounts of player data in real-time.

From an operational perspective, the Grand Paradise Jackpot™ system offers casino managers unprecedented control and flexibility. The system's parameters, such as multiplier ranges, tier structures, and payout rates, may be adjusted to optimize performance and meet regulatory requirements. This adaptability ensures that the jackpot system may be fine-tuned to suit the specific needs of different markets and player demographics.

The Grand Paradise Jackpot™ system also incorporates advanced security and fairness measures. Every aspect of the jackpot, from bet placement to card recognition to payout calculation, is monitored and logged in real-time. This comprehensive audit trail ensures the integrity of the game and provides a robust defense against potential fraud or errors.

In at least one embodiment, the LIVE Dealer-Controlled Multiplayer Games with Grand Paradise Jackpot™ features, concepts and techniques disclosed herein introduce a host of innovations that distinguish it from prior art. Its ability to integrate across multiple game types, enable flexible jackpot triggers and eligibility criteria, and offer varied funding and distribution methods represents a leap forward in table game jackpot systems. Notable benefits of this system include enhanced player engagement, increased wagering activity, and a more exciting and communal gaming experience. Additionally, its compatibility with live dealer and electronic table systems makes it adaptable to a wide range of casino environments. By combining elements of randomness, skill, and social interaction, the Grand Paradise Jackpot™ system delivers a unique and compelling gaming experience that traditional systems cannot match.

The LIVE Dealer-Controlled Multiplayer Games with Grand Paradise Jackpot™ features represent an advanced system integrated into live dealer-controlled multiplayer games, including both Live Dealer Game Tables (LDGTs) and Dealer-controlled Electronic Table Game Systems (DETGs) comprising multiple Electronic Table Game Terminals (ETGTs). This system enables unique Grand Paradise Jackpot™ mechanics that create dynamic and exciting gameplay experiences by incorporating elements of randomness, multiple-player interaction, and diverse game types. A brief summary of various features, functionalities, and benefits of the DETG Grand Paradise Jackpot™ techniques is described below

### Technical Improvements & Advantages

The invention provides specific technical improvements over the technical problems inherent in existing systems. The specific technical problem of prior art is the static jackpot, where a computer is used as a simple lookup table, leading to a disconnect between a jackpot's fixed value and its true, dynamic probability. The invention's Dynamic Probability-Based Jackpot Engine solves this by improving the computer's function, transforming it into a real-time computational engine that continuously recalculates probabilities and adjusts payouts, ensuring mathematical integrity. Another problem is the discrete, burst nature of player engagement, which is limited to a single hand. The Rolling Window trigger solves this by improving the GMS's architecture to be stateful across hands, using a FIFO queue to create a continuous, longitudinal jackpot event that sustains player anticipation. The problem of a passive dealer role is solved by the Secure Dealer Console, which improves the human-computer interface by feeding the dealer system-generated intelligence (near-miss alerts) and accepting their manual input as a trigger for electronic events. The technical problem of rigid, one-size-fits-all wagering is solved by the Player-Selectable Interface; this may require a non-trivial improvement in the GMS's data management, forcing it to maintain and query individualized per-player eligibility maps instead of a single, uniform bet state. Finally, the problem of generic, inefficient bonusing is solved by the Real-Time Personalized Engine, which improves the GMS's function by integrating it with player tracking data and AI models to enable targeted, one-to-one, in-game rewards and challenges, a far more efficient and effective retention mechanism than blanket promotions.

The notable benefits of the invention are numerous. It dramatically enhances player engagement by creating a live, transparent jackpot market and sustained, continuous jackpot opportunities. The system offers unparalleled flexibility and efficiency for operators; jackpot tiers are generated algorithmically based on rules, not stored in massive, static paytables, allowing new tiers to be added or modified with ease. The personalization engine provides a powerful tool for player retention and loyalty by delivering immediate, in-game value and personalized goals. A primary advantage is the robust, immutable, and relational audit trail. This feature is a specific technical solution to the regulatory challenges of a dynamic system, as it allows auditors to mathematically reconstruct any game state, verify the probability calculations, and confirm the fairness of all payouts, providing a clear path to regulatory approval. The modular, game-agnostic design of the specific probability engine also provides a significant commercial advantage, allowing the system to be deployed as a unified, scalable jackpot platform across multiple game types, such as Blackjack and Poker, not just Baccarat.

### Example Use Cases & Potential Applications

The primary application for this invention is as a jackpot side-bet system for live-dealer Baccarat games within a casino environment. It is specifically designed to be integrated with tables that utilize Electronic Table Game Terminals (ETGTs) for player wagering, allowing the dynamically calculated multipliers to be displayed directly to the players in real-time. The system, with all its innovative elements including the rolling window, dealer console, and personalization engine, is intended to be deployed as a complete, premium gaming experience to increase player engagement, retention, and side-bet revenue on Baccarat tables. The features focusing on probability and real-time tracking are particularly well-suited for markets where players actively track shoe history.

The modular, game-agnostic architecture of the specific Dynamic Probability-Based Jackpot Engine enables several alternative applications. The GMS and Probability Engine may be adapted for other card games by loading different game-logic modules. A notable alternative embodiment is its application to Blackjack. In this use case, the GMS would track the Blackjack shoe depletion and dynamically adjust multipliers for Blackjack-specific jackpot tiers, such as a Suited 7-7-7 or 5-Card 21. Another alternative application is for community card poker games. Here, the Probability Engine's logic would be adapted to perform intra-hand conditional probability calculations, dynamically adjusting jackpot odds as the flop, turn, and river cards are revealed. This unified platform architecture also enables novel cross-game or multi-game jackpots, where the GMS's ability to normalize probabilities across different game types would allow for a single, shared jackpot pool, a feat not technically feasible with disparate, static systems.

### Baccarat DETG Grand Paradise Jackpot™ Features and Functionalities

The Grand Paradise Jackpot™ features and functionalities are integrated into DETGs, and include multiple innovative approaches that expand beyond conventional jackpot systems. These concepts involve the use of progressive and multi-casino networks, player engagement features, and flexible configurations for operators. Some notable Grand Paradise Jackpot™ features and functionalities include:
Multi-Casino Progressive Grand Paradise Jackpot™:This involves linking multiple casinos through a shared network, where DETGs across different locations contribute to a single progressive jackpot. The system tracks player engagement across locations in real-time and triggers a jackpot when a certain player threshold is reached. This multi-property integration provides a sense of shared excitement across different geographic locations.
Side Bet-Driven Grand Paradise Jackpot™ Funding: Players' side bets contribute to the jackpot pool, allowing for quick accumulation. This method also creates a sense of involvement for players as they know their bets directly impact the jackpot size.
Cumulative Sequential Player Participation: In this system, the jackpot is awarded when a predefined number of players participate sequentially over a certain time. This concept adds a layer of excitement, as players realize their gameplay is actively contributing to a shared goal.
Player-Selectable Jackpot Modes: Players may select different jackpot participation modes, allowing for a tailored experience where they choose between individual payouts or group-based jackpots. This offers a more personalized gaming experience.
Cross-Game Jackpot Eligibility: Players may qualify for the Grand Paradise Jackpot™ by participating across multiple game types (e.g., blackjack, baccarat), thus fostering more diverse engagement. This differs from traditional systems that limit eligibility to a single game.

These concepts highlight the flexibility and scalability of the Grand Paradise Jackpot™ system, which enables multiple use cases that enhance engagement for both players and casinos.

### Grand Paradise Jackpot™ Eligibility Criteria

Eligibility for the Grand Paradise Jackpot™ may be based on a wide array of criteria, designed to engage a diverse range of players and to reward different styles of gameplay. Some examples include:
Time-Based Participation: Players are eligible if they participate in games during specific time windows, such as a “golden hour”. This drives player activity during off-peak hours, increasing overall game traffic.
Session Duration: Players who continuously play for a specified period (e.g., 30 minutes) may become eligible, encouraging longer playtimes.
High Roller Eligibility: This feature rewards players who consistently place high-value bets. Such criteria incentivize larger wagers, directly benefiting the casino's revenue.
VIP Status: VIP players or those with higher loyalty tier standings may gain special access to the Grand Paradise Jackpot™. This feature enhances customer retention and loyalty programs by offering exclusive benefits.

These diverse eligibility criteria ensure that the Grand Paradise Jackpot™ system may cater to both casual players and high-rollers, providing equal opportunities for participation while driving player retention.

### Grand Paradise Jackpot™ Triggering Criteria

Triggering a Grand Paradise Jackpot™ in the system involves various mechanisms, each designed to add layers of randomness, excitement, and fairness to the gameplay. Some of the innovative triggering criteria include:
Cumulative Wager Threshold: A jackpot is triggered once a cumulative total wager across all DETGs in the casino reaches a predefined threshold. This mechanism fosters a communal sense of achievement as players contribute towards unlocking the jackpot.
Random Timer-Based Trigger: The jackpot may be activated randomly after a certain period of gameplay, maintaining an element of surprise.
Simultaneous Player Bet Match: The Grand Paradise Jackpot™ may trigger if multiple players place identical bets simultaneously. This creates shared moments of anticipation among players.
Game-Specific Trigger: A jackpot may be awarded when a specific card combination or game outcome occurs, making each game round exciting as players anticipate a potential jackpot event.

These criteria introduce novelty by moving beyond static jackpot triggers based solely on wagering or winning outcomes, creating excitement through unpredictable and varied conditions.

### Grand Paradise Jackpot™ Funding Techniques

The Grand Paradise Jackpot™ is funded through a variety of methods that encourage participation from players while ensuring that the jackpot grows rapidly over time. Notable funding techniques include:
Side Bet Contributions: A portion of side bets placed during gameplay is allocated to the jackpot pool. This is particularly effective as side bets are often lower in value, yet collectively significant, ensuring steady growth of the jackpot.
Tiered Bet Contributions: Contributions to the jackpot pool scale according to the size of the wager. High-rollers may contribute more, incentivizing larger bets.
Progressive Wager Matching: The system may match a percentage of player wagers and allocate this to the jackpot. This progressive matching accelerates jackpot accumulation and player engagement.
Loyalty Points Conversion: Players may opt to convert loyalty points into jackpot contributions, allowing them to leverage non-monetary rewards.

These funding techniques create a dynamic and transparent system where players may see how their actions contribute to the growing jackpot, driving engagement and sustained interest.

### Grand Paradise Jackpot™ Distribution Techniques

Once the Grand Paradise Jackpot™ is triggered, the system uses a variety of methods to distribute the jackpot among players. These distribution techniques include:
Bet Proportional Distribution: The jackpot is distributed proportionally based on the size of each player's wagers. This encourages higher betting and rewards players who contribute more significantly to the jackpot pool.
Last Bet Multiplier: The player who placed the last bet before the jackpot was triggered may receive a bonus payout. This creates urgency in gameplay as players aim to be the last to bet.
Skill-Based Distribution: Some jackpots may reward players based on their performance in the game, such as achieving specific skill-based milestones. This adds an element of skill to the traditionally luck-based system.
Neighbor Luck Share: Players sitting adjacent to the jackpot winner may also receive a share of the jackpot, fostering a sense of community and shared excitement at the table.

These techniques allow for flexibility in payout structures, enabling operators to tailor the system to different player segments and enhance the social aspects of the gaming experience.

### Grand Paradise Jackpot™ Enabling/Disabling Techniques

Operators have full control over when and how the Grand Paradise Jackpot™ is enabled or disabled, allowing for dynamic control based on player activity and business objectives. Some of the enabling/disabling criteria include:
Time-Limited Enabling Windows: The jackpot is only enabled during specific time windows (e.g., peak casino hours). This creates urgency and drives traffic during high-traffic periods.
Jackpot Pool Size Trigger: The jackpot becomes enabled once the pool reaches a certain size. This ensures that players are incentivized to engage when the jackpot has reached an appealing amount.
High Bet Activation: The jackpot may only be enabled when players place bets above a certain threshold. This promotes higher betting activity during gameplay.

These enabling/disabling features offer operational flexibility and allow casinos to optimize the system to maximize player engagement while controlling jackpot payouts.

### Innovative Element I—the Dynamic Probability-Based Jackpot Engine

One specific technical innovation is the dynamic jackpot engine, a paradigm shift from conventional static jackpot systems in wager-based gaming. This innovative element describes a comprehensive technological framework centered on a Game Management System (GMS) and a specialized Probability Calculation Engine, designed to solve the technical problem of static jackpots in Baccarat, where the prize value is disconnected from the true, real-time probability of winning. In prior art systems, a jackpot is a fixed prize for a fixed event, regardless of the game's state. This aspect of the invention provides the practical application of a live jackpot market by creating a specific, technical feedback loop. The system utilizes a real-time card recognition system to identify each card dealt from a physical shoe. This card data is fed to the GMS, which maintains a constantly updated dataset of the shoe's remaining composition. With every card deal, this updated dataset is processed by the Probability Calculation Engine to continuously recalculate the combinatorial probability for a plurality of jackpot tiers (e.g., 36 tiers based on six-card combinations). The GMS then dynamically adjusts the jackpot multipliers for each tier based on this real-time probability. This transforms the GMS from a simple computer functioning as a static lookup table into a dynamic, real-time analysis engine, which is a tangible improvement to the computer's functionality. This engine is the foundational platform enabling a host of other innovative elements, such as perceived value weightings and time-based escalations.

### Sequence Diagram Components:

Electronic Table Game Terminals (ETGTs): These are the player-facing client interfaces, implemented as physical terminals at a Live Dealer Game Table (LDGT) or Dealer-controlled Electronic Table Game System (DETG). They are responsible for accepting player wagers, including the optional jackpot side bet, and displaying all game information, most notably the dynamically changing jackpot multipliers transmitted from the GMS.

Live Dealer Station (LDGT/DETG): This is the physical location of the live game, which includes the human dealer, the Baccarat table, and the physical shoe of cards. It serves as the primary source of real-time game events.

Real-Time Card Recognition System: This is an important hardware and software component integrated into the Live Dealer Station. It uses technology such as high-speed optical scanners, image recognition cameras, or RFID-embedded cards to identify the rank and suit of each physical card as it is dealt from the shoe in real-time. It provides the primary data input for the entire dynamic system.

Game Management System (GMS): The GMS is the central server and processing hub of the entire system. It coordinates all components, manages specific game logic, processes all wagers, and, most importantly, maintains the real-time shoe composition dataset. It receives card data from the recognition system and multiplier data from the Probability Calculation Engine, applies business logic, and broadcasts the final jackpot multipliers to all ETGTs.

Probability Calculation Engine: This is a specialized software component, which may be integrated within the GMS or operate as a separate microservice, responsible for the specific mathematical computations. It receives the current shoe composition dataset from the GMS and executes complex combinatorial probability algorithms to calculate the real-time odds of each defined jackpot tier occurring.

Casino Management System (CMS)/Player Tracking System: This is the broader casino backend database that manages player accounts, loyalty data, and financials. The GMS interfaces with the CMS for secure player authentication, wager processing, and payout verification.

### Implementation Details

The technical implementation of the Dynamic Probability-Based Jackpot Engine represents a significant improvement over conventional gaming systems. The system is architected as a real-time data processing pipeline. At the dealer station, the Real-Time Card Recognition System is the primary data source. This may be implemented in several ways to ensure accuracy and speed, such as high-speed optical scanners integrated into the dealing shoe that read card ranks and suits (potentially via barcodes or other markings), or an overhead high-definition camera coupled with an image recognition software module that identifies cards as they are placed on the table. An alternative embodiment involves using physical cards embedded with RFID chips, which are read by an RFID antenna within the dealing shoe, providing instantaneous and error-free data transmission to the GMS. This raw card data (e.g., King of Hearts) is transmitted over a secure, low-latency network connection to the central Game Management System (GMS).

The GMS, a high-availability server, maintains a Shoe Composition Dataset in its memory. For an 8-deck shoe, this dataset is initialized with 416 card entries. As each card is dealt, the GMS receives the data (e.g., King of Hearts) and atomically decrements the count for that specific card in the dataset (e.g., King of Hearts: 8->7). This updated dataset, representing the exact composition of cards remaining in the shoe, is notable input for the Probability Calculation Engine.

The Probability Calculation Engine itself is a specialized software module designed for high-speed combinatorial mathematics. To address the specific algorithms, it calculates the probability of a specific combination (e.g., Six Red Aces) using hypergeometric distribution. The formula calculates the probability of k successes (e.g., 6) in n draws (e.g., 6), from a finite population N(e.g., 408 cards remaining) that contains K successes (e.g., 15 Red Aces remaining). For a tier like Six Red Aces (Same Suit) in an 8-deck shoe (8 Hearts, 8 Diamonds), the probability of getting 6 Aces of Hearts from 8 available, out of 416 total cards, is calculated. The engine performs this complex calculation for all 36+ defined tiers simultaneously after every single card deal.

Once the engine returns the set of new, real-time probabilities to the GMS, the GMS applies a final layer of business logic before broadcasting the multipliers. This includes a novel perceived card value weighting. The system allows operators to configure a weighting factor, for example, applying a 1.2× base multiplier to combinations involving Aces and a 1.0× multiplier to combinations involving 2s, even if their mathematical probability is identical. This provides a technical solution that balances pure math with the psychological appeal for players, a notable consideration for the Macau market. The final, adjusted multipliers are then transmitted via a low-latency protocol to all connected ETGTs, which update their displays in near real-time. This entire scan-calculate-adjust-display loop must execute in sub-second time to avoid slowing the game, representing a significant improvement in computer processing and network function over static systems. This specific engine is also adaptable; its probability-based framework may be applied to other games, such as calculating the odds of a 5-card 21 in Blackjack or specific number sequences in Roulette based on historical data.

### Example Walk-Through Scenario:

A player, Player A, approaches an Electronic Table Game Terminal (ETGT) at a live Baccarat table in a Macau casino. The table is running the Grand Paradise Jackpot system. At the beginning of a new 8-deck shoe, Player A opts-in by placing a $5 jackpot side bet via the dedicated area on their touchscreen. The overhead display and Player A's ETGT show the starting multipliers for all 36 jackpot tiers; the Six Red Aces (Same Suit) tier may start at a 500,000× multiplier.

The dealer begins the first hand, dealing four cards: Ace of Hearts, 8 of Clubs, King of Spades, 7 of Diamonds. The Real-Time Card Recognition System instantly identifies these cards and sends the data to the Game Management System (GMS). The GMS updates its shoe composition dataset, noting one Ace of Hearts is gone (7 remaining). The GMS immediately queries the Probability Calculation Engine with the new dataset. The engine recalculates the odds for all 36 tiers. The probability of hitting Six Red Aces (Same Suit) has now decreased (as it may require 6 Hearts or 6 Diamonds, and one Heart is gone). In response, the GMS dynamically increases the multiplier for the Six Red Aces (Same Suit) tier to 510,000×. This new, higher multiplier is broadcast to all ETGTs, and Player A sees the potential payout for that specific tier visibly increase on their screen.

The game continues for several rounds. Deep into the shoe, no Red Aces have been dealt for 50 hands. The GMS and Probability Engine have continuously recalculated the odds, determining that the remaining Red Aces are clumped in the remaining deck, slightly increasing their probability of appearing together. In response, the GMS dynamically decreases the multiplier for Six Red Aces to 480,000× to reflect this lower rarity. Player A, who is tracking this, understands the jackpot is a live market.

Later, the dealer draws the fifth card of a hand: an Ace of Diamonds. The system again updates. The final card drawn is another Ace of Diamonds. Suddenly, the system recognizes that these two cards, combined with four other Red Aces dealt in previous hands (which were tracked by a separate rolling window feature), do not form a winning combination in this specific scenario. However, let's assume a different win: the first six cards of a new hand are Ace of Diamonds, Ace of Hearts, Ace of Diamonds, Ace of Hearts, Ace of Diamonds, Ace of Diamonds. The GMS receives this sequence. It checks against its jackpot tiers and finds a match for Six Red Aces (Mixed Suits). The GMS instantly checks the current multiplier for that tier, which had been dynamically adjusted to 10,000× based on the depleted shoe state. The system flashes a win notification on Player A's ETGT, calculates the payout (Jackpot Bet*10,000), and interfaces with the CMS to verify and process the payout. All other players see the jackpot has been hit and watch the multiplier for that tier reset to its base level for the next shoe.

### Player Interaction:

A player's interaction with the Dynamic Probability-Based Jackpot Engine is centered on observation and a single, optional betting action. The player sits at an ETGT which features a high-resolution touchscreen display. Alongside the standard Baccarat betting areas for Player, Banker, and Tie, there is a dedicated, clearly marked Grand Paradise Jackpot betting area. To participate, the player simply places a wager in this area before the No More Bets signal, just as they would any other bet.

An important feature of the player's interaction is visual and informational. A portion of the ETGT screen, as well as large overhead displays, is dedicated to showing the list of jackpot tiers and their corresponding multipliers. The defining interaction is that these multipliers are not static. As the game progresses and cards are dealt from the shoe, the player watches these multipliers change in real-time. A player may see the multiplier for Six Black Kings increase significantly after several Black Kings are dealt, indicating the remaining ones are now rarer. Conversely, they may see a multiplier for a low-card combination decrease as the shoe becomes rich in low cards. This transforms the jackpot from a passive, one-time bet into an engaging, live spectacle. This dynamic display adds a layer of strategy and excitement, as knowledgeable players may track the changing probabilities and feel a heightened sense of anticipation when betting into a shoe state that has inflated the multipliers for certain combinations. When a jackpot is hit, the player's ETGT will erupt with celebratory graphics and sounds, clearly displaying the combination, the multiplier applied, and the final win amount.

### Distinguishing Innovative Aspects:

One primary distinguishing innovative element of this system is the paradigm shift from a static, fixed-odds jackpot to a dynamic, real-time, probability-based jackpot. Conventional casino jackpots, including existing Baccarat side bets, are based on a fixed paytable; a specific outcome (e.g., a five-card hand) always pays a fixed amount or a fixed percentage of a progressive pool. These systems are technically static and unconcerned with the changing state of the game.

This aspect of the invention is fundamentally different. Its novelty lies in the creation of a technical feedback loop where the jackpot's value is a direct, calculated function of the current game state. The system technically maintains a real-time dataset of the remaining cards in the shoe, a concept foreign to static jackpots. It then uses this dataset to continuously perform complex combinatorial probability calculations after each card is dealt. The output of this calculation—the true, real-time probability of a rare event occurring—is then used to dynamically modify the jackpot multiplier itself. This creates a live market for jackpots, where the payout displayed to the player is a direct reflection of the event's mathematical rarity at that precise moment. This specific, continuous feedback mechanism (card depletion->probability recalculation->dynamic multiplier adjustment) is a non-obvious technical solution not taught by prior art, which at best teaches balancing odds between different games, not within a single Baccarat shoe in real-time. This dynamic, probability-based multiplier adjustment, enabled by the integration of real-time card recognition and a specialized calculation engine, is the specific innovative element.

### Distinguishing Innovative Steps:

Maintaining a Real-Time Shoe Composition Dataset: The first inventive step is the GMS receiving real-time card data from the recognition system and using it to actively maintain and continuously update a dataset in memory that represents the exact composition of physical playing cards remaining in the shoe. This step is absent in conventional systems, which do not track the shoe's state to modify payouts.

Continuous Real-Time Probability Recalculation: The second inventive step is the GMS, in response to each dealt card, querying the Probability Calculation Engine to execute a complex combinatorial probability calculation (e.g., hypergeometric distribution) for all defined jackpot tiers (e.g., 36 tiers) based on the newly updated shoe composition dataset. This continuous recalculation, rather than a one-time static lookup, is a novel process.

Dynamic Multiplier Adjustment and Broadcast: The third inventive step is the GMS receiving the newly calculated probabilities and dynamically adjusting the jackpot multipliers for each corresponding tier, creating a live feedback loop where the payout value is directly tied to the real-time rarity. This step concludes by the GMS broadcasting this new, updated set of multipliers to all connected ETGTs and displays, ensuring the live market is visible to all players.

### Technical Improvements to Existing Technical Problems

Technical Problem 1: Misaligned Jackpot Value and True Probability. In conventional static jackpot systems, the jackpot prize is fixed. As a Baccarat shoe is dealt, the composition of remaining cards changes, altering the true mathematical probability of a rare event (like Six Red Aces) occurring. A static jackpot's value becomes disconnected from its real-time rarity; it may be overvalued (if the event becomes more likely) or undervalued (if the event becomes rarer), which is a technical flaw in fairness and game integrity.
Technical Solution 1: The Dynamic Probability-Based Jackpot Engine provides a direct technical solution. By continuously tracking the remaining shoe composition and recalculating the combinatorial probability after every card deal, the system ensures the jackpot multipliers are always proportionally aligned with the event's true, real-time mathematical rarity. This represents a tangible improvement in the computer's function, enhancing game fairness, integrity, and providing a more accurate and responsive gaming experience.
Technical Problem 2: Limited Player Engagement in Baccarat. Conventional Baccarat is technically simple, offering few wagering options and a fast-paced but repetitive game flow. Static jackpots offer a set it and forget it side bet that adds little engagement beyond the initial wager. This limited interaction is a technical problem for player retention and engagement.
Technical Solution 2: The dynamic engine transforms the GMS's function from a passive paytable lookup device into an active, real-time engagement engine. The system's output—the dynamically changing multipliers displayed on all ETGTs—creates a live market atmosphere. This provides a new, engaging information feed for players, adding a layer of observable strategy and excitement as they watch the potential payouts for rare combinations grow or shrink with each dealt card. This improves the computer's functionality by using its processing power to create a dynamic, interactive information display that directly enhances player engagement.
Technical Problem 3: Inefficient and Inflexible Jackpot Configuration. Conventional systems may require operators to define and store massive, static paytables for every possible jackpot. This is an inefficient use of computer memory and is highly inflexible; adding, removing, or adjusting a jackpot tier is a cumbersome manual programming task.
Technical Solution 3: The dynamic engine provides a more efficient and flexible technical implementation. Instead of storing static paytables, the system stores a set of rules and algorithms. The jackpot multipliers are not stored, they are generated algorithmically in real-time based on the probability calculations. This is a more efficient use of computer processing over static memory storage. It also provides immense flexibility; an operator may add a new jackpot tier (e.g., Six Red 7s) simply by adding a new rule, and the engine will automatically calculate its probability and generate its dynamic multiplier without requiring a massive new paytable entry. This algorithmic, processing-based approach is a clear improvement in computer functionality, efficiency, and system flexibility.

### Data Input:

The system may require several notable data inputs to function. One primary and most important input is the Real-Time Card Data from the Card Recognition System, which must provide the rank and suit of each card as it is dealt from the shoe. The second input is the Player Jackpot Wager, received from the ETGT when a player opts-in to the side bet. A third, configurable input is the set of Operator-Defined Business Logic Parameters, such as the 36 defined jackpot tiers and any perceived card value weighting factors (e.g., Aces=1.2× weight) that the GMS uses to modify the pure mathematical probabilities.

### Component Interactions and Procedural Steps:

The procedural flow of this engine is a continuous, real-time loop. Step 1: The dealer deals a physical card from the shoe. Step 2: The Real-Time Card Recognition System scans the card and instantly transmits its identity (e.g., Ace of Spades) to the Game Management System (GMS). Step 3: The GMS receives this data and updates its Shoe Composition Dataset by decrementing the count for Ace of Spades. Step 4: The GMS immediately sends a request to the Probability Calculation Engine, providing it with the complete, updated Shoe Composition Dataset. Step 5: The Probability Calculation Engine iterates through all 36+ defined jackpot tiers (e.g., Six Red Aces, Six Black Kings, etc.) and performs a complex combinatorial probability calculation for each one based on the remaining cards in the dataset. Step 6: The Engine returns the full list of new, real-time probabilities to the GMS. Step 7: The GMS applies its business logic, such as perceived card value weightings, to this probability list to determine the final, adjusted multipliers for each tier. Step 8: The GMS broadcasts this new, complete set of multipliers over the network to all connected ETGTs and overhead displays. Step 9: All ETGTs and displays update their graphics to show the new multipliers to the players. This entire loop executes in near-real-time for every single card dealt, ensuring the jackpot values are always synchronized with the true state of the shoe.

### Data Processing:

The specific data processing task is the Real-Time Combinatorial Probability Calculation performed by the Probability Calculation Engine. This involves applying statistical models, such as the hypergeometric distribution, to the shoe composition dataset to determine the odds of drawing specific rare combinations from the remaining finite set of cards. The second processing task is the Multiplier Adjustment Algorithm run by the GMS. This algorithm takes the raw probability data as input and applies configurable weighting factors (like perceived card value) to generate the final, player-facing multiplier. Finally, all calculations, card data, and multiplier adjustments are processed for Data Logging, creating a comprehensive and immutable audit trail for regulatory compliance and game integrity verification.

### Outputs and Responses:

One primary output of the system is the continuous stream of Dynamically Adjusted Jackpot Multiplier Data broadcast by the GMS. This data is rendered by the ETGTs and overhead displays as a visible, real-time list of jackpot tiers and their fluctuating payout values. Another notable output is the Jackpot Win Notification and Payout Calculation. When a winning combination is detected, the GMS outputs a win signal to the specific ETGT and calculates the final payout based on the multiplier at that exact moment. An important backend output is the Comprehensive Audit Log, which records every card scanned, probability calculated, multiplier adjusted, and bet placed, ensuring full transparency and regulatory compliance.

### Data Storage and Reporting:

The system may require several notable data structures. The most important is the Shoe Composition Dataset, which is stored in the GMS's high-speed memory (RAM) for real-time access and continuous updates. Persistently stored in a database are the Jackpot Tier Configuration Tables, which define the 36+ tiers, their triggering combinations (rank, color, suit), and their base multiplier or perceived value weighting. Finally, a Historical Jackpot Log database is desirable for reporting and auditing. This log immutably stores timestamps, card-deal history, calculated probabilities, adjusted multipliers, player bets, and alljackpot win events, providing a comprehensive report for regulators and operators.

### Error Handling and Security Measures:

To ensure system integrity, multiple error handling and security measures are required. The Real-Time Card Recognition System must have high fault tolerance, potentially using redundant scanners or cameras with a validation algorithm to prevent misreads. All network communication between the ETGTs, GMS, and Probability Engine may be encrypted to prevent data sniffing or man-in-the-middle attacks that may alter bets or jackpot values. The most important security feature is the Comprehensive Audit Trail. Every card scanned, every probability calculated, and every multiplier adjusted is logged in real-time by the GMS. This immutable log provides a robust defense against fraud or errors and ensures full regulatory compliance by allowing auditors to reconstruct any game state and verify the mathematical correctness of the jackpots awarded.

### End of Interaction:

The dynamic calculation loop for this engine is continuous, ending only when the Baccarat shoe is completed (i.e., when the cut card is reached). At that point, the dealer initiates the new shoe procedure. The GMS receives this signal, flushes the current Shoe Composition Dataset from its memory, and re-initializes the dataset with the full card count for a new, complete shoe (e.g., 8 decks/416 cards). The Probability Calculation Engine recalculates the base probabilities for the full shoe, and the GMS broadcasts the reset, base-level multipliers to all ETGTs, making them ready for the first hand of the new shoe.

### Subject Matter Eligibility Considerations: Innovative Element 1 (Dynamic Engine)

### Detailed Technical Description & Implementation Details

This element is implemented as a specific technical solution to the technical problem of static jackpots in wager-based card games. The implementation is not an abstract idea but a concrete apparatus and process. The system comprises a first server system, the Game Management System (GMS), which includes a processor and memory executing a specialized software component designated as the Probability Calculation Engine. This engine is communicatively coupled to a physical, real-time card recognition system, such as an RFID reader or optical scanner integrated into the Baccarat shoe. This hardware provides a continuous stream of digital data, where each data packet represents a physical card's rank and suit.

The GMS processor executes specific instructions to maintain a stateful data model, the Shoe Composition Dataset, within its high-speed in-memory database. This dataset is a precise digital representation of the finite population of cards remaining in the physical shoe, for example, a 416-element array or hash map. Upon receiving new card data, the GMS processor atomically decrements the count for that specific card in the dataset. This action of maintaining a real-time, stateful model of a changing physical object is a specific, non-conventional computing task.

Immediately following this data model update, the GMS processor queries the Probability Calculation Engine. This engine is not a simple lookup table; it is a computational engine that executes specific combinatorial mathematics, such as the hypergeometric distribution formula, against the current Shoe Composition Dataset. It calculates the precise, real-time probability of drawing k successes (e.g., 6 Red Aces) in n draws (e.g., 6 cards for the rolling window) from the current finite population N (total cards remaining) which contains K successes (e.g., 12 Red Aces remaining). This calculation is computationally intensive and is performed for all 36 or more defined jackpot tiers simultaneously, in a sub-second timeframe.

The GMS processor then receives this vector of real-time probabilities and performs a further technical transformation: it applies a set of configurable business logic rules, such as a perceived card value weighting, to generate the final, adjusted jackpot multipliers. These multipliers are then broadcast via a low-latency, persistent network protocol, such as a WebSocket, to all connected Electronic Table Game Terminals (ETGTs). This entire, specific, high-speed feedback loop—scan, update data model, recalculate probability, adjust multiplier, broadcast—is a tangible, non-conventional technical implementation.

### Practical Application:

The practical application of this system is the creation of a new type of gaming apparatus: a dynamic, real-time jackpot market engine. This system is not merely using a computer as a tool to display abstract odds; the computer is integral to the invention's function. It performs a specific, practical task that is impossible for a human to perform: the continuous, sub-second recalculation of complex combinatorial probabilities for dozens of jackpot tiers based on a rapidly changing physical game state.

The computer's function is not abstract; it has a direct, physical-world consequence. The output of the GMS processor—the dynamically adjusted multiplier—is used to programmatically alter the fundamental financial rules and payout parameters of the electronic game in real-time. This creates a live feedback loop where the physical action of dealing a card from the shoe has an immediate, tangible, and computer-calculated effect on the electronic jackpot's value across the entire casino network. This transforms the game from a static lottery into a dynamic pricing market, which is a specific, practical, and non-conventional application of computing technology that solves the problem of fixed jackpots being mathematically disconnected from their true, real-time rarity.

### Technological Improvement/Improved Computer Functioning

This dynamic engine provides a specific, tangible improvement to the functioning of the gaming server (GMS) itself, solving a technical problem inherent in all prior art jackpot systems. The technical problem of conventional systems is that the gaming server functions as a static, inflexible data lookup table. Its process is a simple, routine computer function: IF event (e.g., Six Red Aces) occurs, THEN LOOKUP payout (e.g., 1,000,000×). This is an inefficient and technically flawed architecture because the payout value is static and mathematically disconnected from the event's true, dynamic probability, which changes as the shoe is depleted.

The invention's GMS architecture provides a direct technical solution that improves the functioning of the computer. The server's function is fundamentally changed from a static, memory-lookup tool to a dynamic, real-time, computational analysis and pricing engine. Its new, non-conventional process is: ON (card_dealt)->UPDATE data_model; FOR_EACH (tier)->tier.probability=CALCULATE_PROB(data_model); tier.multiplier=GENERATE_MULTIPLIER(tier.probability). This is a more efficient and flexible use of computer resources. Instead of storing massive, static paytables for every possible state, the server stores a set of mathematical rules and algorithms, algorithmically generating the payout parameters in real-time. This transformation from a passive data-storage device to an active, stateful, and computational generation tool is a clear technological improvement to the computer's own functionality. This specific, continuous feedback loop is a non-routine, non-conventional technical solution that is not merely an abstract idea, but a specific implementation that improves the server's operation.

### Example Walk-Through Scenario:

At the start of a new 8-deck (416 card) Baccarat shoe, a player places a jackpot bet at an ETGT. The GMS initializes its in-memory Shoe Composition Dataset. The Probability Calculation Engine calculates the baseline probability for the “Six Red Aces” tier (K=16 Red Aces in N=416 cards). The GMS receives this probability, applies its logic, and broadcasts the starting multiplier, 500,000×, which is displayed on the player's screen.

The game progresses for 30 hands, and 120 cards are dealt. The GMS, receiving data from the card recognition system, updates its dataset in real-time. Its analysis shows that of the 120 cards dealt, zero Red Aces have appeared. The technical state of the GMS data model is now N=296 cards remaining, with K=16 Red Aces still in the shoe. The GMS processor automatically queries the Probability Calculation Engine with this new, specific data model. The engine executes its hypergeometric distribution algorithm and determines that the probability of drawing 6 Red Aces in the next 6 cards is now significantly higher than the baseline, as the remaining shoe is “rich” in Red Aces.

The GMS receives this new, higher probability. Its internal logic, which is designed to keep payouts mathematically aligned with rarity, performs a technical transformation and decreases the multiplier for the Six Red Aces tier to 300,000×. This new, dynamically adjusted multiplier is broadcast to the player's ETGT, which updates its display.

Later, another 100 cards are dealt. The GMS data model now shows N=196, but it has tracked that 10 of the Red Aces have now been dealt. The K value in its data model is now K=6. The GMS processor again queries the engine. The engine calculates that the probability of drawing all 6 remaining Red Aces in the next 6 draws is now astronomically lower than the baseline. The GMS receives this new, near-zero probability and, in response, its logic dramatically increases the multiplier for the Six Red Aces tier to 5,000,000×. This demonstrates the improved function of the computer, acting as a real-time pricing engine that continuously modifies the game's financial rules based on a dynamic, stateful analysis of physical-world events.

### Innovative Element 2—the Rolling Window Consecutive Card Trigger

This innovative element defines a novel jackpot trigger mechanism that is technically distinct from the triggers found in prior art wager-based gaming systems. Conventional Baccarat side bets or jackpots are discrete, per-hand events; they are triggered based on the final outcome or a static combination within a single game or round (e.g., the first five cards dealt). This innovative element provides the practical application of a longitudinal, sustained-excitement jackpot by implementing a rolling window trigger. This system is technically architected to track a specific number (e.g., six) of the most recent consecutive physical playing cards dealt from the shoe, maintaining this count in a data buffer. Crucially, this evaluation is independent of game or hand boundaries, meaning a winning combination may be formed by cards dealt across multiple, separate Baccarat hands. This transforms the Game Management System's (GMS) function from a simple per-hand evaluator into a stateful, continuous monitor. This improvement in computer functionality, which maintains a memory buffer of card history and checks it against jackpot tiers with every single card deal, creates a sustained state of anticipation not found in prior art. Every card dealt, not just the end of a hand, becomes a potentially jackpot-triggering event, which is a non-obvious technical solution to the problem of discrete and fleeting jackpot opportunities in conventional games.

### Sequence Diagram Components:

Electronic Table Game Terminals (ETGTs): The player-facing client interfaces at the live Baccarat table. They accept the jackpot side bet and are responsible for displaying the jackpot status to the player, including potential near-misses related to the rolling window.

Live Dealer Station (LDGT/DETG): The physical location where the live dealer deals cards from the shoe.

Real-Time Card Recognition System: The hardware (e.g., optical scanner, camera) integrated with the dealer station that identifies the rank and suit of each physical card as it is dealt and transmits this data to the GMS.

Game Management System (GMS): The central server that executes the specific logic for this innovative element. It receives all card data, maintains the rolling window data buffer in its memory, compares the buffer's contents to the defined jackpot triggers after each card is processed, and identifies a jackpot win.

Casino Management System (CMS)/Player Tracking System: The backend database that manages player accounts, wagers, and payouts. The GMS instructs the CMS to process the jackpot payout upon a verified win.

### Implementation Details

The technical implementation of the Rolling Window trigger may require a specific software architecture within the Game Management System (GMS). The GMS is configured to maintain a data buffer, specifically a First-In, First-Out (FIFO) queue, in its active memory. This buffer is defined with a fixed size corresponding to the jackpot combination length, for example, six elements. As the Real-Time Card Recognition System (which may be an RFID shoe or an image-recognition camera) transmits the data for each card dealt (e.g., a JSON object {rank: ‘KING’, suit: ‘HEARTS’}), the GMS performs two operations. First, it pushes this new card object onto the queue. Second, if the queue size exceeds the defined limit (e.g., is now seven elements), it discards the oldest element from the front of the queue. This ensures the buffer always contains only the last six consecutive cards dealt.

After each new card is added and the buffer is normalized, the GMS immediately executes a comparison algorithm. This algorithm checks the current six-card combination within the buffer against a stored list of defined jackpot-triggering combinations (e.g., Six Red Aces, Six Black Kings). This comparison logic is an important feature of the invention; it runs with every single card deal, independent of whether that card is the first for the Player, the third for the Banker, or any other position. This makes the trigger evaluation a continuous, longitudinal process rather than a discrete, end-of-hand event.

To support this, several logical rules may be defined to handle edge cases. At the start of a new shoe, the dealer (or an automated signal from the shuffling machine) sends a New Shoe command to the GMS. In response, the GMS immediately purges all data from the rolling window buffer, ensuring the first card of the new shoe is the first entry in a clean buffer. If a player places a jackpot bet mid-shoe, their eligibility begins from that point forward. The GMS logs the timestamp or hand number of their bet and only evaluates them for a jackpot win if the entire six-card combination in the rolling window was dealt after their bet was placed, preventing players from betting on a partially formed combination. This implementation provides a robust, fair, and technically novel solution for a sustained jackpot experience.

### Example Walk-Through Scenario:

A player at an ETGT places a $5 Grand Paradise Jackpot side bet at the start of a new shoe. This bet makes them eligible for the entire duration of the shoe. The GFS (Game Management System) clears its six-card rolling buffer in memory.

### Hand 1:

Dealer deals: Player-Card-I (9 of Hearts)
   GMS Buffer: [9H]
   GMS checks buffer: No match.
Dealer deals: Banker-Card-I (King of Diamonds)
   GMS Buffer: [9H, KD]
   GMS checks buffer: No match.
Dealer deals: Player-Card-2 (King of Hearts)
   GMS Buffer: [9H, KD, KH]
   GMS checks buffer: No match.
Dealer deals: Banker-Card-2 (King of Hearts)
   GMS Buffer: [9H, KD, KH, KH]
   GMS checks buffer: No match.
The hand ends. The GMS buffer is not cleared.

### Hand 2:

The player's jackpot bet is still active.
Dealer deals: Player-Card-1 (King of Hearts)
   GMS Buffer: [KD, KH, KH, KH](The 9H is pushed out)
   GMS checks buffer: No match (contains 4 cards).
Dealer deals: Banker-Card-1 (King of Diamonds)
   GMS Buffer: [KH, KH, KH, KD](The first KD is pushed out)
   GMS checks buffer: No match.

### Hand 3:

The player's jackpot bet is still active.
Dealer deals: Player-Card-1 (King of Hearts)
   GMS Buffer: [KH, KH, KD, KH](The first KH is pushed out)
   GMS checks buffer: No match.
Dealer deals: Banker-Card-1 (King of Hearts)
   GMS Buffer: [KH, KD, KH, KH](The second KH is pushed out)
   GMS checks buffer: No match.
Dealer deals: Player-Card-2 (King of Hearts)
   GMS Buffer: [KD, KH, KH, KH](The first KH from Hand 2 is pushed out)
   GMS checks buffer: No match.
Dealer deals: Banker-Card-2 (King of Hearts)
   GMS Buffer: [KH, KH, KH, KH, KH](The KD from Hand 2 is pushed out)
   GMS checks buffer: No match.
The hand may require a third card for the Player.
Dealer deals: Player-Card-3 (King of Hearts)
   GMS Buffer: [KH, KH, KH, KH, KH, KH](The first KH from Hand 3 is pushed out)
   GMS checks buffer: Match detected! The buffer contains six consecutive King of Hearts cards, which matches a Six Red Kings jackpot tier.
The GMS immediately triggers the jackpot win. The ETGT erupts with celebratory graphics, announcing the jackpot win. The GMS sends a payout instruction to the CMS, and the win is awarded to the player. The game of Baccarat (Hand 3) then concludes normally. The GMS buffer continues to accept new cards, pushing out the winning combination as new cards are dealt.

### Player Interaction:

The player's interaction with the Rolling Window trigger is one of sustained engagement. One primary interaction is placing a single, optional jackpot side bet at the beginning of a new shoe. This bet is placed via a dedicated Jackpot button on the ETGT touchscreen. Once this bet is confirmed, the player's jackpot eligibility is active for the entire shoe.

The secondary interaction is observational and is notable to one aspect of novelty of this feature. On the ETGT display, there may be a small graphical area showing the last six cards dealt, representing the GMS's rolling window. This is not just a hand history; it is the active jackpot buffer. As each new card is dealt by the live dealer, the player physically sees the dealer's action, and simultaneously sees the card appear on their screen, pushing the oldest card out of the 6-card window. This creates a state of high anticipation with every single card, as the player may see near-misses forming (e.g., four Red Kings in a row . . . just need two more!). This transforms the game from a series of discrete hands into one long, continuous jackpot event, holding player attention even during the shuffling or payout phases of a standard Baccarat hand.

### Distinguishing Innovative Aspects:

The specific conceptual novelty of this element is the uncoupling of the jackpot event from the boundaries of a discrete Baccarat hand. Prior art systems, including 6-card Baccarat bets, are universally based on the final outcome of a single round. The jackpot is determined by the specific set of cards (e.g., first five, or final six) dealt to the Player and Banker hands within that one game.

This aspect of the invention is fundamentally different. Its rolling window mechanism is longitudinal and rolling. It is entirely independent of hand boundaries, player/banker assignments, or game outcomes. A winning sequence may be formed by the last card of one hand and the first five cards of the next. This creates a state of continuous jackpot eligibility from a single bet, whereas prior art may require a new bet for each discrete hand's jackpot opportunity. This technical implementation—a GMS maintaining a rolling buffer of consecutive card history and evaluating it with every single card dealt from the shoe—is a specific, non-obvious solution to the problem of limited, discrete jackpot events. It creates a meta-game that spans the entire shoe, a feature not found in conventional systems.

### Distinguishing Innovative Steps:

Maintaining a Rolling Data Buffer: The first inventive step is the GMS maintaining in its memory a rolling buffer or FIFO queue of a fixed size (e.g., six elements) that stores the most recent consecutive cards dealt from the shoe, regardless of which hand they belong to.

Continuous, Per-Card Jackpot Evaluation: The second inventive step is the GMS executing a comparison function in response to every single new card being dealt. This function compares the entire current state of the rolling buffer against the set of defined jackpot-triggering combinations. This continuous, per-card check is distinct from a per-hand, end-of-round evaluation.

Decoupling Eligibility from Hand Boundaries: The third inventive step is the system's logic for accepting a single jackpot bet at the start of a shoe and making that bet valid for all rolling window evaluations for the entire duration of that shoe. This delinks jackpot eligibility from the per-hand wager cycle, enabling the continuous, across-hand jackpot trigger.

### Technical Improvements to Existing Technical Problems

Technical Problem 1: Discrete and Fleeting Player Engagement. In conventional systems, jackpot excitement is limited to the brief moment a hand is dealt and resolved. Once the hand is over, the jackpot opportunity is gone, and player engagement drops until the next bet. This is a technical problem of burst engagement followed by lulls.
Technical Solution 1: The Rolling Window trigger provides a technical solution by transforming the GMS's evaluation logic. Instead of a discrete, per-hand check, the system performs a continuous, per-card check. This improvement in the computer's functionality creates a sustained state of engagement for the player. The player is now watching every card, as any card (not just the first four or five) may be the final piece of a winning combination that spans multiple hands. This solves the burst engagement problem by smearing the jackpot anticipation across the entire shoe.
Technical Problem 2: Limited Wager Value. In prior art, a jackpot side bet has a very limited time value—it is valid only for the single hand on which it is placed. This is an inefficient wagering mechanic and offers low perceived value to the player, requiring them to repeatedly place the bet every hand.
Technical Solution 2: This aspect of the invention improves the functionality of the GMS by allowing it to tie a single jackpot side bet (received at the start of the shoe) to hundreds of subsequent, independent jackpot evaluation events (one for each card dealt). This technically links one wager transaction to multiple probabilistic events, dramatically increasing the perceived value and efficiency of the bet. It's a more efficient use of the system's transaction-handling capabilities.
Technical Problem 3: Inflexible Trigger Mechanisms. Conventional systems are technically rigid. Their trigger logic is hard-coded to a specific, static set of cards within a hand (e.g., first five cards). This is an inflexible computer architecture that does not leverage the continuous stream of data (every card) already being processed.
Technical Solution 3: The Rolling Window is a more flexible and efficient data processing architecture. The GMS is already processing every card for display; This aspect of the invention improves that computer's function by adding a stateful evaluation layer (the buffer) that re-uses this existing data stream for a new purpose. This rolling buffer is a superior and more adaptable software pattern than a static hand evaluator, as the buffer size (e.g., 5, 6, or 7 cards) or trigger rules may be easily reconfigured in the GMS without re-architecting the specific game logic.

### Data Input:

One primary data input for this innovative element is the Real-Time Card Data stream from the Card Recognition System, providing the rank and suit of every card dealt. A second notable data input is the Player Jackpot Side Bet, which is a single wager placed at the beginning of the shoe via the ETGT. A third input is the New Shoe Signal, an electronic signal from the dealer console or automated shuffler that instructs the GMS to clear its rolling buffer.

### Component Interactions and Procedural Steps:

Step 1: The dealer initiates a new shoe. The Dealer Station sends a New Shoe signal to the Game Management System (GMS).
Step 2: The GMS clears its rolling window data buffer in memory.
Step 3: The GMS signals all connected ETGTs to enable jackpot betting for the new shoe.
Step 4: A Player at an ETGT places a single jackpot side bet. The ETGT sends this bet transaction to the GMS, which logs the player as jackpot eligible for this shoe.
Step 5: The dealer deals Card 1. The Real-Time Card Recognition System identifies it and sends the card data to the GMS.
Step 6: The GMS adds Card 1 to its rolling buffer. It then compares the buffer's contents (now 1 card) against its jackpot-triggering combination list. No match is found.
Step 7: Steps 5 and 6 repeat for Cards 2, 3, 4, and 5. With each card, the buffer grows (e.g., [C1, C2, C3, C4, C5]), and the GMS performs its comparison.
Step 8: The dealer deals Card 6. The Card Recognition System sends the data to the GMS.
Step 9: The GMS adds Card 6 to the buffer, which is now full: [C1, C2, C3, C4, C5, C6]. The GMS compares this 6-card combination to the trigger list. No match.
Step 10: The dealer deals Card 7. The GMS adds Card 7 to the end of the buffer and pushes Card 1 out of the front of the buffer. The buffer now contains [C2, C3, C4, C5, C6, C7].
Step 11: The GMS compares this new 6-card combination in the buffer to the trigger list. This process (deal, push/pop buffer, compare) repeats for every card dealt.
Step 12: If a match is detected (e.g., the buffer contains [K-Hearts, K-Hearts, K-Hearts, K-Hearts, K-Hearts, K-Hearts]), the GMS flags a jackpot win.
Step 13: The GMS sends a win notification to the eligible player's ETGT and sends a payout instruction to the Casino Management System (CMS) to credit the player's account.

### Data Processing:

One primary data processing task is Buffer Management (FIFO Queue). The GMS must, with each new card input, efficiently add the new card data to its in-memory buffer and discard the oldest card data, maintaining a constant state of the last six cards. The second notable task is Pattern Matching. After each buffer update, the GMS must execute a high-speed comparison of the buffer's current state against a predefined set of winning combinations. This involves checking for rank and color/suit matches for all 18 or 36 jackpot tiers. A third processing task is Eligibility Management, where the GMS validates that a player who placed a bet mid-shoe is only eligible for jackpots formed by cards dealt after their bet was confirmed.

### Outputs and Responses:

One primary output of this system is the Jackpot Win Notification. When the GMS's pattern matching identifies a win, it outputs a signal to the winning player's ETGT (triggering celebratory graphics/sound) and sends a secure transaction request to the CMS to process the payout. An optional, but important, output is the Real-Time Buffer Display Data. The GMS may continuously send the current state of its rolling buffer to all ETGTs, allowing them to render a Last Six Cards display that visually reinforces the continuous jackpot mechanism for the players.

### Data Storage and Reporting:

The Rolling Window Buffer itself is transient data, stored in the GMS's active memory and continuously overwritten. However, for auditing and regulatory compliance, the GMS must persistently log all data to a secure database. This includes a Card Deal Log, which timestamps every single card dealt from the shoe. It also includes the Jackpot Bet Log, which records which players were eligible for which shoe. Most importantly, the Jackpot Event Log records any jackpot wins, the exact 6-card combination in the buffer that triggered it, the timestamp, and the payout amount. This auditable trail is important for verifying the integrity of the rolling window trigger.

### Error Handling and Security Measures:

A primary error condition is a misread card from the Real-Time Card Recognition System, which would corrupt the rolling buffer. The system must include a mechanism (e.g., a dealer-facing prompt on their console) to correct a misread card, which would then trigger the GMS to retroactively correct its buffer state. Another error is a GMS reboot mid-shoe. To handle this, the GMS must persistently log every card deal, so that upon restart, it may rebuild its rolling buffer from the log and resume from the correct state. Security measures include encrypting the card data transmitted from the recognition system to the GMS and ensuring the GMS's buffer logic is secured in server-side code, inaccessible to players, to prevent any manipulation of the jackpot evaluation.

### End of Interaction:

The interaction for this specific jackpot feature concludes when the Baccarat shoe is finished (i.e., the cut card is reached). The dealer or automated shuffler sends a New Shoe signal to the GMS. In response, the GMS performs two notable actions: it purges all data from the rolling window buffer, and it flags all per-shoe jackpot bets from the previous shoe as expired. The system is now in a clean state, ready to accept new jackpot bets and begin building a new rolling window for the next shoe.

### Subject Matter Eligibility Considerations: Innovative Element 2 (Rolling Window)

### Detailed Technical Description & Implementation Details

This element is implemented as a specific, unconventional data-processing method that solves a technical problem unique to sequential, multi-round card games. The implementation is not an abstract idea but a concrete software architecture. The system comprises a first server system (GMS) with a processor that executes a specific jackpot trigger logic. This logic is technically implemented using a stateful, in-memory data structure, specifically a First-In, First-Out (FIFO) queue, which functions as the rolling data buffer. This buffer is defined with a fixed size, for example, six elements, where each element is a data object representing a single dealt card.

The GMS processor receives a continuous stream of card data from the real-time card recognition system. For every single card dealt, the processor executes a specific, non-conventional algorithm: First, it pushes the new card's data object onto the end of the FIFO queue. Second, it checks if the queue's size now exceeds the fixed limit of six. If it does, the processor pops the oldest card data object from the front of the queue. This push/pop operation is a tangible data manipulation that maintains a constant, rolling state of the last six consecutive physical cards dealt.

Crucially, after this buffer update, the processor immediately executes a pattern-matching algorithm, comparing the current six-card data state within the buffer against a stored list of predefined jackpot-triggering combinations. This entire process—receiving a card, updating the stateful buffer, and performing a comparison—is executed on every single card deal. This is a specific technical solution that is fundamentally distinct from conventional systems, as this logic is explicitly designed to be independent of, and to persist across, the discrete game hand boundaries of Baccarat. A winning combination may be formed by cards dealt across multiple, separate game rounds.

### Practical Application:

The practical application of this system is the creation of a new, tangible jackpot meta-game that runs continuously in parallel with the main Baccarat game. This is not an abstract idea but a specific, machine-based apparatus that solves the technical problem of discrete and fleeting player engagement. In conventional systems, jackpot excitement is limited to the few seconds a single hand is resolved. This invention's practical application is a system that creates a sustained, longitudinal jackpot experience. A single jackpot bet, placed at the start of the shoe, is made valid for hundreds of subsequent, independent, computer-evaluated jackpot events (one for each card dealt).

This system's function is impossible for a human to perform. A dealer or pit boss cannot reliably track the exact sequence of the last six consecutive cards, in order, across dozens of separate hands, while also managing the main game. The computer is integral, as its processor and memory are used to create and maintain this specific, stateful data buffer. The practical application is a fundamental change in the player experience, transforming the jackpot from a series of discrete, forgettable bets into one long, continuous state of anticipation, where every single card dealt from the shoe becomes a potentially jackpot-triggering event.

### Technological Improvement/Improved Computer Functioning

This rolling window buffer provides a specific, tangible improvement to the functioning of the gaming server (GMS) itself. The technical problem it solves is “data-event correlation across discrete, time-separated processes.” In a conventional Baccarat system, the server is largely stateless between hands; it processes a hand, records the outcome, and effectively purges the event data to prepare for the next discrete round. It has no technical mechanism for correlating a card dealt in Hand 5 with a card dealt in Hand 6 for a single jackpot event.

The invention's “rolling data buffer” is a specific technical solution that improves the computer's functionality by making it stateful across these discrete processes. The GMS's software architecture is fundamentally enhanced to maintain this persistent, rolling memory (the FIFO queue) of past game events. This is a non-conventional, non-routine use of a data structure. It improves the computer's function by enabling it to execute a new type of stream-processing logic—analyzing a continuous, consecutive sequence of data rather than discrete, isolated batches. This is a more efficient and powerful use of the computer's resources, as it re-uses the existing card data stream for a new, parallel, and stateful game logic, thereby solving the technical problem of how to track and trigger jackpot events that are not confined to a single game round.

### Example Walk-Through Scenario

A player places a $5 jackpot bet at the start of a new shoe, making them eligible for the rolling window jackpot. The GMS processor clears its 6-element FIFO queue in memory. The buffer is: [ ].
Hand 1: Four cards are dealt: [King of Hearts], [8 of Spades], [7 of Clubs], [King of Hearts]. The GMS buffer now holds: [KH, 8S, 7C, KH]. The processor checks the buffer; no match.
Hand 2: Four cards are dealt: [King of Hearts], [King of Hearts], [Ace of Diamonds], [9 of Spades].
As the [King of Hearts] is dealt, the buffer becomes: [8S, 7C, KH, KH, KH]. No match.
As the next [King of Hearts] is dealt, the buffer becomes: [7C, KH, KH, KH, KH]. No match.
As the [Ace of Diamonds] is dealt, the buffer rolls. The GMS processor pushes the [AD] and pops the [7C]. The buffer is now: [KH, KH, KH, KH, AD]. No match.
As the [9 of Spades] is dealt, the buffer rolls. The GMS processor pushes the [9S] and pops the first [KH]. The buffer is now: [KH, KH, KH, AD, 9S]. No match. The hand ends. The buffer state is maintained by the processor.
Hand 3: The dealer deals the next card, a [King of Hearts]. The GMS processor pushes the [KH] and pops the 15 oldest [KH]. The buffer is now: [KH, KH, AD, 9S, KH]. No match.
Hand 4: The dealer deals the next card, a [King of Hearts]. The GMS processor pushes the new [KH] and pops the oldest [KH]. The buffer is now: [KH, AD, 9S, KH, KH]. No match.
Hand 5: The dealer deals the next card, a [King of Hearts]. The GMS processor pushes the new [KH] and pops the [AD]. The buffer is now: [9S, KH, KH, KH]. This is incorrect. Let's restart the buffer tracking.

### Corrected Scenario:

Start of Shoe: Buffer [ ]
Hand 1: [KH], [8S], [7C], [KH]. Buffer is [KH, 8S, 7C, KH]. No match.
Hand 2: [KH], [KH], [AD], [9S].
Card 5 ([KH]) dealt. Buffer: [KH, 8S, 7C, KH, KH]. No match.
Card 6 ([KH]) dealt. Buffer: [KH, 8S, 7C, KH, KH, KH]. No match (due to 8S, 7C).
Card 7 ([AD]) dealt. Buffer rolls. Buffer is now: [8S, 7C, KH, KH, KH, AD]. No match.
Card 8 ([9S]) dealt. Buffer rolls. Buffer is now: [7C, KH, KH, KH, AD, 9S]. No match. Hand 2 ends.
Hand 3: [KH], [KH].
Card 9 ([KH]) dealt. Buffer rolls. Buffer is now: [KH, KH, KH, AD, 9S, KH]. No match.
Card 10 ([KH]) dealt. Buffer rolls. Buffer is now: [KH, KH, AD, 9S, KH, KH]. No match.
Hand 4: [KH], [KH].
Card 11 ([KH]) dealt. Buffer rolls. Buffer is now: [KH, AD, 9S, KH, KH, KH]. No match.
Card 12 ([KH]) dealt. Buffer rolls. Buffer is now: [AD, 9S, KH, KH, KH, KH]. No match.
Hand 5: [KH], [KH].
Card 13 ([KH]) dealt. Buffer rolls. Buffer is now: [9S, KH, KH, KH, KH, KH]. No match.
Card 14 ([KH]) dealt. Buffer rolls. Buffer is now: [KH, KH, KH, KH, KH, KH].
   The GMS processor's pattern-matching algorithm flags a WIN. This 6-card combination was formed by cards dealt consecutively across Hand 2, Hand 3, Hand 4, and Hand 5. The GMS processor, having verified the win against this specific, stateful data structure, transmits a jackpot trigger signal to the player's ETGT and the Casino Management System. This demonstrates a specific, non-conventional data processing method solving a technical problem.

### Innovative Element 3-Integrated Dealer and Player Agency Interface

This innovative element represents a technical framework for fundamentally enhancing the interactivity of wager-based gaming systems by introducing active, integrated control layers for both the dealer and the player. It moves beyond the passive nature of conventional systems, where dealers merely facilitate the physical game and players make simple, fixed bets. This aspect of the invention provides the practical application of a human-digital bridge by integrating two notable interfaces into the Game Management System (GMS): a Secure Dealer Console and a Player-Selectable Jackpot Interface. The dealer console is a novel showmanship tool, technically empowering the dealer to receive system-generated alerts (like near-misses) and then manually initiate electronic bonus rounds or activate jackpot eligibility, blending live, human-driven excitement with the electronic game. The player interface provides a menu-driven system on the Electronic Table Game Terminal (ETGT), allowing each player to customize their risk profile by choosing which specific jackpot tiers they wish to play for. This may require a significant improvement in the GMS's computer functionality, transforming it from a one-size-fits-all bet processor into a sophisticated engine that must track individualized, per-player eligibility maps in real-time.

### Sequence Diagram Components:

Electronic Table Game Terminals (ETGTs): The player-facing client terminals. For this element, they are critically enhanced to include a Player-Selectable Jackpot Interface, which is a graphical menu that displays all available jackpot tiers and accepts the player's unique subset selection.

Live Dealer Station (LDGT/DETG): The physical location of the live game, including the dealer.

Secure Dealer Console: A specific hardware and software interface, typically a secure touchscreen, communicatively coupled to the GMS. This component is distinct from simple game control (start/stop bet) buttons. It receives alerts from the GMS and sends manual activation signals to the GMS.

Game Management System (GMS): The central server. For this element, its functionality is improved to: 1) detect near-miss events from card data, 2) send alerts to the Dealer Console, 3) receive and process manual activation signals from the Dealer Console, 4) receive and store player tier selections from each ETGT, and 5) run a multi-layered win verification logic that checks both a general bet and the player's individualized tier selection map.

Real-Time Card Recognition System: The component that supplies the live card data to the GMS, which the GMS analyzes to detect the near-miss events that trigger dealer alerts.

Casino Management System (CMS)/Player Tracking System: The backend database that manages payouts. The GMS instructs the CMS to pay a jackpot only to the specific players whose individualized eligibility map confirms they selected the winning tier.

### Implementation Details

The technical implementation of this dual-agency framework may require significant enhancements to the GMS and its peripheral interfaces.

First, the Secure Dealer Console is implemented as a dedicated, access-controlled touchscreen terminal at the dealer's station. It is secure in that it may require dealer authentication (e.g., PIN, keycard, orbiometric scan) to activate its functions, preventing unauthorized use. This console is communicatively coupled to the GMS via an encrypted API. Its interface has two primary functions: 1) An Alerts panel, where the GMS may push real-time messages, such as NEAR MISS: 5 of 6 RED KINGS DETECTED. This is technically achieved by the GMS's game logic engine constantly comparing dealt cards against a near-miss ruleset (e.g., 5 of 6 matching cards). 2) A set of Activation Buttons (e.g., Initiate Bonus Round, Activate 2× Multiplier for 5 Hands). When the dealer presses one, the console sends a specific, secure RESTful API call or a WebSocket message (e.g., POST/api/gms/v1/game/123/manual_trigger with a payload {trigger: ‘BONUS_ROUND_1’}) to the GMS. The GMS then validates this signal and executes the corresponding electronic event for all ETGTs.

Second, the Player-Selectable Jackpot Interface is a software module on the ETGT, rendered at the start of a new shoe. The GMS first transmits the full list of available jackpot tiers (e.g., 36 tiers with their names and odds) to the ETGT. The ETGT displays these in a scrollable, menu-driven interface with checkboxes. The player makes their selection (e.g., checking 5 of the 36 tiers). When they confirm, the ETGT transmits this selection back to the GMS as a data structure, such as a JSON object or a bitmask (e.g., player_id: 456, session_id: 789, selected_tiers: [1, 5, 8, 12, 30]). The GMS must then store this selection in a temporary, high-speed database (like Redis) or in its active memory, creating a per-player eligibility map for the duration of the shoe. This represents a significant improvement in the GMS's data management capabilities over prior art.

When a jackpot-triggering combination is dealt, the GMS's win verification logic is now a more complex, multi-step process: 1) Identify the winning jackpot tier (e.g., Tier 5). 2) Query all ETGTs for players with an active general jackpot bet. 3) For each active player, retrieve their stored per-player eligibility map. 4) Check if the winning tier (Tier 5) exists within that player's specific map. 5) Authorize a payout only to the subset of players whose maps contain Tier 5. This individualized, multi-layered processing is a non-obvious technical solution.

### Example Walk-Through Scenario:

The scenario involves two parts: Player Agency followed by Dealer Agency.

### Part 1: Player Agency (Tier Selection)

At the start of a new shoe, Player A and Player B are at two different ETGTs at the same table. The GMS signals the ETGTs to display the Player-Selectable Jackpot Participation menu. The menu shows 36 tiers, including Tier 1: Six Red Aces and Tier 7: Six Red Kings. Player A is a high-roller and only wants to bet on the biggest prizes; she selects only Tier 1: Six Red Aces and Tier 2: Six Black Aces. Her ETGT sends this selection to the GMS, which stores it. Player B likes to bet on lucky numbers and selects Tier 7: Six Red Kings and Tier 8: Six Black Kings. His ETGT sends this different selection to the GMS, which also stores it. Both players place their $5 jackpot bet.

Twenty hands into the shoe, the rolling window (e.g., from innovative element 2) detects six consecutive Red Kings. The GMS identifies this as a Tier 7 jackpot win. The GMS queries its eligibility database. It finds both Player A and Player B have active $5 jackpot bets. It retrieves Player A's map: [TIER 1, TIER_2]. It checks if TIER_7 is in this map. It is not. It retrieves Player B's map: [TIER_7, TIER 8]. It checks if TIER_7 is in this map. It is. The GMS sends a You Won! notification to Player B's ETGT and instructs the CMS to pay him the jackpot. Simultaneously, it sends a Tier 7 Hit—Not Selected notification to Player A's ETGT, providing clear feedback on why she did not win.

### Part 2: Dealer Agency (Manual Bonus)

Later in the same shoe, the GMS's card recognition logic detects a sequence of five consecutive Red Aces. This is not a win, but it matches a near-miss rule. The GMS instantly sends an alert message to the dealer's Secure Dealer Console, which flashes: NEAR MISS: 5 of 6 RED ACES. The dealer, a skilled showman, sees this alert and the corresponding excitement from Player A (who is betting on that tier). To heighten the drama, the dealer presses the Initiate Jackpot Bonus button on his console. The console sends a manual_activation_signal to the GMS. The GMS receives this signal and immediately broadcasts a Start Bonus command to all ETGTs that have an active jackpot bet (both Player A and Player B). An interactive mini-game (e.g., Pick a Card, Win a Multiplier) launches on both players' screens, providing an additional, dealer-initiated way to win, directly bridging the live-action near-miss with an electronic bonus.

### Player Interaction:

This element introduces two novel forms of player interaction.

First, the Player interaction is one of customization and strategy. At the start of a shoe, the player is presented with a graphical menu on their ETGT. This menu lists all available jackpot tiers, perhaps with their odds and current multiplier. The player interacts by touching or selecting checkboxes next to only the tiers they wish to wager on. This is a deliberate, strategic choice, allowing them to manage their risk and preferences (e.g., I only want to bet on high-payout, low-odds tiers or I only want to bet on ‘Red’ combinations). After making their selections, they press a Confirm Selection button, which locks in their personalized jackpot profile for that shoe.

Second, the Dealer interaction is one of performance and agency. The dealer interacts with their Secure Dealer Console. They log in at the start of their shift. During the game, they receive information from the GMS in the form of alerts on their screen (e.g., Near Miss Detected!). This prompts a new, non-passive interaction: the dealer may choose to act. They may press a physical or touchscreen button on their console labeled Activate Bonus or Start Jackpot Frenzy. This manual, physical action by the dealer is a direct input that triggers a complex, system-wide electronic event, giving the dealer a new tool for showmanship that directly impacts the electronic game.

### Distinguishing Innovative Aspects:

The distinguishing novelty of this element is its active control layer, which fundamentally changes the passive nature of prior art gaming. Conventional systems are entirely programmatic or random; the dealer is a non-technical participant, and the player's only input is a simple, binary bet/no bet decision.

This aspect of the invention is technically distinct in two ways:
1. Dealer Agency: It provides a Secure Dealer Console that is not just a simple game-control (start/stop) device, but a performance interface. The GMS is technically improved to feed game-state intelligence (near-misses) to the dealer, and the console is technically implemented to receive secure, manual trigger signals from the dealer. This creates a novel human-in-the-loop technical framework where a live, human observation or decision may directly initiate a complex, electronic jackpot event.
2. Player Agency: It provides a Player-Selectable Jackpot Interface that is not a simple bet button, but a customization menu. This may require a non-obvious improvement in the GMS's functionality. The GMS is no longer a simple bet processor; it may be re-architected to become a per-player eligibility manager, capable of creating, storing, and checking against dozens of unique, individualized bet maps (one for each player) in real-time for every jackpot event. This technical solution for individualized risk management and bet customization on a community game table is not taught by prior art.

### Distinguishing Innovative Steps:

Transmitting a GMS-Generated Alert to a Dealer Console: The first inventive step is the GMS processing real-time card data, detecting a predefined near-miss event (a non-winning but close combination), and outputting a specific alert signal to the secure dealer console interface.

Receiving a Manual Activation Signal from the Dealer Console: The second inventive step is the GMS receiving a secure, validated manual activation signalfrom the dealer console, which was initiated by a physical action from the live dealer, and using this signal as the primary trigger for a system-wide electronic jackpot event (like a bonus round).

Displaying a Player-Selectable Menu of Jackpot Tiers: The third inventive step is the ETGT, upon a signal from the GMS, rendering a graphical interface that displays a plurality of distinct jackpot tiers and allows the player to select a subset of those tiers.

Storing and Checking an Individualized Player Selection Map: The fourth inventive step is the GMS receiving, storing, and maintaining this player-specific subset selection in memory, and then, upon a jackpot-triggering event, using this individualized map as an important part of the win verification logic, awarding the win only if the hit tier is present in that specific player's map.

### Technical Improvements To Existing Technical Problems

Technical Problem 1: Passive and Monotonous Dealer Role. In conventional electronic table games, the dealer's role is often reduced to that of a card turner or button pusher (start/stop bet). This leads to dealer boredom and a sterile, robotic player experience, which is a notable problem for casinos trying to sell a live entertainment experience.
Technical Solution 1: The Secure Dealer Console provides a specific technical solution by empowering the dealer. The GMS is improved to function as a digital assistant for the dealer, feeding them intelligence (near-miss alerts). The console, in turn, is a technical tool that allows the dealer to use this intelligence to perform. By manually triggering a bonus round, the dealer becomes an active, integral part of the electronic game's excitement, solving the problem of a passive dealer and improving the human-computer interaction of the entire system.
Technical Problem 2: Rigid, One-Size-Fits-All Wagering. Prior art jackpot systems are technically inflexible. A player is offered a single jackpot bet. If they take it, they are betting on all possible outcomes (e.g., all 36 tiers). This is a rigid wagering structure that fails to accommodate different player risk profiles, preferences, or bankrolls.
Technical Solution 2: The Player-Selectable Jackpot Interface is a specific technical improvement to the GMS and ETGT. It provides a technical framework for A la carte wagering. This may require a non-trivial improvement in the GMS's functionality, changing its computer logic from IF (bet_placed) THEN (award_win) to IF (bet_placed) AND (player_map CONTAINS winning_tier) THEN (award_win). This more complex, individualized data processing and storage solves the technical problem of rigid wagering by enabling player-level customization and risk management.
Technical Problem 3: Disconnected Bonus Triggers. In conventional systems, electronic bonus rounds are typically triggered by an RNG or a specific winning outcome. They feel canned and disconnected from the human drama of the live game, such as a near-miss that builds suspense but results in no payoff.
Technical Solution 3: This aspect of the invention provides a technical solution by creating a new data pipeline that connects the human drama to the electronic bonus. The system's computers are improved to 1) recognize the near-miss event from card data, 2) communicate this event to the human dealer via the console, and 3) allow the human dealer's manual response to be the trigger for the electronic bonus. This technical integration of card-recognition, dealer-alert, and manual-trigger logic solves the problem of disconnected bonuses by creating a bonus system that is directly responsive to the live, physical game flow.

### Data Input:

The system may require two novel types of data inputs. The first is the Manual Activation Signal, a secure, encrypted data packet (e.g., {event: trigger_bonus, dealer_id: 771}) sent from the Secure Dealer Console to the GMS when the dealer presses a button. The second is the Player Jackpot Tier Selection, a data structure (e.g., an array or bitmask) sent from an ETGT to the GMS at the start of a shoe, which details the specific subset of jackpot tiers that player has chosen to activate. A third, internal data input is the GMS's own Near-Miss Detection Data, which is generated by the game logic and fed to the dealer console's display interface.

### Component Interactions and Procedural Steps:

This element has two parallel procedural flows:

### Dealer Agency Flow:

1. The Real-Time Card Recognition System sends card data (e.g., King of Hearts) to the GMS.
2. The GMS processes this data and its logic detects a near-miss event (e.g., 5 of 6 Red Kings in the rolling window).
3. The GMS generates an alert message and sends it via an API call to the Secure Dealer Console.
4. The Dealer Console displays the message: ALERT: NEAR MISS—5/6 RED KINGS.
5. The live dealer sees this, feels the table's excitement, and physically presses the Manual Bonus Round button on the console.
6. The console sends a secure Manual Activation Signal (e.g., TRIGGER_BONUS_1) to the GMS.
7. The GMS receives and validates this dealer-initiated signal.
8. The GMS then broadcasts a Start Bonus command to all ETGTs that have an active jackpot bet.
9. The ETGTs receive this command and launch the interactive bonus mini-game for their respective players.

### Player Agency Flow:

1. The GMS signals the start of a new shoe.
2. The GMS sends the full list of 36 jackpot tiers to all ETGTs.
3. The ETGTs render the Player-Selectable Jackpot Interface menu.
4. A player at ETGT-1 selects Tiers A, B, and C.
5. The ETGT-1 sends the player's selection [A, B, C] to the GMS.
6. The GMS stores this selection in its memory, associated with ETGT-1's session.
7. The game proceeds. The GMS's logic detects a winning combination for Tier C.
8. The GMS performs its win check: It retrieves the eligibility map for ETGT-1, sees that it contains [A, B, C], and confirms that C is in the map.
9. The GMS sends a You Won Tier C! message to ETGT-1 and instructs the CMS to process the payout for that player.

### Data Processing:

The GMS performs several novel data processing tasks. First, Near-Miss Detection, an algorithm that compares the current game state (e.g., the rolling window) against the full list of jackpot triggers and identifies close or partial matches, which are then formatted as alerts for the dealer. Second, Individualized Eligibility Mapping, which involves receiving, storing, and managing unique data maps (the player's tier selections) for every active player. Third, Multi-Layered Win Verification, a more complex win-checking algorithm that, upon a jackpot hit, must query and cross-reference both the general bet status and the player's individualized selection map before authorizing a payout. This individualized data processing is a significant improvement over conventional, uniform bet processing.

### Outputs and Responses:

The system generates several novel outputs. From the GMS to the Secure Dealer Console, it outputs Near-Miss Alerts, providing real-time game intelligence to the dealer. From the GMS to the ETGTs, it outputs the Player-Selectable Tier Menu data, allowing the terminal to render the customization interface. In response to a dealer's manual signal, the GMS outputs a Bonus Round Initiation Command to all ETGTs, instructing them to launch a mini-game. Finally, when a jackpot hits, the GMS outputs Individualized Win/Loss Notifications to the ETGTs, telling Player A You won! while simultaneously telling Player B Tier X hit, but you did not select it, which provides desirable feedback for the selection-based system.

### Data Storage and Reporting:

Two new, important data structures may be stored. First, the Player Tier Selection Database/Cache may be maintained by the GMS. This is a high-speed, in-memory notable-value store (like Redis) that maps a player_session_id to their selected list of tiers (e.g., session_789: [1, 5, 12]). This data is transient and valid only for the duration of the shoe. Second, a persistent Dealer Action Log may be stored in the casino's main database for auditing and reporting. This log must record every signal received from the dealer console, including the dealer id, timestamp, and event triggered (e.g., BONUS_ROUND_1). This allows management to track bonus frequency, dealer performance, and ensure regulatory compliance.

### Error Handling and Security Measures:

One primary security measure for this element is securing the Dealer Console. Access may be strictly controlled via dealer-specific authentication (e.g., PIN, RFID card, or biometric scan) to prevent unauthorized personnel or players from triggering bonuses. All communication between the console and the GMS may be encrypted. For player agency, the important error-handling measure is Bet Finalization. The GMS must lock a player's tier selection before the first card of the shoe is dealt. This is an important processing step to prevent players from seeing the first few cards and then changing their selected tiers to chase a forming combination, which would compromise game integrity. The ETGT interface must also be exceptionally clear about which tiers are selected and which are not, to prevent player disputes.

### End of Interaction:

The interaction for player-selected tiers is tied to the shoe. When the GMS detects the end of a shoe, it automatically purges the stored Player Tier Selection maps for all active sessions. When the new shoe begins, the GMS re-initiates the process, prompting all ETGTs to display the selection menu again, forcing players to make new selections for the new shoe. The dealer-initiated bonus is a discrete event. Its interaction ends when the mini-game on the ETGTs is complete. The ETGTs transmit the bonus results (e.g., Player A won $50) to the GMS, which processes the payouts and signals all ETGTs to return to the main Baccarat game display, ready for the next hand.

### Subject Matter Eligibility Considerations: Innovative Element 3 (Dealer Control)

### Detailed Technical Description & Implementation Details

This element is implemented as a specific, non-abstract human-machine interface that solves a technical problem of securely integrating manual, human-initiated commands into an automated, high-security financial transaction system. The implementation is not the abstract idea of dealer participation, but a concrete apparatus. The system comprises a first server system (GMS) and a dedicated piece of hardware, the Secure Dealer Console, communicatively coupled to the GMS via a secure, encrypted, and wired network interface. This console is a hardened, industrial-grade touchscreen terminal, not a generic tablet, and is secured with a specific authentication mechanism, such as an integrated RFID reader for staff ID cards or a biometric scanner, to solve the technical problem of unauthorized access.

The GMS processor is technically improved with two specific, non-conventional logic modules to support this console. First, a near-miss detection module analyzes the real-time card data stream from the card recognition system. This module compares the current game state (e.g., the rolling window buffer) against jackpot-triggering rules to identify predefined near-miss events, such as 5 of 6 matching cards. When detected, the GMS sends a specific data packet—an alert signal—to the dealer console, causing it to display a message like, “NEAR MISS: 5/6 RED KINGS.”

Second, the GMS is configured with a secure API endpoint to receive a specific command: a manual activation signal from the dealer console. When the dealer, prompted by the alert or by table excitement, physically presses an “Activate Bonus” button on the console, the console transmits a secure, authenticated data packet (e.g., a signed JSON Web Token) to the GMS. The GMS processor is operable for validating this signal and, in direct response, enabling a special jackpot eligibility period or triggering a system-wide electronic bonus round on all connected ETGTs. This entire, auditable workflow is a specific technical implementation.

### Practical Application:

The practical application of this system is the creation of a new type of gaming apparatus: a human-in-the-loop electronic jackpot system. This system solves the technical problem of the live dealer being a passive, non-integrated component in an electronic game, which leads to a sterile player experience. The computer is integral to the invention's function; it is not merely a tool, but the secure backbone that enables this new interaction. It provides the dealer with computer-generated intelligence (the near-miss alert) and securely accepts the dealer's human judgment as a valid, authenticated command input to alter the game's electronic state.

This is a task that cannot be performed by a human or by conventional systems. A pit boss cannot manually and securely trigger a synchronized bonus event across 50 electronic terminals, nor may a conventional jackpot server accept a “showmanship” input from a live dealer. The practical application is a specific apparatus—the GMS server communicatively and securely linked to the authenticated dealer console—that operationally bridges the live, human-driven “show” of Baccarat with the secure, automated, and electronic backend jackpot system. This creates a more interactive, engaging, and secure gaming experience that is not abstract, but is a tangible, machine-facilitated process.

### Technological Improvement/Improved Computer Functioning

This dealer-controlled interface provides a specific, tangible improvement to the functioning of the gaming server (GMS) and the overall security of the casino network. The technical problem it solves is “how to securely integrate an unpredictable, manual, human-initiated command into a high-security, automated financial transaction system” without compromising its integrity. Conventional automated systems are technically designed to prevent manual, human intervention to ensure fairness and security.

The invention's GMS architecture provides a direct technical solution that improves the computer's functionality in a non-conventional way. It improves the computer's I/O capabilities by adding a new, secure input channel (the dealer console interface) that is specifically designed to accept authenticated human commands. It improves the computer's processing logic by adding a specific validation module for these manual signals. Most importantly, it improves the system's security and auditability. The GMS processor is technically improved to create a specific, immutable audit log for every single dealer-initiated event (e.g., [Timestamp: 12:30:05, Event: DEALER_BONUS_ACTIVATED, Dealer_ID: 778, Table_ID: B12]). This provides a verifiable, technical solution to the regulatory and security challenges of manual intervention. This specific, secure, and auditable human-machine interface is a technical improvement over both fully-automated systems (which are inflexible) and insecure manual systems (which are not auditable), improving the computer's function by making it more flexible, interactive, and secure.

### Example Walk-Through Scenario:

A live dealer is at a DETG Baccarat table, logged into the Secure Dealer Console using her RFID staff card, which the GMS has authenticated. A player at a connected ETGT has an active jackpot bet. The game progresses, and the GMS receives real-time card data from the shoe scanner. The “rolling window” buffer in the GMS memory contains [KC, KS, 9H, KC, KS, KC]. The GMS's near-miss detection module analyzes this buffer and finds a match for “5 of 6 Black Kings.”

The GMS processor immediately sends an alert signal data packet over the secure network to the dealer's console. The console's screen flashes with the text: “NEAR MISS: 5/6 Black Kings.” The dealer sees this alert and also sees the player's excited reaction. Using her showmanship, the dealer announces, “It's getting exciting! Let's start a bonus!” She then presses the “Initiate Bonus Round” physical button on her console.

The console generates a secure, signed data packet (e.g., {“command”: “START_BONUS_1”, “dealer id”: 778, “timestamp”: “ . . . ” }) and transmits it to the GMS's dealer console interface API. The GMS processor receives this signal. It validates the signature and the dealer's authentication status. The command is valid. In response, the GMS processor executes two technical functions: First, it writes a new, immutable entry to the casino's audit log: [Event: DEALER_BONUS_ACTIVATED, Source: Dealer_778]. Second, it broadcasts a “Start Bonus” command packet to all active ETGTs at that table, including the player's. The player's ETGT screen immediately transitions to an interactive mini-game. This demonstrates a specific, non-abstract technical process of a computer securely integrating a manual, human-initiated command to alter the electronic game state for all players.

### Innovative Element 4—Real-Time Personalized Jackpot Engine

This innovative element describes a sophisticated technical solution for personalizing the wager-based gaming experience, moving far beyond the abstract concept of loyalty rewards. It provides a specific, concrete implementation for a Real-Time Personalized Jackpot Engine that integrates directly with the specific Game Management System (GMS) and the casino's Player Tracking System (CMS). The system's technical innovation lies in its ability to synthesize aplayer's historical profile and loyalty status with the real-time, dynamic jackpotlogic. This engine analyzes a player's profile (tier status, play history) and applies unique, in-game, real-time modifications to the jackpot system itself, tailored specifically to that player. This provides the practical application of a truly personalized incentive system. This is not merely a generic comp points system; it is an improvement to the computer's specific gaming functionality, enabling it to manage a unique set of jackpot rules and payout parameters for every individual player at a table, simultaneously. This engine may generate personalized jackpot multipliers, create unique, AI-driven jackpot challenges based on play history, or even manage long-term, narrative jackpot journeys for players, representing a non-obvious technical solution to the problem of generic, one-size-fits-all bonusing.

### Sequence Diagram Components:

Electronic Table Game Terminals (ETGTs): The player-facing client interface. For this element, its software is enhanced to render a personalized User Interface (UI), displaying unique jackpot multipliers or challenges received from the GMS.

Game Management System (GMS): The central server. Its functionality is critically improved to: 1) Interface with the CMS via an API to retrieve player profiles, 2) Pass profiles to the Personalization Engine, 3) Receive and store personalized jackpot parameters (rules, multipliers, challenges) in the player's active session, and 4) Apply these unique parameters during its real-time payout and win-verification logic.

Casino Management System (CMS)/Player Tracking System: The backend database of record for all player data. It serves as the data source for player profiles, including loyalty tier, average bet, game preferences, and overall play history, which it provides to the GMS upon request.

AI/ML Personalization Engine: A specialized software component, running as a service or module within the GMS. This engine's function is to receive a player profile as input, analyze it using pre-trained machine learning models or configurable business rules, and output a specific, actionable personalization rule (e.g., a custom multiplier or a unique challenge) back to the GMS.

### Implementation Details

The technical implementation of the Real-Time Personalized Jackpot Engine is achieved through a novel, high-speed data pipeline that synthesizes player history with live game logic. The process begins when a player inserts their loyalty card into an ETGT. The ETGT sends the player_id to the Game Management System (GMS). The GMS, in turn, initiates a high-speed API call (e.g., a RESTful GET/api/cms/v1/player_profile/{player_id}) to the casino's main Player Tracking System (CMS). The CMS validates the ID and returns a data object (e.g., a JSON payload) containing the player's profile: {tier: VIP_GOLD, avg_bet: 150, preferred_game: Baccarat, history: [ . . . ]}.

This player profile is then passed by the GMS to the AI/ML Personalization Engine. This engine, which addresses the disclosure gap regarding AI/ML architecture, is a technically advanced module. It may be implemented in two ways: 1) As a sophisticated rules engine, where operators define rules like IF tier=VIP_GOLD THEN apply_multiplier=2.0 TO combination_group=Aces. 2) As a true machine learning model (e.g., a predictive neural network or reinforcement learning model) trained on a massive dataset of player behavior. This model may generate more dynamic rules, such as {type: challenge, goal: BANKER_STREAK_3, reward: 5000}because the player's history shows they frequently abandon play after two banker wins.

The engine outputs this personalization rule to the GMS. The GMS then stores this rule within the player's active session data (e.g., in a high-speed in-memory cache like Redis). This rule is now live for that player. The GMS also sends a corresponding data packet to the player's ETGT, instructing its UI to update (e.g., Welcome, VIP! Your Ace Jackpots are now 2×!).

The GMS's specific jackpot logic is now fundamentally improved. When a jackpot event occurs (e.g., Six Red Aces), the GMS's payout algorithm performs a multi-step check. First, it fetches the base dynamic multiplier from the Probability Calculation Engine (innovative element 1), e.g., 500,000×. Second, it queries its session database for a personalization rule for the winning player. It finds the {type: multiplier, target: Aces, value: 2.0}rule. Third, it applies this unique rule, calculating the final payout as Payout=(Bet*Base_Multiplier*Personalized_Multiplier), or (Bet*500,000*2.0). For a challenge-based system, the GMS's win-checking logic is altered. Instead of only looking for card combinations, it also tracks the player's progress against their stored challenge (e.g., current_banker_streak: 2). When the player wins a third banker bet, this logic branch triggers the jackpot win, completely independent of the standard card-based triggers. This entire architecture provides a concrete, non-obvious technical implementation for personalization that is deeply integrated into the computer's specific game and payout functions.

### Example Walk-Through Scenario:

Two players are at the same live Baccarat table. Player A is a known VIP, and Player B is a new, registered player.

### Scenario 1: Player A (Personalized Multiplier—Tech #15)

1. Player A inserts her VIP Gold player card into her ETGT.
2. The ETGT sends her player_id to the GMS.
3. The GMS queries the CMS and receives Player A's profile: {tier: GOLD, play_frequency: HIGH}.
4. The GMS passes this profile to the Personalization Engine. The engine's ruleset dictates: IF tier=GOLD THEN apply_multiplier=2.0 TO combination group=Aces.
5. The GMS stores this [Ace Multiplier: 2.0] rule in Player A's active session.
6. The GMS sends a UI update command to Player A's ETGT, which now displays a VIP GOLD: 2× ACE JACKPOTS! banner.
7. The game proceeds. The Six Red Aces combination is dealt. The Dynamic Probability Engine (innovative element 1) has set the base multiplier for this event at 500,000×.
8. The GMS's payout logic fires. It checks Player A's session, finds the [Ace Multiplier: 2.0] rule, and calculates her win as: ($10 Bet*500,000 Base*2.0 VIP)=$10,000,000.
9. The GMS instructs the CMS to pay $10,000,000 to Player A.

### Scenario 2: Player B (Personalized Challenge—Tech #28)

1. Player B inserts his new player card.
2. The GMS queries the CMS and receives Player B's profile: {tier: BRONZE, session_count: 1, avg_bet: 10}.
3. The Personalization Engine analyzes this. Its AI model, designed to encourage engagement from new players, generates a long-termjourney quest (Tech #37).
4. The GMS stores this as Player B's personalization rule: {type: journey, quest: DRAGON_QUEST_CH1, goal: WIN_ANY_HAND_WITH_NATURAL_8, reward: $50_BONUS}.
5. Player B's ETGT displays: New Quest: The Dragon's Eye! Win a hand with a Natural 8 to win a $50 Bonus Jackpot!
6. The Six Red Aces combination is dealt. The GMS's payout logic fires. It checks Player B's session, finds no rule related to Aces, and thus calculates his win as: ($10 Bet*500,000 Base)=$5,000,000.
7. Two hands later, Player B wins a hand with a Natural 8. The GMS's game logic, which is also checking for personalized challenge completion, detects this.
8. This secondary logic branch triggers. The GMS confirms completion of the DRAGON_QUEST_CH1 goal and instructs the CMS to pay the $50 bonus jackpot to Player B, who is then presented with his next quest.

### Player Interaction:

The player's interaction with this engine begins by inserting their player loyalty card into the ETGT. This is notable action that initiates the personalization. Unlike a conventional, non-personalized system where the screen is identical for all players, the ETGT interface immediately updates to reflect the player's unique status.

For a player with a personalized multiplier, their main interaction is observational: they will see a specific, customized UI element (e.g., VIP: All ‘King’ Jackpots 3×!) that is not visible on other players' screens. This directly and continuously reinforces the value of their loyalty within the game itself.

For a player with a personalized challenge or journey, the interaction is far more dynamic. Their ETGT screen will display a quest or challenge module (e.g., Your Challenge: Win 3 Banker Bets in a Row!). A progress bar or other graphical element will update in real-time as they play (e.g., Progress: 1 of 3). This creates a game within a game, where the player is actively interacting with the system to complete a goal. Their betting decisions (e.g., choosing Banker to complete the challenge) are a direct interaction with this novel personalization engine. When the challenge is completed, the ETGT provides a unique, celebratory notification for this bonus jackpot win.

### Distinguishing Innovative Aspects:

One primary distinguishing novelty is the technical implementation of real-time personalization, moving it from an abstract marketing concept (like comp points) into a concrete, in-game payout mechanic. Prior art systems are one-to-many (one jackpot rule for all players) and disconnected from player loyalty data. This aspect of the invention provides a one-to-one technical framework.

The specific novelty is the real-time synthesis of three distinct data sources by the GMS: 1) real-time game state data (the dealt cards), 2) real-time dynamic probability data (e.g., the base multipliers from innovative element 1), and 3) historical player profile data (from the CMS). The GMS is technically improved to become a Personalized Payout Engine, capable of managing and executing a unique set of jackpot rules, triggers, and multipliers for every individual player, all simultaneously at the same live table. This ability to run parallel, customized jackpot logic for each player, based on their personal profile, is a non-obvious and technically complex solution not found in conventional systems. The AI-driven aspect, which generates narrative journeys or adaptive challenges, is a further, significant technical improvement that transforms the GMS from a simple bet processor into a dynamic player engagement and retention engine.

### Distinguishing Innovative Steps:

Interfacing with a Player Tracking System for Game Logic: The first inventive step is the GMS, in real-time upon a player login at an ETGT, executing a programmatic interface call (e.g., an API query) to an external Player Tracking System (CMS) to retrieve a player's historical profile and loyalty status.

Generating a Personalized, In-Game Jackpot Parameter: The second inventive step is an AI or rules-based engine (the Personalization Engine) analyzing this retrieved profile and generating a new, unique data object—a personalization rule (e.g., a custom multiplier [tier: ‘Aces’, value: 2.0] or a custom trigger [goal: ‘BANKER_STREAK_3’])—which is then stored in the player's active session data.

Applying the Personalized Parameter to Real-Time Payouts: The third inventive step is the GMS, when a jackpot event is detected, executing an enhanced, multi-step payout algorithm. This algorithm not only checks the game event but also retrieves the player's unique stored personalization rule and uses it to modify the final jackpot payout (by applying the multiplier) or to validate the win (by confirming the challenge was met).

### Technical Improvements To Existing Technical Problems

Technical Problem 1: Generic and Impersonal Bonusing. Conventional casino loyalty systems are technically disconnected from the live game. A player earns comp points or free play which are abstract and redeemed later. This creates a disconnect between the player's actions and their rewards, a technical problem of low engagement.
Technical Solution 1: This engine provides a direct technical solution by integrating the loyalty system into the specific game logic of the GMS. The GMS is technically improved to use the player's loyalty status not for a deferred reward, but to modify its own real-time payout calculations. The reward (e.g., a 2× Multiplier) is immediate, in-game, and context-aware. This improves the computer's functionality by transforming it from a simple game host into a personalized rewards-delivery platform, solving the disconnected bonus problem.
Technical Problem 2: High Player Churn and Lack of Long-Term Goals. In pure-luck games like Baccarat, players have no long-term goals or sense of progression. This is a technical problem for retention, as there is no stickiness to keep a player engaged beyond the next hand.
Technical Solution 2: The AI-driven Personalization Engine (Tech #28, #37) provides a specific technical solution. It improves the GMS's function by transforming it into a quest manager. The GMS may now create, track, and save long-term, narrative jackpot journeys for each player, with progress spanning multiple gaming sessions. This gives the player a persistent, personal goal. This is a non-obvious technical improvement that solves the no long-term goal problem, significantly enhancing the system's capability for player retention.
Technical Problem 3: Inefficient and Non-Targeted Bonusing. Casinos often use blanket promotions (e.g., 2× comp points for everyone on Tuesday) to drive traffic. This is an inefficient use of computer resources and bonusing funds, as it rewards all players regardless of their value or behavior.
Technical Solution 3: The Personalization Engine is a more efficient and targeted technical implementation. It allows the GMS to execute surgical, one-to-one incentives. For example, it may use its AI model to identify a player who is about to churn and automatically generate a personalized, achievable challenge to re-engage them. Or, it may reward a player for a specific, desirable behavior (like a successful skill streak, per Tech #29). This improves the computer's function by enabling it to act as an intelligent, targeted retention agent, a far more efficient solution than a blanket bonus system.

### Data Input:

One primary novel data input is the Player Profile Data, received from the CMS/Player Tracking System. This data, typically a JSON object, includes player_id, loyalty_tier, session_count, average_bet, preferred_game_history, and potentially churn_risk_score. A second notable input is the Real-Time Player Behavior Data Stream, which includes every bet placed, hand outcome, and challenge progression. This stream is used as a real-time input back into the AI/ML Personalization Engine to dynamically adjust challenges or journeys during the player's session, creating a dynamic feedback loop.

### Component Interactions and Procedural Steps:

1. A player logs into an ETGT using their player loyalty card.
2. The ETGT transmits the player id to the Game Management System (GMS).
3. The GMS makes a synchronous API call (e.g., GET/profile/{player_id}) to the Casino Management System (CMS)/Player Tracking System.
4. The CMS returns the player's profile data (e.g., {tier: GOLD, history: [ . . . ]}).
5. The GMS forwards this profile data to the internal AI/ML Personalization Engine.
6. The Personalization Engine analyzes the profile and applies its ruleset or model. It generates a personalization rule (e.g., {type: multiplier, target: Aces, value: 2.0}).
7. The GMS receives this rule and stores it in the player's active session data (e.g., session_123.personalization={rule_id: 101, multiplier: 2.0, target: Aces}).
8. The GMS sends a data packet to the ETGT, instructing it to display the personalized UI (e.g., VIP: 2× Ace Jackpots!).
9. A game hand is played. A jackpot-triggering event occurs (e.g., Six Red Aces).
10. The GMS's payout logic executes. It retrieves the base dynamic multiplier (e.g., 500,000×) from the Probability Engine.
11. The GMS then queries its session data for session_123. It finds the personalization rule, sees it matches the Aces target, and retrieves the 2.0 value.
12. The GMS processes the final payout calculation: Payout=(Bet*Base_Multiplier*Personalized_Multiplier).
13. The GMS sends the final, personalized payout instruction to the CMS and a You Won! message (with the personalized total) to the ETGT.

### Data Processing:

The GMS performs several novel data processing tasks. First, Player Profile Analysis, where the AI/ML Personalization Engine parses the historical data from the CMS to classify the player and select or generate an appropriate personalization rule. Second, Personalized Challenge Tracking, a new, stateful processing task where the GMS must, for each player with a challenge, track their progress in real-time (e.g., current_banker_streak: 2). This is a continuous, per-hand processing load that is unique to this system. Third, Multi-Factor Payout Calculation, where the final win amount is no longer a simple lookup but a dynamic calculation that must programmatically query and integrate the base dynamic multiplier and the player's unique personalization multiplier.

### Outputs and Responses:

The system generates several unique outputs. One primary output is Personalized UI Data, which is a data packet sent from the GMS to a specific ETGT, instructing it to render a UI that is unique to that player (e.g., displaying their custom challenge or multiplier). Another notable output is the Personalized Payout Calculation, which is the final, modified jackpot amount sent as a transaction request to the CMS. For challenge-based systems, an important output is the Challenge Progress Update, a real-time message sent from the GMS to the ETGT (e.g., Progress: 2 of 3 wins!) to keep the player engaged in their personal quest.

### Data Storage and Reporting:

This system leverages the existing CMS/Player Tracking Database as its primary input source. It introduces a new, important data storage requirement: a Player Journey State Database. This database may be persistent and linked to a player's ID. It is used to store the long-term progress of Personalized Jackpot Journeys (Tech #37), so a player may log out, and when they return weeks later, the GMS may query this database and resume their quest (e.g., Welcome back! You are on Chapter 3 of the ‘Dragon's Treasure’ quest.). The GMS's audit log must also be enhanced to store which personalization rule was applied to a win, ensuring a transparent audit trail for regulatory reporting.

### Error Handling and Security Measures:

A primary error condition is the CMS/Player Tracking System being unavailable. If the GMS cannot retrieve a player's profile upon login, it may be programmed to gracefully degrade. In this scenario, the GMS simply skips the personalization step and treats the player as a standard, non-personalized guest, ensuring the base game is not interrupted. Security is paramount. All personalization logic, especially payout calculations, may be executed exclusively on the secure, server-side GMS. The ETGT client only displays the information given to it, preventing any client-side manipulation of multipliers or challenges. All personalization rules and AI models may be auditable by regulators to ensure they meet gaming fairness standards and do not constitute unfair discrimination. The audit log must clearly state why a player received a specific bonus (e.g., Rule ‘VIP_GOLD’ applied).

### End of Interaction:

The end of the interaction depends on the type of personalization. For session-based personalization (like Tech #15's multipliers), when the player cashes out and their session at the ETGT ends, the GMS purges the personalization rule from its active memory. The next player at that terminal will be treated as a new, separate entity. For journey-based personalization (like Tech #37), when the player cashes out, the GMS performs a final write operation. It saves the player's current quest progress (e.g., {quest_id: 101, chapter: 3, progress: 2_of_5_stars}) to the persistent Player Journey State Database, linking it to their player id. This ensures their long-term quest is waiting for them upon their next visit, creating a powerful retention mechanic.

### Subject Matter Eligibility Considerations: Innovative Element 4 (Personalization)

### Detailed Technical Description & Implementation Details

This element is implemented as a specific technical integration of two disparate computer systems-a Game Management System (GMS) and a Player Tracking System (PTS)—to achieve a new, non-conventional function. The implementation is not the abstract idea of rewarding loyalty, but a concrete apparatus and data processing method. The system comprises a first server system (GMS) which is technically enhanced with a new software component: a specific, secure API interface for real-time communication with the casino's external PTS. The GMS processor is operable for executing a specific personalization logic flow.

This flow begins when a player logs in at an Electronic Table Game Terminal (ETGT). The ETGT sends the player's identification data to the GMS. The GMS processor then uses its new API interface to transmit a query to the external PTS. The PTS, a separate database system, returns a player profile data object, for example, a JSON payload containing the player's loyalty status, play history, and average bet.

The GMS processor's personalization engine—a specific, non-conventional software module—receives this external data as an input. It analyzes this profile against a set of configurable business rules or a machine learning model. Based on this analysis, the engine performs a technical data-generation task: it creates a new, specific, in-game rule object for that player, such as {type: “multiplier”, target_tier: “Six_Aces”, value: 2.0}. This rule is then stored in the GMS's high-speed in-memory session cache, associated with that player's active session.

The specific technical implementation is the modification of the GMS's financial payout algorithm itself. When a jackpot-triggering event occurs, the GMS processor is operable for executing a new, multi-step validation and calculation. For every winning player, it retrieves the base jackpot multiplier and then performs an additional, non-conventional lookup in its session cache for a personalized rule. If a matching rule exists, the processor applies this rule to modify the payout algorithm for that specific player, such as: Final_Payout=(Base_Bet*Base_Multiplier)*Personalized_Multiplier. This is a specific, real-time, per-player modification of specific game logic based on external data, a tangible technical process.

### Practical Application:

The practical application of this system is the creation of a new type of gaming apparatus: a fully integrated, one-to-one, real-time bonusing engine. This system solves the technical problem of loyalty rewards being abstract, disconnected, and non-immediate. In conventional systems, a player tracking system merely accrues abstract “comp points” which have no bearing on the game itself. This invention's practical application is a system that directly connects player loyalty to the game's financial logic.

The computer is integral to this function and is not merely a tool. This process is impossible for a human to perform. A pit boss or dealer cannot, in real-time, query a player's lifetime gaming history from a separate database, calculate a personalized multiplier, and securely apply it to an electronic jackpot payout, all in the sub-second timeframe of a game round and for every player at the table simultaneously. The practical application is the GMS server itself, functioning as an intelligent, one-to-one engagement engine. It uses the data from one computer system (the PTS) to dynamically and immediately alter the financial rules of another computer system (the GMS's own payout logic) on a per-player, per-event basis. This is a specific, practical, and machine-based implementation, not an abstract idea.

### Technological Improvement/Improved Computer Functioning

This personalization engine provides a specific, tangible improvement to the functioning of the gaming server (GMS) itself. It solves a specific technical problem: “how to integrate and action real-time data from a disparate, external computer system (the Player Tracker) to modify the specific game logic of a primary system (the GMS).” In conventional casino architectures, these two systems are technically siloed. The GMS handles game logic, and the PTS handles marketing and loyalty. The data flow is one-way: the GMS reports play data to the PTS for later, out-of-game reward calculation.

The invention's GMS architecture provides a direct technical solution that improves the computer's functionality in a non-conventional way. It introduces a new, bi-directional data flow, improving the GMS's I/O capabilities with a specific API to query and ingest datafrom the PTS in real-time. More importantly, it improves the GMS's central processing logic. The GMS's payout algorithm is fundamentally enhanced from a static, one-to-many function (Payout=Bet*Multiplier) into a dynamic, one-to-one, multi-factor function (Payout=Bet*Base_Multiplier* Get_Personalized_Multiplier(Player_ID)). This new processing step—performing a real-time, per-player lookup and applying a conditional, personalized multiplier to the financial calculation—is a specific technical improvement to the computer's own functionality. This is not the abstract idea of “rewarding loyalty,” but the specific, non-routine technical implementation of an inter-system data integration that modifies a specific financial algorithm in real-time.

### Example Walk-Through Scenario:

Player A, a VIP Gold member, sits at ETGT-1 and logs in with her player card. The ETGT sends her Player ID, “PLAYER_A_VIP”, to the GMS. The GMS processor immediately uses its Player Tracking System Interface to send an API query to the external PTS server: GET/api/v1/player/PLAYER_A_VIP. The PTS server returns a JSON profile: {tier: “GOLD”, avg_bet: 500, game_pref: “Aces” }. The GMS's personalization engine analyzes this profile. Its rules state: IF tier==“GOLD” AND game_pref==“Aces” THEN create_rule: {type: “multiplier”, target: “Aces_Tiers”, value: 3.0}. The GMS processor stores this new rule in its in-memory session cache for Player A. The GMS also sends a UI command to ETGT-1, which displays a “VIP GOLD: 3× ACE JACKPOTS!” banner.

Simultaneously, Player B, a new player, logs into ETGT-2. The GMS queries the PTS and receives the profile: {tier: “BRONZE”, avg_bet: 10, game_pref: null}. The personalization engine's rules find no match, and no rule is generated for Player B.

Later in the shoe, the “Six Red Aces” jackpot combination is hit. Both Player A and Player B had an active jackpot bet. The GMS's Dynamic Probability Engine (Innovative Element 1) has set the current base multiplier for this tier at 500,000×. The GMS's payout logic now executes for each winner.

For Player B: The GMS processor checks the session cache for a personalized rule. It finds “null”. It executes the standard payout algorithm: Payout=(Player B's Bet)*500,000.

For Player A: The GMS processor checks the session cache. It finds the rule {type: “multiplier”, target: “Aces_Tiers”, value: 3.0}. The jackpot event matches the “Aces_Tiers” target. The GMS processor executes the modified, personalized payout algorithm: Payout=(Player A's Bet)*500,000 * 3.0.

This demonstrates the computer's improved, non-conventional function of executing parallel, customized payout logic for different players at the same table, based on real-time data from an external system.

### The Probability Calculation Engine Algorithm

### Detailed Technical Description & Implementation Details

The Probability Calculation Engine is a specialized, high-availability software component, implemented as a microservice or an integrated module within the Game Management System (GMS). Its function is to execute the specific mathematical logic that enables the dynamic jackpot. It is not a static lookup table; it is a real-time computational engine.

To address the specific algorithms, the engine's calculations are based on the hypergeometric distribution. This mathematical model is the correct technical choice as it describes the probability of k successes (e.g., drawing 6 specific cards) in n draws (e.g., 6 cards), without replacement, from a finite population N (the total remaining cards in the shoe) that contains K total successes (the total number of a specific card type, e.g., Red Aces, remaining in the shoe). The GMS provides the N (total cards remaining) and K (target cards remaining) parameters to the engine after every card deal. The engine then calculates the probability P(X=k) for each of the 36+ jackpot tiers, where the jackpot-triggering combination is k and the rolling window or draw size is n (e.g., n=6).

A clear, step-by-step example of this calculation is as follows:
1. Define Target: The jackpot tier is Six Red Aces (e.g., same suit or mixed, the logic is similar).
2. Initialize Shoe: The system is configured for an 8-deck Baccarat shoe, which has N=416 total cards. For the Six Red Aces (mixed suit) tier, there are K=16 total Red Aces (8 Hearts, 8 Diamonds) in the shoe.
3. Update State: The game progresses. The GMS, tracking the real-time card recognition feed, determines that 40 cards have been dealt. Among these, 10 Aces have been dealt (e.g., 5 Red Aces and 5 Black Aces).
4. Provide Parameters: The GMS updates its dataset and queries the Probability Calculation Engine with the new parameters:
   The total population Nis now 416-40=376 cards remaining in the shoe.
   The total successes K is now 16-5=11 Red Aces remaining in the shoe.
5. Calculate Probability: The engine calculates the probability of drawing k=6 Red Aces in the next n=6 draws (for the rolling window) from this new population.
   First, it calculates the Number of Favorable Combinations (the number of ways to choose 6 Red Aces from the 11 remaining): K choose k, or Combinations(11, 6).
   Second, it calculates the Total Possible Combinations (the number of ways to choose any 6 cards from the 376 remaining): N choose n, or Combinations(376, 6).
   The final probability is P=[Combinations(11, 6)]/[Combinations(376, 6)].
6. Return Value: The engine returns this precise, real-time probability to the GMS.

Finally, the perceived card value weighting is a mathematical definition applied by the GMS after receiving the pure probability from the engine. It is a configurable business logic layer, not a probability modifier. The GMS calculates the final multiplier using a formula such as: Final_Multiplier=(Base_Payout_Rate/Real_Time_Probability)*W, where W is the Perceived Card Value Weighting Factor. This factor W is stored in a configuration table, for example: W=1.5 for all ‘Ace’ combinations, W=1.2 for ‘King’ combinations, and W=1.0 for all other ranks. This allows the casino to mathematically inflate the payout (not the odds) for combinations that players, particularly in markets like Macau, psychologically value more highly.

### Practical Application:

The Probability Calculation Engine is the specific component that provides the practical application of a live jackpot market, which is a novel concept in wager-based gaming. The computer system (GMS) is not merely being used as a tool to display static information; it is integral to the invention's function. This engine's calculations are not abstract. They are directly and programmatically tied to the real-time card data from the physical game. The output of this engine—the continuously updated probability—is used by the GMS to dynamically change the game's specific payout rules (the multipliers) from moment to moment.

This is a practical application that is impossible for a human to perform. A human dealer or pit boss cannot, in the sub-second interval between card deals, recalculate the hypergeometric distribution for 36 different jackpot tiers and update the game's payout structure. The computer's function is to act as a real-time analysis engine that continuously bridges the physical game state (cards in shoe) with the electronic game's financial parameters (the jackpot multipliers). This application solves the technical problem of static jackpots, where the payout value is disconnected from the true, real-time probability of the event, thereby creating a fairer, more transparent, and more engaging game for the player.

### Technological Improvement/Improved Computer Functioning

This engine provides a tangible improvement to the functioning of the gaming computer (the GMS). A conventional GMS for a jackpot system functions as a simple, static lookup table. Its process is: Receive_Event (e.g., Six Red Aces)->Lookup_Paytable(Event)->Return_Static_Prize ($1,000,000). This is an inflexible, memory-based operation.

The invention's Probability Calculation Engine fundamentally improves this computer's functioning. The new process is: Receive_Card_Data->Update_Shoe_State->Calculate_Probability(Shoe_State, Event_Tier)->Generate_Dynamic_Multiplier(Probability). This is a shift from a static, memory-lookup function to a dynamic, real-time computational function. This improvement in computer functioning is more efficient and flexible. It is more efficient because the system only needs to store the mathematicalformulas and rules for the 36 tiers, not a massive, pre-calculated paytable for every possible shoe state. It is more flexible because an operator may add a new Tier 37 simply by defining its rule (e.g., Six Red 7s), and the engine will automatically calculate its probability and generate a dynamic multiplier for it without any need to re-program a static table. This algorithmic, processing-based approach transforms the GMS from a simple data server into an intelligent, real-time analysis platform, solving the technical problem of inflexible, static jackpot payouts.

### Example Walk-Through Scenario:

A player at an ETGT opts-in for the Grand Paradise Jackpot at the start of an 8-deck (416 card) Baccarat shoe.

The system's Six Red Aces (mixed suit) tier (K=16) has a starting probability P_start of [Combinations(16, 6)/Combinations(416, 6)]. The GMS calculates the starting multiplier based on this probability and a weighting factor W of 1.5, displaying a 500,000× multiplier on the player's screen.

The game progresses. Over the next 30 hands, 100 cards are dealt from the shoe. The GMS, via the Real-Time Card Recognition System, tracks every card. It determines that among the 100 dealt cards, zero Red Aces have appeared.

The GMS immediately queries the Probability Calculation Engine with the new shoe state. The parameters are:
Total Population N=416-100=316 cards remaining.
Total Successes K=16-0=16 Red Aces remaining.

The Engine calculates the new probability, P_new, for hitting Six Red Aces in the next 6 draws: P=[Combinations(16, 6)/Combinations(316, 6)]. This new probability is signficantly higher than P_start because the remaining shoe is rich in Red Aces.

The GMS receives this new, higher probability. It re-applies its multiplier logic: Final_Multiplier=(Base_Payout_Rate/P_new)*W. Because P_new is now much higher, the resulting Final_Multiplier decreases significantly to reflect that this event is now mathematically more likely.

The GMS broadcasts this new multiplier to the player's ETGT. The player sees the multiplier for Six Red Aces drop from 500,000× to 350,000×. This demonstrates the live market in action; the system has technically improved its own function by re-evaluating the jackpot's value in real-time to maintain a fair and accurate payout-to-probability ratio, a process impossible in prior art static systems.

### AI/ML Model Architecture

### Detailed Technical Description & Implementation Details

The AI/ML Model Architecture is a sophisticated software component, implemented as a secure microservice or an integrated library within the Game Management System (GMS). Its primary function is to enable the Real-Time Personalized Jackpot Engine (innovative element 4) by transforming raw player data into actionable, personalized, in-game jackpot rules. This goes far beyond generic bonusing, providing a concrete technical implementation for dynamically tailoring the jackpot experience.

To address the specific models and architecture, the system is designed to be flexible, supporting two primary implementation types:
1. Reinforcement Learning (RL) Model for Challenges (Tech #28): This is the more advanced implementation. A Q-learning or Deep Q-Network (DQN) model is used. This model is trained to optimize for a specific reward, such as maximize player session duration or maximize player retention over 30 days.
   Training Data: The model is trained offline on a massive, anonymized historical dataset. The state input for training includes player_tier, current_session_duration, hands_played, avg_bet_size, bet_volatility, and churn_risk_score. The actions the model may choose are the challenge_type (e.g., BANKER_STREAK, WIN_NATURAL_8) and reward_value (e.g., $10, $50, $100). The reward for the model during training is the observed outcome (e.g., +0.1 for each additional hand played after issuing the challenge, +10.0 if the player returned for another session within 7 days).
   Live Implementation: In real-time, when a player logs in, the GMS feeds their current state to the trained model. The model outputs the optimal action (the challenge) it predicts will maximize the reward. For example, it may learn that for high-volatility, low-tier players, issuing a short-term Win 3 Hands in 5 challenge is most effective at extending their session. This is a dynamic, predictive system, not a simple lookup table.
2. Predictive Model (e.g., Classifier) for Journeys (Tech #37): This model is used to assign players to long-term jackpot journeys.
   Training Data: A classifier model (like a Random Forest or Gradient Boosted Tree) is trained offline to predict a player's archetype (e.g., High-Roller, Grinder, Social Player, Churn-Risk). The training features are historical data: total_wagered, session_duration, game_preference, bet_volatility, loyalty_tier, etc.
   Live Implementation: When a new player registers, the GMS passes their initial profile to this model. The model outputs a predicted archetype, e.g., Grinder. The GMS then queries a Narrative Database and assigns the long-term jackpot journey specifically designed for the Grinder archetype (e.g., a long quest with many small, incremental milestones).

### System Architecture:

The AI engine runs as a containerized service (e.g., in Kubernetes) alongside the GMS. The data flow is as follows:
1. Input: GMS receives a player_id upon login.
2. Data Fetch: GMS queries the CMS/Player Tracking database for the player's historical profile (the feature vector).
3. API Call: GMS sends a secure, internal API request (e.g., POST/api/ai/v1/get_challenge) to the AI Engine service, passing the player's feature vector.
4. Model Inference: The AI Engine's model (e.g., the trained DQN) runs an inference step, processing the vector and selecting an optimal action (the challenge).
5. Output: The AI Engine returns a JSON object to the GMS, e.g., {type: challenge, challenge_id: CH-105, goal: BANKER_STREAK_3, reward: 50}.
6. Storage & Execution: The GMS stores this challenge in the player's active session data and begins tracking their progress against the BANKER_STREAK_3 goal.

This architecture is robust, scalable, and provides a clear separation of concerns, allowing the AI models to be re-trained and updated independently of the specific GMS game logic.

### Practical Application:

This AI/ML architecture provides the practical application of a smart or adaptive casino game. The computer system is not merely being used as a tool to display a static game; it is integral to the invention's function, acting as an intelligent agent that personalizes the game rules for each player.

The practical application is a GMS that may, in real-time, generate a unique, one-to-one jackpot quest for every single player at a table. This is a task impossible for a human pit boss or for a conventional, static gaming system. For example, the system may identify a high-value player whose behavior indicates they are getting bored (e.g., decreasing bet size, increasing time between hands) and proactively generate a unique, high-value challenge to re-engage them. It may also identify a new player and assign them a long-term journey to build loyalty.

This system solves the technical problem of generic, one-size-fits-all bonusing by creating a technical framework for adaptive incentive delivery. The computer's function is improved from a simple game host to an active, personalized player engagement and retention engine. The personalization is not cosmetic; it is a fundamental modification of the game's bonusing rules, tailored to each player in real-time.

### Technological Improvement/Improved Computer Functioning

This AI/ML architecture represents a significant technological improvement to the functioning of the GMS and the overall casino network.

A conventional GMS is a reactive, stateless, or simply-stateful system. It processes bets, determines outcomes, and pays wins based on a fixed, universal ruleset. Its functionality is static.

The introduction of this AI/ML engine improves the GMS's functionality in several non-obvious ways:
1. From Reactive to Predictive: The GMS is transformed from a reactive system (which only reacts to bets) into a predictive andproactive system. It may now anticipate player behavior (like churn) and proactively modify its own state (by issuing a challenge) to optimize for a business goal (retention).
2. Enables Mass 1-to-1 Customization: A conventional GMS is a one-to-many system (one rule for all players). This new architecture enables one-to-one customization at scale. The GMS's specific logic is improved to manage N unique, parallel sets of bonus rules (one for each of N players), querying the AI engine and storing personalized challenge states for every active session. This is a significant enhancement in the computer's data processing and state management capabilities.
3. Efficient, Algorithmic Bonusing: Prior art bonusing is manual and inefficient (e.g., 2× points on Tuesdays). This system improves the computer's efficiency by enabling algorithmic, surgical bonusing. Instead of wasting bonus funds on all players, the AI model allows the GMS to allocate bonus incentives only to the specific players for whom it will have the most impact (e.g., a churn-risk player), leading to a more efficient use of the casino's computational and financial resources.

This integration of a real-time inference engine with the specific game logic is a tangible improvement that solves the technical problem of generic, non-adaptive player engagement.

### Example Walk-Through Scenario:

A player, Player 123, logs into an ETGT with her loyalty card. The GMS receives her player id.
1. Data Fetch: The GMS queries the CMS and retrieves Player 123's historical data, which is compiled into a feature vector: {tier: BRONZE, session_count: 3, avg_session_hands: 25, churn_risk_score: 0.85 (High)}.
2. API Call: The GMS sends this vector to the AI Engine's POST/api/ai/v1/get_challenge endpoint.
3. Model Inference: The AI Engine (a trained DQN model optimizing for session_duration) processes this vector. The model's logic determines that for high-churn, low-session players, a short-term, achievable, non-game-specific goal is optimal.
4. Return Action: The AI Engine returns its chosen action as a JSON object: {type: challenge, challenge_id: CH-201, description: Play 10 more hands (any bet), reward: 25, priority: HIGH}.
5. GMS Execution: The GMS receives this rule. It stores {challenge: CH-201, progress: 0, goal: 101 in Player 123's active session data.
6. UI Update: The GMS sends a command to Player 123's ETGT, which displays: New Challenge: Play 10 hands and win a $25 Bonus Jackpot!
7. Real-Time Tracking: As Player 123 plays each hand (win or lose), the GMS receives the hand-completion event. It increments the progress counter in her session data (progress: 1, progress: 2, etc.) and sends real-time updates to the ETGT's progress bar.
8. Challenge Completion: When Player 123 completes her 10th hand, the GMS's tracking logic sees progress==goal. It flags the challenge as complete, triggers a celebratory Bonus Jackpot Won! message on the ETGT, and sends a secure instruction to the CMS to credit Player 123's account with the $25 bonus.
9. New Challenge: The GMS then immediately queries the AI Engine again with the updated player state, beginning the cycle anew with a fresh, adaptive challenge.

### System Hardware and Network Specifications

### Detailed Technical Description & Implementation Details

The robust and real-time operation of the dynamic jackpot system is critically dependent on a specific architecture of high-performance hardware and a low-latency, secure network.

### System Hardware Specifications:

1. Game Management System (GMS): The GMS is not a generic server but a high-availability, fault-tolerant system, implemented as a rack-mounted blade server. It may be equipped with multi-specific CPUs (e.g., 2×32-specific AMD EPYC or Intel Xeon Gold) to handle simultaneous probability calculations for dozens of tiers across multiple tables, and a large amount of high-speed RAM (e.g., 256 GB or more) to hold the Shoe Composition Dataset and all active player session data (like personalized multipliers or rolling window buffers) in-memory for microsecond-level access. It must also feature redundant, hot-swappable power supplies and high-speed (e.g., 10 GbE or 25 GbE) redundant network interface controllers (NICs) to ensure zero downtime.
2. Real-Time Card Recognition System: This is a specialized hardware component with several potential embodiments:
   Optical Scanner (Shoe-Integrated): This embodiment integrates high-speed CMOS sensors directly into the dealing slot of the Baccarat shoe. The physical playing cards may be custom-printed with machine-readable markings, such as high-resolution barcodes or a matrix of dots (similar to QR codes) on their edges, which are invisible to the players. As the dealer slides a card out, the sensor reads the marking instantly, decodes it, and transmits the card's rank and suit to the GMS.
   RFID-Based System: This is a more advanced embodiment. Each of the 416 physical playing cards in the 8-deck shoe is manufactured with a tiny, passive RFID chip embedded within its layers. The intelligent dealing shoe is equipped with an RFID reader and antenna. As the dealer slides a card past the dealing point, the antenna energizes the chip and reads its unique ID, which is instantly cross-referenced by the GMS with a database (e.g., card_id: 30A_Spades->Ace of Spades) for 100% accuracy.
   Image Recognition (Overhead): This embodiment uses one or more high-definition (e.g., 4K) cameras mounted directly above the dealer's dealing area. This hardware is connected to a dedicated image processing unit (e.g., a small-form-factor PC with a GPU like an NVIDIA Jetson) that runs a trained computer vision (CV) model to identify the rank and suit of each card as it is revealed, before it is placed on the table.
3. Secure Dealer Console: This is not a generic tablet but an industrial-grade, hardened touchscreen terminal (e.g., a 10-inch capacitive display) physically integrated into the dealer's station. It is a secure appliance, not a general-purpose computer. It must include a mechanism for secure dealer authentication, such as an integrated RFID card reader (for staff ID cards) or a biometric (e.g., fingerprint) scanner. This console must have a direct, encrypted, wired Ethernet connection to the GMS to ensure signals (like manual bonus activation) are secure and instant.

### Network Specifications:

The network is a mission-important component. It may be a physically segregated, high-priority gaming LAN, separate from any public or corporate Wi-Fi. All important components (GMS, ETGTs, Card Recognition, Dealer Console) may be connected via wired 10 GbE Ethernet for maximum speed and stability. The communication protocol between the GMS and the ETGTs is important; a persistent, low-latency protocol like WebSockets or gRPC is implemented. This is superior to standard HTTP requests, as it allows the GMS to push data (the new multipliers) to all ETGTs simultaneously and in real-time. The system's performance requirement is that the entire loop—from card scan to GMS processing to new multiplier display on all ETGTs—may be completed in under 500 milliseconds. All network traffic, without exception, may be encrypted end-to-end using TLS 1.3 to protect the integrity of game data, wagers, and payout instructions from tampering or sniffing.

### Practical Application:

The specified hardware and network architecture provides the practical application of a high-integrity, real-time, physically-coupled gaming system. This is not a generic computer network; it is a specialized apparatus designed to solve the specific technical problem of capturing, processing, and responding to physical game events at a speed that makes a live market for jackpots viable.

The computer (GMS) is not merely a tool for displaying data; it is integral to the invention. Its function is to continuously alter the game's financial rules (the multipliers) based on physical-world inputs. The specialized hardware (e.g., RFID-embedded cards, secure dealer console) provides the necessary, practical, and non-generic input mechanism to bridge the physical-digital divide with the speed and accuracy required. The specified low-latency, encrypted network is the practical output mechanism to ensure the GMS's real-time calculations are delivered to all players synchronously, which is desirable for game fairness. A human cannot perform this; a generic office network cannot guarantee this. This specific hardware and network configuration is the practical and tangible implementation that enables the specific innovative element.

### Technological Improvement/Improved Computer Functioning

This specification details a tangible improvement to the functioning of the gaming computer system.
1. Improved Data Input Integrity and Speed: A conventional system may rely on a dealer's manual-typed input or slow, error-prone optical character recognition (OCR) from a standard camera. This is a flawed input method for a real-time probability engine. The specified hardware, particularly the RFID-embedded cards or integrated shoe scanner, provides a massive technological improvement. It improves the computer's (GMS's) input function by guaranteeinga 100% accurate, near-instantaneous (sub-100 ms) data feed of game events. This accurate, high-speed input is a non-trivial technical prerequisite that enables the specific probability engine to function at all; without it, the engine would be processing garbage data, rendering the invention non-functional.
2. Improved System Responsiveness and Synchronization: A generic computer network using standard HTTP polling would be far too slow to run a dynamic odds system. By the time an ETGT polled for a new multiplier, the data would be several seconds old and stale, creating a technical problem of fairness (a player may bet on a multiplier that is no longer valid). The specified low-latency network (sub-500 ms) using a WebSocket push protocol is a specific technological improvement. It improves the computer's (GMS's) output and synchronization function. The GMS is improved from a simple request-response server into a real-time broadcast hub, ensuring all player terminals are in a synchronized state.
3. Improved System Security and Integrity: A conventional system may use a simple, unsecured button for a dealer function. This is a technical security flaw. The specified Secure Dealer Console (with mandatory authentication) is a technological improvement. It improves the GMS's security and I/O functionality by ensuring that privileged system commands (like activate bonus) may only be received from a verified, authenticated hardware source, solving the technical problem of unauthorized system manipulation and ensuring a trusted link between the human dealer and the specific game logic.

### Example Walk-Through Scenario:

A dealer at a Baccarat table initiates a new shift. She swipes her RFID-enabled staff ID card at the Secure Dealer Console. The console authenticates her credentials against the GMS, which then logs her as the active, authorized dealer for this table.

Next, the dealer unwraps a new 8-deck shoe of RFID-embedded cards and places them into the intelligent dealing shoe. The shoe's internal RFID reader performs a bulk scan, verifying all 416 unique card IDs are present and correct, and transmits this full shoe manifest to the GMS. The GMS uses this manifest to initialize its in-memory Shoe Composition Dataset for the Probability Calculation Engine.

The dealer presses Start Bets on her console. The GMS receives this secure command and broadcasts a start_betting message via its WebSocket server to all connected ETGTs over the 10 GbE network.

The dealer pulls the first card. As it passes the dealing slot, the RFID reader instantly identifies its unique ID (e.g., card_id: 301A). A local firmware-level map translates this to Ace of Spades and sends this data packet to the GMS. This entire scan-and-send process takes less than 50 ms.

The GMS receives Ace of Spades. It instantly updates its dataset (decrementing Ace of Spades), and its Probability Calculation Engine re-computes all 36 jackpot multipliers. This processing takes 20 ms.

The GMS immediately serializes the new list of multipliers and pushes this data packet over the persistent WebSocket connections to all ETGTs simultaneously. This broadcast and network transit takes 150 ms.

The players' ETGTs receive the new multiplier data and their UI is re-rendered to display the new, adjusted values. The entire card-to-screen loop is completed in well under 500 ms. A player sees the multiplier for Six Black Aces drop slightly before the dealer has even finished placing the Ace of Spades on the Player hand layout, demonstrating a truly real-time, high-integrity, and technologically advanced gaming system.

### Rolling Window Logic and Edge Cases

### Detailed Technical Description & Implementation Details

The Rolling Window logic is a specific software component within the Game Management System (GMS) that technically enables the Six Consecutive Card Jackpot Trigger (innovative element 2). This logic is implemented using a First-In, First-Out (FIFO) queue data structure, which is managed in the GMS's high-speed active memory. This queue is defined with a fixed size equal to the length of the jackpot trigger, for example, six elements, where each element is a data object representing a single dealt card (e.g., {rank: KING, suit: HEARTS, timestamp: . . . }).

The memory management of this rolling buffer is precise. When the Real-Time Card Recognition System transmits a new card, the GMS pushes this new card object onto the end of the queue. If the queue's size now exceeds the fixed limit (i.e., it contains seven elements), the GMS simultaneously pops the oldest card object from the front of the queue. This push/pop operation ensures the buffer always contains only the N (e.g., 6) most recent consecutive cards dealt from the shoe, maintaining a rolling state of the game's history.

To fully enable this feature, several important edge cases may be handled by the GMS logic:
1. Start of a New Shoe/Shuffle: This is the most important edge case for game integrity. When a dealer or an automated shuffling machine initiates a new shoe, it sends a NEW_SHOE signal (e.g., via the Secure Dealer Console or an automated API call) to the GMS. Upon receiving this signal, the GMS must execute a PURGE or CLEAR command on the rolling buffer. This action flushes all card data from the previous shoe, ensuring the buffer is empty. The very first card dealt from the new shoe will be the first element to enter the clean buffer, preventing any invalid across-shoe jackpot combinations.
2. Player Placing a Bet Mid-Shoe: This edge case is important for fairness. A player may walk up to an ETGT and place a per-shoe jackpot bet after 50 cards have already been dealt. The GMS must handle this. When the player's bet is confirmed, the GMS logs the exact state of the game, such as the current_hand_number or the timestamp_of_last_card_dealt. From this point, the GMS's jackpot verification logic for this specific player is modified. When a winning 6-card combination is detected in the rolling buffer, the GMS must perform an additional check for this player: it must compare the timestamp of the oldest card in the winning buffer against the player's bet confirmation timestamp. If the oldest card was dealt before the player placed their bet, that player is not eligible for that specific win. They are only eligible for combinations where all 6 cards in the buffer were dealt after their bet was confirmed.
3. Partial Buffer (Start of Shoe): The jackpot evaluation logic must account for a partially-filled buffer. For the first five card deals of a new shoe, the buffer will contain fewer than six cards. The GMS's pattern-matching algorithm will run, but will find no 6-card match, as is correct. The system only begins full jackpot evaluation on and after the 6th card is dealt.

### Practical Application:

This Rolling Window logic provides the practical application of a continuous, longitudinal jackpot game that runs in parallel to the main Baccarat game. The computer system is not merely a tool for displaying a hand's outcome; it is integral to creating this new meta-game. The GMS's function is to maintain this stateful, 6-card window that is completely independent of Baccarat's hand boundaries (Player hand, Banker hand). This application is impossible for a human to manage. A dealer cannot be expected to remember the last 6 consecutive cards, in order, across multiple hands, while also managing the main game and payouts.

This computer-implemented logic solves the technical problem of discrete or fleeting jackpot excitement. By maintaining this buffer, the system makes every single card deal a potentially game-changing, jackpot-triggering event. This provides the practical application of sustained player engagement, as the player's jackpot bet is in-action for the entire duration of the shoe, not just for a single hand. The handling of edge cases, particularly the mid-shoe bet validation, is a practical application of complex computer logic to ensure fairness and prevent cheating (i.e., betting after a winning combination has already started to form).

### Technological Improvement/Improved Computer Functioning

This logic represents a tangible improvement to the functioning of the gaming computer (the GMS). A conventional GMS for Baccarat is largely stateless between hands. It processes a hand, records the outcome, and then effectively resets for the next hand.
1. Enables Cross-Hand Statefulness: This Rolling Window logic improves the GMS's functionality by introducing persistent, cross-hand statefulness. The GMS is technically improved to maintain a memory of past game events (the last 6 cards) and use this memory as the primary input for a new, parallel game logic. This is a non-trivial architectural improvement, transforming the GMS from a simple, transactional processor into a stateful, stream-processing engine.
2. Improved Data Re-use and Efficiency: The GMS is already receiving real-time card data from the recognition system for the purpose of displaying the hand. This aspect of the invention improves the computer's function by re-using this existing data stream in a novel way. Instead of just displaying the card and discarding the data after the hand, the GMS logic is improved to feed this data into the FIFO queue. This is a more efficient use of the computer's resources, as it leverages a single data input for two distinct game functions.
3. Enhanced Fairness and Integrity Logic: The logic for handling the mid-shoe bet edge case is a specific improvement to the computer's security and fairness functions. A simple system would just check IF bet_is_active. This improved system may require the GMS to perform a more complex, conditional check: IF bet_is_active AND timestamp_of_oldest_card_in_buffer>player_bet_timestamp. This additional processing step is a specific technical solution that improves the computer's function by preventing a known angle-shooting or cheating scenario, thus enhancing the integrity of the game.

### Example Walk-Through Scenario:

Scene: A new Baccarat shoe begins. The GMS receives the NEW_SHOE signal and purges its 6-card rolling buffer. The buffer is now: [ ].
1. Player A places a $5 per-shoe jackpot bet. The GMS logs Player_A_bet_timestamp: 10:30:01.
2. Hand 1: Four cards are dealt: [KC, 8S, QH, 7D]. The GMS buffer now holds these 4 cards. No 6-card match is possible.
3. Hand 2: Five cards are dealt: [AC, 5H, 6C, 8D, KS].
   As the 5th card (KS) is dealt, the GMS buffer is now: [QH, 7D, AC, 5H, 6C, 8D]. (The KC and 8S have been pushed out). No match.
   As the 6th card (KS) is dealt, the buffer is: [7D, AC, 5H, 6C, 8D, KS]. No match.
4. Player B walks up and places a $5 per-shoe jackpotbet. The GMS logs Player_B bet timestamp: 10:32:15 (which is after the KS was dealt).
5. Hand 3: The dealer deals a King of Spades (KS_2).
   The GMS buffer becomes: [AC, 5H, 6C, 8D, KS, KS_2]. No match. The oldest card, 7D, has timestamp: 10:31:05.
6. Hand 4: The dealer deals a King of Spades (KS_3).
   The buffer becomes: [5H, 6C, 8D, KS, KS_2, KS_3]. No match.
7. Hand 5: The dealer deals a King of Spades (KS 4), then a King of Spades (KS_5), then a King of Spades (KS_6).
   When KS_6 is dealt, the GMS buffer is now: [KS, KS_2, KS_3, KS_4, KS_5, KS 6].
   The GMS pattern matcher flags a WIN! for the Six Black Kings tier.
   The GMS checks Player A: The timestamp of the oldest card (KS from Hand 2) is 10:32:00. Player A's bet time is 10:30:01. 10:32:00>10:30:01. Player A is eligible.
   The GMS checks Player B: The timestamp of the oldest card (KS) is 10:32:00. Player B's bet time is 10:32:15. 10:32:00<10:32:15. The oldest card in the winning combination was dealt before Player B placed his bet. Player B is ineligible.
8. The GMS awards the jackpot to Player A. Player B sees the Jackpot Hit notification but is not paid. This demonstrates the fairness logic in action.

### Security, Audit, and Regulatory Compliance

### Detailed Technical Description & Implementation Details

To address the significant regulatory questions raised by a dynamic, non-static jackpot system, a robust security and audit framework is technically implemented. The cornerstone of this framework is a comprehensive, immutable, and relational audit trail. This is not a simple text-based log file; it is a high-integrity, write-only data ledger, potentially implemented using an append-only database table structure or a private, permissioned blockchain to guarantee immutability. This audit trail is managed directly by the Game Management System (GMS) and is a specific part of its function.

For every single game event, the GMS is technically required to create a timestamped, relational log entry. This includes:
Card Event: Every card identified by the Real-Time Card Recognition System is logged with its rank, suit, shoe_id, hand_id, and timestamp_ms.
Bet Event: Every bet placed at an ETGT is logged with its player_id, session_id, bet_type (main game or jackpot), bet_amount, and timestamp_ms.
Shoe State Event: After each card is logged, the GMS logs a snapshot or hash of its Shoe Composition Dataset (the array of all 416 cards and their remaining counts).
Calculation Event: Every time the Probability Calculation Engine runs (i.e., after every card deal), the GMS logs the inputs (the Shoe_State_ID) and the outputs (the full list of probabilities for all 36 tiers).
Multiplier Event: Every time the GMS adjusts a multiplier, it logs the tier_id, old_multiplier, new_multiplier, the Calculation_ID that prompted the change, and the reason code (e.g., ProbabilityRecalc).
Payout Event: Every jackpot win is logged with the player_id, win_amount, triggering_card_event_IDs, the final Multiplier_ID applied, and the Bet_ID that won.

All communications within the system are secured using end-to-end TLS 1.3 encryption. This includes the link from the Card Recognition System to the GMS, the GMS to the ETGTs, and the GMS to the backend Casino Management System (CMS). Access to the GMS and its audit ledger is strictly controlled via Role-Based Access Control (RBAC). Casino operators have limited, read-only access for reporting. Regulators are given a secure, read-only portal to the audit database. Developers have zero access to production data. This ensures averifiable, transparent, and secure system that may mathematically prove its own fairness to a regulator at any time.

### Practical Application:

This audit and security framework provides the practical application of a trustworthy and regulatable dynamic jackpot. One primary technical problem with a non-static jackpot is gaining regulatory approval, as regulators cannot test a fixed paytable. This aspect of the invention provides the technical solution: instead of verifying a static table, the regulator verifies a dynamic process.

The computer system is integral to this solution. It is not merely a tool for logging; it is a tool for creating a mathematical proof of its own integrity in real-time. The immutable, relational audit trail is the practical, tangible output that allows a regulator to, for the first time, audit a dynamic odds-based game. A regulator may use the logged data to perform the practical application of replaying any game, at any second. They may take the logged Shoe_State_ID, independently run the documented probability algorithm (from Disclosure Gap 5.1), and mathematically verify that the Output_Probability logged by the GMS was correct. They may then verify that the Multiplier Applied to a win was the correct one for that probability. This provides a practical, verifiable, and transparent system that solves the specific regulatory challenge.

### Technological Improvement/Improved Computer Functioning

This framework represents a significant technological improvement to the functioning of a gaming computer's audit and security systems.
1. Improvement from Flat Files to Relational Ledgers: Conventional gaming machines often log events to simple, flat text files (.log). This is a technically inferior system for auditing, as it is difficult to query and the data is not relationally linked (e.g., the payout event is just a line of text, not programmatically linked to the bet that won it). This aspect of the invention improves the computer's storage and data management function by implementing a relational audit ledger. A Payout_Event is not just text; it is a database row that contains a foreign notable to the Bet_Event row and the Card_Event row(s) that triggered it. This technical structure allows a regulator's computer to run a single, efficient query to retrieve the entire causal chain of an event, which is a massive improvement in audit efficiency and reliability over manually parsing multiple, disconnected flat log files.
2. Improvement from Passive to Proactive Security: Conventional logs are passive; they are only reviewed after a problem (e.g., fraud or a bug) has been reported. This system's GMS is technically improved to be proactive. The GMS may be configured to run a Log Integrity Monitor process in real-time. This process monitors the audit trail as it is being written for anomalous patterns. For example, if it detects a Card_Event for an Ace of Spades when the Shoe_State log shows 0 Ace of Spades remaining, it may identify this as an important data integrity failure (e.g., a card misread). This improves the computer's function by allowing it to automatically halt the game and alert security before a wrongful payout may be made, solving the technical problem of reactive-only security.
3. Improvement from Tamper-Prone to Immutable Storage: Conventional log files are not secure; a system administrator with root access may theoretically edit or delete log file entries to cover up malfeasance. This aspect of the invention's use of an append-only ledger (or a private blockchain) is a technical improvement to the computer's storage function. It creates a tamper-proof, write-only data structure. Once a Card_Event or Payout Event is logged, it cannot be altered or deleted. This provides a mathematically verifiable guarantee of data integrity, which is a fundamental technological improvement for a high-stakes financial system and is important for gaining regulatory trust.

### Example Walk-Through Scenario:

A gaming regulator, Ms. Chen, receives a player complaint about a jackpot that was hit at 8:15 PM on Table B-12. The player claims the multiplier seemed wrong. Ms. Chen logs into the secure, read-only Regulatory Compliance Portal provided by the GMS.
1. She queries the Payout_Event table for table: B-12 and timestamp between 8:14 PM and 8:16 PM.
2. She finds the win: Payout_ID: 98765, Timestamp: 8:15:02 PM, Player_ID: 456, Tier_ID: 18 (Six Black 2s), Amount: $5,000. The record also contains Calculation_ID: 55432 and Bet_ID: 12345.
3. Ms. Chen first clicks on Bet_ID: 12345. The relational query pulls the bet record: Player ID: 456, Bet_Amount: $5, Bet_Type: Jackpot, Timestamp: 8:14:30 PM. The bet is valid.
4. Next, she clicks on Calculation_ID: 55432. The query pulls the calculation record: Timestamp: 8:15:01 PM (the moment the multiplier was set, just before the win).
5. This calculation record contains the input: Shoe_State_ID: 77654. It shows the output probability for Tier 18 was P=0.00001 and the resulting Output Multiplier was 1,000×.
6. The payout was $5,000 ($5 bet*1,000× multiplier). The multiplier appears correct based on the calculation.
7. As a final check, Ms. Chen clicks on Shoe_State_ID: 77654. The query pulls the full database snapshot of the shoe composition dataset at 8:15:00 PM. The snapshot shows that at that exact moment, 300 cards remained in the shoe, and 12 Black 2s were still present.
8. Ms. Chen's own software runs the hypergeometric distribution formula: P(6 successes in 6 draws) from a population of N=300 with K=12 total successes. Her software confirms the probability is P=0.00001.
9. The comprehensive, relational audit trail has allowed Ms. Chen to, in under 5 minutes, mathematically prove that the dynamic probability was calculated correctly, the multiplier was set correctly based on that probability, and the payout was correct based on that multiplier. She may confidently dismiss the player complaint, her trust in the system's integrity affirmed.

### Alternative Embodiments and Game Adaptations

### Detailed Technical Description & Implementation Details

To broaden the scope and provide robust support, a specific technical aspect of the invention—the Dynamic Probability-Based Jackpot Engine (innovative element 1)—is explicitly described as a game-agnostic platform. Its adaptation to other card games, such as Blackjack and Poker, is a notable alternative embodiment. This may require the Game Management System (GMS) and its Probability Calculation Engine to be architected in a modular fashion.

### 1. Adaptation for Blackjack:

Game Logic Module: The GMS would be loaded with a Blackjack Jackpot Module. This module defines a new set of jackpot-triggering combinations specific to Blackjack, which are stored in the GMS database. Examples include:
   BJ-Tier-1: Player Suited 7-7-7 (e.g., three 7s of Hearts).
   BJ-Tier-2: Player 5-Card 21 (a 5-card hand totaling 21).
   BJ-Tier-3: Player/Dealer Matched Suited Blackjacks (both player and dealer get a Blackjack of the same suit, e.g., Ace/King of Spades).
Engine Implementation: The specific technical principle remains identical to Baccarat. The GMS uses the Real-Time Card Recognition System to track every card dealt from the 6-deck or 8-deck Blackjack shoe, maintaining the Shoe Composition Dataset.
Dynamic Odds Calculation: When a player places the jackpot bet, the GMS and Probability Engine are in an active state. After every card deal, the GMS queries the engine. For example, to calculate the probability of Suited 7-7-7, the engine is fed the current state: N (total cards remaining in shoe) and K (total 7s of Hearts remaining). As other cards are dealt, N decreases, and the probability (and thus the multiplier) changes. If many 7s of Hearts are dealt and removed from the shoe, the K value for that tier drops, causing the probability of that event to plummet, which in turn causes the GMS to dramatically increase the jackpot multiplier for that specific combination.

### 2. Adaptation for Community Card Poker (e.g., Texas Hold'em):

Game Logic Module: This is a different but related application. The shoe is a single 52-card deck, and the game is discrete (reshuffled every hand). The dynamic probability calculation is not shoe-based but intra-hand. The jackpot module defines triggers like:
   PK-Tier-1: Bad Beat Jackpot (e.g., Quad Jacks losing to a higher hand).
   PK-Tier-2: Flop a Royal Flush.
Engine Implementation: The GMS uses the card recognition system (e.g., RFID-embedded cards) to identify the player's hole cards and the community cards (Flop, Turn, River) as they are dealt.
Dynamic Odds Calculation (Conditional Probability): The Probability Engine's function shifts from hypergeometric distribution on a large shoe to conditionalprobability on a 52-card deck.
   Example: A player has [Ac, Kc]. The flop comes [Qc, Jc, 10c]. A Flop a Royal Flush jackpot is triggered.
   Alternative: A player has [Ac, Kc]. The flop comes [Qc, Jc, 7d]. The engine is now queried. The GMS provides the state: 5 cards are known (2 hole, 3 flop). N=47 cards remain. The engine calculates the conditional probability of the Turn and River being exactly [10c] and [Qc](or vice versa, in some implementations). This real-time, intra-hand probability calculation may be used to dynamically adjust a Progressive Royal Flush multiplier, creating a new, dynamic jackpot for poker.

### Practical Application:

The practical application of these alternative embodiments is the creation of a unified, intelligent jackpot platform for the entire casino, rather than a collection of disparate, static jackpot controllers. The GMS, equipped with its specific Probability Calculation Engine, becomes a central brain that may be adapted to any card game simply by loading a different Game Logic Module.

This provides a practical solution to jackpot fatigue and operational inefficiency. Instead of a casino buying, installing, and maintaining dozens of different, siloed jackpot systems (one for Blackjack, one for Baccarat, one for Poker), they may deploy this single, scalable, and intelligent system. The computer (GMS) is integral to this, as it is performing the complex, real-time calculations that are specific to each game's rules but are based on the same universal mathematical principles (card depletion and conditional probability). This allows the casino to offer novel, dynamic, and engaging jackpots across their entire floor, all managed by one central, auditable, and secure computer system, which is a tangible and practical improvement over the prior art.

### Technological Improvement/Improved Computer Functioning

This modular, game-agnostic architecture represents a significant technological improvement to the functioning of the GMS and the casino network.
1. Improved Efficiency and Scalability: A conventional casino environment may require multiple, disparate, and often redundant jackpot controller computers, each hard-coded for a single game. This is a highly inefficient use of computer hardware and resources. This aspect of the invention improves the GMS's functionality by abstracting the specific calculation logic. The Probability Calculation Engine is game-agnostic; it simply computes probabilities. The GMS is improved to function as a modular host that just loads different game-logic scripts (e.g., baccarat_triggers.json, blackjack_triggers.json). This is a vastly more efficient, scalable, and maintainable software architecture. A single GMS server may now run the dynamic jackpots for multiple different game types simultaneously, a clear improvement in computer resource utilization.
2. Enables Cross-Game Synergy: This architecture is notable technical prerequisite for enabling synergistic multi-game jackpots (Tech #36). A problem with prior art is that there is no way for a computer to fairly balance a jackpot contribution from a Blackjack player and a Baccarat player, as their static jackpots have different odds and hit frequencies. This aspect of the invention's GMS solves this technical problem. Because the Probability Calculation Engine knows the real-time mathematical probability of Event_A (in Baccarat) and Event_B (in Blackjack), it may normalize the jackpot contributions and payouts. This improves the GMS's function by enabling it to perform cross-game odds normalization, a complex computational task that is impossible for siloed, static systems.
3. Enhanced Data Re-use: At a modern, electronic multi-game table (where a player may switch between Baccarat and Blackjack), a conventional system would may require two separate jackpot systems. This aspect of the invention improves the computer's functionality by allowing the same hardware (the ETGT, the GMS, the Card Recognition system) to be used for both. When the player switches the game from Baccarat to Blackjack on their ETGT, the GMS simply receives this state change and loads the blackjack_triggers.json module, using the exact same Probability Engine to drive a new, dynamic jackpot. This is a superior and more efficient use of the underlying computer hardware.

### Example Walk-Through Scenario:

A casino has deployed the Grand Paradise Jackpot Engine across its floor, linked to both Baccarat and Blackjack tables.

At the Baccarat Table (Table 1):
Game: 8-deck shoe. Jackpot Trigger: Six Red Aces.
Start: At the start of the shoe (N=416, K=16 Red Aces), the GMS and Probability Engine calculate the probability P_Baccarat and set the multiplier to 500,000×.
Mid-Shoe: 208 cards (half the shoe) are dealt. The GMS tracking shows that zero Red Aces have been dealt.
Engine Query: The GMS queries the engine with the new state: N=208, K=16. The engine calculates a new, higher probability P_Baccarat_New (as the remaining shoe is rich in Red Aces).
GMS Action: The GMS receives this higher probability and lowers the multiplier to 200,000× to reflect that the event is now more likely.

At the Blackjack Table (Table 2):
Game: 6-deck shoe. Jackpot Trigger: Suited 7-7-7 of Hearts.
Start: At the start of the shoe (N=312, K=6 7 of Hearts), the GMS and Probability Engine calculate the probability P_Blackjack and set the multiplier to 800,000×.
Mid-Shoe: 156 cards (half the shoe) are dealt. The GMS tracking shows thatfive of the six 7 of Hearts have been dealt.
Engine Query: The GMS queries the engine with the new state: N=156, K=1. The engine calculates the new probability P_Blackjack_New of drawing the one remaining 7 of Hearts in the next three card draws. This probability is astronomically lower than the starting probability.
GMS Action: The GMS receives this near-zero probability and massively increases the multiplier for this event to 10,000,000×.

This scenario demonstrates the power and flexibility of a specific technical aspect of the invention. The same GMS and Probability Engine, running in parallel, are using the same specific principle (real-time probability based on card depletion) to manage two completely different jackpots, for two different games, with two different sets of rules, providing a technologically advanced, unified, and dynamic solution.

### Technical Solutions & Improved Computer Functioning

To help ensure that the claimed invention is not mischaracterized as an abstract idea, the present application explicitly includes details describing the technical problems inherent in conventional systems and the specific, non-conventional technical solutions provided by various aspects and features of the invention.

Technical Problem: Conventional casino jackpot systems (prior art) are technically static. They are dumb systems that rely on a computer merely as a data storage and lookup tool. A conventional Game Management System (GMS) stores a massive, static paytable (e.g., in a SQL database) where a fixed event (e.g., Five-Card Royal Flush) is permanently mapped to a fixed prize (e.g., $1,000,000). This is an inefficient and rigid computer architecture. It has a significant technical problem: it is non-responsive to the real-time state of the physical game, leading to payouts that are mathematically disconnected from the true, dynamic odds, and it is highly inefficient to modify or expand.

### Technical Solution & Improved Computer Functioning

One aspect of the invention provides a specific, technical solution that improves the functioning of the computer itself. The invention's GMS and Probability Calculation Engine are architected as a dynamic, processing-based system, not a static, memory-based one.

Instead of storing massive, static paytables, the invention's computer system stores a set of mathematical algorithms and rules (e.g., the hypergeometric distribution formula and the 36 tier definitions). The computer's function is fundamentally changed. It no longer performs a simple LOOKUP operation. Instead, it performs a continuous, complex, real-time computational process:
1. Receive real-time physical-world data (a dealt card).
2. Update a stateful dataset in active memory (the shoe composition).
3. Execute a complex mathematical algorithm (the probability calculation) on this dataset for all 36 tiers.
4. Generate a new, dynamic data output (the adjusted multipliers).

This is a more efficient use of computer resources. For example, a conventional system needing 36 jackpot tiers would may require 36 static database entries. If the casino wants to add 36 new tiers, they must manually define and add 36 new static entries. The invention's GMS, by contrast, simply may require adding 36 new rules to its configuration. The engine algorithmically generates all the payout parameters in real-time. This represents a more efficient, scalable, and processing-based approach, reducing memory storage requirements and enabling a near-infinite variety of jackpot tiers to be generated algorithmically. This is a tangible improvement in computer functionality over the brute-force, static-memory approach of the prior art.

### Practical Application:

The invention is not an abstract idea (like changing odds or a jackpot); it is a concrete, practical application and a specific, tangible implementation. The system is physically rooted in a machine-based apparatus. The claims are directed to a first server system (a specific computer) that is inextricably linked in a real-time feedback loop with other physical hardware: a real-time card recognition system (a physical scanner or camera), physical playing cards, and electronic table game terminals (physical player interfaces).

The practical application is the creation of a new type of gaming machine: one that dynamically modifies its own payout rules in real-time based on a live, physical data feed. The GMS server is not just performing calculations for display; it is executing a technical process that has a direct, tangible consequence: the jackpot_multiplier variable for a specific player's bet is actively modified. This modified variable is then used in a concrete financial transaction—the payout calculation. This system, which integrates physical card data, a stateful memory dataset, a real-time probability algorithm, and a dynamic multiplier output to control financial outcomes, is a specific, practical application of technology that solves the technical problem of static, disconnected jackpots. It is not an idea that may be performed in the human mind.

### Technological Improvement/Improved Computer Functioning

The invention provides a specific, tangible improvement to the functioning of the gaming computer (GMS) itself.

A conventional gaming server functions as a static data lookup table. Its specific logic is: IF event==TRIGGER_A THEN payout=PAY_A. This is a non-inventive, routine use of a computer, equivalent to a digital file cabinet.

The invention's GMS functions as a dynamic, real-time probability-analysis engine. Its specific logic is: ON (card_dealt)->UPDATE shoe_state; FOR_EACH (tier)->tier.probability=CALCULATE_PROB(shoe_state, tier.rule); tier.multiplier=GENERATE_MULTIPLIER(tier.probability). This is a non-conventional, specific improvement. The computer's function is enhanced from a simple, passive lookup tool to an active, stateful, and computational generation tool.

This is achieved via the dynamic feedback loop. The computer's output (the multiplier) is continuously modified based on its input (the card data), creating a closed-loop system that is not conventional. This system solves a specific technological problem inherent in prior art gaming systems: their static, non-responsive nature. The invention's technical solution is this dynamic feedback loop, which represents a clear improvement in the computer's functionality. This is a non-routine, non-conventional technical solution that is not merely the abstract idea of changing odds, but the specific, technical implementation of a real-time probability engine that dynamically modifies its own payout logic based on a live data feed from the physical world.

### Example Walk-Through Scenario:

### Conventional System (The Technical Problem):

A casino operator wants to add a new jackpot for Six Red 7s. With a conventional system, the operator must:
1. Have a statistician manually calculate the static, full-shoe probability for this event.
2. Define a fixed payout for this event (e.g., $100,000).
3. Instruct a developer to access the gaming server's database.
4. The developer must manually INSERT a new row into the Static_Jackpot_Paytable (e.g., (trigger_event: SIX_RED_7S, payout_amount: 100000)).
5. This process is slow, may require manual calculation, and is inflexible. The computer is just a dumb storage box.

### Invention's System (the Technical Solution & Improved Functioning):

The casino operator wants to add the same Six Red 7s jackpot.
1. The operator accesses the GMS configuration portal.
2. They add a new rule to the Probability Engine's configuration file: {tier_id: 37, name: Six Red 7s, cards: [7H, 7D], count: 6, weighting: 1.0}.
3. The operator saves the configuration and restarts the GMS module.
4. The system is now live. The GMS automatically adds Tier 37 to its processing loop.
5. After every card deal, the Probability Calculation Engine automatically and algorithmically calculates the real-time probability of Six Red 7s based on the current shoe_state (e.g., N=312, K=16).
6. The GMS automatically and algorithmically generates a dynamic multiplier for this new tier and broadcasts it to all ETGTs.

This scenario clearly demonstrates the improved computer functioning. The GMS is not a static database; it is an intelligent, rule-based, algorithmic engine. The operator's action was to add a rule, not a static payout. The computer generates the payout parameters itself, in real-time. This is a more efficient, flexible, scalable, and non-conventional use of a computer, representing a clear technological improvement.

Grand Paradise Jackpot™ Calculation and Distribution Technique #1a—Dynamic Jackpot Multipliers Based on Six-Card Combination Rarity and Perceived Card Values

The Grand Paradise Jackpot™ Calculation and Distribution Technique #1A introduces a sophisticated dynamic jackpot multiplier system for live dealer baccarat games, revolutionizing the traditional jackpot experience. This innovative approach utilizes advanced probability calculations and real-time data processing to offer escalating multipliers based on the rarity of six-card combinations dealt during gameplay. The system is designed to seamlessly integrate with both Live Dealer Game Tables (LDGTs) and Dealer-controlled Electronic Table Games systems (DETGs) comprising multiple Electronic Table Game Terminals (ETGTs).

The specific feature of this technique is its ability to continuously calculate and adjust jackpot multipliers for 36 distinct tiers of card combinations, ranging from same-suit to mixed-suit scenarios. By incorporating both mathematical rarity and perceived card value, the system creates an engaging and psychologically appealing jackpot structure. This approach not only enhances player excitement but also allows for strategic marketing of high-value combinations.

The implementation of this technique in LDGT and DETG systems involves sophisticated hardware and software components. These include advanced card recognition technology at the dealer station, real-time data transmission networks, and powerful central processing units capable of instant probability calculations and multiplier adjustments. The system's flexibility allows for customization of multiplier structures, balancing mathematical fairness with player perception and marketing strategies.

This technique significantly enhances the baccarat experience by offering potentially massive payouts for extremely rare card combinations without altering the game's fundamental rules. It caters particularly well to the preferences of Macau casino operators and patrons, known for their affinity for high-stakes, excitement-driven gameplay.

The Grand Paradise Jackpot™ Calculation and Distribution Technique #1A introduces an innovative dynamic jackpot multiplier system for live dealer baccarat games, where the multiplier increases based on the rarity of the six-card combination dealt. Dynamic Jackpot Multipliers may be based on six-card combination rarity and perceived card values. This approach adds an extra layer of excitement to the game by offering potentially massive payouts for extremely rare card combinations. The system continuously calculates the probability of each combination occurring and adjusts the multipliers accordingly, ensuring that payouts remain proportional to the combination's rarity. This technique may be implemented in both physical live dealer tables and electronic table game systems, enhancing the thrill of baccarat without altering its fundamental rules.

This system enhances player engagement by offering substantial payouts for extremely rare six-card combinations. The technique may be seamlessly implemented in Live Dealer Game Tables (LDGTs) and Live Dealer-controlled Electronic Table Games (DETGs) comprising multiple Electronic Table Game Terminals (ETGTs).

The proposed Grand Paradise Jackpot™ introduces a dynamic jackpot multiplier system for live dealer baccarat games, enhancing player engagement by offering substantial payouts for extremely rare six-card combinations. Notable features include:
Dynamic Multiplier System: Multipliers increase based on the rarity of the six-card combination dealt, with the rarest combinations (e.g., Six Red Aces of the same suit) triggering the highest multipliers.
Probability-Based Adjustments: The system continuously calculates the probability of each combination occurring and adjusts the multipliers accordingly, ensuring payouts remain proportional to the combination's rarity.
Implementation Across Platforms: The technique may be implemented in both physical live dealer tables and electronic table game systems, enhancing the game's thrill without altering its fundamental rules.
Dynamic Multiplier Adjustments: Multipliers increase based on the rarity of the six-card combination dealt, with the rarest combinations triggering the highest multipliers.
Real-Time Probability Calculations: The system continuously calculates the probability of each combination occurring and adjusts the multipliers accordingly.
Enhanced Player Experience: By offering potentially massive payouts for rare combinations, the game becomes more thrilling without altering its fundamental rules.

### Example Implementation Details

Dedicated Jackpot Betting Area: Each ETGT includes a specific area where players may place jackpot bets.
Real-Time Card Recognition: The live dealer station uses advanced card recognition technology to read and transmit card values instantly to the GMS.
Continuous Probability Monitoring: The GMS, in conjunction with the Probability Calculation Engine, continuously monitors the dealt cards, updating probabilities and corresponding multipliers for each possible combination.
Tiered Jackpot Structure: The jackpot is structured into distinct tiers, each corresponding to unique six-card combinations, divided into Same Suit and Mixed Suit categories.

In one embodiment, the jackpot is structured into distinct tiers, each corresponding to a unique six-card combination:

### Same Suit Jackpot Multiplier Tiers:

Tier 1. Six Red Aces (same suit)
Tier 2. Six Black Aces (same suit)
Tier 3. Six Red Kings (same suit)
Tier 4. Six Black Kings (same suit)
Tier 5. Six Red Queens (same suit)
Tier 6. Six Black Queens (same suit)
Tier 7. Six Red Jacks (same suit)
Tier 8. Six Black Jacks (same suit)
Tier 9. Six Red 10s (same suit)
Tier 10. Six Black 10s (same suit)
Tier 11. Six Red 7s (same suit)
Tier 12. Six Black 7s (same suit)
Tier 13. Six Red 6s (same suit)
Tier 14. Six Black 6s (same suit)
Tier 15. Six Red 5s (same suit)
Tier 16. Six Black 5s (same suit)
Tier 17. Six Red 2s (same suit)
Tier 18. Six Black 2s (same suit)
Mixed Suit Jackpot Multiplier Tiers:
Tier 19. Six Red Aces (mixed suits)
Tier 20. Six Black Aces (mixed suits)
Tier 21. Six Red Kings (mixed suits)
Tier 22. Six Black Kings (mixed suits)
Tier 23. Six Red Queens (mixed suits)
Tier 24. Six Black Queens (mixed suits)
Tier 25. Six Red Jacks (mixed suits)
Tier 26. Six Black Jacks (mixed suits)
Tier 27. Six Red 10s (mixed suits)
Tier 28. Six Black 10s (mixed suits)
Tier 29. Six Red 7s (mixed suits)
Tier 30. Six Black 7s (mixed suits)
Tier 31. Six Red 6s (mixed suits)
Tier 32. Six Black 6s (mixed suits)
Tier 33. Six Red 5s (mixed suits)
Tier 34. Six Black 5s (mixed suits)
Tier 35. Six Red 2s (mixed suits)
Tier 36. Six Black 2s (mixed suits)

In one embodiment, implementation in LDGTs and DETGs involves integrating advanced card recognition technology, real-time data processing, and player interfaces that display current multiplier values. This approach differentiates itself from traditional systems by providing a dynamic and engaging gaming experience that responds to real-time game events.

Sequence Diagram Components: The Grand Paradise Jackpot™ Calculation and Distribution Technique #1A involves several notable components:
1. Electronic Table Game Terminals (ETGTs): These are player interfaces for placing bets and viewing game information. Each ETGT is equipped with a high-resolution display, touch screen interface, and secure payment systems.
2. Dealer-controlled Electronic Table Games system (DETG): This central system manages the overall game flow, integrating inputs from the live dealer and ETGTs.
3. Live Dealer Game Table (LDGT): The physical table where the dealer manages the game, equipped with advanced card recognition technology and real-time data transmission capabilities.
4. Game Management System (GMS): The central software controlling game logic, multiplier calculations, and communications between all components.
5. Probability Calculation Engine: A specialized software component for real-time odds calculations based on card distributions and game progression.
6. Multiplier Adjustment Algorithm: Software that dynamically updates multiplier values based on current probabilities and jackpot pool size.
7. Player A, Player B, etc.: Individual players at the ETGTs, interacting with the game through their terminals.
8. Dealer: The live dealer managing physical cards and game flow at the LDGT.
9. Multiplier Display System: Large screens or integrated displays showing current multiplier values for different combinations.
10. Card Recognition System: Technology at the LDGT for real-time card value reading and transmission.
11. Casino Management System (CMS): Backend system for player tracking, accounting, and jackpot fund management.
12. Random Number Generator (RNG): For verifying the integrity of physical card deals and ensuring game fairness.

Implementation Details: The implementation of the Grand Paradise Jackpot™ Calculation and Distribution Technique #1A in LDGT and DETG systems may require a sophisticated integration of hardware and software components. Each ETGT is equipped with a high-resolution touchscreen display, capable of rendering detailed graphics for the baccarat table layout and real-time jackpot information. The ETGTs feature a dedicated jackpot betting area on the screen, allowing players to easily place their jackpot wagers alongside traditional baccarat bets.

The heart of the system lies in the advanced Card Recognition System integrated into the LDGT. This system utilizes high-speed cameras and image processing algorithms to instantly recognize and digitize card values as they are dealt. The data is immediately transmitted to the Game Management System (GMS) via a secure, low-latency network connection.

The GMS, powered by state-of-the-art servers, houses the Probability Calculation Engine and Multiplier Adjustment Algorithm. These components work in tandem to process the card data in real-time. The Probability Calculation Engine continuously updates the odds of each six-card combination occurring, taking into account the cards already dealt and the remaining deck composition. Simultaneously, the Multiplier Adjustment Algorithm dynamically adjusts the multiplier values for each of the 36 jackpot tiers based on these probabilities and the current jackpot pool size.

A notable innovation in this implementation is the flexible multiplier structure. The system allows casino operators to choose between a mathematically fair model (where all same-probability combinations have equal multipliers) and a perceived-value model (where higher-ranking cards receive higher multipliers despite equal probabilities). This flexibility is achieved through a configurable parameter system in the GMS, allowing easy adjustments to suit different market preferences or promotional strategies.

The Multiplier Display System, consisting of large LED screens strategically placed around the gaming area, receives real-time updates from the GMS. These displays show the current multiplier values for each tier, creating a visually engaging environment that builds excitement among players.

To ensure game integrity, the system incorporates a Random Number Generator (RNG) that verifies the fairness of physical card deals. This RNG data is cross-referenced with the Card Recognition System output, providing an additional layer of security and compliance with gaming regulations.

The implementation also includes a robust data management system that interfaces with the Casino Management System (CMS). This integration allows for real-time tracking of jackpot contributions, player activities, and payout events. The system is designed to handle high volumes of simultaneous players across multiple LDGTs and DETGs, ensuring scalability and consistent performance even during peak hours.

This implementation represents a significant advancement over traditional ETGT and EGD systems. Unlike prior art systems that typically offer fixed jackpots or simple progressive structures, this technique introduces a dynamic, probability-based multiplier system that adapts in real-time to game outcomes. The integration of perceived card value into the multiplier structure is a novel approach that enhances player engagement and marketing potential, setting this system apart from conventional jackpot implementations in the casino industry.

Example Walk-through Scenarios: To help illustrate the implementation of the Grand Paradise Jackpot™ Calculation and Distribution Technique #1A, let's walk through different example scenarios at a Baccarat DETG System.

### Example Scenario A

Example Use Case: Player A approaches an ETGT connected to a live baccarat table. The large display above the table shows the current jackpot amount of 10,000,000 HKD and the multiplier values for various card combinations. Player A inserts her casino membership card and transfers 50,000 HKD to the ETGT's credit meter.

As the dealer announces the start of a new round, Player A places a 1,000 HKD bet on the Player hand and a 200 HKD bet on the Grand Paradise Jackpot™. The ETGT's touchscreen displays a confirmation of these bets and updates Player A's credit balance.

The dealer begins dealing cards. As each card is revealed, the Card Recognition System instantly captures and transmits the data to the GMS. The first four cards dealt are: Ace of Hearts, King of Spades (Player hand), Queen of Diamonds, Jack of Clubs (Banker hand).

The Probability Calculation Engine rapidly updates the odds for all possible six-card combinations. The Multiplier Adjustment Algorithm recalculates the multipliers for each jackpot tier based on these new probabilities. The large displays around the table update in real-time, showing increased multipliers for combinations involving the remaining Aces, Kings, Queens, and Jacks.

The dealer draws the fifth card: a 10 of Hearts (Player hand). The system again updates all probabilities and multipliers. The tension builds as players realize that drawing another red 10 would trigger a significant jackpot win.

The final card drawn is the 10 of Diamonds (Banker hand). Instantly, the system recognizes that this six-card combination (A♥, K [symbol] , Q♦, J [symbol] , 10♥, 10♦) matches one of the jackpot tiers: “Six Red 10s (mixed suits)” with a current multiplier of 10,000×.

The ETGT's display lights up, announcing that Player A has won the jackpot. The payout is calculated: 200 HKD (jackpot bet)×10,000 (multiplier)=2,000,000 HKD. The Casino Management System verifies the win and initiates the payout process.

### Player Interactions:

1. Player A inserts her membership card into the ETGT.
2. She transfers funds to the ETGT's credit meter using the touchscreen interface.
3. When betting opens, Player A places her bets on the Player hand and the Grand Paradise Jackpot™ using the ETGT's intuitive betting interface.
4. Throughout the deal, Player A watches both the physical table and the ETGT's display, which shows real-time updates of card values and changing jackpot multipliers.
5. When the jackpot is hit, Player A interacts with the ETGT to confirm the win and choose her payout method.

### ETGT Internal Operations:

1. The ETGT validates Player A's membership card and credit transfer.
2. It records and transmits Player A's bets to the GMS.
3. As cards are dealt, the ETGT receives real-time updates from the GMS about card values and changing multipliers.
4. The ETGT's internal software continuously updates its display, showing current game state, jackpot information, and Player A's potential winnings.
5. When the jackpot is hit, the ETGT's software calculates the win amount and displays it to Player A.
6. The ETGT communicates with the CMS to initiate the jackpot payout process.

### Casino Gaming Network Activities:

1. The CMS verifies Player A's identity and available funds when she logs in.
2. Throughout the game, the GMS receives data from the Card Recognition System and updates probabilities and multipliers.
3. The CMS tracks all bets placed, including jackpot contributions from all connected ETGTs.
4. When the jackpot is hit, the CMS verifies the win, updates the jackpot pool, and manages the payout process.
5. The entire process is logged for regulatory compliance and security purposes.

### Data Flow and Communication:

1. Continuous real-time data flow occurs between the LDGT, ETGTs, GMS, and CMS.
2. Card data flows from the Card Recognition System to the GMS.
3. Updated probability and multiplier data flow from the GMS to all ETGTs and display systems.
4. Player bet and win data flow between ETGTs, GMS, and CMS.
5. All communications are encrypted and validated to ensure data integrity and regulatory compliance.

Component Interactions and Procedural Steps: The implementation of the Grand Paradise Jackpot™ Calculation and Distribution Technique #1A involves intricate interactions between various components of the casino gaming network. The process begins when a player approaches an Electronic Table Game Terminal (ETGT) connected to a Dealer-controlled Electronic Table Games system (DETG).
1. Player Authentication and Fund Transfer: The ETGT's card reader scans the player's membership card and communicates with the Casino Management System (CMS) to verify the player's identity and retrieve their account information. The ETGT's touchscreen interface allows the player to transfer funds from their casino account to the ETGT's credit meter. This transaction is processed in real-time by the CMS, which updates the player's account balance and the ETGT's credit meter.
2. Bet Placement and Transmission: As the dealer announces the start of a new round, the player uses the ETGT's touchscreen to place bets on the baccarat game and the Grand Paradise Jackpot™. The ETGT's software records these bets and instantly transmits the data to the Game Management System (GMS) via a secure network protocol. The GMS acknowledges receipt of the bet data and updates the global bet pool for the current game round.
3. Card Dealing and Recognition: The dealer at the Live Dealer Game Table (LDGT) begins dealing physical cards. As each card is revealed, the advanced Card Recognition System, utilizing high-resolution cameras and sophisticated image processing algorithms, instantly captures the card's value and suit. This data is immediately transmitted to the GMS through a low-latency, high-reliability network connection.
4. Real-time Probability Calculations: Upon receiving each card's data, the GMS activates its Probability Calculation Engine. This specialized software component performs complex calculations in milliseconds, updating the probabilities of all possible six-card combinations based on the cards already dealt and the composition of the remaining deck. This real-time probability update is a novel feature that sets this system apart from traditional fixed-odds jackpot systems.
5. Dynamic Multiplier Adjustments: Simultaneously with the probability calculations, the GMS's Multiplier Adjustment Algorithm springs into action. This innovative algorithm takes into account the updated probabilities, the current jackpot pool size, and pre-configured parameters (such as the desired balance between mathematical fairness and perceived card value) to dynamically adjust the multiplier values for each of the 36 jackpot tiers. This real-time adjustment of multipliers based on both mathematical and psychological factors is a unique aspect of this system.
6. Display Updates: The newly calculated multiplier values are instantly transmitted to all connected ETGTs and the central Multiplier Display System. The ETGTs update their individual displays, showing players the current multipliers and their potential winnings. The large central displays update simultaneously, creating a synchronized, exciting atmosphere across the entire gaming area.
7. Jackpot Win Detection and Verification: As the final card is dealt, the GMS's pattern recognition module identifies whether the six-card combination matches any of the jackpot tiers. In the event of a jackpot win, the GMS immediately flags this to the ETGT of the winning player(s) and the CMS. The Random Number Generator (RNG) is activated to verify the integrity of the physical card deal, providing an additional layer of security and fairness verification.
8. Win Calculation and Payout Initiation: Upon confirmation of a jackpot win, the GMS calculates the payout amount based on the winning player's bet and the final multiplier value. This win data is transmitted to the winning ETGT and the CMS. The ETGT displays the win amount to the player, while the CMS initiates the payout process, updating the player's account and adjusting the jackpot pool accordingly.
9. Data Logging and Compliance: Throughout this entire process, each component logs its activities in detail. The CMS maintains a comprehensive record of all transactions, game outcomes, and jackpot events. This data is notable for regulatory compliance, financial auditing, and potential dispute resolution.

This intricate series of interactions and procedural steps represents a significant advancement over traditional ETGT and EGD systems. The real-time probability calculations, dynamic multiplier adjustments, and seamless integration of physical card dealing with digital systems create a unique and engaging player experience that was not possible with prior art techniques. The system's ability to balance mathematical fairness with perceived value in its multiplier structure is a novel approach that enhances both player engagement and marketing potential.

Player Interaction: The Grand Paradise Jackpot™ Calculation and Distribution Technique #1A offers a highly interactive and engaging experience for players at Electronic Table Game Terminals (ETGTs). This novel approach to jackpot gaming in baccarat significantly enhances player engagement compared to traditional systems.

When a player approaches an ETGT, they are immediately greeted by a vibrant, high-resolution touchscreen display. The interface is intuitively designed, allowing even novice players to easily navigate the betting options. A prominent section of the screen is dedicated to the Grand Paradise Jackpot™, displaying current multiplier values for various card combinations and the potential payout based on the player's bet.

Players begin by inserting their casino membership cards or by creating a temporary account. The ETGT's secure interface allows them to transfer funds from their casino account to the terminal's credit meter. This process is streamlined and instantaneous, leveraging the casino's advanced financial transaction systems.

As the live dealer announces the start of a new round, players may place their bets on the traditional baccarat outcomes (Player, Banker, Tie) using familiar touch controls. The Grand Paradise Jackpo^{f} bet is presented as an exciting additional option, with clear instructions on how it works. Players may adjust their jackpot bet amount, seeing in real-time how different bet sizes affect potential payouts for each card combination.

A unique feature of this system is the dynamic nature of the jackpot display. As cards are dealt at the live table, players watch in anticipation as the multipliers for various combinations change in real-time. This creates a thrilling experience, as players see the potential payouts fluctuate with each card revealed. The ETGT's display synchronizes perfectly with the large central displays, ensuring all players have access to the same up-to-the-second information.

In the event of a jackpot win, the lucky player's ETGT erupts with celebratory graphics and sounds, instantly notifying them of their win. The display shows a detailed breakdown of the winning combination and the payout amount. Players may then choose how they wish to receive their winnings, whether as credits on their account, a printed ticket, or through other available methods.

This level of interactivity and real-time engagement is a significant advancement over traditional ETGTs and Electronic Gaming Machines (EGDs). Unlike prior systems where jackpot odds and payouts were static, this technique allows players to actively engage with the changing odds throughout each game round. The visual representation of changing multipliers adds an extra layer of excitement and anticipation to every hand dealt.

Moreover, the system's ability to cater to different player preferences through its flexible multiplier structure is a novel feature. Players who appreciate mathematical fairness may opt for games where multipliers are strictly based on probabilities, while those who value the perceived importance of high-ranking cards may enjoy games with multipliers adjusted for card value. This customization option, easily accessible through the ETGT interface, is a unique aspect that sets this system apart from conventional jackpot implementations.

The integration of advanced graphics and animations on the ETGT display, synchronized with the live dealer actions, creates a seamless blend of physical and digital gaming experiences. This hybrid approach is particularly appealing to players in Macau, where the excitement of live table games is highly valued.

### Example Scenario B

Player A approaches an ETGT and inserts their player card. The ETGT authenticates the player with the CMS and displays their account balance. Player A then places a standard baccarat bet and opts in for the Paradise Jackpot side bet.

As the dealer initiates the game, the DETG's electronic dealing system feeds card information directly to the GMS. The Probability Calculation Engine immediately updates the probabilities for all possible six-card combinations based on the cards dealt.

The Multiplier Adjustment Algorithm then recalculates the multipliers for each jackpot tier. These updated multipliers are instantly displayed on Player A's ETGT and the central Multiplier Display System.

Let's say the first four cards dealt are all Aces. The GMS recognizes this rare occurrence and significantly increases the multipliers for six-Ace combinations. Player A's ETGT screen flashes an alert, showing the potential payout if the final two cards are also Aces.

This creates a moment of high tension and excitement. Other players at nearby ETGTs, seeing the increased multipliers on the central display, may be inspired to place Paradise Jackpot bets for the next round.

As the final two cards are dealt, they turn out to be a King and a Queen. While not triggering the jackpot, the GMS records this information for future probability calculations.

Throughout this process, the ETGT is continuously communicating with the GMS and CMS, updating bet information, game state, and player balance. All transactions are logged securely for regulatory compliance.

After the game concludes, Player A's ETGT displays the game result, updates their balance, and prepares for the next round. The central Multiplier Display System resets to show the base multipliers for the upcoming game.

This scenario demonstrates how the system creates an engaging, dynamic experience that responds to game events in real-time, significantly enhancing the traditional baccarat game.

Component Interactions and Procedural Steps: The implementation of the Grand Paradise Jackpot™ system involves complex interactions between various components:
1. Game Initiation: When Player A places a bet, the ETGT sends this information to the GMS via the network. The GMS updates the jackpot pool and communicates this to the CMS for accounting purposes.
2. Card Dealing and Recognition: In LDGTs, as cards are dealt, the Card Recognition System instantly captures and processes the card information. In DETGs, this information comes directly from the electronic dealing system. This data is immediately sent to the GMS.
3. Probability Calculation: The GMS's Probability Calculation Engine uses the card information to update the probabilities of all possible six-card combinations. This involves complex statistical calculations performed in milliseconds.
4. Multiplier Adjustment: Based on the new probabilities, the Multiplier Adjustment Algorithm recalculates the multipliers for each jackpot tier. This algorithm balances mathematical probabilities with perceived card values to maintain game excitement and fairness.
5. Display Updates: The new multipliers are sent to all ETGTs and the central Multiplier Display System. ETGTs update their individual displays, while the central system updates the large screens visible to all players.
6. Jackpot Evaluation: After all six cards are dealt, the GMS evaluates if a jackpot has been triggered. If so, it calculates the payout based on the final multiplier and bet amount.
7. Payout Processing: If a jackpot is won, the GMS instructs the CMS to process the payout. The CMS updates player balances and triggers any necessary financial transactions.
8. Data Logging: Throughout the process, all game events, probability calculations, and financial transactions are logged securely for regulatory compliance and auditing purposes.

These steps represent a significant advancement over traditional jackpot systems. The real-time probability calculations and multiplier adjustments create a dynamic, responsive gaming environment that was not possible with static jackpot structures. The integration of advanced card recognition technology (in LDGTs) and direct electronic dealing systems (in DETGs) with sophisticated probability engines enables a level of real-time interaction and excitement previously unseen in baccarat games.

Player Interaction: The Grand Paradise Jackpot™ system offers a unique and engaging experience for players interacting with the ETGTs:
1. Betting Interface: Players use the ETGT's touchscreen to place their bets. The interface clearly displays standard baccarat bets and the Paradise Jackpot side bet. As players place their bets, the screen provides real-time feedback, showing the potential payout for each bet based on current multipliers.
2. Dynamic Multiplier Display: During the game, players may watch as multipliers change in real-time. The ETGT screen may use animations or color changes to highlight significant multiplier increases, drawing player attention to potentially lucrative jackpot opportunities.
3. Game Progress Visualization: As cards are dealt, the ETGT displays them in high-resolution graphics. For partially completed rare combinations, the screen may highlight the potential jackpot combinations, building tension and excitement.
4. Jackpot Alerts: If a player's bet qualifies for a jackpot, the ETGT provides visual and audio alerts, creating a moment of anticipation and excitement.
5. Multi-Game Viewing: Players may use their ETGT to view the progress of multiple games simultaneously, allowing them to track several potential jackpot opportunities at once.
6. Account Management: Players may easily check their balance, view betting history, and manage their funds directly from the ETGT interface.

This level of interaction and real-time feedback is a significant advancement over traditional ETGTs, providing a more immersive and engaging experience that keeps players involved throughout the gaming session.

Distinguishing Aspects and Features: The Grand Paradise Jackpot™ Calculation and Distribution Technique #1A incorporates several novel implementation features that set it apart from prior art techniques and enable its unique deployment in Live Dealer Game Tables (LDGTs) and Dealer-controlled Electronic Table Games systems (DETGs):
1. Dynamic Real-Time Multiplier Adjustments: Unlike traditional fixed-odds jackpot systems, this technique employs a sophisticated Multiplier Adjustment Algorithm that continuously recalculates and updates jackpot multipliers in real-time. This dynamic approach takes into account the current game state, cards dealt, and remaining deck composition to adjust the multipliers for each of the 36 jackpot tiers instantly. This feature creates an unprecedented level of engagement and excitement, as players witness potential payouts changing with each card dealt.
2. Integrated Card Recognition System: The implementation of an advanced Card Recognition System at the LDGT is a notable innovation. This system uses high-resolution cameras and cutting-edge image processing algorithms to instantly recognize and digitize card values as they are dealt physically. The seamless integration of this technology with the digital betting system bridges the gap between traditional table games and electronic gaming, offering a unique hybrid experience that appeals particularly to Macau's gaming market.
3. Flexible Multiplier Structure: The system's ability to switch between mathematically fair and perceived-value multiplier structures is a novel feature. This flexibility allows casino operators to tailor the jackpot experience to different player preferences or marketing strategies. The ability to adjust these parameters easily through the Game Management System (GMS) is unique to this implementation and not found in prior ETGT or LDGT systems.
4. Probability Calculation Engine: The incorporation of a dedicated Probability Calculation Engine that performs complex odds calculations in real-time is a distinguishing feature. This component enables the system to maintain accurate and fair jackpot odds throughout the game, even as the deck composition changes with each card dealt. This level of mathematical precision in a live table game environment is unprecedented in prior art systems.
5. Synchronized Multi-Display Integration: The seamless synchronization between individual ETGT displays and large central displays is a novel aspect of this implementation. This feature ensures that all players, regardless of their position or the ETGT they are using, have access to the same real-time information about jackpot multipliers and potential payouts. This creates a unified and immersive gaming experience across the entire casino floor.
6. Adaptive Jackpot Contribution System: The technique incorporates an innovative approach to jackpot contributions, allowing for dynamic adjustment of contribution rates based on game outcomes and jackpot sizes. This adaptive system ensures the long-term sustainability of the jackpot while maintaining player interest through consistently attractive potential payouts.
7. Enhanced Player Engagement Through Visualization: The implementation includes advanced graphical representations of changing odds and potential payouts on ETGT screens. This visual approach to displaying complex probability data is a unique feature that enhances player understanding and engagement, setting it apart from text-based or static display systems in prior art ETGTs.
8. Integration with Random Number Generator (RNG): The novel integration of an RNG to verify the integrity of physical card deals adds an extra layer of security and fairness verification not typically found in traditional live table games. This feature bridges the gap between the trustworthiness of electronic systems and the authenticity of physical card games.

These distinguishing aspects and features collectively enable the Grand Paradise Jackpot™ Calculation and Distribution Technique to offer a uniquely engaging and fair gaming experience in LDGT and DETG environments. The system's ability to blend the excitement of live dealer games with the precision and flexibility of electronic systems represents a significant advancement over prior art techniques in the casino gaming industry.

Noteworthy Procedural Steps: The Grand Paradise Jackpot™ Calculation and Distribution Technique #1A incorporates several novel steps that differentiate it from prior art Electronic Gaming Machines (EGDs) and enable its unique implementation in Live Dealer Game Table (LDGT) systems and Dealer-controlled Electronic Table Games (DETG) systems:
1. Real-Time Probability Recalculation and Multiplier Adjustment: This innovative step involves continuously updating the probabilities of all possible six-card combinations and their corresponding jackpot multipliers as each card is dealt. The process includes: a) Instant card recognition and digitization using advanced image processing. b) Rapid recalculation of probabilities for all 36 jackpot tiers based on the current deck composition. c) Dynamic adjustment of multiplier values using a proprietary algorithm that balances mathematical fairness with perceived card value.

This step is unique in its ability to provide a constantly evolving jackpot scenario that responds to the actual cards dealt in real-time. Unlike static jackpot systems in traditional EGDs, this approach creates a more engaging and mathematically fair gaming experience. It's particularly suited for LDGT and DETG systems where live card dealing is integrated with electronic betting.
2. Synchronized Multi-Terminal Display Updates: This novel step ensures that all Electronic Table Game Terminals (ETGTs) and central displays are updated simultaneously with the latest jackpot information. The process involves: a) Instantaneous transmission of updated multiplier data from the central Game Management System (GMS) to all connected devices. b) Synchronization of visual elements across diverse display types (individual ETGTs, large central screens, dealer station displays). c) Real-time rendering of complex probability data into easily understandable graphical formats.

This step significantly enhances the communal aspect of the game, creating a unified experience across multiple terminals that is not possible with traditional single-player EGDs. It's notable for maintaining fairness and excitement in the DETG environment where multiple players interact with the same live game.
3. Adaptive Jackpot Contribution and Payout Mechanism: This step introduces a flexible approach to managing the jackpot pool, including: a) Dynamic adjustment of jackpot contribution rates based on current pool size and recent payout history. b) Implementation of a tiered payout structure that allows for both large headline jackpots and more frequent smaller payouts. c) Real-time calculation of potential payouts for each player based on their current bet and the dynamically adjusted multipliers.

This adaptive mechanism ensures the long-term sustainability of the jackpot while maintaining player interest through consistently attractive potential payouts. It's a significant advancement over fixed contribution and payout systems found in traditional EGDs and is particularly suited to the varied betting patterns encountered in LDGT and DETG environments.

These novel steps are uniquely tailored for supporting LDGT and DETG systems, offering a level of dynamism and player engagement not possible with traditional EGDs. The integration of live card dealing with sophisticated real-time electronic calculations and display updates represents a significant innovation in the field of casino gaming. This approach bridges the gap between the excitement of live table games and the precision of electronic gaming systems, creating a hybrid experience that is particularly appealing in markets like Macau where both traditional and technological aspects of gaming are highly valued.

35 USC 101 Considerations: The Grand Paradise Jackpot™ Calculation and Distribution Technique #1A presents a strong case for patent eligibility under 35 USC 101, as it embodies a specific improvement over prior art that solves a problem in an existing technological process and integrates this improvement into a practical application that enables a discernible advancement in computer functionality.

Firstly, this technique goes beyond a mere abstract idea by implementing a concrete and tangible improvement in the field of electronic gaming systems. The dynamic real-time calculation and adjustment of jackpot multipliers based on actual card distributions represent a specific technological improvement over static or predetermined jackpot systems. This is not simply an implementation of a mathematical concept, but rather a novel integration of real-time data processing, advanced probability calculations, and user interface updates that creates a new and improved gaming experience.

Secondly, the technique is directed at solving a specific problem in the existing technological process of electronic table games. Traditional systems struggle to maintain player engagement and fairness in jackpot scenarios, especially in live dealer environments where physical cards are used. This invention addresses this issue by creating a seamless integration between physical card dealing and electronic betting systems, enhancing both the accuracy of jackpot odds and the overall player experience. The use of advanced card recognition technology, coupled with real-time probability calculations, solves the technical challenge of maintaining fair and exciting jackpot opportunities in a live gaming environment.

Thirdly, the technique integrates its improvements into a practical application that enables a discernible advancement in computer functionality. The system's ability to process complex probability calculations in real-time, adjust multipliers dynamically, and synchronize this information across multiple display devices represents a significant advancement in the computational capabilities of gaming systems. This is not merely the implementation of known computer functions, but rather a novel approach that pushes the boundaries of what existing gaming computers may achieve in terms of real-time data processing and display synchronization.

Furthermore, the technique's adaptive jackpot contribution and payout mechanism demonstrates a practical application that goes beyond generic computer implementation. It utilizes computer technology to create a more sustainable and engaging jackpot system, which is a concrete improvement in the field of electronic gaming.

The integration of physical elements (live card dealing) with advanced digital processing (real-time probability calculations and display updates) also supports the argument that this technique is more than an abstract idea. It represents a tangible and practical application of technology that improves the functioning of electronic gaming systems in a specific and meaningful way.

The Grand Paradise Jackpot™ system presents a strong case for patent eligibility under 35 USC 101:
(a) Specific Improvement Over Prior Art: This system goes beyond a mere abstract idea by implementing a concrete, technological solution to the problem of static and unengaging jackpot systems. The real-time probability calculations and multiplier adjustments represent a specific improvement in the field of electronic gaming, enhancing both the player experience and the mathematical fairness of jackpot games.
(b) Improvement in Computer Functionality: The system's ability to perform complex probability calculations and adjust multipliers in real-time demonstrates a clear improvement in computer functionality. This solves the technological problem of creating dynamic, responsive jackpot systems in live dealer environments, a challenge that existing systems have not adequately addressed.
(c) Integration into Practical Application: The Grand Paradise Jackpot™ system integrates its novel features into a practical application that provides tangible benefits. It enhances the gaming experience by offering real-time, dynamic jackpot opportunities, and improves the operational efficiency of casinos by automating complex probability calculations and jackpot management. This integration results in a discernible advancement in the functionality and capabilities of electronic gaming systems.

The system's use of advanced algorithms for real-time probability calculations, sophisticated display systems for player feedback, and seamless integration of physical and electronic components all contribute to its status as a patent-eligible improvement in gaming technology.

The Grand Paradise Jackpot™ Calculation and Distribution Technique #1A meets the criteria for patent eligibility under 35 USC 101. It presents a specific technological improvement, solves a problem in existing gaming technology, and integrates these improvements into a practical application that advances computer functionality in the context of electronic gaming systems. This technique goes beyond abstract ideas or mere instructions to apply an exception using generic computer components, offering instead a novel and non-obvious solution to challenges in the field of electronic table games.

Event Detection and Data Tracking: The Grand Paradise Jackpot™ Calculation and Distribution Technique #1A relies on sophisticated event detection and data tracking mechanisms to enable its implementation in Live Dealer Game Table (LDGT) systems and Dealer-controlled Electronic Table Games (DETG) systems. This technique monitors and processes a wide range of events, conditions, and data types, including several Innovative Elements that set it apart from prior art systems:
1. Real-Time Card Detection and Digitization: The system employs advanced image recognition technology to instantly detect and digitize card values and suits as they are physically dealt. This real-time card tracking is a notable novel feature that enables the dynamic probability calculations central to this technique.
2. Player Betting Patterns: The system tracks not only the amounts bet on traditional baccarat outcomes but also the specific jackpotbets placed by each player. This granularbetting data is desirable for calculating potential payouts and adjusting jackpot contributions.
3. Deck Composition Tracking: As cards are dealt, the system continuously updates its record of the remaining deck composition. This ongoing tracking is notable for accurate probability calculations and is a unique feature not typically found in traditional baccarat systems.
4. Multiplier State Changes: The system monitors and logs every change in jackpot multipliers across all 36 tiers. This detailed tracking of multiplier fluctuations is a novel aspect that supports the dynamic nature of the jackpot system.
5. Jackpot Pool Dynamics: The technique tracks real-time changes in the jackpot pool size, including contributions from all connected ETGTs and any payouts made. This comprehensive pool tracking enables the adaptive jackpot contribution mechanism.
6. Player Interaction Data: The system monitors how players interact with their ETGTs, including screen touches, bet adjustments, and viewing patterns of jackpot information. This behavioral data may be used to refine the user interface and gaming experience.
7. Synchronized Display States: The technique tracks the display state of all connected devices (ETGTs, central displays) to ensure synchronized information presentation across the gaming floor.
8. Random Number Generator (RNG) Verification Events: The system logs RNG activations used to verify the integrity of physical card deals, creating an auditable trail of game fairness.
9. Jackpot Win Triggers: The technique detects and logs the specific card combinations that trigger jackpot wins, including the exact time and associated betting data.
10. System Performance Metrics: The technique monitors various system performance indicators, such as calculation speeds, network latency, and display update rates, to ensure optimal operation of the jackpot system.

This comprehensive and granular approach to event detection and data tracking enables the Grand Paradise Jackpot™ Calculation and Distribution Technique to offer a uniquely responsive and engaging gaming experience. The integration of physical card tracking with digital betting and probability calculations represents a novel approach in LDGT and DETG systems, setting this technique apart from prior art methods.

Data Processing: The Grand Paradise Jackpot™ Calculation and Distribution Technique #1A employs advanced data processing steps to enable its unique implementation in Live Dealer Game Table (LDGT) and Dealer-controlled Electronic Table Games (DETG) systems. These processing steps, executed by sophisticated software components, include several Innovative Elements that distinguish this technique from prior art systems:
1. Real-Time Probability Calculation: The Probability Calculation Engine performs complex mathematical operations to instantly update the odds of all possible six-card combinations after each card is dealt. This involves: a) Rapid analysis of current deck composition. b) Calculation of conditional probabilities for each jackpot tier. c) Adjustment of odds based on the number of decks in play.
2. Dynamic Multiplier Adjustment: The Multiplier Adjustment Algorithm processes probability data along with other factors to update jackpot multipliers in real-time. This includes: a) Balancing mathematical fairness with perceived card value. b) Adjusting multipliers based on current jackpot pool size. c) Applying configurable weighting factors for different jackpot tiers.
3. Synchronized Display Update Computation: The system calculates and prepares display update data for all connected devices, ensuring synchronized information across the gaming floor. This involves: a) Generating optimized data packets for different display types (ETGT screens, central displays). b) Calculating transitions for smooth visual updates of changing multipliers.
4. Individual Player Payout Calculation: For each player, the system continuously calculates potential payouts based on their current bets and the latest multiplier values. This includes: a) Real-time adjustment of payout calculations as multipliers change. b) Computation of multi-tiered payouts for different jackpot scenarios.
5. Jackpot Contribution Rate Adjustment: The system dynamically calculates optimal jackpot contribution rates based on current game conditions. This involves: a) Analyzing recent payout history and jackpot pool growth rates. b) Adjusting contribution percentages to maintain jackpot attractiveness and sustainability.
6. Card Recognition Data Processing: The system processes image data from the Card Recognition System to accurately identify and digitize card values. This includes: a) Image enhancement and noise reduction. b) Pattern matching against known card templates. c) Confidence scoring for recognition accuracy.
7. RNG Integration and Verification: The system processes data from the Random Number Generator to verify the integrity of physical card deals. This involves: a) Comparing RNG outputs with actual card distributions. b) Calculating statistical measures of randomness and fairness.

These sophisticated data processing steps enable the Grand Paradise Jackpot™ Calculation and Distribution Technique to offer a uniquely responsive and mathematically sound gaming experience. The integration of real-time probability calculations with dynamic multiplier adjustments and synchronized multi-device updates represents a significant advancement over prior art systems in LDGT and DETG Environments.

### Alternate Embodiment of Sequence Diagram Components

In at least one embodiment, to implement this dynamic jackpot multiplier system:
1. Configuration of ETGTs:
   Dedicated Jackpot Betting Interface: Each ETGT is equipped with a dedicated area for placing jackpot bets and displays showing current multipliers.
   User Interface Enhancements: The ETGT software includes modules to display real-time updates on multipliers, probabilities, and jackpot statuses.
   Integration with Card Recognition Systems: ETGTs receive real-time data from the card recognition system at the LDGT.
2. Live Dealer Station Enhancements:
   Advanced Card Recognition Technology: Cameras and sensors capture and transmit card information instantly to the GMS.
   Dealer Interface: Provides the dealer with real-time feedback and alerts regarding jackpot events.
3. Game Management System (GMS):
   Central Processing Hub: Aggregates data from ETGTs, card recognition systems, and calculates probabilities and multipliers.
   Probability Calculation Engine: Continuously computes the odds of each six-card combination occurring.
   Multiplier Adjustment Algorithm: Dynamically adjusts multipliers based on real-time probabilities and predefined rules.
4. Network Infrastructure:
   High-Speed Communication: Ensures low-latency data transmission between all components.
   Security Protocols: Encrypts data to protect player information and game integrity.
5. Casino Management System (CMS) Integration:
   Jackpot Fund Management: Tracks contributions to the jackpot pool from each bet.
   Accounting and Reporting: Logs all transactions and jackpot payouts for compliance and auditing.
6. Regulatory Compliance:
   Data Logging: Maintains records of all game events, player actions, and system processes.
   Random Number Generation Verification: Ensures that electronic elements meet randomness standards.
      Differentiation from Prior Art:
Dynamic Adjustments: Unlike static jackpot systems, this technique adjusts multipliers in real-time based on actual game events.
Integration of Live and Electronic Systems: Combines the authenticity of live dealer games with the efficiency of electronic systems.
Enhanced Player Engagement: Offers a personalized gaming experience with real-time updates and potential for significant payouts.

### Example Walk-Through Scenario

A player, Player A, approaches an ETGT at a baccarat table in a casino. The ETGT displays the current game state and the dynamic jackpot multipliers for various six-card combinations. Player A inserts their player loyalty card, deposits funds, and places a standard bet on the Player hand, along with an optional jackpot side bet.

During the game:
1. Game Play Events:
   The live dealer deals the cards, and the card recognition system captures each card's value and suit, transmitting this data to the GMS.
   The GMS updates the probabilities and adjusts the multipliers in real-time, displaying any changes on the ETGTs and the multiplier display system.
2. Jackpot Trigger:
   If the six-card combination dealt matches one of the predefined jackpot combinations (e.g., Six Red Aces of the same suit), the system triggers the jackpot payout.
   Player A's ETGT displays a celebratory animation, indicating the jackpot win and the multiplier applied to their jackpot bet.
3. Payout Process:
   The CMS processes the payout, crediting the winnings to Player A's account.
   All relevant game data and transaction details are logged for auditing and compliance.

### Player Interactions

Initiating Gameplay: Player A logs in using their loyalty card and navigates the ETGT interface to place bets.
Wagering: Selects the desired bet amounts for both the main game and the jackpot side bet.
Game Participation: Watches the live dealer and the game progress on the ETGT screen, with real-time updates.
Jackpot Engagement: Observes the dynamic multipliers and understands the potential payouts for rare combinations.

### ETGT Internal Operations

Monitoring Game Play: Receives real-time data from the GMS about card values and game states.
Calculating and Updating Information: Displays current multipliers, potential payouts, and game statistics.
Handling Payouts: Automatically credits winnings to the player's account upon a jackpot win.
Interfacing with External Systems: Communicates with the GMS and CMS for data synchronization and transaction processing.

### Casino Gaming Network Activities

Game Outcome Monitoring: The GMS tracks all card deals and game outcomes.
Data Recording: Stores game events, player actions, and jackpot triggers in the data storage system.
Regulatory Compliance: Ensures all processes adhere to gaming laws and regulations, including data security and fairness.

### Data Flow and Communication

Real-Time Updates: Card data flows from the card recognition system to the GMS and then to the ETGTs.
Player Data Management: The CMS handles player authentication, account balances, and loyalty program integration.
Jackpot Contributions: Wagering data is used to update the jackpot pool in real-time.
Payout Triggers: When jackpot conditions are met, the GMS signals the CMS to process payouts.

### Component Interactions and Procedural Steps

1. Player Action:
   Step: Player A places a bet on the ETGT.
   Components Involved: ETGT interface, player account system.
   Noteworthy Features: Integration of jackpot betting options with real-time multiplier display.
2. Card Dealing and Recognition:
   Step: Live dealer deals the cards; the card recognition system captures card details.
   Components Involved: LDGT, card recognition hardware, GMS.
   Noteworthy Features: Real-time data capture and transmission to the GMS.
3. Probability and Multiplier Calculation:
   Step: GMS calculates the probabilities and adjusts multipliers dynamically.
   Components Involved: Probability Calculation Engine, Multiplier Adjustment Algorithm.
   Noteworthy Features: Continuous recalibration of multipliers based on live data.
4. Data Dissemination:
   Step: Updated multipliers and game states are communicated to ETGTs.
   Components Involved: Network Communication Components, ETGTs.
   Noteworthy Features: Real-time synchronization across multiple terminals.
5. Jackpot Trigger and Payout:
   Step: Jackpot conditions are met; payouts are processed.
   Components Involved: GMS, CMS, ETGTs.
   Noteworthy Features: Immediate recognition and processing of rare event outcomes.

### Noteworthy Implementation Features:

Dynamic Multiplier Adjustments: Differ from prior art by adjusting in real-time, not pre-set values.
Integration of Live and Electronic Systems: Enhances player experience beyond traditional ETGTs.

Advanced Data Processing: Real-time computations for probabilities and payouts.

Player Interaction: Players interact with the system as follows:
Engagement with Dynamic Multipliers: Players are informed of current multipliers, enhancing decision-making and excitement.
Seamless Betting Experience: The ETGT interface allows easy placement of main and jackpot bets.
Real-Time Feedback: Players receive immediate updates on game progress and potential winnings.
Enhanced Entertainment: The possibility of significant payouts for rare combinations adds thrill.

### Noteworthy Aspects:

Interactive Displays: Unlike traditional ETGTs, the dynamic multiplier display offers a unique interactive element.
Personalized Experience: Players receive tailored information based on their bets and game events.
Increased Engagement: The dynamic nature of the game keeps players more involved.

### Distinguishing Aspects and Features

Dynamic Jackpot Multipliers: Adjusting multipliers in real-time based on actual game events is a significant innovation over static jackpot systems.
Real-Time Probability Calculations: Continuously computing probabilities for each combination is novel in the context of live dealer games.
Integration of Advanced Technologies: The use of card recognition systems and advanced algorithms differentiates this technique from prior art.
Enhanced Player Interfaces: ETGTs display real-time data, which is uncommon in traditional systems.
Seamless Live and Electronic Integration: Blending live dealer action with electronic processing creates a unique gaming environment.

These features enable deployment in LDGTs and DETGs by leveraging real-time data processing and interactive player interfaces, which are not present in prior art systems.

### Noteworthy Procedural Steps

1. Real-Time Dynamic Multiplier Adjustment:
   Noteworthy Step: Implementing an algorithm that adjusts jackpot multipliers in real-time based on the rarity of the current six-card combination.
   Utilization: Enhances the gaming experience by providing up-to-the-minute potential payouts.
   Differentiation: Traditional systems use fixed multipliers; this dynamic approach is unique.
2. Integration of Card Recognition with Probability Engines:
   Noteworthy Step: Using advanced card recognition technology to feed live game data into probability calculation engines.
   Utilization: Allows for accurate and immediate probability assessments and multiplier adjustments.
   Differentiation: Prior art does not combine live card recognition with dynamic probability calculations.
3. Enhanced ETGT Player Interface with Real-Time Data:
   Noteworthy Step: Developing ETGT software that displays dynamic multipliers, probabilities, and potential payouts.
   Utilization: Increases player engagement and transparency.
   Differentiation: Traditional ETGTs do not provide this level of interactive feedback.

These steps support LDGT and DETG systems by offering a more engaging, transparent, and technologically advanced gaming experience compared to prior art.

### 35 USC 101 Considerations

### (a) Specific Improvement Over Prior Art

The Grand Paradise Jackpot™ Calculation and Distribution Technique transcends a mere abstract idea by implementing a concrete system that dynamically adjusts jackpot multipliers based on real-time game data. It introduces specific technological solutions, such as integrating card recognition systems with probability engines, which are not found in prior art.

### (b) Improvement in Computer Functionality

This technique improves computer functionality by solving the problem of static and less engaging jackpot systems. It enhances the ETGT's capabilities to process and display real-time data, thereby improving the efficiency and responsiveness of gaming systems. The dynamic adjustment algorithms optimize computational resources by focusing on relevant data streams.

### (c) Integration into Practical Application

The technique integrates the improvement into a practical application by directly impacting how players interact with the game. It enables advancements in computer functionality that result in a discernible improvement in the gaming experience. Players benefit from real-time updates, and casinos may offer more engaging games, demonstrating a tangible application of the innovation.

### Event Detection and Data Tracking

Card Dealing Events: Detection of each card dealt by the live dealer, including rank and suit.
Combination Formation: Tracking the formation of specific six-card combinations.
Player Input: Monitoring bets placed, including jackpot side bets.
Game State Data: Recording the current state of the game, including hands dealt and outcomes.
Wagering Data: Tracking amounts wagered on main bets and jackpot bets.
Jackpot Contribution: Calculating contributions to the jackpot pool from each bet.
Multiplier Adjustments: Recording changes in multipliers based on real-time probabilities.

### Noteworthy Data Tracking:

Real-Time Probability Metrics: Continuously updating the likelihood of specific combinations occurring.
Dynamic Multiplier Data: Adjusting and recording multiplier values as the game progresses.

This level of event detection and data tracking is more advanced than prior art, which typically does not involve real-time adjustments based on live data.

### Data Processing

Card Data Processing:
   Parsing card information from the recognition system.
   Updating game state databases.
Probability Computations:
   Calculating the current probability of each six-card combination.
   Utilizing statistical models within the Probability Calculation Engine.
Multiplier Adjustments:
   Applying the Multiplier Adjustment Algorithm to update multipliers.
   Ensuring adjustments are within predefined limits to maintain game balance.
Player Data Handling:
   Authenticating player identities.
   Updating account balances and loyalty points.
Payout Calculations:
   Computing payouts when jackpot conditions are met.
   Interfacing with the CMS for transaction processing.

### Noteworthy Processing Steps:

Integration of Live Data Streams: Processing real-time data from the card recognition system for immediate computations.
Dynamic Algorithm Application: Employing algorithms that adjust in real-time, which is a significant advancement over static systems.
Enhanced Computational Models: Using sophisticated statistical models to calculate probabilities, which is not common in traditional ETGTs.

### Probability Calculations for Six-Card Combinations

In baccarat, certain six-card combinations involving specific ranks and suits have extremely low probabilities.

The probability of drawing six cards of the same rank and suit (e.g., six Aces of Hearts or six 2s of Hearts) is identical across all ranks due to the equal number of each card in the shoe. Despite these equal probabilities, the multipliers assigned to each tier differ. This is because multipliers are influenced not only by mathematical probabilities but also by factors such as player perception, marketing strategies, and game balance considerations.

In at least one embodiment, the system may dynamically calculate the probabilities of each six-card combination occurring. Once it determines these probabilities, it may assign appropriate multiplier values that reflect the rarity of each combination while ensuring the game's payout structure remains balanced.

### Example Assumptions:

A standard baccarat game uses 8 decks of cards (416 cards in total).
The game deals 6 cards in total: two initial cards each for the Player and Banker, and one possible additional card for each hand.

However, since a Grand Paradise Jackpot™ may be based on specific six-card combinations, the system may initially assume that in every game, exactly six cards are dealt. The system may then calculate the probability of each specific combination occurring during a single game round.

### Step 1: Calculate Total Possible Six-Card Combinations

### Total Possible Six-Card Combinations:

To calculate the total number of ways to choose 6 cards from a shoe containing 416 cards (which is 8 standard 52-card decks), the system may use the combination formula:

$$Total Combinations = ( \begin{matrix}416 \\ 6\end{matrix} ) = \frac{416 !}{6 ! ( 416 - 6 ) !}$$

### Probability Formula for a Specific Six-Card Combination:

The probability of a specific six-card combination occurring is calculated as:

$$P = \frac{Number of Favorable Combinations}{Total Combinations}$$

### Step 2: Calculate Probabilities for Each Tier

### Example Calculation For Tier 1: Six Red Aces (Same Suit)

### Step 1: Calculate the Number of Favorable Combinations

Total Aces of Hearts and Diamonds:

Since there are 8 decks, each with one Ace of Hearts and one Ace of Diamonds:

$$Total Aces of Hearts = 8 and Total Aces of Diamonds = 8$$

Number of Ways to Choose 6 Aces from One Suit:

For either Hearts or Diamonds:

$$Favorable Combinations ( One Suit ) = ( \begin{matrix}8 \\ 6\end{matrix} ) = \frac{8 !}{6 ! ( 8 - 6 ) !} = 28$$

Total Favorable Combinations (Both Suits):

Since there are two suits (Hearts and Diamonds):

Total Favorable Combinations=2×28=56

### Step 2: Calculate the Probability

$${P}_{Tier 1} = \frac{Total Favorable Combinations}{Total Combinations} = \frac{56}{( \begin{matrix}416 \\ 6\end{matrix} )}$$

General Probability Formula for Any Tier

For any specific six-card combination:

$$P = \frac{Number of Ways to Choose the Specific Cards}{( \begin{matrix}416 \\ 6\end{matrix} )}$$

Combination Formula Explanation

The combination formula is:

$$( \begin{matrix}n \\ k\end{matrix} ) = \frac{n !}{k ! ( n - k ) !}$$

### Additional Example: Tier 19—Six Red Aces (Mixed Suits)

### Step 1: Total Red Aces

There are 16 red aces in total (8 of Hearts and 8 of Diamonds):

$$Total Red Aces = 8 + 8 = 16$$

### Step 2: Number of Favorable Combinations

$$Favorable Combinations = ( \begin{matrix}16 \\ 6\end{matrix} ) = \frac{16 !}{6 ! ( 16 - 6 ) !}$$

### Step 3: Calculate the Probability

$${P}_{Tier 19} = \frac{Favorable Combinations}{Total Combinations} = \frac{( \begin{matrix}16 \\ 6\end{matrix} )}{( \begin{matrix}416 \\ 6\end{matrix} )}$$

### General Approach for Other Tiers:

Same Suit Combinations: Calculate combinations where all six cards are the same rank and same suit.
Mixed Suit Combinations: Calculate combinations where all six cards are the same rank and color but may be of any suit within that color.

### Step 3: Assign Multiplier Values

Since exact probabilities are extremely small and difficult to compute precisely due to the large numbers involved, we may assign multiplier values based on the relative rarity of each tier.

### Calculating Probabilities

Total Possible Six-Card Combinations

The total number of ways to choose 6 cards from a shoe containing 416 cards (8 decks) is:

$$Total Combinations = ( \begin{matrix}416 \\ 6\end{matrix} ) = \frac{416 !}{6 ! ( 416 - 6 ) !}$$

Probability of Drawing Six Cards of the Same Rank and Suit

For any specific rank and suit (e.g., Aces of Hearts or 2s of Hearts):

Total Cards of Specific Rank and Suit: 888 (since there are 8 decks and each deck has one of each card).

Number of Ways to Choose 6 Cards from 8:

$$Favorable Combinations = ( \begin{matrix}8 \\ 6\end{matrix} ) = \frac{8 !}{6 ! ( 8 - 6 ) !} = 28$$

Considering Both Suits of the Same Color (e.g., Hearts and Diamonds for red cards):

$$Total Favorable Combinations = 2 \times 28 = 56$$

Probability:

$$P = \frac{Total Favorable Combinations}{Total Combinations} = \frac{56}{( \begin{matrix}416 \\ 6\end{matrix} )}$$

### Deriving the Multipliers

### 1. Base Multiplier Determination

Given the extremely low probability of these events, a base multiplier is chosen for the rarest and most desirable combinations to create excitement and attract players.

Base Multiplier for Top Tier (Tier 1): 1,000,000×1,000,000×1,000,000×

### 2. Factors Influencing Multiplier Assignments

a. Player Perception and Psychological Impact

### Higher Card Ranks Perceived as More Valuable:

Players often associate higher-ranking cards (like Aces and face cards) with greater significance or excitement.

Assigning higher multipliers to these cards enhances their perceived value.

b. Marketing Considerations

### Attractiveness of Top Prizes:

Large multipliers for high-ranking cards serve as a strong marketing tool to draw players. Illustrating a potential 1,000,000×1,000,000×1,000,000× win is highly appealing.

c. Game Balance and Profitability

### Ensuring Sustainable Payouts:

Multipliers are adjusted to maintain the house edge and ensure long-term profitability.

d. Creating a Tiered Reward Structure
Variety in Payouts: Differentiating multipliers across tiers adds diversity to potential outcomes, encouraging player engagement.

### 3. Calculation of Multipliers for Each Tier

a. High-Tier Multipliers (Tiers 1-4):

### Assigned Multipliers Based on Rank Hierarchy:

Tier 1 (Six Red Aces, Same Suit): 1,000,000×1,000,000×1,000,000×
Tier 2 (Six Black Aces, Same Suit): 800,000×800,000×800,000×
Tier 3 (Six Red Kings, Same Suit): 600,000×600,000×600,000×
Tier 4 (Six Black Kings, Same Suit): 500,000×500,000×500,000×

### Rationale:

Aces are considered the highest and most valuable cards. Kings follow in perceived value. Multipliers decrease accordingly to reflect this hierarchy.

b. Mid-Tier Multipliers (Tiers 5-18):
Gradual Decrease in Multipliers with Rank:

As the rank decreases (Queens, Jacks, 10s, etc.), multipliers are reduced.

### Example

Tier 5 (Six Red Queens, Same Suit): 400,000×400,000×400,000×
Tier 17 (Six Red 2s, Same Suit): 100×100×100×
Tier 18 (Six Black 2s, Same Suit): 50×50×50×

### Rationale:

Lower-ranking cards are perceived as less exciting; multipliers are adjusted to reflect player interest and maintain game balance.

c. Low-Tier Multipliers (Tiers 19-36, Mixed Suits):

### Further Reduction in Multipliers:

Mixed suit combinations are more probable than same suit combinations (though still extremely rare). Multipliers are lower to reflect the increased probability and lesser excitement.

### Examples

Tier 19 (Six Red Aces, Mixed Suits): 25×25×25×
Tier 36 (Six Black 2s, Mixed Suits): 1.01×1.01×1.01×

### Explanation of How Multipliers Are Calculated

### 1. Establishing the Multiplier Scale

Starting Point: Assign the highest multiplier to the most desirable combination (Tier 1).

$$Base Multiplier = 1 , 000 , 000 x$$

### 2. Adjusting Multipliers According to Card Rank

### Multiplier Adjustment Factor:

$$Adjustment Factor = \frac{P e rceived Vaule of Rank}{Maximum Perceived Value}$$

### Assigning Multipliers:

For tiers with equal probabilities, assign different multipliers based on the rank's perceived value.

### Example for Tier 2 (Six Black Aces, Same Suit):

$${Multiplier}_{Tier 2} = Base Multiplier \times Adjustment Factor$$

If the adjustment factor is 0.80.80.8:

$${Multiplier}_{Tier 2} = 1 , 000 , 000 x \times 0.8 = 800 , 000 x$$

### 3. Factors Influencing the Perceived Value

### Card Rank Hierarchy:

$$Aces > Kings > Queens > Jacks > 10 s > … > 2 s .$$

### Assigning Multipliers for Lower Ranks:

### Example for Tier 17 (Six Red 2s, Same Suit):

$${Multiplier}_{Tier 17} = 1 , 000 , 000 x \times ( \frac{P e rceived Value of 2 s}{Perceived Value of Aces} )$$

If the perceived value ratio is 0.00010.00010.0001:

$${Multiplier}_{Tier 17} = 1 , 000 , 000 x \times 0.0001 = 100 x$$

### 4. Adjustments for Game Balance

### Expected Payout Calculation:

$$Expected Payout = P \times Multiplier \times Average Bet Size$$

### Ensuring Total Expected Payouts are Manageable:

Adjust multipliers so that the sum of expected payouts across all tiers does not exceed acceptable limits. Why Multipliers Differ for Equal Probabilities

### 1. Enhancing Game Appeal

Creating Excitement: Higher multipliers for high-ranking cards increase excitement.
Player Motivation: Players are more motivated to play when they perceive the potential for significant rewards.

### 2. Marketing Strategies

Differentiation: Differentiating multipliers helps in marketing the game with varied prize levels.
Attracting Different Player Segments: High rollers may be attracted by the possibility of massive payouts.

### 3. Psychological Factors

Perceived Value of High Cards: Players often assign greater importance to high-ranking cards.
Emotional Impact: Winning with high-ranking cards feels more rewarding, justifying higher multipliers.

### 4. Balancing Payouts and House Edge

Ensuring Profitability: While probabilities are the same, adjusting multipliers allows the casino to manage payout ratios effectively.
Strategic Payout Distribution: By offering larger payouts for certain combinations, the game may distribute payouts in a way that maintains profitability.

Considering both the equal probabilities of the combinations and factors such as player perception, marketing strategies, and game balance, one example of a Proposed Multiplier Structure (Table 1) for each tier (1-36) is illustrated in Table 1. The multipliers have been adjusted to reflect both the equal rarity of the combinations and the perceived value of higher-ranking cards.

### Example Multiplier Structure

TABLE 1

| Tier | Combination | Multiplier |
|---|---|---|
| 1 | Six Red Aces (same suit) | 1,000,000x |
| 2 | Six Black Aces (same suit) | 1,000,000x |
| 3 | Six Red Kings (same suit) | 1,000,000x |
| 4 | Six Black Kings (same suit) | 1,000,000x |
| 5 | Six Red Queens (same suit) | 1,000,000x |
| 6 | Six Black Queens (same suit) | 1,000,000x |
| 7 | Six Red Jacks (same suit) | 1,000,000x |
| 8 | Six Black Jacks (same suit) | 1,000,000x |
| 9 | Six Red 10s (same suit) | 1,000,000x |
| 10 | Six Black 10s (same suit) | 1,000,000x |
| 11 | Six Red 7s (same suit) | 1,000,000x |
| 12 | Six Black 7s (same suit) | 1,000,000x |
| 13 | Six Red 6s (same suit) | 1,000,000x |
| 14 | Six Black 6s (same suit) | 1,000,000x |
| 15 | Six Red 5s (same suit) | 1,000,000x |
| 16 | Six Black 5s (same suit) | 1,000,000x |
| 17 | Six Red 2s (same suit) | 1,000,000x |
| 18 | Six Black 2s (same suit) | 1,000,000x |
| 19 | Six Red Aces (mixed suits) | 10,000x |
| 20 | Six Black Aces (mixed suits) | 10,000x |
| 21 | Six Red Kings (mixed suits) | 10,000x |
| 22 | Six Black Kings (mixed suits) | 10,000x |
| 23 | Six Red Queens (mixed suits) | 10,000x |
| 24 | Six Black Queens (mixed suits) | 10,000x |
| 25 | Six Red Jacks (mixed suits) | 10,000x |
| 26 | Six Black Jacks (mixed suits) | 10,000x |
| 27 | Six Red 10s (mixed suits) | 10,000x |
| 28 | Six Black 10s (mixed suits) | 10,000x |
| 29 | Six Red 7s (mixed suits) | 10,000x |
| 30 | Six Black 7s (mixed suits) | 10,000x |
| 31 | Six Red 6s (mixed suits) | 10,000x |
| 32 | Six Black 6s (mixed suits) | 10,000x |
| 33 | Six Red 5s (mixed suits) | 10,000x |
| 34 | Six Black 5s (mixed suits) | 10,000x |
| 35 | Six Red 2s (mixed suits) | 10,000x |
| 36 | Six Black 2s (mixed suits) | 10,000x |

Equal Multipliers for Equal Probabilities:
Since the probability of drawing six cards of the same rank and suit is identical across all ranks (Tiers 1-18), all same-suit combinations are assigned the same maximum multiplier of 1,000,000×.
Similarly, all mixed-suit combinations (Tiers 19-36) have equal probabilities and are assigned a multiplier of 10,000×.
Rationale:
Mathematical Fairness: Assigning equal multipliers to combinations with equal probabilities ensures mathematical fairness.
Player Perception: While higher-ranking cards like Aces are perceived as more valuable, the equal rarity justifies equal multipliers.
Marketing Appeal: Offering a top prize of 1,000,000× across all same-suit combinations increases the excitement and attractiveness of the game.
Game Balance:
Sustainable Payouts: The multipliers are set to maintain game profitability while providing substantial rewards.
Simplified Structure: A consistent multiplier structure simplifies understanding for players and aids in marketing.

### Alternative Multiplier Structure (Based Onperceived Value)

If desired, the system may adjust the multipliers to reflect perceived card value while keeping the probabilities in mind, as illustrated in Table 2:

TABLE 2

| Tier | Combination | Multiplier |
|---|---|---|
| 1 | Six Red Aces (same suit) | 1,000,000x |
| 2 | Six Black Aces (same suit) | 1,000,000x |
| 3 | Six Red Kings (same suit) | 800,000x |
| 4 | Six Black Kings (same suit) | 800,000x |
| 5 | Six Red Queens (same suit) | 600,000x |
| 6 | Six Black Queens (same suit) | 600,000x |
| 7 | Six Red Jacks (same suit) | 400,000x |
| 8 | Six Black Jacks (same suit) | 400,000x |
| 9 | Six Red 10s (same suit) | 200,000x |
| 10 | Six Black 10s (same suit) | 200,000x |
| 11 | Six Red 7s (same suit) | 100,000x |
| 12 | Six Black 7s (same suit) | 100,000x |
| 13 | Six Red 6s (same suit) | 50,000x |
| 14 | Six Black 6s (same suit) | 50,000x |
| 15 | Six Red 5s (same suit) | 25,000x |
| 16 | Six Black 5s (same suit) | 25,000x |
| 17 | Six Red 2s (same suit) | 10,000x |
| 18 | Six Black 2s (same suit) | 10,000x |
| 19 | Six Red Aces (mixed suits) | 5,000x |
| 20 | Six Black Aces (mixed suits) | 5,000x |
| 21 | Six Red Kings (mixed suits) | 4,000x |
| 22 | Six Black Kings (mixed suits) | 4,000x |
| 23 | Six Red Queens (mixed suits) | 3,000x |
| 24 | Six Black Queens (mixed suits) | 3,000x |
| 25 | Six Red Jacks (mixed suits) | 2,000x |
| 26 | Six Black Jacks (mixed suits) | 2,000x |
| 27 | Six Red 10s (mixed suits) | 1,000x |
| 28 | Six Black 10s (mixed suits) | 1,000x |
| 29 | Six Red 7s (mixed suits) | 500x |
| 30 | Six Black 7s (mixed suits) | 500x |
| 31 | Six Red 6s (mixed suits) | 250x |
| 32 | Six Black 6s (mixed suits) | 250x |
| 33 | Six Red 5s (mixed suits) | 100x |
| 34 | Six Black 5s (mixed suits) | 100x |
| 35 | Six Red 2s (mixed suits) | 50x |
| 36 | Six Black 2s (mixed suits) | 50x |

Perceived Value Adjustments:
   Higher-ranking cards receive higher multipliers due to perceived value, even though the probabilities are the same.
   Multipliers decrease progressively from Aces to 2s to reflect the traditional card hierarchy.
Balancing Fairness and Appeal:
   While probabilities are equal, this structure balances mathematical fairness with player perception.
   It offers substantial rewards for all same-suit combinations but emphasizes higher-ranking cards.
Marketing Strategy:
   This tiered approach allows for targeted marketing, highlighting the top prizes associated with high-ranking cards.

### Final Considerations

Choice of Structure:
   The selection between the uniform multiplier structure and the tiered one depends on the system's configuration:
      Uniform Structure: Emphasizes mathematical fairness and simplicity.
      Tiered Structure: Emphasizes player perception and marketing appeal.
Game Balance:
   Ensure that the total expected payouts remain within acceptable limits for game profitability.
   Adjust multipliers as necessary based on simulations and financial projections.

### Grand Paradise Jackpot™ Calculation and Distribution Technique #1B (Alternate Embodiment)-Multi-Tiered Six-Card Jackpot Structure for Live Dealer Baccarat

This technique introduces a multi-tiered jackpot structure for live dealer baccarat games, based on specific six-card combinations of the same rank and color. The jackpot is triggered when the first six cards dealt in abaccarat game (three to the Player hand and three to the Banker hand) form certain predefined combinations. The structure includes multiple tiers, with increasingly rare combinations corresponding to larger jackpot amounts. For example, six cards of the same rank and color (e.g. six red Kings) may trigger the top-tier jackpot, while six cards of the same rank but mixed colors may trigger a lower tier. This technique may be implemented in both physical live dealer tables and electronic table game systems, adding an exciting jackpot element to traditional baccarat gameplay without altering the specific game rules.

Sequence Diagram Components: The notable components involved in this technique include:
1. Electronic Table Game Terminals (ETGTs): Individual player stations where bets are placed and game information is displayed.
2. Live Dealer Station: The physical table where cards are dealt, equipped with card readers and cameras.
3. Game Management System (GMS): Central software controlling game logic, jackpot calculations, and communications.
4. Player A, Player B, etc.: Individual players at the ETGTs.
5. Dealer: The live dealer managing the physical cards and game flow.
6. Jackpot Display System: Large screens visible to all players showing current jackpot amounts.
7. Card Recognition System: Technology for reading and transmitting card values in real-time.
8. Casino Management System (CMS): Backend system for player tracking, accounting, and jackpot fund management.
9. Random Number Generator (RNG): For verifying the integrity of physical card deals.

Implementation Details: To implement this jackpot technique, each ETGT is equipped with a dedicated jackpot betting area on its touch screen interface. Players may opt into the jackpot by placing an additional bet in this area before each round. The live dealer station incorporates advanced card recognition technology that instantly reads and transmits card values to the GMS as they are dealt. The GMS continuously monitors the cards dealt and compares them against the predefined jackpot combinations.

The jackpot tiers are structured as follows:
Tier 1 (Highest): Six cards of the same rank and color (e.g., six red Kings)
Tier 2: Six cards of the same rank, mixed colors
Tier 3: Six cards of the same color, mixed ranks
Tier 4: Six cards of the same suit

Each tier corresponds to a different percentage of the total jackpot pool. The GMS calculates and updates jackpot amounts in real-time, factoring in new bets and any wins. This implementation allows for seamless integration with existing baccarat games, as it doesn't affect the base game rules or outcomes. The system also supports progressive jackpots, where a portion of each jackpot bet contributes to growing the jackpot pool over time.

Example Walk-Through Scenario: Let's walk through a typical round featuring this jackpot technique:
1. Players at multiple ETGTs opt into the jackpot by placing bets on their screens.
2. The dealer begins the baccarat round, dealing cards as usual.
3. As each card is dealt, the card recognition system instantly reads and transmits its value to the GMS.
4. The GMS compares the dealt cards against the jackpot combinations in real-time.
5. After the first six cards are dealt (three to Player, three to Banker), the GMS determines if a jackpot is triggered.
6. Suppose the six cards are: King of Hearts, King of Diamonds, King of Hearts, King of Diamonds, King of Hearts, King of Diamonds.
7. The GMS identifies this as a Tier 2 jackpot combination (six cards of the same rank, mixed colors).
8. The jackpot win is immediately announced on all ETGTs and the main jackpot display.
9. The GMS calculates the win amount based on the Tier 2 percentage of the current jackpot pool.
10. Winning players are notified on their ETGTs, with celebratory animations and sounds.
11. The CMS processes the payout, updating player balances and jackpot accounting.
12. The base baccarat game continues and concludes as normal.
13. The jackpot pool is reset or adjusted according to predefined rules, and the next round begins.

This scenario demonstrates how the jackpot system operates alongside the standard baccarat game, adding excitement without disrupting the specific gameplay.

Player Interaction: Players interact with this jackpot system primarily through their ETGTs. Before each round, players have the option to place a jackpot bet using the touch screen interface. This bet is separate from their main baccarat wagers. The ETGT displays current jackpot amounts for each tier, updating in real-time. During the game, players may watch both the physical dealer actions and their ETGT screens, which show digital representations of the dealt cards and any potential jackpot progress.

If a jackpot is won, all participating players receive instant notifications on their screens, with winners seeing congratulatory messages and payout amounts. The system also supports partial payouts for lower tiers, potentially rewarding multiple players in a single round. This constant engagement and the potential for large wins on any given hand significantly enhance the player experience compared to traditional baccarat games.

Distinguishing Grand Paradise Jackpot™ Calculation And Distribution Techniques: This technique introduces several Innovative Elements that distinguish it from conventional jackpot systems:
1. Six-Card Combination Focus: Unlike most baccarat jackpots that rely on specific pairs or three-card combinations, this system uniquely uses all six initially dealt cards, creating more complex and exciting win conditions.
2. Multi-Tiered Structure: The tiered approach with varying combination difficulties allows for more frequent smaller wins while still offering the allure of a massive top-tier jackpot.
3. Color-Based Combinations: Incorporating card color into the win conditions (not just rank and suit) adds a new dimension to baccarat jackpots, increasing the number of possible combinations.
4. Real-Time Calculation and Display: The system's ability to instantly read, process, and display potential jackpot combinations as cards are dealt creates a dynamic, suspenseful experience not found in traditional systems.
5. Integration with Live Dealer Play: This technique seamlessly blends electronic jackpot tracking with the authenticity of live dealer baccarat, bridging the gap between traditional table games and modem gaming technology.
6. Scalability Across Multiple Tables: The system may link jackpots across numerous live baccarat tables in a casino or even between properties, creating larger pools and more excitement than isolated table jackpots.

These distinguishing features make this jackpot system particularly well-suited for the modem casino environment, especially in markets like Macau where baccarat is extremely popular and players are always seeking new, exciting ways to play.

### Noteworthy Procedural Steps:

1. Dynamic Jackpot Probability Adjustment: The system continuously recalculates the probability of hitting each jackpot tier based on the cards already dealt in previous rounds. This ensures that the jackpot odds remain fair and exciting throughout long gaming sessions, even as certain cards become more or less to appear.
2. Personalized Jackpot Tracking: Each ETGT maintains a history of near-misses for individual players, using this data to provide personalized statistics and encourage continued play. For example, a player who has come close to the top-tier jackpot multiple times may receive a special bonus or increased payout on lower tiers.
3. Adaptive Jackpot Contribution Rates: The system analyzes player betting patterns and jackpot win frequencies to dynamically adjust the percentage of each bet that contributes to the jackpot pool. This helps maintain an optimal balance between jackpot growth rate and win frequency, maximizing player engagement.

These steps are unique to this system and go beyond conventional jackpot implementations. They leverage the capabilities of electronic table games to create a more engaging, personalized, and mathematically balanced jackpot experience that is not possible with traditional mechanical systems or simpler electronic implementations.

35 USC 101 Considerations: This Grand Paradise Jackpot™ Calculation And Distribution Technique represents patentable subject matter under 35 USC 101 for several compelling reasons:
(a) The technique goes beyond a mere abstract idea by implementing a specific, novel approach to jackpot calculation and distribution in live dealer baccarat games. It combines physical card dealing with real-time electronic monitoring and complex combination analysis, resulting in a tangible improvement to the gaming experience.
(b) The technique is directed to an improvement in computer functionality within the context of casino gaming systems. It solves the problem of integrating engaging jackpot mechanics into traditional baccarat games without disrupting the specific gameplay. This is achieved through a sophisticated interplay of hardware (card readers, ETGTs) and software (real-time analysis, multi-tiered jackpot calculations), representing a clear technological advancement.
(c) The technique integrates its improvements into a practical application that enables a discernible advancement in computer-assisted gaming functionality. By implementing dynamic probability adjustments, personalized tracking, and adaptive contribution rates, the system demonstrates a level of complexity and responsiveness that goes well beyond basic computer implementation of jackpot rules. These features create a more engaging player experience and a more efficiently managed jackpot system, directly translating technological advancements into practical benefits for both players and casino operators.

Furthermore, the technique's ability to seamlessly blend electronic systems with live dealer play addresses the unique challenges of modernizing traditional table games, a specific technological problem in the gaming industry. The solution provided is not merely a generic application of computers to gambling, but a carefully crafted system that enhances the game in ways that would be impossible without this specific technological implementation.

Data Input: This system may require several types of data inputs to function effectively:
1. Player Jackpot Bets: Each ETGT must transmit the amount and timing of jackpot bets to the GMS.
2. Card Values: The card recognition system at the live dealer station must accurately read and transmit the rank, suit, and color of each dealt card in real-time.
3. Game State Information: The GMS needs to track the current state of each baccarat game, including which cards have been dealt to which hand.
4. Player Identification: For personalized features, the system may require player tracking data, usually via casino loyalty cards or ETGT login information.
5. Jackpot Pool Status: Continuous updates on the current jackpot amounts for each tier, including contributions from linked tables or properties.
6. Dealer Input: In some cases, the dealer may need to confirm or input data, such as verifying a jackpot win or inputting cards manually if the automatic system fails.

These inputs are uniquely tailored to support the multi-tiered, six-card jackpot structure, requiring more detailed and frequent data transmission than conventional baccarat or simpler jackpot systems.

### Component Interactions and Procedural Steps:

1. Bet Placement: ETGTs transmit jackpot bet data to the GMS, which updates the jackpot pool.
2. Game Initiation: The dealer begins the baccarat round, triggering the GMS to prepare for card input.
3. Card Dealing and Recognition: As each card is dealt, the card recognition system reads its value and transmits it to the GMS.
4. Real-time Analysis: For each card, the GMS: a. Updates the game state b. Compares the current card combination against jackpot tiers c. Calculates the probability of hitting each jackpot tier d. Updates ETGTs and the jackpot display with current status
5. Jackpot Determination: After six cards, the GMS determines if a jackpot is won.
6. Win Processing: If a jackpot is hit, the GMS: a. Calculates the win amount b. Notifies all ETGTs and the jackpot display c. Instructs the CMS to process payouts d. Resets or adjusts the jackpot pool
7. Player History Update: The GMS updates individual player statistics on near-misses and jackpot participation.
8. Adaptive Adjustments: Periodically, the system analyzes betting patterns and win frequencies to adjust contribution rates and probabilities.

These steps highlight the complex interactions between physical and electronic components, as well as the continuous calculations and updates that set this system apart from conventional jackpots.

Data Processing: The GMS performs several notable processing steps:
1. Jackpot Tier Checking: For each new card, the system must efficiently compare the current six-card combination against all predefined jackpot tiers.
2. Probability Calculations: The system continuously recalculates the odds of hitting each jackpot tier based on the cards already dealt, requiring complex statistical computations.
3. Payout Calculations: When a jackpot is hit, the system must quickly determine the correct payout amount based on the tier hit, current jackpot pool, and number of qualifying players.
4. Personalization Algorithms: The system processes individual player data to generate personalized statistics and potentially adjust payouts or bonuses.
5. Contribution Rate Optimization: Regular analysis of betting patterns and win frequencies to dynamically adjust jackpot contribution rates for optimal engagement.

These processing steps go beyond simple win/lose determinations, incorporating advanced statistical analysis and personalization features unique to this system.

Outputs and Responses: The system provides various outputs to players and other components:
1. Real-time Jackpot Updates: All ETGTs and the main jackpot display show continuously updated jackpot amounts for each tier.
2. Jackpot Progress Indicators: As cards are dealt, ETGTs display visual indicators of progress towards various jackpot tiers.
3. Win Notifications: Immediate, eye-catching notifications on all screens when a jackpot is hit, with specific congratulatory messages for winners.
4. Personalized Statistics: Individual ETGTs display player-specific data on jackpot participation, near-misses, and potential personalized bonuses.
5. Dealer Notifications: The dealer station receives alerts about jackpot wins, prompting appropriate actions or announcements.
6. Management Reports: The CMS generates detailed reports on jackpot performance, player engagement, and financial data for casino management.

These outputs are designed to maximize engagement and excitement, leveraging the electronic nature of the system to provide more dynamic and personalized information than traditional jackpot systems.

Data Storage and Reporting: The system stores various types of data:
1. Jackpot History: Records of all jackpot wins, including time, amount, winning combination, and winner details.
2. Player Jackpot Statistics: Individual histories of jackpot participation, near-misses, and wins.
3. Contribution Data: Detailed logs of all jackpot contributions, used for auditing and optimization.
4. Card Frequency Data: Statistics on card appearances to verify fairness and inform probability calculations.

This data is securely stored in the CMS and used to generate comprehensive reports for regulatory compliance, game performance analysis, and player behavior insights.

Error Handling and Security Measures: The system incorporates several safeguards:
1. Redundant Card Reading: Multiple cameras or sensors to ensure accurate card recognition.
2. Manual Override: Dealer ability to correct misread cards or confirm jackpot wins.
3. Encryption: All data transmissions are encrypted to prevent tampering.
4. Audit Trails: Comprehensive logging of all system actions for security and dispute resolution.
5. Automated Alerts: The system flags unusual patterns that may indicate technical issues or attempted fraud.

These measures ensure the integrity of the jackpot system while maintaining smooth gameplay.

End of Interaction: At the end of each baccarat round:
1. The GMS finalizes all jackpot calculations and updates player statistics.
2. ETGTs reset for the next round, clearing previous bets but retaining player history.
3. The jackpot display updates to show new amounts, potentially with animations to build excitement.
4. The system performs quick diagnostic checks to ensure all components are ready for the next round.

This reset process is designed to be quick and seamless, maintaining the pace of play while setting the stage for continued jackpot excitement.

### Grand Paradise Jackpot™ Calculation and Distribution Technique #1C (Alternate Embodiment)—Multi-Tiered Jackpot Structure for Live Dealer Baccarat Based on Specific Six-Card Combinations of the Same Rank and Color

Description and Implementation: The Grand Paradise Jackpot™ introduces a sophisticated multi-tiered jackpot structure specifically designed for live dealer baccarat games implemented on Live Dealer Gaming Tables (LDGTs) and Electronic Table Game Terminals (ETGTs). This innovative system evaluates six consecutive cards dealt during the course of baccarat gameplay, searching for specific combinations where all six cards match in both rank and color.

The jackpot is structured into 18 distinct tiers, each corresponding to a unique six-card combination:
1. Six Red Aces
2. Six Black Aces
3. Six Red Kings
4. Six Black Kings
5. Six Red Queens
6. Six Black Queens
7. Six Red Jacks
8. Six Black Jacks
9. Six Red 10s
10. Six Black 10s
11. Six Red 7s
12. Six Black 7s
13. Six Red 6s
14. Six Black 6s
15. Six Red 5s
16. Six Black 5s
17. Six Red 2s
18. Six Black 2s

Each tier is assigned a different prize value, with Six Red Aces offering the relatively largest jackpot amount. The system continuously monitors the cards dealt from the shoe, maintaining a rolling window of the last six cards in play. When a qualifying combination is detected, the corresponding jackpot tier is triggered.

Implementation on LDGTs involves integrating high-resolution cameras and computer vision software to accurately read and record each card as it's dealt. For ETGTs, the system directly interfaces with the electronic card shoe to track card information. A central jackpot server maintains real-time jackpot amounts, processes win events, and coordinates displays across all connected terminals.

Players may opt into the jackpot by placing a separate side bet at the beginning of each shoe. This bet remains active for all hands played until the shoe is exhausted, allowing players to potentially win on any qualifying combination that occurs during that period.

Benefits to Players: The Grand Paradise Jackpot™ offers players an exciting new dimension to traditional baccarat gameplay. By introducing the possibility of massive jackpot wins based on card combinations that span multiple hands, it creates sustained excitement throughout an entire shoe. Players benefit from:
1. Increased engagement and anticipation as every card dealt may contribute to a jackpot-winning combination.
2. Multiple winning opportunities with 22 different jackpot tiers, providing a range of potential payouts.
3. Extended gameplay value, as a single jackpot side bet remains active for numerous hands.
4. A sense of community, as all players betting on the jackpot share in the excitement of potential wins.
5. Transparent odds and clear winning conditions, allowing players to easily understand their chances of winning.

Benefits to Casinos: For casinos, the Grand Paradise Jackpot™ provides numerous advantages:
1. Increased revenue through additional side bets, attracting both regular baccarat players and jackpot enthusiasts.
2. Enhanced player retention, as the rolling six-card evaluation encourages players to stay at tables longer.
3. Differentiation in a competitive market, offering a unique jackpot experience specific to baccarat.
4. Flexible implementation across both LDGTs and ETGTs, allowing for widespread adoption.
5. Scalable jackpot pools that may be linked across multiple tables or even properties, creating headline-grabbing top prizes.
6. Increased foot traffic and table utilization, as players are drawn to tables with active jackpots.
7. Additional marketing opportunities, leveraging large jackpot amounts to attract new players.
   Example Walk-Through Scenario: John, an experienced baccarat player, approaches a Grand Paradise Jackpot™-enabled ETGT. He inserts his player card and buys in for $1000. The display shows the current jackpot tiers, with Six Red Aces at $1,000,000 and lower tiers scaled accordingly.

John places a $100 main bet on the Player hand and adds a $10 jackpot side bet. The dealer begins a new shoe, and John's jackpot bet will remain active until the shoe is completed. The first hand is dealt: Player receives 8♥, 3♥, and Banker gets K [symbol] , 5♦. No jackpot combination is formed, but the system logs these cards.

Several hands later, the cumulative cards dealt include A♥, A♦, A♥, A♥, K [symbol] , Q [symbol] John notices this on the jackpot tracking display and feels excited as only one more red Ace is needed for a major jackpot. Two more uneventful hands pass.

Suddenly, on the next hand, the Player is dealt A♦. The table erupts in excitement as this completes the Six Red Aces combination! The jackpot alarm sounds, and the dealer confirms the win. Even though this hand's result is a Banker win, John and all other players with active jackpot bets share in the $1,000,000 prize, proportional to their bet amounts.

John's $10 bet represents 2% of the total jackpot bets placed on this shoe. He wins $20,000 from the jackpot, in addition to his regular baccarat gameplay. The jackpot resets to its seed amount, and a new shoe begins with fresh excitement.

### Example System Procedural Flow:

1. Player Authentication:
   ETGT reads player card or accepts guest login
   Player data is retrieved from casino management system
   ETGT displays personalized welcome and account balance
2. Jackpot Opt-In:
   Player selects jackpot participation and bet amount
   ETGT sends bet information to central jackpot server
   Server confirms bet placement and updates global jackpot pool
3. Shoe Initialization:
   Dealer initiates new shoe on LDGT
   Card shoe sends encrypted “new shoe” signal to jackpot server
   Server resets six-card tracking window for connected ETGTs
4. Card Dealing and Tracking:
   Each card is dealt and scanned by LDGT camera or read by electronic shoe
   Card data is encrypted and sent to jackpot server
   Server updates six-card window and checks for winning combinations
   ETGTs receive real-time updates of tracked cards and display to players
5. Jackpot Evaluation:
   After each card, server compares current six-card window to winning combinations
   If match found, server initiates win verification protocol
6. Win Verification:
   Server signals LDGT to pause game
   Dealer confirms six-card combination visually
   LDGT sends confirmation to server
7. Payout Calculation:
   Server calculates individual payouts based on active jackpot bets
   Payout data is sent to casino management system and ETGTs
8. Win Announcement and Distribution:
   ETGTs display win animations and individual payout amounts
   Casino management system processes payments to player accounts
   Jackpot amount is reset on server and updated on all displays
9. Game Continuation:
   LDGT signals ready to resume play
   ETGTs return to normal gameplay interface
   Process repeats from step 4 for subsequent hands

Noteworthy Aspects and Features: The Grand Paradise Jackpot™ system introduces several innovative features that set it apart from traditional casino jackpots:
1. Six-card evaluation window that spans multiple baccarat hands, creating a unique longitudinal jackpot mechanic.
2. Integration of color in addition to card rank, doubling the number of potential jackpot combinations.
3. Tiered structure that provides frequent lower-level wins while maintaining the allure of a massive top prize.
4. Seamless integration with both LDGTs and ETGTs, allowing for consistent implementation across various table types.
5. Real-time tracking and display of potential jackpot combinations, heightening player engagement.
6. Shoe-length jackpot eligibility, encouraging extended play sessions.
7. Scalable architecture that allows for property-wide or even multi-casino linked jackpots.
8. Transparent odds and combination tracking, promoting trust and excitement among players.

These features combine to create a jackpot system uniquely tailored to the pace and structure of baccarat, offering an unparalleled gaming experience that may significantly boost casino revenues and player satisfaction.

### Grand Paradise Jackpot™ Calculationand Distribution Technique #2A—Dynamic Jackpot Multipliers Based on Six-Card Combination Rarity

This technique introduces a dynamic jackpot multiplier system for live dealer baccarat games, where the multiplier increases based on the rarity of the six-card combination dealt. The rarest combination—Six Red Aces—triggers the highest multiplier. This approach adds an extra layer of excitement to the game by offering potentially massive payouts for extremely rare card combinations. The system continuously calculates the probability of each combination occurring and adjusts the multipliers accordingly, ensuring that payouts remain proportional to the combination's rarity. This technique may be implemented in both physical live dealer tables and electronic table game systems, enhancing the thrill of baccarat without altering its fundamental rules.

Sequence Diagram Components: The notable components involved in this technique include:
1. Electronic Table Game Terminals (ETGTs): Player interfaces for placing bets and viewing game information.
2. Live Dealer Station: Physical table with card readers and cameras for dealing cards.
3. Game Management System (GMS): Central software controlling game logic, multiplier calculations, and communications.
4. Player A, Player B, etc.: Individual players at the ETGTs.
5. Dealer: Live dealer managing physical cards and game flow.
6. Multiplier Display System: Large screens showing current multiplier values for different combinations.
7. Card Recognition System: Technology for real-time card value reading and transmission.
8. Casino Management System (CMS): Backend system for player tracking, accounting, and jackpot fund management.
9. Probability Calculation Engine: Specialized software component for real-time odds calculations.
10. Random Number Generator (RNG): For verifying the integrity of physical card deals.
11. Multiplier Adjustment Algorithm: Software component that dynamically updates multiplier values based on current probabilities and jackpot pool size.

Implementation Details: To implement this dynamic multiplier technique, each ETGT is equipped with a dedicated jackpot betting area and a display showing current multiplier values for various card combinations. The live dealer station incorporates advanced card recognition technology that instantly reads and transmits card values to the GMS as they are dealt. The GMS, in conjunction with the Probability Calculation Engine, continuously monitors the cards dealt and updates the probabilities and corresponding multipliers for each possible combination.

The multiplier system is structured as follows:
Highest Multiplier: Six Red Aces (rarest combination);
High Multipliers: Other six-of-a-kind combinations (e.g., Six Kings, Six Queens)
Medium Multipliers: Mixed six-of-a-kind (e.g., Six Aces of mixed colors)
Lower Multipliers: Other rare combinations (e.g., Six cards of the same suit)

The Multiplier Adjustment Algorithm dynamically updates these multipliers based on:
1. Current probability of each combination occurring
2. Size of the jackpot pool
3. Recent betting patterns and jackpot win history

This implementation allows for a constantly evolving jackpot experience, where players may see multipliers changing in real-time as cards are dealt and removed from play. The system also supports a base jackpot amount that is then multiplied by the relevant multiplier when a winning combination occurs.

Example Walk-Through Scenario: Let's walk through a typical round featuring this dynamic multiplier jackpot technique:
1. Players at multiple ETGTs opt into the jackpot by placing bets on their screens.
2. Before the deal, current multipliers for various combinations are displayed on all ETGTs and the main multiplier display.
3. The dealer begins the baccarat round, dealing cards as usual.
4. As each card is dealt, the card recognition system instantly reads and transmits its value to the GMS.
5. The Probability Calculation Engine updates the odds of each combination occurring.
6. The Multiplier Adjustment Algorithm recalculates and updates all multiplier values, which are immediately reflected on all displays.
7. After the first six cards are dealt (three to Player, three to Banker), the GMS determines if a jackpot-winning combination has occurred.
8. Suppose the six cards are: Ace of Hearts, Ace of Hearts, Ace of Hearts, Ace of Diamonds, Ace of Hearts, Ace of Hearts.
9. The GMS identifies this as a “Six Aces, Five Red” combination.
10. The current multiplier for this combination (let's say 5000×) is applied to the base jackpot amount.
11. The jackpot win is immediately announced on all ETGTs and the main multiplier display.
12. The GMS calculates the win amount based on the current base jackpot and the 5000× multiplier.
13. Winning players are notified on their ETGTs, with celebratory animations and sounds.
14. The CMS processes the payout, updating player balances and jackpot accounting.
15. The base baccarat game continues and concludes as normal.
16. The jackpot pool and multipliers are reset or adjusted according to predefined rules, and the next round begins.

This scenario demonstrates how the dynamic multiplier system creates a constantly evolving and exciting jackpot experience alongside the standard baccarat game.

Player Interaction: Players engage with this dynamic multiplier jackpot system primarily through their ETGTs. Before each round, players may place a jackpot bet using the touch screen interface. The ETGT displays current multiplier values for various combinations, updating in real-time. This creates a unique experience where players may see the potential payouts changing as cards are dealt, adding an extra layer of anticipation to each hand.

During the game, players watch both the physical dealer actions and their ETGT screens, which show digital representations of the dealt cards, current multiplier values, and any potential jackpot progress. The constantly changing multipliers encourage players to participate in every round, as the potential payout for any given combination may be at its peak at any time.

If a jackpot is won, all participating players receive instant notifications on their screens, with winners seeing congratulatory messages and payout amounts calculated based on the final multiplier value. The system also supports partial payouts for near-miss combinations, potentially rewarding multiple players in a single round. This dynamic and interactive approach significantly enhances player engagement compared to static jackpot systems in traditional baccarat games.

Distinguishing Grand Paradise Jackpot™ Calculation And Distribution Techniques: This technique introduces several Innovative Elements that distinguish it from conventional jackpot systems:
1. Dynamic Multiplier System: Unlike static jackpot systems, this technique employs a constantly evolving multiplier system that adjusts in real-time based on game conditions.
2. Six-Card Combination Focus: The use of all six initially dealt cards creates more complex and exciting win conditions than typical three-card or pair-based jackpot systems.
3. Probability-Based Adjustments: The system's ability to recalculate probabilities and adjust multipliers on-the-fly is a significant advancement over fixed-odds jackpot systems.
4. Integration of Rarity and Pool Size: The Multiplier Adjustment Algorithm uniquely combines the rarity of card combinations with the current jackpot pool size to determine multipliers, ensuring balanced and exciting payouts.
5. Real-Time Display Updates: The instant reflection of changing multipliers across all ETGTs and displays creates a dynamic, suspenseful experience not found in traditional systems.
6. Near-Miss Rewards: The ability to offer scaled payouts for near-miss combinations keeps more players engaged and rewarded.

These distinguishing features create a jackpot system that is particularly well-suited for the modem casino environment, especially in markets like Macau where baccarat is extremely popular and players seek innovative gaming experiences.

### Noteworthy Procedural Steps:

1. Adaptive Probability Recalculation: The system continuously recalculates the probability of each card combination based on the cards already dealt in previous rounds and the current round. This ensures that the multipliers accurately reflect the true odds of each combination occurring at any given moment.
2. Multi-Factor Multiplier Adjustment: The Multiplier Adjustment Algorithm considers not only the current probabilities but also factors such as the jackpot pool size, recent betting patterns, and the frequency of recent jackpot wins. This multi-faceted approach ensures that multipliers remain exciting for players while maintaining the mathematical integrity of the game.
3. Personalized Multiplier Boosts: The system tracks individual player betting patterns and jackpot participation, occasionally offering personalized multiplier boosts for specific combinations. This encourages continued play and adds an element of individual excitement to the communal jackpot experience.

These steps represent a significant advancement over traditional jackpot systems, leveraging real-time data processing and personalization to create a more engaging and mathematically sophisticated jackpot experience.

35 USC 101 Considerations: This Grand Paradise Jackpot™ Calculation And Distribution Technique represents patentable subject matter under 35 USC 101 for several compelling reasons:
(a) The technique goes beyond a mere abstract idea by implementing a specific, novel approach to jackpot calculation in live dealer baccarat games. It combines physical card dealing with real-time electronic monitoring, complex probability calculations, and dynamic multiplier adjustments, resulting in a tangible improvement to the gaming experience that may not be achieved through mental processes alone.
(b) The technique is directed to an improvement in computer functionality within the context of casino gaming systems. It solves the problem of creating engaging, mathematically sound jackpot mechanics that may adapt in real-time to changing game conditions. This is achieved through a sophisticated interplay of hardware (card readers, ETGTs) and software (probability calculations, multiplier adjustments), representing a clear technological advancement in the field of electronic gaming.
(c) The technique integrates its improvements into a practical application that enables a discernible advancement in computer-assisted gaming functionality. By implementing adaptive probability recalculations, multi-factor multiplier adjustments, and personalized multiplier boosts, the system demonstrates a level of complexity and responsiveness that goes well beyond basic computer implementation of jackpot rules. These features create a more engaging player experience and a more efficiently managed jackpot system, directly translating technological advancements into practical benefits for both players and casino operators.

Furthermore, the technique's ability to seamlessly blend complex mathematical operations with live dealer play addresses the unique challenges of modernizing traditional table games, a specific technological problem in the gaming industry. The solution provided is not merely a generic application of computers to gambling, but a carefully crafted system that enhances the game in ways that would be impossible without this specific technological implementation.

Data Input: This dynamic multiplier jackpot system may require several types of data inputs to function effectively:
1. Player Jackpot Bets: Each ETGT must transmit the amount and timing of jackpot bets to the GMS.
2. Card Values: The card recognition system at the live dealer station must accurately read and transmit the rank, suit, and color of each dealt card in real-time.
3. Game State Information: The GMS needs to track the current state of each baccarat game, including which cards have been dealt to which hand and which cards have been played in previous rounds.
4. Player Identification: For personalized features, the system may require player tracking data, usually via casino loyalty cards or ETGT login information.
5. Jackpot Pool Status: Continuous updates on the current jackpot amount and recent win history.
6. Betting Patterns: Aggregate data on player betting behavior across all ETGTs.
7. Dealer Input: In some cases, the dealer may need to confirm or input data, such as verifying a jackpot win or inputting cards manually if the automatic system fails.

These inputs are uniquely tailored to support the dynamic multiplier system, requiring more detailed and frequent data transmission than conventional baccarat or static jackpot systems.

### Component Interactions and Procedural Steps:

1. Bet Placement: ETGTs transmit jackpot bet data to the GMS, which updates the jackpot pool.
2. Pre-Game Multiplier Display: The Multiplier Adjustment Algorithm calculates initial multipliers, which are displayed on all ETGTs and the main display.
3. Game Initiation: The dealer begins the baccarat round, triggering the GMS to prepare for card input.
4. Card Dealing and Recognition: As each card is dealt, the card recognition system reads its value and transmits it to the GMS.
5. Real-time Analysis: For each card, the GMS: a. Updates the game state b. Triggers the Probability Calculation Engine to recalculate odds c. Activates the Multiplier Adjustment Algorithm to update multipliers d. Updates ETGTs and the multiplier display with new values
6. Jackpot Determination: After six cards, the GMS determines if a jackpot-winning combination has occurred.
7. Win Processing: If a jackpot is hit, the GMS: a. Applies the final multiplier to calculate the win amount b. Notifies all ETGTs and the multiplier display c. Instructs the CMS to process payouts d. Resets or adjusts the jackpot pool and multipliers
8. Player History Update: The GMS updates individual player statistics on jackpot participation and near-misses.
9. Adaptive Adjustments: The system continuously analyzes betting patterns and win frequencies to fine-tune multiplier calculations.

These steps highlight the complex, real-time interactions between physical and electronic components, as well as the continuous calculations and updates that set this system apart from conventional jackpots.

Data Processing: The GMS, in conjunction with specialized components, performs several notable processing steps:
1. Probability Calculations: The Probability Calculation Engine continuously recalculates the odds of each jackpot-winning combination occurring based on the cards already dealt and remaining in the shoe.
2. Multiplier Adjustments: The Multiplier Adjustment Algorithm dynamically updates multiplier values based on current probabilities, jackpot pool size, and recent game history.
3. Jackpot Combination Checking: For each new card, the system efficiently compares the current six-card combination against all predefined jackpot-winning combinations.
4. Payout Calculations: When a jackpot is hit, the system must quickly determine the correct payout amount based on the final multiplier and current jackpot pool.
5. Personalization Algorithms: The system processes individual player data to generate personalized multiplier boosts and statistics.
6. Trend Analysis: Regular analysis of betting patterns and win frequencies to optimize multiplier ranges and jackpot contribution rates.

These processing steps involve complex mathematical operations and real-time data analysis, going far beyond the capabilities of traditional jackpot systems.

Outputs and Responses: The system provides various outputs to players and other components:
1. Real-time Multiplier Updates: All ETGTs and the main multiplier display show continuously updated multiplier values for various card combinations.
2. Jackpot Progress Indicators: As cards are dealt, ETGTs display visual indicators of progress towards various jackpot-winning combinations.
3. Win Notifications: Immediate, eye-catching notifications on all screens when a jackpot is hit, with specific congratulatory messages for winners and the final multiplier applied.
4. Personalized Statistics: Individual ETGTs display player-specific data on jackpot participation, near-misses, and potential personalized multiplier boosts.
5. Dealer Notifications: The dealer station receives alerts about jackpot wins and significant multiplier changes, prompting appropriate actions or announcements.
6. Management Reports: The CMS generates detailed reports on jackpot performance, multiplier effectiveness, player engagement, and financial data for casino management.

These outputs are designed to maximize engagement and excitement, leveraging the dynamic nature of the multiplier system to provide a constantly evolving and personalized jackpot experience.

Data Storage and Reporting: The system stores various types of data:
1. Jackpot History: Records of all jackpot wins, including time, amount, winning combination, final multiplier, and winner details.
2. Player Jackpot Statistics: Individual histories of jackpot participation, near-misses, wins, and personalized multiplier boosts.
3. Multiplier Logs: Detailed records of multiplier values and adjustments over time, used for auditing and system optimization.
4. Card Frequency Data: Statistics on card appearances to inform probability calculations and verify game integrity.

This data is securely stored in the CMS and used to generate comprehensive reports for regulatory compliance, game performance analysis, and player behavior insights. The system's ability to track and analyze multiplier effectiveness over time provides valuable data for continual refinement of the jackpot experience.

Error Handling and Security Measures: The system incorporates several safeguards:
1. Redundant Card Reading: Multiple cameras or sensors to ensure accurate card recognition, notable for proper probability and multiplier calculations.
2. Manual Override: Dealer ability to correct misread cards or confirm jackpot wins, ensuring the integrity of the game even in case of technical issues.
3. Encryption: All data transmissions, especially those related to multiplier values and jackpot wins, are encrypted to prevent tampering.
4. Audit Trails: Comprehensive logging of all system actions, including every multiplier adjustment, for security and dispute resolution.
5. Automated Alerts: The system flags unusual patterns in betting or multiplier changes that may indicate technical issues or attempted fraud.

These measures ensure the integrity and fairness of the dynamic multiplier jackpot system while maintaining smooth gameplay.

End of Interaction: At the end of each baccarat round:
1. The GMS finalizes all jackpot calculations and updates player statistics.
2. ETGTs reset for the next round, clearing previous bets but retaining player history and personalized multiplier information.
3. The multiplier display updates to show new base values, potentially with animations to build excitement for the next round.
   Grand Paradise Jackpot™ Calculation and Distribution Technique #2B (Alternate Embodiment)—Dynamic Jackpot Multipliers that Increase Based on the Rarity of the Six-Card Combination, with Six Red Aces as the Highest Multiplier

Description and Implementation: The Grand Paradise Jackpot™ introduces an innovative dynamic multiplier system that adjusts jackpot payouts based on the rarity of specific six-card combinations in live dealer baccarat games.

This system is designed for seamless integration with both Live Dealer Gaming Tables (LDGTs) and Electronic Table Game Terminals (ETGTs), offering an exciting new dimension to traditional baccarat gameplay.

The specific concept revolves around 22 distinct six-card combinations, each consisting of cards of the same rank and color. These combinations are ranked according to their probability of occurrence, with Six Red Aces being the rarest and thus associated with the highest multiplier. The system dynamically calculates and displays multipliers for each combination in real-time, adjusting based on factors such as the number of decks in play, cards already dealt, and current jackpot pool size.

Implementation on LDGTs involves high-resolution cameras and advanced image recognition software to accurately track dealt cards. For ETGTs, the system interfaces directly with the electronic shoe, providing precise card data. A central server continuously updates multipliers and jackpot amounts, broadcasting this information to all connected terminals and displays.

The base jackpot starts at a predetermined amount, for example, $100,000. As cards are dealt, the multipliers for each combination fluctuate. For instance, if several red aces have already appeared in play, the multiplier for Six Red Aces may increase dramatically, reflecting its increased rarity.

Players may opt into the jackpot by placing a side bet at the beginning of each shoe. This bet remains active for all hands until the shoe is exhausted. The jackpot is triggered when six consecutive cards matching one of the 22 combinations are dealt, regardless of whether they appear in player hands, banker hands, or across multiple rounds.

A notable feature of this system is its ability to create moments of heightened excitement. As rarer combinations become possible based on the cards already in play, their associated multipliers increase, potentially leading to massive jackpots. This dynamic adjustment keeps players engaged throughout the entire shoe, as every card dealt may significantly impact potential payouts.

### Benefits to Players:

1. Increased excitement and engagement throughout the entire baccarat shoe.
2. Potential for enormous jackpot wins, especially with rarer combinations.
3. Transparent odds displayed in real-time, allowing players to make informed decisions.
4. Multiple winning possibilities with 22 different combinations.
5. Extended value from a single jackpot bet lasting an entire shoe.
6. A unique gaming experience that combines traditional baccarat with dynamic jackpot mechanics.
7. Opportunity to win large payouts from relatively small side bets.
8. Enhanced social experience as all players may track and anticipate potential jackpot triggers.

### Benefits to Casinos:

1. Increased revenue through attractive jackpot side bets.
2. Higher player retention rates due to extended engagement throughout each shoe.
3. Differentiation in the competitive Macau market with a unique baccarat offering.
4. Flexible implementation across various table types (LDGTs and ETGTs).
5. Potential for marketing promotions centered around large jackpot amounts.
6. Increased table utilization as players are incentivized to stay for entire shoes.
7. Attraction of both traditional baccarat players and jackpot enthusiasts.
8. Scalable system that may be implemented across multiple tables or properties.
   Example Walk-Through Scenario: Lisa, an avid baccarat player, approaches a Grand Paradise Jackpot™-enabled ETGT in a bustling Macau casino. She inserts her player card and buys in for HK$10,000. The vibrant display shows the current jackpot at HK$500,000, with dynamic multipliers for each six-card combination.

Lisa places a HK$1,000 main bet on the Player hand and adds a HK$100 jackpot side bet. As the new shoe begins, she notices the multiplier for Six Red Aces is at 1000×, while Six Black Twos is at 100×, reflecting their relative rarities.

The first few hands play out without triggering the jackpot, but Lisa observes the multipliers shifting after each card is dealt. Halfway through the shoe, she notices that no red kings have appeared yet. The display now shows the Six Red Kings multiplier has increased to 800×, creating a palpable sense of anticipation among the players.

Several hands later, a red king finally appears in the Player's hand. The table buzz intensifies as players realize the potential for a significant jackpot. Two hands later, another red king is dealt to the Banker. The suspense builds with each subsequent deal.

Incredibly, over the next few hands, four more red kings appear in succession. As the sixth red king is revealed, the table erupts in celebration. The jackpot alarm sounds, and the dealer confirms the win. The final multiplier for Six Red Kings had reached 750×, resulting in a jackpot win of HK$37,500,000 (500,000×750).

Lisa's HK$100 jackpot bet represents 2% of the total jackpot side bets placed on this shoe. She wins an astounding HK$750,000 from the jackpot, in addition to her regular baccarat winnings. The jackpot resets to its base amount, and a new shoe begins with fresh excitement and possibilities.

### Example System Procedural Flow:

1. System Initialization:
   Casino management system boots up Grand Paradise Jackpot™ server
   Server initializes connection with all LDGTs and ETGTs
   Base jackpot amount and initial multipliers are set
2. Player Authentication and Buy-in:
   ETGT reads Lisa's player card
   Player data is retrieved from casino management system
   ETGT displays personalized welcome and account balance
   Lisa's buy-in is processed and credited to her account
3. Jackpot Opt-in:
   Lisa selects jackpot participation and bet amount on ETGT
   ETGT sends bet information to central jackpot server
   Server confirms bet placement and updates global jackpot pool
4. Shoe Initialization:
   Dealer initiates new shoe on LDGT
   Card shoe sends encrypted “new shoe” signal to jackpot server
   Server resets card tracking and multiplier calculations for new shoe
5. Real-time Card Tracking and Multiplier Updates:
   Each card is dealt and scanned by LDGT camera or read by electronic shoe
   Card data is encrypted and sent to jackpot server
   Server updates internal card count and recalculates multipliers for all combinations
   Updated multipliers are broadcast to all connected ETGTs and displays
6. Continuous Jackpot Evaluation:
   After each card, server compares last six cards to winning combinations
   If match found, server initiates win verification protocol
7. Win Verification:
   Server signals LDGT to pause game
   Dealer confirms six-card combination visually
   LDGT sends confirmation to server
8. Dynamic Payout Calculation:
   Server retrieves final multiplier for winning combination
   Jackpot amount is multiplied by final multiplier
   Server calculates individual payouts based on proportion of active jackpot bets
9. Win Announcement and Distribution:
   ETGTs display win animations and individual payout amounts
   Casino management system processes payments to player accounts
   Jackpot amount is reset on server and updated on all displays
10. Game Continuation:
   LDGT signals ready to resume play
   ETGTs return to normal gameplay interface
   Process repeats from step 5 for subsequent hands

Noteworthy Aspects and Features: The Grand Paradise Jackpot™'s dynamic multiplier system introduces several innovative features that distinguish it from traditional casino jackpots:
1. Real-time multiplier adjustments based on card distribution, creating a truly dynamic and engaging jackpot experience.
2. Integration of probability calculations that factor in the number of decks and cards already dealt, providing accurate and transparent odds.
3. Extended gameplay value through shoe-length jackpot eligibility, encouraging longer play sessions.
4. A unique combination of traditional baccarat gameplay with elements of lottery-style excitement in the jackpot mechanics.
5. Scalable architecture allowing for property-wide or multi-casino linked jackpots with synchronized multiplier updates.
6. Potential for strategic jackpot betting as players may observe multiplier trends throughout the shoe.
7. Enhanced social gaming aspect as all players may track and anticipate potential jackpot triggers together.
8. Flexibility to adjust base jackpot amounts and multiplier ranges to suit different casino preferences and player demographics.

These features create a jackpot system that is particularly well-suited to the Macau market, where baccarat is hugely popular and players often seek high-stakes, high-reward gaming experiences. The dynamic nature of the multipliers adds a new layer of excitement to each shoe, potentially attracting both traditional baccarat enthusiasts and players looking for innovative jackpot mechanics.

### Grand Paradise Jackpot™ Calculation and Distribution Technique #3—Six Consecutive Card Jackpot Trigger

Description and Implementation: This Grand Paradise Jackpot™ calculation and distribution technique implements a jackpot triggering mechanism that evaluates six consecutive cards dealt in live baccarat for matching rank and color. The system monitors the cards dealt during each hand of live baccarat played at a Dealer-controlled Electronic Table Game (DETG) system. As cards are dealt, the system tracks sequences of six consecutive cards, regardless of whether they are dealt to the player hand or banker hand. When a sequence of six consecutive cards all match in both rank and color (e.g., six red Kings or six black Aces), the Grand Paradise Jackpot™ is triggered.

The DETG system utilizes advanced card recognition technology integrated with the dealing shoe to instantly identify each card as it is dealt. This information is relayed in real-time to the central game server, which maintains a rolling buffer of the last six cards dealt. After each card is dealt, the server evaluates the buffer to check for a matching sequence. If a match is detected, the jackpot is immediately triggered, and all eligible players are notified via their Electronic Table Game Terminals (ETGTs).

This jackpot mechanism adds an extra layer of excitement to every hand of baccarat, as players watch each card with anticipation, knowing that any card may complete the winning sequence. The rarity of such a specific six-card sequence ensures that the jackpot may grow to substantial amounts, creating the potential for life-changing wins.

Benefits to Players: This jackpot mechanism offers players an additional way to win big, independent of the outcome of the main baccarat game. It adds excitement and anticipation to every card dealt, enhancing the overall gaming experience. Players have the chance to win a potentially large jackpot without needing to alter their baccarat strategy or place additional side bets. The transparency of the trigger condition (six consecutive matching cards) is easy for players to understand and follow along with during gameplay.

Benefits to Casinos: For casinos, this jackpot feature serves as a powerful attraction to draw more players to their baccarat tables. The potential for large jackpot wins may increase player engagement and time spent at the tables. The mechanism may be implemented with minimal changes to the existing baccarat game flow, making it easy to integrate into current operations. The rarity of the trigger event allows casinos to offer substantial jackpots without significantly impacting their overall revenue. Additionally, the excitement generated by near-misses and eventual jackpot hits may create a buzz on the casino floor, attracting more players to the baccarat area.

Example Walk-Through Scenario: John sits down at an ETGT connected to a live baccarat table streaming from the casino floor. He notices the Grand Paradise Jackpot™ display showing a current value of $500,000. The dealer begins a new shoe, and John places his usual baccarat bets. As the game progresses, John watches each card intently, knowing that any sequence of six matching cards may trigger the jackpot.

In the third hand of the shoe, the dealer draws a red King for the player hand. John's interest is piqued. The next card, for the banker hand, is another red King. John sits up straighter, realizing a sequence may be forming. The third and fourth cards dealt are also red Kings, causing a stir among the players at the table. The fifth card drawn is yet another red King, and the tension in the air is palpable. Players around the table are holding their breath as the dealer prepares to draw the sixth card.

As the final card is revealed to be a red King, the ETGT erupts with lights and sounds, announcing the jackpot has been hit. John and the other players cheer in excitement. The dealer confirms the sequence, and the casino staff initiates the jackpot payout procedure. John, along with the other players who had opted into the jackpot, receive their share of the $500,000 prize based on their level of participation.

For the rest of his session, John remains at the table, enjoying the heightened atmosphere and hoping lightning may strike twice. He appreciates how this jackpot feature added an extra thrill to the game without changing the fundamental baccarat experience he enjoys.

Example System Procedural Flow:
1. The DETG system initializes the card tracking buffer at the start of each new shoe.
2. As each card is dealt, the dealing shoe's integrated scanner identifies the card's rank and color.
3. The card information is instantly transmitted to the central game server.
4. The server adds the new card to the rolling buffer of the last six cards dealt, removing the oldest card if necessary.
5. The server evaluates the current six-card sequence in the buffer: a. If all six cards match in rank and color, proceed to step 6. b. If no match is found, return to step 2 for the next card.
6. Upon detecting a matching sequence, the server immediately flags a jackpot trigger event.
7. The server queries the player management system to identify all players currently opted into the jackpot across all connected ETGTs.
8. The jackpot amount is calculated based on the current pool value.
9. The server determines each eligible player's share of the jackpot based on their level of participation.
10. Notification messages are generated and sent to all connected ETGTs, with personalized win amounts for eligible players.
11. The ETGTs display the jackpot win animation and individual win amounts to players.
12. The server instructs the casino management system to initiate the payout process for winning players.
13. The jackpot pool is reset to its seed amount, and the system returns to step 1 for the next shoe.

Throughout this process, the DETG system maintains constant communication with the ETGTs, updating displays with each card dealt and the current state of the potential jackpot sequence. This real-time interaction ensures that all players are engaged and informed throughout the game.

Noteworthy Aspects and Features: This Grand Paradise Jackpot™ mechanism stands out for its seamless integration into the existing baccarat game flow. Unlike many side bets or jackpot systems that may require additional wagers or complicate the game, this feature adds excitement without disrupting the specific baccarat experience. The use of six consecutive cards as the trigger strikes a balance between being achievable enough to maintain player interest and rare enough to allow for significant jackpot amounts.

The real-time card recognition and evaluation system demonstrates a sophisticated use of technology in a traditional table game setting. This blend of classic game play with modern tracking capabilities showcases the casino's commitment to innovation. The transparent nature of the jackpot trigger—visible cards on the table—builds trust with players, as they may see and verify the winning condition themselves.

Furthermore, the system's ability to award the jackpot across multiple ETGTs, potentially in different locations, highlights its versatility in a networked casino environment. This feature may be particularly attractive in Macau, where high-stakes baccarat is immensely popular, and players are always seeking new and exciting ways to win big.

### Grand Paradise Jackpot™ Calculation and Distribution Technique #4—Enhanced Paradise Jackpot Integration

Description and Implementation: This Grand Paradise Jackpot™ calculation and distribution technique involves integrating the Grand Paradise Jackpot™ as an enhancement to the existing Paradise Jackpot system on live baccarat tables. The enhanced system builds upon the familiar Paradise Jackpot framework, which typically awards jackpots based on specific card combinations in the first five cards dealt. The Grand Paradise Jackpot™ adds an additional layer of excitement by introducing new, more challenging combinations and larger potential payouts.

In this enhanced system, players may opt into the Grand Paradise Jackpot™ by placing an additional side bet. The system tracks both the traditional Paradise Jackpot combinations and the new Grand Paradise combinations simultaneously. The Dealer-controlled Electronic Table Game (DETG) system utilizes advanced card recognition technology to identify and evaluate card combinations in real-time as they are dealt from the shoe.

The Grand Paradise Jackpot™ introduces new winning combinations such as six-of-a-kind (e.g., six Aces regardless of suit), same-suit runs (e.g., 9, 10, J, Q, K, A all in hearts), or specific color patterns (e.g., alternating red and black cards). These combinations are evaluated across multiple hands if necessary, adding a layer of anticipation that spans several rounds of play.

Benefits to Players: Players benefit from this enhanced system by having more opportunities to win significant jackpots. The familiar Paradise Jackpot remains in place, providing the excitement players already enjoy, while the Grand Paradise Jackpot™ offers even larger potential payouts for more rare combinations. This tiered approach allows players to aim for different levels of jackpots, catering to various risk appetites and bankrolls. The extended evaluation period across multiple hands keeps players engaged for longer periods, enhancing their overall gaming experience.

Benefits to Casinos: For casinos, this enhanced jackpot system serves as a powerful tool to attract and retain players at their baccarat tables. The integration with the existing Paradise Jackpot system means minimal additional training for staff and players. The higher-tier Grand Paradise Jackpot™ may be marketed as an exclusive or VIP feature, potentially attracting high-rollers and increasing overall table stakes. The system's ability to keep players engaged across multiple hands may increase time-on-device and, consequently, casino revenue. Additionally, the rarity of Grand Paradise Jackpot™ hits allows for substantial prize pools, creating buzz and excitement on the casino floor.

Example Walk-Through Scenario: Lisa approaches a live baccarat table equipped with the enhanced Paradise Jackpot system. She's familiar with the traditional Paradise Jackpot but notices the new Grand Paradise Jackpot™ display showing a massive $1,000,000 prize. Intrigued, she sits at an Electronic Table Game Terminal (ETGT) and reads the rules for the new jackpot tiers.

As Lisa plays, she opts into both the Paradise and Grand Paradise Jackpot™s by placing the required side bets. In the first hand, the dealer draws an Ace of hearts for the player hand. Lisa's interest is piqued as this may start a same-suit run for the Grand Paradise Jackpot™. The next card is a King of hearts, followed by a Queen of hearts. The excitement builds as players realize a rare combination may be forming.

Over the next two hands, the Jack and 10 of hearts are dealt, leaving Lisa and the other players on the edge of their seats. In the fourth hand, as the dealer prepares to draw the first card, the tension is palpable. The card is revealed to be the 9 of hearts, completing the same-suit run and triggering the Grand Paradise Jackpot™!

The ETGT erupts with lights and sounds, announcing the major win. Casino staff verify the sequence, and Lisa, along with other players who had opted into the Grand Paradise Jackpot™, are awarded their shares of the million-dollar prize based on their bet amounts.

For the remainder of her session, Lisa continues to play, now even more excited about the potential for both Paradise and Grand Paradise Jackpot™ wins. She appreciates how this enhanced system has added an extra layer of thrill to her favorite game without complicating the specific baccarat experience.

Example System Procedural Flow:
1. The DETG system initializes at the start of a new shoe, resetting all jackpot tracking mechanisms.
2. As players join the table, the ETGTs present options for Paradise and Grand Paradise Jackpot™ participation.
3. Players place their main baccarat bets and optional jackpot side bets via the ETGTs.
4. The dealing shoe scans and identifies each card as it's dealt, transmitting the information to the central server.
5. For each hand: a. The server evaluates the dealt cards for traditional Paradise Jackpot combinations. b. Simultaneously, it updates the tracking for Grand Paradise Jackpot™ combinations, which may span multiple hands.
6. If a Paradise Jackpot combination is hit: a. The server immediately calculates and awards the appropriate payout. b. Notifications are sent to relevant ETGTs and casino staff.
7. For Grand Paradise Jackpot™ tracking: a. The server maintains a rolling buffer of cards dealt across multiple hands. b. After each card, it checks for qualifying Grand Paradise combinations. c. If a combination is forming, the server sends alerts to ETGTs to build anticipation.
8. If a Grand Paradise Jackpot™ combination is completed: a. The server immediately flags the event and freezes the jackpot amount. b. It identifies all eligible players across connected ETGTs. c. The server calculates individual payouts based on bet amounts and participation levels. d. Win notifications are sent to ETGTs and casino management systems. e. The jackpot is reset to its seed amount.
9. Throughout gameplay, the server continuously updates ETGT displays with current jackpot amounts, recent wins, and near-miss information to maintain player engagement.
10. The system also communicates with the casino's player tracking system, updating player profiles with jackpot participation and win data.

This procedural flow ensures seamless integration of the Grand Paradise Jackpot™ with existing systems while providing a transparent and exciting experience for players.

Noteworthy Aspects and Features: The enhanced Paradise Jackpot system stands out for its ability to build upon an already popular feature in a way that adds excitement without overwhelming players. By maintaining the familiar Paradise Jackpot alongside the new Grand Paradise tier, it caters to both conservative players and those seeking bigger thrills.

The system's capability to track complex combinations across multiple hands is a technical achievement that sets it apart from simpler jackpot systems. This multi-hand evaluation creates a unique form of anticipation and engagement that may keep players at the tables for extended periods.

The integration of this enhanced system with existing DETG and ETGT infrastructure showcases the versatility and scalability of modem casino technology. It allows for the introduction of new, complex gaming features without requiring a complete overhaul of existing hardware.

Furthermore, the tiered jackpot approach aligned with varying bet levels caters well to the diverse player base found in Macau casinos, where both mass-market and VIP players often coexist in the same gaming areas. This inclusivity, combined with the potential for massive Grand Paradise Jackpot™ wins, makes this system particularly well-suited for the Macau market, where baccarat is king and players are always seeking the next big win opportunity.

### Grand Paradise Jackpot™ Calculation and Distribution Technique #5—Real-Time Probability-Based Jackpot Updates

Description and Implementation: This Grand Paradise Jackpot™ calculation and distribution technique implements real-time jackpot amount updates displayed on Electronic Table Game Terminals (ETGTs) based on the probability of each six-card combination occurring. The system dynamically adjusts the jackpot amount as cards are dealt, reflecting the changing odds of hitting specific combinations.

The Dealer-controlled Electronic Table Game (DETG) system employs sophisticated algorithms that calculate the probability of each potential six-card combination based on the cards remaining in the shoe. As each card is dealt, the system instantly recalculates these probabilities and adjusts the jackpot amounts accordingly. For example, if several Aces have been dealt early in a shoe, the jackpot for an all-Aces combination would increase, reflecting the reduced likelihood of that combination occurring.

This real-time update system is integrated with the card recognition technology in the dealing shoe, ensuring immediate and accurate probability calculations. The ETGTs display these constantly updating jackpot amounts, creating a dynamic and engaging visual for players. Additionally, the system may highlight “hot” combinations that have become more based on the cards already dealt, adding another layer of excitement to the game.

Benefits to Players: This system offers players an unprecedented level of transparency and engagement in the jackpot process. Players may see in real-time how the odds of winning change with each card dealt, adding an element of strategy and anticipation to their jackpot participation. The dynamic nature of the jackpot amounts means that players may be incentivized to place jackpotbets at strategic times when the potential payout for certain combinations is higher. This creates a more interactive and potentially more rewarding jackpot experience.

Benefits to Casinos: For casinos, this system serves as a powerful tool for increasing player engagement and time spent at the baccarat tables. The constantly changing jackpot amounts create a sense of urgency and excitement that may keep players at the tables longer. The transparency of the system may also build trust with players, potentially leading to increased participation in jackpot bets. Furthermore, the dynamic nature of the jackpots allows the casino to maintain appropriate risk levels while still offering attractive potential payouts.

Example Walk-Through Scenario: Sarah sits down at an ETGT connected to a live baccarat table. She notices the Grand Paradise Jackpot™ display, which shows different jackpot amounts for various six-card combinations. As the dealer begins a new shoe, Sarah sees that the jackpot for six consecutive Aces stands at $500,000.

As the game progresses, Sarah watches the jackpot amounts fluctuate with each card dealt. After several hands where no Aces are drawn, she notices the jackpot for six Aces has increased to $550,000. The ETGT display highlights this combination, indicating it's becoming a “hot” possibility.

Intrigued by the increasing jackpot and the system's indication of improved odds, Sarah decides to place a jackpot side bet. Over the next few hands, she watches in excitement as the jackpot for Aces continues to climb, reaching $600,000 as the likelihood of drawing six consecutive Aces increases.

In a surprising turn, the next hand results in four consecutive Aces being dealt. The table erupts in excitement as players realize they're on the brink of a massive jackpot. Sarah's heart races as she watches the dealer prepare to draw the fifth card. Unfortunately, the streak is broken by a King, and Sarah doesn't win the jackpot this time. However, the near-miss experience and the transparent, dynamic nature of the jackpot system have thoroughly engaged Sarah. She continues to play, intrigued by the constantly changing odds and jackpot amounts for different combinations.

Throughout her session, Sarah finds herself paying close attention to the cards dealt and the corresponding changes injackpot amounts. She strategically places jackpot bets when she feels the odds are in her favor, adding an extra layer of excitement to her baccarat play. Even when she doesn't hit the jackpot, Sarah enjoys the enhanced gaming experience and the feeling of making informed decisions about her jackpot participation.

### Example System Procedural Flow:

1. At the start of a new shoe, the DETG system initializes the card tracking and probability calculation algorithms.
2. The system sets initial jackpot amounts for each possible six-card combination based on their base probabilities.
3. As each card is dealt from the shoe: a. The integrated card scanner identifies the card and transmits the information to the central server. b. The server updates its record of cards remaining in the shoe. c. The probability calculation algorithm immediately recalculates the odds for each possible six-card combination. d. Based on the new probabilities, the system adjusts the jackpot amounts for each combination. e. The updated jackpot amounts are instantly transmitted to all connected ETGTs.
4. The ETGTs receive the updated information and refresh their displays in real-time, showing: a. New jackpot amounts for each combination. b. Highlighted “hot” combinations that have become more likely. c. Trend indicators showing whether specific jackpots are increasing or decreasing.
5. As players place bets: a. The ETGTs transmit bet information to the central server. b. The server records each player's jackpot participation and bet amount.
6. The system continuously monitors for winning six-card combinations: a. If a winning combination occurs, the system immediately flags it. b. The current jackpot amount for that combination is locked in. c. The server identifies all eligible players and calculates their share of the jackpot based on bet amounts.
7. In the event of a jackpot win: a. The system sends win notifications to the relevant ETGTs. b. It instructs the casino management system to initiate the payout process. c. The jackpot for the hit combination is reset to its base amount.
8. Throughout gameplay, the system also: a. Tracks near-misses and uses this data to adjust engagement strategies. b. Provides real-time analytics to casino management on jackpot participation rates and player behavior. c. Integrates with the casino's player tracking system to record individual player's jackpot betting patterns.

This procedural flow ensures a dynamic, engaging, and transparent jackpot experience that evolves with every card dealt.

Noteworthy Aspects and Features: This Grand Paradise Jackpot™ calculation and distribution technique stands out for its innovative use of real-time probability calculations to create a dynamic and engaging jackpot experience. Unlike static jackpot systems, this approach turns each card dealt into a potentially game-changing event, not just for the base game of baccarat, but for the jackpot odds as well.

The system's ability to instantly recalculate probabilities and adjust jackpot amounts demonstrates a sophisticated application of mathematical algorithms in a live gaming environment. This real-time processing and display capability showcases the power of modern casino technology to enhance traditional table games.

The transparency of the system, showing players exactly how the odds and potential payouts change with each card, is a unique feature that may build trust and encourage more informed jackpot participation. This level of information was previously unavailable to players in traditional jackpot systems.

The highlighting of “hot” combinations adds an element of gamification to the jackpot experience, potentially driving increased participation and excitement. This feature may be particularly appealing in the Macau market, where baccarat players often look for patterns and trends.

Furthermore, the system's ability to adapt jackpot amounts based on real-time odds allows casinos to offer more attractive potential payouts while maintaining appropriate risk levels. This balancing act between exciting players with large jackpots and managing the house edge is notable in the competitive Macau casino landscape.

The integration of this system with ETGTs and the central server also demonstrates the potential for creating a networked, property-wide jackpot experience. This may be especially attractive in Macau's large integrated resorts, where multiple baccarat tables across different areas may contribute to and participate in the same dynamic jackpot system.

### Grand Paradise Jackpot™ Calculation and Distribution Technique #6—Progressive Multi-Tier Jackpot Structure

Description and Implementation: This Grand Paradise Jackpot™ calculation and distribution technique implements a progressive jackpot structure where lower-tier six-card combinations contribute to higher-tier jackpots. The system creates a multi-layered jackpot experience, with each tier representing increasingly rare card combinations. As players place bets on the jackpot, a portion of each wager is allocated to different tiers based on predefined contribution rates.

The DETG system manages multiple jackpot tiers simultaneously, each associated with specific six-card combinations. For example, the lowest tier may be triggered by six consecutive cards of the same color, while the highest tier may require six consecutive Aces of the same suit. As lower-tier combinations occur more frequently, a percentage of their payout is redirected to feed the higher-tier jackpots, ensuring that the most prestigious prizes may grow to substantial amounts.

The system utilizes advanced tracking algorithms to monitor card distributions and adjust contribution rates dynamically. This ensures that all tiers maintain appealing prize pools while allowing the top-tier jackpots to reach life-changing sums. Real-time displays on the ETGTs show the current amount for each jackpot tier, creating a visually engaging experience for players.

Benefits to Players: This progressive structure offers players a range of winning possibilities, from more frequent, smaller payouts to rare, massive jackpots. The multi-tier system caters to different player preferences and risk appetites, allowing participants to aim for their preferred balance of win frequency and payout size. The visible growth of higher-tier jackpots, fueled by lower-tier hits, creates a sense of shared progress and excitement among all players at the table.

Benefits to Casinos: For casinos, this system drives increased player engagement and jackpot participation. The variety of win possibilities appeals to a broader range of players, potentially increasing overall betting volume. The progressive structure allows for the creation of headline-grabbing top-tier jackpots without requiring all players to aim for these rare combinations. This may attract high-rollers while still providing exciting opportunities for more conservative players.

Example Walk-Through Scenario: Michael sits down at an ETGT and notices the Grand Paradise Jackpot™ display showing four different tiers of jackpots. The lowest tier, for six consecutive cards of the same color, stands at $10,000. The highest tier, for six consecutive Aces of spades, shows an impressive $5,000,000.

As Michael plays, he witnesses a player at the table hit the lowest tier jackpot with six consecutive red cards. The winner receives $8,000, while the remaining $2,000 is distributed among the higher tiers, visibly increasing their amounts. This excites Michael, knowing that even when lower tiers hit, the bigger prizes continue to grow.

Over the next hour, Michael sees the second-lowest tier hit twice, each time contributing to the growth of the top two tiers. The visible progression of the jackpots keeps him engaged, and he finds himself placing more jackpot side bets than he initially planned.

Towards the end of his session, the third-tier jackpot is hit when six consecutive face cards are dealt. This significant win creates a buzz around the table. As the winner celebrates their substantial payout, Michael and the other players watch in anticipation as a portion of the win feeds into the top-tier jackpot, pushing it to a new record high.

Although Michael doesn't hit a jackpot himself, the dynamic nature of the progressive system and the shared excitement of contributing to and watching the growth of the top-tier jackpots enhance his overall gaming experience. He leaves the table already planning his next visit, eager to take another shot at the now even larger top-tier prize.

### Example System Procedural Flow

1. The DETG system initializes the multi-tier jackpot pools at the start of operations, setting each tier to its predetermined seed amount.
2. As players join the game, the ETGTs present the current jackpot amounts for each tier and offer jackpot side bet options.
3. When a player places a jackpot bet: a. The ETGT transmits the bet amount to the central server. b. The server allocates the bet across the jackpot tiers according to the predefined contribution rates. c. The server updates the jackpot amounts and broadcasts the new values to all connected ETGTs.
4. As each hand is played: a. The dealing shoe scans and identifies each card, sending the information to the server. b. The server evaluates the cards for any qualifying six-card combinations. c. If a combination is forming, the server sends alerts to ETGTs to build anticipation.
5. If a jackpot-winning combination occurs: a. The server immediately identifies the winning tier and locks in the current jackpot amount. b. It determines eligible players based on their jackpot participation. c. The server calculates the payout, reserving a portion for distribution to higher tiers if applicable. d. Win notifications are sent to the relevant ETGTs and casino management system. e. The server instructs the payment system to initiate the award process for winning players.
6. After a jackpot hit: a. The server redistributes the reserved portion of the payout to higher jackpot tiers. b. It resets the hit jackpot tier to its seed amount. c. The server broadcasts updated jackpot amounts to all ETGTs.
7. Throughout gameplay, the system continuously: a. Monitors betting patterns and jackpot growth rates. b. Adjusts contribution rates if necessary to maintain balanced growth across all tiers. c. Updates displays on ETGTs with current jackpot amounts and recent win information. d. Provides real-time analytics to casino management on jackpot performance and player engagement.

This procedural flow ensures a dynamic and engaging multi-tier progressive jackpot experience that maintains player interest across all prize levels.

Noteworthy Aspects and Features: This Grand Paradise Jackpot™ calculation and distribution technique stands out for its innovative approach to creating a comprehensive and engaging jackpot ecosystem. The multi-tier structure caters to the diverse preferences of baccarat players, particularly in the Macau market where both mass-market and VIP players coexist.

The system's ability to dynamically redistribute funds from lower-tier wins to higher tiers is a unique feature that ensures sustained interest in all jackpot levels. This “trickle-up” approach allows for the creation of massive top-tier jackpots without relying solely on direct contributions to those rare combinations.

The real-time display of jackpot growths across all tiers creates a visually engaging experience that may drive increased player participation. The visible impact of each bet and each lower-tier win on the overall jackpot ecosystem fosters a sense of community and shared progress among players.

The flexibility of the system to adjust contribution rates based on betting patterns and jackpot growth rates demonstrates a sophisticated use of data analytics in real-time gaming operations. This adaptability ensures that the jackpot system may remain balanced and attractive to players over extended periods.

Furthermore, the multi-tier structure aligns well with the high-low betting patterns often seen in Macau baccarat, where players may make smaller bets on common outcomes while also placing occasional large bets on rare events. This jackpot system mirrors that behavior, potentially increasing its appeal to local players.

The integration of this complex jackpot system with the DETG and ETGT infrastructure showcases the advanced capabilities of modern casino technology. It allows for the implementation of intricate gaming features that would be challenging to manage in a traditional, non-electronic table game environment.

### Grand Paradise Jackpot™ Calculation and Distribution Technique #7—Dealer-Controlled Jackpot Activation

Description and Implementation: This Grand Paradise Jackpot™ calculation and distribution technique implements a dealer-controlled activation of Grand Paradise Jackpot™ eligibility on a per-shoe basis. The system empowers the dealer to initiate special jackpot periods, adding an element of surprise and excitement to the game. Using a secure interface on the dealing table, the dealer may activate the Grand Paradise Jackpot™ feature at strategic moments during the shoe.

The DETG system is equipped with a dealer console that includes a protected jackpot activation control. This control may be a physical button or a touchscreen interface, accessible only with proper authentication. When activated, the system enters a “jackpot eligible” state for a predetermined number of hands or time period. During this state, all jackpot bets placed by players have the potential to win the Grand Paradise Jackpot™ in addition to regular jackpot prizes.

The activation of the jackpot period is broadcast to all connected ETGTs, triggering special animations and sound effects to alert players to the enhanced winning opportunities. The system may also implement variable jackpot multipliers during these special periods, further increasing the potential payouts.

Benefits to Players: This feature adds an extra layer of excitement and anticipation to the game. Players never know when a jackpot period may be activated, encouraging more consistent participation in jackpot side bets. The dealer-initiated nature of the feature may create a sense of camaraderie between the dealer and players, enhancing the overall gaming experience. During active jackpot periods, players have the chance to win significantly larger prizes, adding to the thrill of each hand.

Benefits to Casinos: For casinos, this system provides a tool to dynamically increase player engagement and betting activity. The unpredictable nature of jackpot activations may help maintain player interest over extended gaming sessions. The dealer's ability to strategically time these special periods allows for management of jackpot frequency and may be used to boost activity during typically slower periods. The added excitement may also attract more players to the table, increasing overall revenue.

Example Walk-Through Scenario: Emma takes a seat at a baccarat table, noticing a special “Grand Paradise Jackpot™” indicator that is currently inactive. She places her usual bets, including a small jackpot side bet. After a few hands, the dealer announces, “Ladies and gentlemen, the next five hands will be Grand Paradise Jackpot™ eligible!” and presses a button on their console.

Suddenly, the ETGTs light up with exciting graphics and sounds, indicating the special jackpot period has begun. Emma, along with other players, sees that the potential jackpot payout has significantly increased for this period. Excited by the opportunity, Emma increases her jackpot side bet for the upcoming hands.

During the third hand of the jackpot period, a rare card combination appears, triggering a substantial Grand Paradise Jackpot™ win. The table erupts in celebration as Emma and the other participating players share in the massive payout, their wins multiplied by the special period bonus.

As the jackpot period ends, Emma finds herself more engaged with the game than ever before. She continues to play, eagerly anticipating the next time the dealer may activate the special jackpot feature. Even during regular play, she maintains her jackpot side bets, not wanting to miss out on any future surprise activations.

### Example System Procedural Flow:

1. At the start of each shoe, the DETG system initializes in a standard, non-jackpot eligible state.
2. The dealer is provided with a secure interface to activate the Grand Paradise Jackpot™ feature.
3. At a strategic moment, the dealer initiates the jackpot period: a. The dealer authenticates using a secure method (e.g., notable card, fingerprint, or code). b. The dealer activates the jackpot feature via the console. c. The DETG system verifies the activation and enters jackpot eligible state.
4. Upon activation: a. The central server broadcasts the jackpot eligible status to all connected ETGTs. b. ETGTs display special animations and sounds to alert players. c. The server adjusts jackpot calculations to include enhanced payouts or multipliers.
5. During the jackpot eligible period: a. The system tracks the number of hands played or time elapsed. b. All jackpot bets are evaluated for both standard and Grand Paradise Jackpot™ wins. c. The dealer console displays the remaining duration of the jackpot period.
6. For each hand during the jackpot period: a. The dealing shoe scans and identifies each card, sending data to the server. b. The server evaluates for any jackpot-winning combinations. c. If a win occurs, the server calculates the enhanced payout based on the active multipliers.
7. If a Grand Paradise Jackpot™ is hit: a. The server immediately locks in the win and identifies eligible players. b. Win notifications are sent to relevant ETGTs and the casino management system. c. The server initiates the enhanced payout process.
8. At the end of the jackpot period: a. The system automatically returns to the standard state. b. The server sends notifications to all ETGTs to update their displays. c. The dealer is notified that the period has ended.
9. Throughout the process, the system: a. Maintains detailed logs of all jackpot activations and outcomes. b. Provides real-time data to casino management on jackpot performance. c. Integrates with player tracking systems to record individual participation in special jackpot periods.

This procedural flow ensures a secure, exciting, and dynamically managed Grand Paradise Jackpot™ experience.

Noteworthy Aspects and Features: This Grand Paradise Jackpot™ calculation and distribution technique stands out for its innovative integration of dealer interaction with the electronic jackpot system. By allowing the dealer to initiate special jackpot periods, it creates a unique blend of traditional table game atmosphere with the excitement of modern, high-payoutjackpot systems.

The unpredictable nature of the jackpot activation adds a new layer of anticipation to the game, potentially increasing player engagement and time spent at the table. This feature may be particularly appealing in the Macau market, where players often look for unique gaming experiences and opportunities for large wins.

The system's ability to implement variable jackpot multipliers during special periods showcases the flexibility of modern casino technology. This allows for the creation of truly exceptional winning opportunities that may generate buzz and excitement on the casino floor.

The secure authentication required for jackpot activation demonstrates a commitment to game integrity, an important factor in maintaining player trust, especially in high-stakes environments like those found in Macau.

The real-time communication between the dealer console, central server, and ETGTs highlights the sophisticated networking capabilities of modern casino systems. This seamless integration allows for the immediate transmission of jackpot status changes and win notifications, enhancing the overall player experience.

Furthermore, the ability to strategically time jackpot periods provides casino management with a powerful tool to influence player behavior and table activity. This may be particularly useful in Macau's competitive casino landscape, where attracting and retaining players is notable.

The system's detailed logging and reporting features also provide valuable data for casino operations, allowing for analysis of jackpot effectiveness and player responses to these special periods. This data-driven approach to game management aligns well with the increasing emphasis on analytics in the casino industry.

### Grand Paradise Jackpot™ Calculation and Distribution Technique #8—Player-Selectable Jackpot Participation

Description and Implementation: This Grand Paradise Jackpot™ calculation and distribution technique implements player-selectable jackpot participation options at Electronic Table Game Terminals (ETGTs) for each baccarat shoe. The system provides players with a range of customizable jackpot betting options, allowing them to tailor their jackpot experience to their preferences and risk tolerance.

At the start of each new shoe, players are presented with a menu of jackpot participation options on their ETGT screens. These options may include different bet amounts, various jackpot tiers, and even specific card combinations to bet on. Players may choose to participate in all available jackpots, select specific ones, or opt out entirely. The system also allows players to set up automatic jackpot betting patterns that may be applied throughout the shoe.

The DETG system tracks each player's selected jackpot options and applies them to every hand played during the shoe. Players have the flexibility to modify their selections at predetermined intervals, such as after every 10 hands or at the halfway point of the shoe.

Benefits to Players: This feature empowers players with greater control over their jackpot experience. It allows them to align their jackpot participation with their betting strategy, bankroll, and risk preferences. Players may focus on jackpot combinations they find lucky or exciting, potentially increasing their enjoyment of the game. The ability to set up automatic betting patterns also provides convenience for players who prefer consistent jackpot participation.

Benefits to Casinos: For casinos, this system may lead to increased jackpot participation as players are more to engage with options they've personally selected. The customizable nature of the jackpot bets may appeal to a wider range of players, potentially attracting both conservative bettors and high-rollers. The data gathered from player selections provides valuable insights into customer preferences, which may inform future game development and marketing strategies.

Example Walk-Through Scenario: David sits down at an ETGT and inserts his player card. As the dealer prepares to start a new shoe, David's screen displays a “Jackpot Options” menu. He sees choices for low, medium, and high-tier jackpots, as well as options to bet on specific card combinations.

Feeling lucky, David selects the high-tier jackpot option and adds a specific bet on a six-Ace combination. He sets his jackpot bet amount to $10 per hand and chooses to have these selections apply automatically for the first 20 hands of the shoe.

As play begins, David watches his regular baccarat bets while also keeping an eye on the jackpot possibilities. His ETGT display shows his active jackpot selections and tracks any near-misses or potential jackpot formations.

After 20 hands, David's screen prompts him to review his jackpot options. Noticing that several Aces have already been dealt, he decides to modify his selection. He removes the six-Ace combination bet and instead opts for a mid-tier jackpot that may require a straight flush of six cards. He also increases his jackpot bet to $15 per hand, feeling that the change may bring him better luck.

As the shoe progresses, David appreciates the ability to adjust his jackpot strategy. He experiences a few near-misses on his selected combinations, which keeps him engaged and excited. Towards the end of the shoe, his straight flush jackpot hits, resulting in a significant win. The personalized nature of his jackpot selection makes the win feel even more special and rewarding.

Throughout his session, David experiments with different jackpot combinations and bet amounts, finding that this customizable approach adds an extra layer of strategy and excitement to his baccarat play. Even when he doesn't win, he enjoys the sense of control and the ability to chase jackpots that appeal to him personally.

### Example System Procedural Flow

1. At the start of a new shoe, the DETG system initiates the jackpot selection process: a. The server sends a signal to all connected ETGTs to display the jackpot options menu. b. Each ETGT retrieves the associated player's preferences (if a player card is inserted) and pre-populates selections.
2. Players make their jackpot selections on the ETGT: a. The ETGT presents a user-friendly interface for jackpot choices, including bet amounts, jackpot tiers, and specific combinations. b. Players may set up automatic betting patterns and specify intervals for option reviews. c. The ETGT transmits the selected options to the central server.
3. The central server processes each player's selections: a. It validates the choices against available jackpot options and the player's credit balance. b. The server stores the selections and links them to the player's session or player card. c. It calculates and allocates the appropriate portion of each player's bets to the selected jackpot pools.
4. During gameplay: a. For each hand, the server applies the player's jackpot selections automatically. b. The dealing shoe scans and identifies each card, sending the information to the server. c. The server evaluates the cards against each player's selected jackpot combinations. d. ETGTs display relevant jackpot information, including near-misses and potential forming combinations.
5. At predetermined intervals or upon player request: a. The server signals ETGTs to prompt players for jackpot option reviews. b. Players may modify their selections, with changes taking effect from the next hand. c. The server updates its records with any changes and adjusts jackpot allocations accordingly.
6. If a jackpot is hit: a. The server immediately identifies the winning combination and eligible players based on their selections. b. It calculates payouts according to each player's bet amount and selected options. c. Win notifications are sent to the relevant ETGTs and casino management system. d. The server initiates the payout process for winning players.
7. At the end of the shoe: a. The system resets all jackpot selections. b. Players are prompted to make new selections for the upcoming shoe.
8. Throughout the process, the system: a. Maintains detailed logs of all player selections and jackpot outcomes. b. Provides real-time analytics to casino management on popular jackpot options and player behaviors. c. Integrates with player tracking systems to record individual jackpot preferences and win history.

This procedural flow ensures a personalized, engaging, and efficiently managed player-selectable jackpot experience.

Noteworthy Aspects and Features: This Grand Paradise Jackpot™ calculation and distribution technique stands out for its high degree of personalization and player engagement. By allowing players to select their preferred jackpot options, it creates a more interactive and tailored gaming experience, which may be particularly appealing in the sophisticated Macau market.

The system's ability to offer a wide range of jackpot options, from conservative to high-risk, caters to the diverse preferences of baccarat players. This flexibility may attract a broader player base and potentially increase overall jackpot participation rates.

The feature of setting up automatic betting patterns adds a layer of convenience for players, encouraging consistent jackpot participation throughout the shoe. This may lead to larger jackpot pools and more exciting potential payouts.

The integration of player card data to pre-populate jackpot selections demonstrates a sophisticated use of player tracking technology. This personalized touch may enhance player loyalty and provide a seamless gaming experience across multiple sessions.

The ability for players to modify their jackpot selections at intervals during the shoe adds a strategic element to jackpot betting. This dynamic approach keeps players engaged and allows them to adapt their strategy based on the cards they've observed, aligning well with the pattern-tracking behavior common among baccarat players in Macau.

The real-time display of near-misses and potential forming combinations on the ETGTs adds excitement and anticipation to every hand, even when players don't win. This feature may increase player engagement and time spent at the tables.

The system's detailed tracking and analysis of player selections provide valuable data for casino operations. This information may be used to refine jackpot offerings, inform marketing strategies, and optimize the overall gaming experience.

Furthermore, the customizable nature of the jackpot options allows casinos to easily introduce new combinations or special promotional jackpots, providing flexibility to keep the gaming experience fresh and exciting for regular players.

The seamless integration of this complex, player-driven jackpot system with the DETG and ETGT infrastructure showcases the advanced capabilities of modern casino technology. It allows for a level of personalization and interactivity that would be challenging to implement in a traditional, non-electronic table game environment.

Grand Paradise Jackpot™ Calculation and Distribution Technique #9—Independent Grand Paradise Jackpot™ Side Bets that Maybe Placed Separately from Main Baccarat Wagers.

Description and Implementation: This innovative Grand Paradise Jackpot™ calculation and distribution technique introduces independent side bets specifically for the jackpot, allowing players to participate in the jackpot opportunity without requiring a wager on the main baccarat game. The Electronic Table Game Terminals (ETGTs) are equipped with a dedicated jackpot betting area, separate from the main game interface. Players may place jackpot side bets of varying amounts, with the potential jackpot payout scaling proportionally to the bet size. The system tracks these side bets independently, allowing for flexible jackpot participation even when players choose to sit out main game rounds. This implementation leverages the ETGT's touchscreen interface to provide an intuitive jackpot betting area, complete with bet amount selection and confirmation buttons. The backend system maintains a separate balance for jackpot side bets, ensuring accurate tracking and payout calculations independent of main game wagers.

Benefits to Players: This technique offers players enhanced flexibility and control over their gaming experience. Players may participate in the excitement of the Grand Paradise Jackpot™ without being obligated to play every hand of baccarat, allowing for more strategic bankroll management. It also caters to players who may be primarily interested in the jackpot opportunity rather than the base game, potentially attracting a new segment of casino patrons. The ability to adjust jackpot bet sizes independently provides players with more options to tailor their risk and potential reward.

Benefits to Casinos: For casinos, this implementation may lead to increased overall betting volume and revenue. By decoupling jackpot participation from main game wagers, casinos may maintain steady contributions to the jackpot pool even during slower periods of base game play. This technique also simplifies accounting and tracking of jackpot contributions, as they are handled separately from main game bets. Additionally, it provides an opportunity to market the jackpot feature more prominently, potentially attracting players who may not otherwise be interested in baccarat.

Example Walk-Through Scenario: John approaches an ETGT at the casino and decides to participate in the Grand Paradise Jackpot™ without playing the main baccarat game. He navigates to the jackpot betting area on the touchscreen interface, which displays the current jackpot amount and betting options. John selects a $5 jackpot side bet and confirms his wager. The ETGT acknowledges his bet with a visual and audio confirmation, and his account balance is updated to reflect the wager.

As the live dealer begins the baccarat hand, John watches intently, even though he hasn't placed a main game bet. The dealer draws cards for the player and banker hands, and the ETGT's display updates in real-time. After the hand is complete, the system evaluates the cards for any jackpot-winning combinations. In this round, no jackpot is triggered, but John's excitement builds as he sees how close the combination came to a win.

For the next hand, John decides to increase his jackpot side bet to $10 while still abstaining from the main game. He places his bet and watches as new cards are dealt. This time, a rare combination appears, triggering a mid-tier jackpot win. The ETGT erupts with celebratory graphics and sounds, announcing John's win. His jackpot prize, proportional to his $10 bet, is immediately credited to his account. John may now choose to continue playing, cashing out, or using his winnings for main game bets.

Throughout his session, John alternates between placing only jackpot side bets and occasionally participating in the main baccarat game, appreciating the flexibility this system offers.

### Example System Procedural Flow

1. Player logs into the ETGT using their player card or guest account.
2. ETGT displays main game and jackpot betting options.
3. Player navigates to the jackpot betting area and selects desired bet amount.
4. ETGT sends jackpot bet information to the central server for validation and recording.
5. Central server confirms bet placement and updates player's account balance.
6. ETGT displays confirmation of jackpot bet to the player.
7. Live dealer initiates baccarat hand, dealing cards as per standard rules.
8. ETGT receives real-time card information from the dealer's table system.
9. Central server evaluates dealt cards against jackpot-winning combinations.
10. If a jackpot is triggered, the server calculates the player's share based on their bet amount and the total jackpot pool.
11. Server sends win information to the ETGT and updates the player's balance.
12. ETGT displays win animation and updated balance to the player.
13. System resets for the next hand, allowing new jackpot side bets to be placed.
14. Jackpot pool is updated based on new contributions and any wins paid out.
15. Process repeats for subsequent hands, with the player free to adjust or skip jackpot bets as desired.

Noteworthy Aspects and Features: This Grand Paradise Jackpot™ calculation and distribution technique stands out for its ability to separate jackpot participation from main game play, offering unprecedented flexibility to players. The system's ability to handle variable bet sizes for the jackpot adds a layer of customization that caters to different player preferences and bankrolls. The real-time updating of jackpot information across all connected ETGTs creates a sense of community and shared excitement among players. The integration of this feature into the existing ETGT interface demonstrates a seamless blend of technology and game design, enhancing the overall player experience without disrupting the flow of the base game. This implementation also showcases the potential for increased player engagement and casino revenue through innovative side bet options in electronic table games.

### Grand Paradise Jackpot™ Calculation and Distribution Technique #10—Partial Jackpot Awards for Near-Miss Scenarios (E.G., 5 Out of 6 Matching Cards In Rank and Color).

Description and Implementation [minimum 150 words required]: This innovative technique introduces a tiered system of partial jackpot awards for near-miss scenarios in the Grand Paradise Jackpot™. Instead of an all-or-nothing approach, players may win smaller jackpot amounts for close combinations. The system is programmed to recognize and reward 5 out of 6, 4 out of 6, and even 3 out of 6 matching cards in rank and color.

Each ETGT is equipped with advanced pattern recognition software that continuously analyzes the cards dealt in real-time. When a partial match is detected, the system immediately calculates the appropriate award based on pre-determined payout ratios. These ratios are dynamically adjusted based on the current jackpot pool size, ensuring sustainable payouts while maintaining player excitement.

The partial awards are displayed prominently on the ETGT screens, with eye-catching animations that highlight the matching cards and the near-miss nature of the win. This visual feedback serves to heighten anticipation and encourage continued play, as players may see how close they came to the full jackpot.

Benefits to Players: Players benefit greatly from this system as it significantly increases their chances of winning something from their jackpotbets. The near-miss awards provide more frequent payouts, enhancing the overall gaming experience and potentially extending play time. This approach also helps maintain player engagement and excitement, as even when the full jackpot isn't hit, there's still a chance for a substantial win. The tiered system adds an extra layer of anticipation to each hand, as players watch for partial matches that may result in unexpected wins.

Benefits to Casinos: For casinos, this technique may lead to increased player satisfaction and loyalty. The more frequent payouts, albeit smaller, may encourage longer playing sessions and repeat visits. This system also allows for better jackpot pool management, as the partial payouts help to regulate the main jackpot's growth while still maintaining its attractiveness. The near-miss scenarios create additional marketing opportunities, as casinos may promote both the mainjackpot and the excitement of partial wins. This may potentially attract a wider range of players, including those who may be intimidated by the long odds of hitting a full jackpot.

Example Walk-through Scenario [minimum 250 words required]: Lisa sits down at an ETGT and decides to participate in the Grand Paradise Jackpot™. She places a $10 bet on the jackpot side bet and watches as the live dealer begins to deal the cards for the baccarat game. As the hand progresses, Lisa notices that the first four cards dealt match in both rank and color—all red Kings. Her excitement builds as she realizes she's potentially close to a significant win.

The fifth card is revealed, and it's another red King. The ETGT's screen lights up, indicating a near-miss scenario. Although the sixth and final card isn't a red King, breaking the perfect sequence, Lisa has still achieved a 5 out of 6 match. The system immediately calculates her partial jackpot award based on the current jackpot pool and the pre-set ratio for a 5 out of 6 match.

The ETGT displays an engaging animation, highlighting the five matching red Kings and showing how close Lisa came to the full jackpot. A message appears, congratulating her on winning a partial jackpot award of $500. This amount is instantly credited to her account balance.

Excited by her win, Lisa decides to continue playing. In the next hand, she achieves a 4 out of 6 match with black Queens. While this results in a smaller payout of $100, it further reinforces her enjoyment of the game and the frequent win opportunities.

As Lisa continues her session, she experiences several more near-miss scenarios, including a 3 out of 6 match that pays out a modest but welcome $25. Each of these partial wins keeps her engaged and entertained, even as she continues to hope for that elusive full 6 out of 6 match.

Throughout her play, Lisa notices other players at nearby ETGTs also winning partial jackpot awards. This creates a buzzing atmosphere of excitement around the baccarat area, with players sharing in each other's near-miss triumphs and collectively anticipating the possibility of hitting the full jackpot.

### Example System Procedural Flow [Minimum 250 Words Required]

1. Player logs into the ETGT and selects to participate in the Grand Paradise Jackpot™
2. ETGT communicates with the central server to verify player eligibility and current jackpot status.
3. Player places their jackpot side bet, which is recorded by the ETGT and transmitted to the central server.
4. Live dealer begins the baccarat hand, with card information relayed in real-time to all connected ETGTs and the central server.
5. As each card is dealt, the ETGT's pattern recognition software analyzes it against the jackpot criteria.
6. The central server simultaneously performs its own analysis, ensuring redundancy and accuracy.
7. If a partial match is detected (3, 4, or 5 out of 6 cards), both the ETGT and central server flag the potential near-miss scenario.
8. Once all six relevant cards are dealt, the final analysis is performed to confirm the level of match achieved.
9. The central server calculates the appropriate partial jackpot award based on the current jackpot pool size and pre-determined payout ratios.
10. This award amount is transmitted back to the player's ETGT.
11. The ETGT displays the near-miss win animation, highlighting the matching cards and the award amount.
12. The central server updates the player's account balance with the partial jackpot win.
13. Simultaneously, the jackpot pool is adjusted to reflect the partial payout.
14. The central server sends updated jackpot pool information to all connected ETGTs.
15. All ETGTs update their displays with the new jackpot amount.
16. The system logs the near-miss win details for auditing and analysis purposes.
17. If multiple players achieve near-miss wins on the same hand, the central server calculates and distributes the appropriate awards to each player's ETGT.
18. The casino management system is notified of the near-miss win(s) for potential marketing and player comp considerations.
19. The system resets for the next hand, ready to analyze new card combinations.
20. Throughout this process, the central server continuously monitors for any full jackpot wins, ready to override partial win calculations if a 6 out of 6 match occurs.

Noteworthy Aspects and Features [minimum 150 words required]: This Grand Paradise Jackpot™ calculation and distribution technique is particularly innovative in its approach to maintaining player engagement through frequent, smaller wins. The implementation of advanced pattern recognition software in real-time demonstrates a significant technological advancement in electronic table games.

The dynamic adjustment of payout ratios based on the jackpot pool size showcases a sophisticated balance between player excitement and casino sustainability. This feature ensures that the jackpot remains attractive while also allowing for more frequent payouts.

The visual feedback system, with its engaging animations highlighting near-miss scenarios, adds a new dimension to the player experience. This not only enhances individual gameplay but also creates a shared sense of excitement among all participants.

The tiered approach to partial jackpot awards introduces a novel complexity to jackpot betting, potentially attracting players who appreciate more nuanced betting options. This system also provides rich data for casinos to analyze player behavior and jackpot performance, allowing for continual refinement of the game offering.

Grand Paradise Jackpot™ Calculation and Distribution Technique #11—Time-Based Jackpot Multipliers that Increase the Longer a Specific Six-Card Combination Goes Unhit.

Description and Implementation: This innovative technique introduces dynamic jackpot multipliers that grow over time for each specific six-card combination in the Grand Paradise Jackpot™ system. As each combination remains unhit, its associated multiplier increases, creating escalating excitement and potential payouts. The system tracks the time elapsed since each combination was last hit, applying a predetermined growth rate to the multiplier.

Each ETGT displays a real-time update of these multipliers, showing players which combinations currently offer the highest potential payouts. The multipliers are applied to the base jackpot amount for each combination, potentially resulting in massive wins for long-unhit combinations.

The implementation may require sophisticated timing and tracking software integrated into the casino's central server and each ETGT. This system continuously monitors all active baccarat tables, updating multipliers in real-time. When a combination is hit, its multiplier resets to 1×, while others continue to grow.

To prevent multipliers from growing indefinitely, the system may implement caps or diminishing growth rates over extended periods. This ensures the jackpot remains financially viable for the casino while still offering substantial winning potential to players.

Benefits to Players: This system offers players a dynamic and exciting jackpot experience. The visible growth of multipliers creates a sense of urgency and opportunity, encouraging players to participate when they see high multipliers. It also adds an element of strategy, as players may choose to play more when certain combinations have high multipliers. The potential for enormous payouts on long-unhit combinations may create life-changing win opportunities, adding to the thrill of the game.

Benefits to Casinos: For casinos, this technique may significantly boost player engagement and jackpot participation. The constantly evolving multipliers create ongoing interest and excitement, potentially increasing the frequency and duration of play. It also provides natural marketing opportunities, as casinos may promote high multipliers to attract players. The system's ability to reset multipliers upon wins helps manage the overall jackpot liability while still offering attractive payouts.

Example Walk-Through Scenario: Mark enters the casino and notices the Grand Paradise Jackpot™ ETGTs displaying unusually high multipliers. He sees that the “Six Red Aces” combination currently has a 50× multiplier, having gone unhit for several weeks. Excited by the potential, Mark decides to play.

He sits at an ETGT and places a $10 jackpot side bet. As he plays, he watches the multipliers for various combinations continue to tick upward. After several hands, the “Five Black Kings and One Black Queen” combination is hit at another table. Mark watches as its multiplier resets to 1×, while others continue to grow.

Suddenly, on Mark's table, the dealer begins revealing a series of red Aces. The first four come out, and the ETGT's screen lights up with anticipation. The fifth red Ace appears, and the excitement in the area is palpable. Finally, the sixth card is revealed—another red Ace!

The ETGT erupts with lights and sounds, announcing the hit of the “Six Red Aces” combination with its 50× multiplier. Mark's $10 bet is now set to pay out an incredible amount. The screen shows the calculation: the base jackpot amount for this combination multiplied by 50, resulting in a multi-million dollar win.

Casino staff quickly verify the win, and Mark is escorted to process his massive jackpot payout, all thanks to the time-based multiplier system.

### Example System Procedural Flow

1. The central server initializes the jackpot system, setting base multipliers to 1× for all combinations.
2. ETGTs connect to the central server, receiving initial multiplier data.
3. As gameplay begins, the central server starts individual timers for each six-card combination.
4. The server applies the predetermined growth rate to each multiplier at regular intervals (e.g., hourly).
5. Updated multiplier information is broadcast to all connected ETGTs.
6. ETGTs display current multipliers and jackpot amounts to players.
7. Players place jackpot bets on their chosen ETGTs.
8. ETGTs transmit bet information to the central server.
9. As cards are dealt, ETGTs and the central server analyze the combinations in real-time.
10. If a jackpot combination is hit, the ETGT immediately notifies the central server.
11. The server verifies the win and calculates the payout using the current multiplier.
12. The winning combination's multiplier is reset to 1×, and its timer is restarted.
13. All ETGTs are updated with the new multiplier information and jackpot reset.
14. The server initiates the payout process for the winning player.
15. Surveillance and security systems are notified for win verification.
16. The jackpot accounting system is updated to reflect the win and new jackpot status.
17. Marketing systems are notified to update promotions based on current high multipliers.
18. The process continues, with multipliers growing until the next win occurs.

Noteworthy Aspects and Features: This Grand Paradise Jackpot™ calculation and distribution technique stands out for its dynamic nature, creating an ever-changing jackpot landscape. The visible growth of multipliers adds a new layer of excitement and strategy to jackpot participation. The system's ability to manage multiple combinations with individual multipliers demonstrates advanced tracking and calculation capabilities.

The integration of time-based elements into the jackpot system represents a significant innovation in electronic table games. It creates a sense of history and continuity across gaming sessions, potentially fostering player loyalty as they return to check on favorite combinations.

The flexible nature of the multiplier system allows casinos to fine-tune the growth rates and caps to balance excitement with financial responsibility. This adaptability ensures the long-term viability of the jackpot system while maintaining its appeal to players.

The real-time updating and display of multipliers across all ETGTs create a unified and immersive experience for players, regardless of which specific table they're playing at. This networked approach enhances the community aspect of the game, as all players may share in the excitement of growing multipliers and potential massive wins.

Grand Paradise Jackpot™ Calculation and Distribution Technique #12—Jackpot Awards Split Between the Triggering Player and Other Active Etgt Players Based on their Jackpot Bet Amounts.

Description and Implementation: This innovative technique introduces a community aspect to the Grand Paradise Jackpot™, where the jackpot award is splitbetween the triggering player and other active players at Electronic Table Game Terminals (ETGTs). The distribution is based on the respective jackpot bet amounts placed by each participating player.

The system tracks all active jackpot bets across the network of ETGTs in real-time. When a jackpot is triggered, the central server calculates the distribution of the award. The triggering player receives a significant portion (e.g., 50%) of the jackpot, while the remaining amount is divided among other active players proportionally to their bet sizes.

This implementation may require advanced networking capabilities to ensure all ETGTs are constantly synchronized with the central server. Each terminal may be able to quickly process incoming jackpot win information and display personalized payout amounts to players.

The system also incorporates safeguards to prevent abuse, such as minimum bet requirements for jackpot eligibility and time thresholds for bet placement to be considered “active” in a given round.

Benefits to Players: This approach creates a more inclusive jackpot experience, where multiple players may benefit from a single triggering event. It fosters a sense of community among players, as everyone actively betting on the jackpot has a stake in each hand. The shared nature of the jackpot may also lead to more frequent, albeit smaller, wins for players, increasing overall engagement and satisfaction.

Benefits to Casinos: For casinos, this technique may significantly boost player participation injackpot side bets. The increased frequency of payouts, even if smaller, may lead to higher overall bet volumes. The community aspect may create a more vibrant and exciting atmosphere on the casino floor, potentially attracting more players to the ETGTs. It also encourages longer play sessions, as players may be motivated to stay active to participate in potential shared jackpots.

Example Walk-Through Scenario: Sarah sits down at an ETGT and places a $20 jackpot side bet. She notices on the display that there are currently 50 active players participating in the jackpot across various ETGTs in the casino. As she plays, she sees other players joining and leaving the jackpot pool.

Several hands later, a player at another ETGT triggers the jackpot with a rare six-card combination. The screens on all active ETGTs light up with the announcement. Sarah watches as the system calculates the distribution of the $1,000,000 jackpot.

The triggering player receives 50% of the jackpot, or $500,000. The remaining $500,000 is to be split among the other active players, including Sarah. The system quickly determines that the total of all active jackpot bets is $1,000, of which Sarah's $20 bet represents 2%.

Sarah's screen displays her personalized win amount: 2% of $500,000, which is $10,000. She's thrilled to have won such a significant amount without even triggering the jackpot herself. Around her, other players are similarly celebrating their unexpected wins.

As the excitement settles, Sarah notices more players rushing to nearby ETGTs, eager to participate in the next round of jackpot betting. The shared win has created a palpable buzz throughout the baccarat area.

### Example System Procedural Flow

1. Players log into ETGTs and place jackpot side bets.
2. Each ETGT transmits bet information to the central server.
3. The server continuously updates the pool of active jackpot participants and their bet amounts.
4. As each baccarat hand is played, the system monitors for jackpot-triggering combinations.
5. When a jackpot is triggered, the ETGT immediately notifies the central server.
6. The server verifies the win and initiates the jackpot distribution process.
7. It calculates the triggering player's share (e.g., 50% of the total jackpot).
8. The remaining amount is pooled for distribution among other active players.
9. The server calculates each active player's share based on their bet amount relative to the total active bets.
10. Individual win amounts are transmitted to each eligible ETGT.
11. ETGTs display personalized win animations and amounts to players.
12. The central accounting system processes all payouts simultaneously.
13. Player balances are updated across all ETGTs.
14. The jackpot is reset to its starting amount.
15. The system logs all transaction details for auditing purposes.
16. Marketing systems are notified of the shared win for potential promotional use.
17. The jackpot betting pool is cleared, ready for the next round of bets.
18. ETGTs prompt players to place new jackpot bets for the next hand.

Noteworthy Aspects and Features: This Grand Paradise Jackpot™ calculation and distribution technique is particularly innovative in its community-oriented approach. By allowing multiple players to benefit from a single jackpot trigger, it creates a unique sense of shared excitement and camaraderie among ETGT players.

The real-time tracking and calculation of bet proportions demonstrate the sophisticated capabilities of the networked ETGT system. This instant processing ensures that players may immediately see their personalized win amounts, maintaining the excitement of the moment.

The flexible nature of the distribution system allows casinos to adjust the balance between the triggering player's reward and the shared pool, fine-tuning the experience to maximize player satisfaction and participation.

The implementation of safeguards against abuse, such as minimum bets and timing thresholds, shows foresight in maintaining the integrity of the jackpot system. This helps ensure fair play and maintains player trust in the system.

The potential for smaller, more frequent wins across a larger player base may lead to increased word-of-mouth marketing, as more players have positive jackpot experiences to share. This may be a powerful tool for attracting new players to the ETGTs and the casino in general.

Grand Paradise Jackpot™ Calculation and Distribution Technique #13—Cascading Jackpot Triggers where Hitting a Lower-Tier Combination has a Chance to Trigger Higher-Tier Jackpots.

Description and Implementation: This innovative technique introduces a multi-tiered jackpot system with cascading trigger potential, adding layers of excitement to the Grand Paradise Jackpot™. The system categorizes six-card combinations into tiers, with lower tiers being more common and higher tiers rarer and more valuable.

When a player hits a combination, they not only win that tier's jackpot but also have a chance to trigger the next tier up, and potentially cascade through multiple tiers. The probability of triggering the next tier decreases as the tiers increase, maintaining the exclusivity of top-tier jackpots.

Implementation may require sophisticated random number generation (RNG) integrated with the ETGT and central server systems. When a jackpot combination is hit, the system immediately awards that tier and then uses the RNG to determine if the next tier is triggered. This process may repeat through multiple tiers, with each successful trigger adding to the player's total win.

The ETGT displays feature dynamic animations showing the cascading process, building suspense as players watch to see how far their win may cascade. A community display board shows near-real-time updates of cascading wins across all connected ETGTs.

Benefits to Players: This system offers players the excitement of potentially turning a smaller win into a massive jackpot. It adds an extra layer of anticipation to every jackpot hit, as even lower-tier wins have the potential to become life-changing payouts. The tiered structure also provides more frequent wins at lower levels, maintaining engagement even when the top jackpots aren't hit.

Benefits to Casinos: For casinos, this technique may significantly increase player engagement and time spent at ETGTs. The potential for cascading wins encourages higher participation in jackpot side bets. The system also creates natural marketing opportunities, with the possibility of promoting stories of lower-tier wins that cascaded to major jackpots. The tiered structure allows for more control over jackpot frequency and sizes, helping to manage overall payouts while maintaining excitement.

Example Walk-Through Scenario: Tom sits down at an ETGT and places a $10 jackpot side bet. He's aware of the cascading jackpot system and hopes for a lucky break. As he plays, he watches other players hitting lower-tier jackpots, some cascading to higher tiers.

After several hands, Tom hits a Tier 3 combination. His screen lights up, announcing his initial win of $5,000. But then, a new animation begins, showing a chance to cascade to Tier 2. The ETGT builds suspense, finally revealing a successful trigger to Tier 2, adding $20,000 to Tom's win.

The excitement builds as the system now calculates for a Tier 1 trigger. The odds are lower, but the potential payout is massive. Tom and surrounding players watch in anticipation. Amazingly, the Tier 1 trigger hits! The ETGT erupts in lights and sound, announcing Tom's cascade to the top-tier jackpot of $500,000.

In total, Tom's initial $10 bet and Tier 3 hit has cascaded through all tiers, resulting in a total win of $525,000. The community board updates, showing Tom's spectacular cascade, and creating a buzz throughout the casino floor. Other players, inspired by Tom's win, increase their jackpot bets, hoping to replicate his lucky cascade.

### Example System Procedural Flow

1. Player logs into ETGT and places a jackpot side bet.
2. ETGT communicates bet information to the central server.
3. Live baccarat hand is dealt, with card information relayed to all ETGTs and the central server.
4. System analyzes the hand for jackpot combinations.
5. If a jackpot combination is hit, the system identifies the tier level.
6. ETGT displays the initial tier win to the player.
7. Central server initiates the cascading trigger process.
8. RNG system generates a number to determine if the next tier is triggered.
9. If triggered, the win amount is updated, and the process repeats for the next tier.
10. If not triggered, or after reaching the top tier, the final win amount is calculated.
11. ETGT displays the cascading process and final win amount to the player.
12. Central server updates the player's account with the total win.
13. Community display board is updated with the cascade result.
14. System logs all cascade details for auditing and analysis.
15. Marketing team is notified of significant cascades for promotional use.
16. Jackpot pools are adjusted based on the cascade results.
17. All ETGTs are updated with new jackpot amounts.
18. The system resets, ready for the next hand and potential cascade.

Noteworthy Aspects and Features: This Grand Paradise Jackpot™ calculation and distribution technique stands out for its ability to create multiple moments of excitement from a single jackpot hit. The cascading feature adds a unique twist to traditional jackpot structures, offering players a “second chance” (or more) with every win.

The integration of RNG technology for determining cascades demonstrates a sophisticated blend of predetermined jackpots and chance-based progression. This combination may help satisfy regulatory requirements while still offering an unpredictable and exciting player experience.

The tiered structure of the jackpot allows for more nuanced control over payout frequencies and amounts. This may help casinos manage their jackpot liability while still offering the potential for massive wins.

The real-time community display of cascading wins adds a social element to the game, potentially driving interest and participation.

Grand Paradise Jackpot™ Calculation and Distribution Technique #14—Dealer-Controlled Jackpot Bonus Rounds Initiated after Certain Partial Six-Card Combinations are Dealt.

Description and Implementation: This innovative technique introduces an interactive element to the Grand Paradise Jackpot™ system by allowing dealers to initiate special bonus rounds when certain partial six-card combinations appear during regular baccarat play. The system is designed to recognize near-miss scenarios, such as five out of six matching cards, and prompt the dealer to activate a bonus round.

Implementation may require enhanced software for the dealer's console, allowing them to trigger the bonus round with a simple touch interface. Each Electronic Table Game Terminal (ETGT) is equipped with a dedicated bonus round interface that activates when the dealer initiates the round. The central server coordinates the bonus round across all participating ETGTs, ensuring synchronization and fair play.

During the bonus round, players are presented with a selection of virtual cards or symbols on their ETGT screens. They must choose one or more options within a time limit, with each selection potentially adding to their jackpot win or advancing them to higher bonus levels. The dealer's role in initiating these rounds adds a human touch to the electronic system, creating a blend of traditional table game atmosphere with modem gaming technology.

The bonus rounds are designed with various themes and difficulty levels, providing diverse experiences for players. Some rounds may offer guaranteed small wins to all participants, while others present higher risk-reward scenarios for potentially larger payouts.

Benefits to Players: This system offers players additional chances to win jackpot amounts, even when the full six-card combination isn't achieved. The interactive nature of the bonus rounds increases engagement and gives players a sense of control over their jackpot destiny. The variety of bonus round themes keeps the experience fresh and exciting, encouraging repeated play.

Benefits to Casinos: For casinos, this technique may significantly boost player engagement and time spent at the ETGTs. The dealer's involvement in triggering bonus rounds maintains the important human element in electronic table games, potentially attracting players who enjoy traditional table game interactions. The bonus rounds also create natural breaks in gameplay, allowing for moment

Example Walk-Through Scenario: Lisa sits down at an ETGT and places her usual baccarat bets, including a $10 jackpot side bet. As the dealer reveals the cards, she notices that five out of six cards form a partial jackpot combination—all red Kings. The dealer's console lights up, prompting them to initiate a bonus round.

The dealer announces the bonus round, and Lisa's ETGT screen transforms into a themed interface. This round's theme is “Royal Treasure,” featuring a grid of facedown playing cards. Lisa has 30 seconds to select three cards from the grid.

She quickly taps her choices. The first card reveals a modest 5× multiplier on her original jackpot bet. The second card uncovers a “level up” symbol, advancing her to a higher-value grid. On this new level, her third selection unveils a impressive 50× multiplier.

The bonus round concludes, and Lisa's total win is calculated: her original $10 bet, multiplied by 55 (5+50), resulting in a $550 jackpot win. While not the full jackpot, Lisa is thrilled with this unexpected bonus from what started as a near-miss.

Around her, other players who participated in the jackpot bet are celebrating their own bonus round wins. The casino floor is buzzing with excitement, and Lisa notices more players rushing to nearby ETGTs, eager to join in for the next hand and potential bonus round.

### Example System Procedural Flow

1. The baccarat hand is dealt, and card information is relayed to all ETGTs and the central server.
2. The system detects a partial jackpot combination (e.g., 5 out of 6 matching cards).
3. The dealer's console alerts the dealer to the bonus round opportunity.
4. The dealer initiates the bonus round via their touch interface.
5. The central server activates the bonus round module and sends signals to all participating ETGTs.
6. ETGTs display the bonus round interface to eligible players (those who placed jackpot bets).
7. Players interact with the bonus round, making selections within the time limit.
8. Each player's selections are transmitted in real-time to the central server.
9. The server processes each selection, calculating wins or advancements.
10. Results are sent back to the ETGTs, which display outcomes to players.
11. If multiple bonus levels exist, steps 7-10 repeat for each level.
12. Upon completion of the bonus round, final win amounts are calculated for each player.
13. The central server updates player balances and jackpot pools accordingly.
14. Win information is logged for auditing and analysis purposes.
15. ETGTs return to the standard baccarat interface, displaying updated balances.
16. The dealer is notified that the bonus round is complete.
17. Regular baccarat play resumes, with the system reset to detect the next potential bonus round trigger.

Noteworthy Aspects and Features: This Grand Paradise Jackpot™ calculation and distribution technique stands out for its fusion of electronic gaming with traditional dealer interaction. By allowing dealers to initiate bonus rounds, it maintains the human touch that many players appreciate in table games, while leveraging the capabilities of electronic systems for complex bonus features.

The adaptability of the bonus round system, with various themes and difficulty levels, allows casinos to keep the jackpot experience fresh and engaging over time. This may be particularly effective in encouraging repeat visits from players eager to experience new bonus round variations.

The use of near-miss scenarios to trigger bonus rounds adds an extra layer of excitement to every hand, as players know that even falling short of the full jackpot combination may lead to significant wins. This may help maintain high levels of player engagement and jackpot participation.

The real-time, synchronized bonus rounds across multiple ETGTs create a communal gaming experience, fostering a sense of shared excitement among players. This community aspect may enhance the overall atmosphere of the casino floor and potentially lead to increased player retention.

Grand Paradise Jackpot™ Calculation and Distribution Technique #15—Integration with Player Tracking Systems to Offer Personalized Jackpot Multipliers for Specific Six-Card Combinations.

Description and Implementation: This innovative technique leverages the casino's player tracking system to offer personalized jackpot multipliers to players based on their gaming history and preferences. The system analyzes player data to assign custom multipliers for specific six-card combinations in the Grand Paradise Jackpot™

Implementation may require a sophisticated integration between the ETGT network, the central jackpot server, and the casino's player tracking database. When a player logs into an ETGT with their player card, the system retrieves their profile and calculates personalized multipliers based on predefined criteria such as play frequency, average bet size, and past jackpot participation.

These personalized multipliers are then displayed on the ETGT screen, showing players their enhanced potential payouts for each six-card combination. The multipliers may vary widely, from small boosts for newer players to significant multipliers for high-value or loyal customers.

The system updates these multipliers in real-time based on the player's current session, potentially increasing multipliers for extended play or higher betting volumes. Additionally, the casino may use this system to run targeted promotions, temporarily boosting multipliers for specific player segments or during certain time periods.

Benefits to Players: This system offers players a tailored jackpot experience that rewards their loyalty and playing style. The personalized multipliers give players a sense of exclusivity and added value, potentially encouraging higher jackpot participation. Players may see tangible benefits from their continued play and loyalty to the casino, beyond traditional comp points or tier benefits.

Benefits to Casinos: For casinos, this technique may significantly enhance player loyalty and increase jackpot participation. The personalized nature of the multipliers allows for more targeted marketing and player retention strategies. It also provides another avenue for differentiating high-value players, potentially increasing their play time and bet sizes. The system generates rich data on player preferences and behaviors, allowing for continual refinement of marketing and game offerings.

Example Walk-Through Scenario: Mark, a regular at the casino, sits down at an ETGT and inserts his player card. The screen welcomes him by name and displays his personalized jackpot multipliers. Due to his frequent play and high average bets, Mark sees that his multiplier for the “Six Red Aces” combination is an impressive 3× the standard jackpot amount.

Excited by this personalized offer, Mark places a $50 jackpot side bet, higher than his usual wager. As he plays, he notices his multipliers increasing slightly with each hand, rewarding his continued play.

Several hands later, the dealer reveals a sequence of cards that completes the “Six Red Aces” combination. The ETGT screen erupts with lights and sound, announcing Mark's incredible win. The standard jackpot for this combination is $1,000,000, but with Mark's personalized 3× multiplier, his payout is calculated at an astonishing $3,000,000.

As casino staff verify the win, Mark notices other players around him checking their own personalized multipliers and increasing their jackpot bets. The personalized system has not only rewarded Mark's loyalty with a life-changing win but has also sparked increased interest and participation from surrounding players.

### Example System Procedural Flow

1. Player inserts their card into the ETGT, triggering a login process.
2. ETGT sends player identification to the central server.
3. Server queries the player tracking database for the player's history and status.
4. Based on predefined criteria, the server calculates personalized multipliers for each jackpot combination.
5. Multiplier information is sent back to the ETGT and displayed to the player.
6. Player places their bets, including jackpot side bets.
7. As the game progresses, the ETGT continuously sends betting data to the server.
8. The server updates the player's profile and adjusts multipliers in real-time if necessary.
9. If a jackpot is triggered, the server immediately calculates the enhanced payout based on the personalized multiplier.
10. The winning amount is verified and communicated back to the ETGT.
11. ETGT displays the win amount and animation to the player.
12. The central accounting system processes the payout.
13. Player tracking database is updated with the win information.
14. Marketing systems are notified for potential promotional follow-ups.
15. The server analyzes the win data to refine future multiplier calculations.
16. If the player continues playing, the process repeats from step 6, with potentially adjusted multipliers.

Noteworthy Aspects and Features: This Grand Paradise Jackpot™ calculation and distribution technique stands out for its high level of personalization, creating a unique jackpot experience for each player. The integration of player tracking data with real-time jackpot multipliers demonstrates a sophisticated use of casino information systems to enhance game play.

The dynamic nature of the multipliers, adjusting based on current play patterns, adds an element of gamification to the jackpot system. This may encourage longer play sessions and higher bet volumes as players see their potential payouts increasing.

The system's ability to support targeted promotions through temporary multiplier boosts provides a powerful tool for casino marketing efforts. This may be particularly effective for reactivating lapsed players or driving traffic during typically slower periods.

The rich data generated by this system, including player responses to different multiplier levels, may provide valuable insights for game development and casino operations. This data-driven approach to jackpot design represents a significant advancement in electronic table game systems.

### Grand Paradise Jackpot™ Calculation and Distribution Technique #16—Multi-Table Linked Grand Paradise Jackpot™s Across Multiple Live Baccarat Streams, Evaluated on a Per-Shoe Basis.

Description and Implementation: This innovative technique expands the scope of the Grand Paradise Jackpot™ by linking multiple live baccarat tables, each with its own live stream, into a unified jackpot system. The jackpot is evaluated on a per-shoe basis, allowing for more frequent jackpot opportunities and creating a sense of shared excitement across different tables and potentially different casino locations.

Implementation may require a robust networking infrastructure to connect all participating tables and their associated ETGTs to a central jackpot server. Each table's shoe is equipped with RFID or optical scanning technology to track cards as they're dealt. The system aggregates data from all active shoes across the linked tables, evaluating for jackpot-winning combinations on a continuous basis.

Players at any linked ETGT may participate in the shared jackpot, regardless of which specific table they're playing on. The ETGTs display a unified jackpot amount, updated in real-time, along with information about active shoes across all linked tables.

The system also implements a fair distribution mechanism for cases where winning combinations occur simultaneously at different tables. This may involve splitting the jackpot proportionally based on bet amounts or triggering multiple full payouts, depending on casino preferences.

Benefits to Players: This system offers players increased chances of hitting a jackpot, as they're effectively participating in multiple games simultaneously. The larger player pool typically results in faster-growing jackpot amounts, creating the potential for more substantial wins. Players also benefit from the excitement of being part of a larger gaming community, with jackpot events potentially occurring at any linked table.

Benefits to Casinos: For casinos, this technique may significantly increase player engagement and jackpot participation across multiple tables. It allows for more efficient use of floor space, as every table becomes part of a larger, more attractive jackpot system. The linked nature of the jackpot may also encourage players to explore different tables and potentially different areas of the casino, increasing overall foot traffic.

Example Walk-Through Scenario: Sarah enters the casino and notices a large display showing the Grand Paradise Jackpot™ amount, currently at $5,000,000. The display indicates that the jackpot is linked across 20 live baccarat tables, with 15 shoes currently in play.

She sits at an ETGT and places a $25 jackpot side bet. Her screen shows her table's shoe progress, but also displays a minimized view of all active shoes. As she plays, she watches the jackpot amount climbing rapidly, fueled by bets from players across all linked tables.

Suddenly, her screen lights up with an alert. A jackpot-winning combination has occurred, but not at her table. The notification shows that a player at Table 12, three floors up, has hit the winning combination.

The system quickly calculates the distribution. In this case, the casino has opted for a split payout system. The triggering player at Table 12 receives 50% of the jackpot, while the remaining 50% is distributed among all other active jackpot bettors, proportional to their bet amounts.

Sarah's $25 bet represents 0.1% of the total active jackpot bets. She's thrilled to see that she's won 0.1% of the $2,500,000 distributed pool, earning her a surprise payout of $2,500.

As the excitement settles, Sarah notices the jackpot resetting to its base amount. The ETGTs around her are buzzing with activity as players, energized by the recent win, place new bets for the next round of multi-table linked play.

### Example System Procedural Flow

1. Player logs into an ETGT at any linked baccarat table.
2. ETGT displays current jackpot amount and active shoe information from all linked tables.
3. Player places a jackpot side bet, which is recorded by the central server.
4. As cards are dealt at each table, shoe scanning technology relays card information to the central server.
5. The server continuously evaluates all active shoes for jackpot-winning combinations.
6. ETGTs are updated in real-time with jackpot amounts and shoe statuses.
7. When a winning combination occurs, the triggering ETGT immediately notifies the central server.
8. The server verifies the win and initiates the jackpot distribution process.
9. If simultaneous wins occur, the server applies predetermined distribution rules.
10. The server calculates individual payout amounts for all active jackpot bettors.
11. Payout information is sent to each ETGT with an active jackpot bet.
12. ETGTs display win animations and payout amounts to players.
13. The central accounting system processes all payouts simultaneously.
14. The jackpot is reset to its starting amount across all linked tables.
15. The system logs all transaction details for auditing purposes.
16. Marketing systems are notified of the jackpot hit for promotional use.
17. All ETGTs prompt players to place new jackpot bets for the next round.

Noteworthy Aspects and Features: This Grand Paradise Jackpot™ calculation and distribution technique stands out for its ability to create a unified jackpot experience across multiple tables and potentially multiple casino locations. The per-shoe evaluation method ensures frequent jackpot opportunities, maintaining high levels of player engagement.

The real-time aggregation and display of data from multiple shoes demonstrate sophisticated networking and data processing capabilities. This creates a dynamic and information-rich gaming environment for players.

The flexible distribution system for simultaneous wins shows foresight in managing complex jackpot scenarios, ensuring fair and exciting outcomes for all participants.

The potential for this system to link tables across different casino properties opens up new possibilities for multisite progressive jackpots, which may be particularly attractive for larger casino groups or gaming jurisdictions looking to create jurisdiction-wide jackpot offerings.

### Grand Paradise Jackpot™ Calculation and Distribution Technique #17—Jackpot Eligibility Tied to Minimum Bet Thresholds on the Main Baccarat Game for Each Shoe.

Description and Implementation: This innovative technique introduces a dynamic relationship between a player's main game bets and their eligibility for the Grand Paradise Jackpot™. The system sets minimum bet thresholds for the main baccarat game that players must meet or exceed to qualify for jackpot participation. These thresholds are calculated on a per-shoe basis, allowing for flexibility and encouraging consistent play.

Implementation may require advanced tracking software integrated into each Electronic Table Game Terminal (ETGT) and the central server. The system continuously monitors players' betting patterns throughout each shoe, calculating their average bet size and total wager amount. Threshold levels may be set by the casino and may vary based on factors such as time of day, table limits, or player tier status.

ETGTs display real-time information about a player's current betting status and jackpot eligibility. Visual indicators, such as progress bars or color-coded displays, show how close a player is to meeting or maintaining the threshold. When a player reaches the required level, the ETGT prominently displays their eligible status and may trigger celebratory animations.

The central server manages threshold calculations and eligibility determinations across all connected ETGTs. It also allows for dynamic adjustments to thresholds based on overall player activity or specific promotional periods.

Benefits to Players: This system rewards players for their engagement in the main baccarat game by granting access to potentially life-changing jackpots. It creates a clear link between regular play and jackpot opportunities, providing additional motivation for players to maintain or increase their betting levels. The visual feedback on progress towards eligibility adds an element of gamification to the betting process, potentially enhancing the overall gaming experience.

Benefits to Casinos: For casinos, this technique may drive higher betting volumes in the main baccarat game, potentially increasing overall revenue. It encourages players to maintain consistent betting levels throughout a shoe, which may lead to longer play sessions. The system also provides a natural way to differentiate between casual and more serious players, allowing for more targeted marketing and comp strategies.

Example Walk-Through Scenario: Tom sits down at an ETGT and begins playing baccarat. The screen displays that the current jackpot eligibility threshold for this shoe is an average bet of $50 per hand, with a minimum of 20 hands played. Tom usually bets $25 per hand but decides to increase his bets to qualify for the jackpot.

As Tom plays, a progress bar on his screen fills, showing his advancement towards jackpot eligibility. After 15 hands at $50 each, the display indicates he's 75% of the way to qualification. Excited by his progress, Tom continues playing.

On his 20th hand, having maintained his $50 average bet, the ETGT screen erupts in a celebratory animation. A message appears: “Congratulations! You've qualified for the Grand Paradise Jackpot™!” The jackpot bet option, previously grayed out, now becomes active.

Tom immediately places a $10 jackpot side bet. Two hands later, a rare six-card combination appears, triggering the jackpot. Because Tom had qualified and placed a jackpot bet, he wins a substantial payout. Had he not met the threshold, he would have missed this opportunity.

As news of Tom's win spreads, other players at nearby ETGTs start increasing their bets, striving to meet the eligibility threshold and participate in the next jackpot opportunity.

### Example System Procedural Flow

1. Casino management sets jackpot eligibility thresholds for each baccarat table or gaming floor section.
2. Player begins a session at an ETGT, which displays current threshold requirements.
3. As the player places main game bets, the ETGT transmits bet amounts to the central server.
4. The server continuously calculates the player's average bet and hand count for the current shoe.
5. ETGT updates its display with the player's progress towards jackpot eligibility.
6. If the player meets the threshold, the server flags their account as jackpot-eligible.
7. ETGT receives eligibility confirmation and activates jackpot betting options for the player.
8. Player may now place jackpot side bets along with their main game wagers.
9. The system continues to monitor the player's betting pattern to ensure maintained eligibility.
10. If the player's average falls below the threshold, a warning is displayed on the ETGT.
11. The central server regularly analyzes overall betting patterns and may adjust thresholds dynamically.
12. When a new shoe begins, the eligibility tracking resets, and the process starts over.
13. In the event of a jackpot trigger, the server verifies the eligibility of all participating players.
14. Only eligible players who placed jackpot bets are included in the payout calculations.
15. The system logs all eligibility data and jackpot participations for future analysis and player comping purposes.

Noteworthy Aspects and Features: This Grand Paradise Jackpot™ calculation and distribution technique stands out for its direct linkage between main game play and jackpot opportunities. By tying eligibility to betting thresholds, it creates a more immersive and integrated jackpot experience that goes beyond simple side bets.

The dynamic nature of the eligibility tracking, resetting with each new shoe, adds an element of freshness and opportunity to every gaming session. This may help maintain player engagement over extended periods.

The visual feedback system, with progress bars and real-time updates, gamifies the betting process. This not only enhances the player experience but also subtly encourages increased betting to reach and maintain eligibility.

The flexibility for casinos to adjust thresholds based on various factors allows for sophisticated yield management strategies. This may be particularly effective for balancing jackpot participation rates with overall house edge and profitability goals.

The system's ability to track and analyze betting patterns provides valuable data for casino operations, potentially informing decisions on table limits, marketing strategies, and player development efforts.

### Grand Paradise Jackpot™ Calculation and Distribution Technique #18—Random Mystery Jackpot Awards Tied to Specific Subsets of the 22 Possible Six-Card Combinations.

Description and Implementation: This innovative technique introduces an element of surprise and anticipation to the Grand Paradise Jackpot™ system by implementing random mystery jackpot awards tied to specific subsets of the 22 possible six-card combinations in baccarat. Instead of players aiming for predetermined combinations, the system randomly selects a subset of combinations before each shoe, keeping the winning criteria a mystery until a jackpot is triggered.

Implementation may require advanced random number generation (RNG) software integrated with the central jackpot server. Before each shoe begins, the system randomly selects a subset of the possible six-card combinations, assigning them as mystery jackpot triggers. The size of this subset may vary, adding another layer of unpredictability.

Each Electronic Table Game Terminal (ETGT) displays an enigmatic interface that hints at the mystery nature of the jackpot without revealing specific combinations. As cards are dealt, the system tracks the appearances of various combinations, building tension as players wonder which may be the hidden triggers.

When a mystery combination is completed, the jackpot is triggered, and the winning combination is revealed across all ETGTs. This creates moments of shared excitement and surprise among all players.

Benefits to Players: This system offers players a unique and suspenseful jackpot experience. The mystery element adds excitement to every hand, as any combination may potentially be a winner. It also levels the playing field, as all combinations have an equal chance of being selected as triggers, rather than always focusing on the rarest combinations.

Benefits to Casinos: For casinos, this technique may significantly increase player engagement and jackpot participation. The mystery element creates natural talking points and shared experiences among players, potentially enhancing the social aspect of the game. The random nature of the triggers also allows for more control over jackpot frequency and sizes, helping to manage overall payouts while maintaining excitement.

Example Walk-Through Scenario: Lisa sits down at an ETGT and notices the intriguing “Mystery Jackpot” display. The screen shows shadowed card outlines, hinting at hidden winning combinations. Intrigued, she places her usual baccarat bets along with a $20 jackpot side bet.

As the shoe progresses, Lisa watches the mystery display animate subtly with each hand, building anticipation. After several hands, a combination of four black 10s appears. Suddenly, the ETGT erupts in lights and sound. The mystery is revealed: four black 10s was one of the randomly selected winning combinations for this shoe!

The screen displays the full set of mystery combinations for this shoe, showing that Lisa has hit one of five possible triggers. Her $20 side bet has won her a substantial mystery jackpot of $50,000.

Around her, other players react with a mix of excitement and surprise. Some had noticed the frequency of black 10s but hadn't realized it was a potential trigger. The revelation of the other mystery combinations creates buzz as players speculate on their chances in the next shoe.

As the next shoe begins, a new set of mystery combinations is generated, and the excitement builds anew.

### Example System Procedural Flow:

1. Before each shoe, the central server's RNG selects a subset of six-card combinations as mystery triggers.
2. The selected combinations are securely stored and not revealed to players or staff.
3. ETGTs display a cryptic interface indicating the mystery jackpot is active.
4. Players place their main game and jackpot side bets.
5. As cards are dealt, the central server tracks the appearance of all combinations.
6. ETGTs update their mystery displays, hinting at progress without revealing specifics.
7. If a mystery combination is completed, the server immediately flags it as a jackpot trigger.
8. All connected ETGTs are notified of the jackpot win.
9. The winning combination and full set of mystery combinations for that shoe are revealed across all ETGTs.
10. The server calculates payouts based on jackpot side bets and predetermined prize structures.
11. Winning players' accounts are credited with their jackpot winnings.
12. The system logs all details of the trigger and payout for auditing purposes.
13. As the next shoe begins, the process repeats with a new set of mystery combinations.
14. The server analyzes trigger frequency and adjusts the subset size or selection criteria if necessary to maintain desired jackpot frequency.

Noteworthy Aspects and Features: This Grand Paradise Jackpot™ calculation and distribution technique stands out for its ability to create suspense and shared excitement among players. The mystery element adds a new dimension to the jackpot experience, moving beyond traditional visible progressive meters.

The use of RNG technology to select trigger combinations for each shoe ensures fairness and unpredictability, which may be notable for regulatory compliance and player trust. This dynamic system also prevents players from developing strategies to target specific combinations, maintaining the game's integrity.

The flexibility in selecting the number and type of trigger combinations allows casinos to fine-tune the jackpot frequency and size. This adaptability may be particularly useful for managing jackpot liabilities while still offering attractive potential payouts.

The reveal of all mystery combinations at the end of each trigger event creates an educational moment for players, potentially increasing their engagement and understanding of the game's possibilities. This may lead to increased participation in subsequent shoes.

The system's ability to track and analyze trigger frequencies provides valuable data for ongoing game refinement and marketing strategies. Casinos may use this information to optimize the jackpot offering and create targeted promotions based on popular or rare combinations.

### Grand Paradise Jackpot™ Calculation and Distribution Technique #19—Jackpot Award Ceremonies Customized for Live Streaming Environments, Featuring the Six Triggering Cards.

Description and Implementation: This innovative technique elevates the Grand Paradise Jackpot™ experience by introducing elaborate, customized award ceremonies designed specifically for live streaming environments. When a jackpot is triggered, the system initiates a multi-media celebration that showcases the six winning cards and creates a spectacle for both in-person and online audiences.

Implementation may require integration of advanced audio-visual systems with the existing ETGT network and central server. Each baccarat table is equipped with additional cameras and lighting rigs that activate during a jackpot win. The dealer's station includes a special ceremonial area where the six triggering cards are dramatically revealed.

The central server coordinates the ceremony, syncing the physical card reveal with digital effects displayed across all connected ETGTs and streaming platforms. A dedicated master of ceremonies (MC) is alerted to jackpot wins and provides live commentary, adding a personal touch to the digital celebration.

The ceremony is designed in segments, allowing for seamless integration of sponsorship opportunities and player interviews. The six cards are revealed one by one, building suspense, with each reveal accompanied by unique visual and sound effects.

Benefits to Players: This system transforms a jackpot win from a mere payout into an unforgettable experience. Winners enjoy their moment in the spotlight, while other players share in the excitement and spectacle. The ceremonies create aspirational moments that may enhance overall player engagement and loyalty.

Benefits to Casinos: For casinos, these ceremonies provide powerful marketing opportunities, illustrating big wins to wide audiences through live streams. The spectacle may attract new players and encourage higher participation in jackpot side bets. The segmented nature of the ceremonies also opens up new sponsorship and advertising possibilities.

Example Walk-Through Scenario: Jack is playing baccarat via a live stream on his tablet when he hits the Grand Paradise Jackpot™. Immediately, the stream switches to a wide-angle view of the table, where spotlights suddenly illuminate the area. The dealer carefully moves the six winning cards to the ceremonial area as an MC appears on screen, announcing the jackpot hit.

The MC introduces Jack, who appears via video call on a large screen visible to both in-person and streaming audiences. As Jack expresses his shock and joy, the MC begins the card reveal ceremony. Each card is dramatically flipped over, with accompanying music and digital effects across all viewing platforms.

Between card reveals, the MC engages Jack in banter, asking about his betting strategy and plans for the winnings. The stream's chat is ablaze with congratulations and excitement from viewers. Sponsorship messages are subtly integrated, with branded animations accompanying each card reveal.

As the final card is turned, confetti cannons fire in the physical casino while a dazzling digital fireworks display covers streaming screens. The MC announces the final jackpot amount, and Jack's reaction is captured for all to see. The ceremony concludes with a recap of the winning combination and an invitation for viewers to join the next game for their chance at a similar experience.

### Example System Procedural Flow

1. Jackpot win is detected by the central server.
2. Server immediately notifies the AV control system and alerts the MC.
3. Live streams are seamlessly transitioned to the wide-angle jackpot ceremony view.
4. Physical spotlights and special effects are activated at the winning table.
5. Dealer carefully transfers the six winning cards to the ceremonial area.
6. MC is given winner details through an earpiece and begins the ceremony.
7. Winner is connected via video call, which is displayed on in-casino screens and the live stream.
8. Server cues the card reveal sequence, synchronizing physical and digital elements.
9. Each card reveal triggers specific animations and effects across all ETGTs and streams.
10. Between reveals, the system cues sponsorship messages and animations.
11. The central server calculates and verifies the final jackpot amount during the ceremony.
12. After the final reveal, the server triggers the culmination of visual and audio effects.
13. MC announces the official jackpot amount and concludes the ceremony.
14. System transitions streams back to normal game view and resets ceremonial elements.
15. A condensed video of the ceremony is immediately produced and made available for social media sharing.
16. The server logs all ceremony details for future analysis and marketing use.

Noteworthy Aspects and Features: This Grand Paradise Jackpot™ calculation and distribution technique stands out for its focus on creating a shared, memorable experience around jackpot wins. By designing ceremonies specifically for live streaming, it bridges the gap between physical and online play, creating a unified jackpot community.

The integration of physical elements (like the ceremonial card reveal area) with digital effects demonstrates a sophisticated blend of traditional casino atmosphere and modem technology. This may appeal to both traditional baccarat players and younger, tech-savvy audiences.

The involvement of a live MC adds a human touch to the digital experience, creating opportunities for genuine moments of excitement and interaction that may resonate with viewers. This personal element may significantly enhance the aspirational aspect of the jackpot.

The segmented nature of the ceremony, with individual card reveals, creates natural breaks for sponsorship integration. This opens up new revenue streams for casinos, potentially offsetting some of the costs associated with large jackpot payouts.

The automatic generation of shareable ceremony recap videos leverages the power of social media for organic marketing. Winners sharing their experiences may create powerful testimonials that attract new players to the game.

Grand Paradise Jackpot™ Calculation and Distribution Technique #20—Adaptive Jackpot Algorithms that Adjust Award Frequencies Based on the Occurrence of Partial Matching Combinations.

Description and Implementation: This innovative technique introduces a dynamic jackpot system that adapts in real-time based on the frequency of partial matching combinations occurring during gameplay. The system uses advanced algorithms to analyze card distributions and adjust jackpot award frequencies to maintain optimal excitement and fairness.

Implementation may require sophisticated machine learning algorithms integrated into the central jackpot server. The system continuously monitors all hands played across connected Electronic Table Game Terminals (ETGTs), tracking the occurrence of partial matches (e.g., 3, 4, or 5 cards of a winning combination). Based on this data, the algorithm adjusts the probability of a full jackpot trigger in real-time.

For example, if the system detects an unusually high number of 5-card partial matches, it may slightly increase the probability of the 6th card completing a jackpot combination. Conversely, if partial matches are scarce, the system may marginally decrease the jackpot probability to build suspense and allow the jackpot pool to grow.

The ETGTs display a “Hot” or “Cold” indicator, giving players a sense of the current jackpot climate without revealing specific probabilities. This adds an extra layer of excitement and strategy to jackpot participation.

Benefits to Players: This system offers players a more dynamic and potentially more frequent jackpot experience. The adaptive nature means that jackpots are more to trigger during periods of “hot” gameplay, creating a sense of momentum and excitement. The visible indicators allow players to make more informed decisions about their jackpot participation.

Benefits to Casinos: For casinos, this technique helps maintain an optimal balance between jackpot frequency and pool growth. The adaptive system may prevent excessively long periods without a jackpot win, which may discourage player participation. It also allows for more predictable long-term jackpot performance, aiding in financial planning and risk management.

Example Walk-Through Scenario: Emma sits down at an ETGT and notices the jackpot indicator showing “Warm.” Intrigued, she places her usual baccarat bets along with a jackpot side bet. As she plays, she observes several hands where 4 or 5 cards of potential jackpot combinations appear.

The “Warm” indicator changes to “Hot,” and Emma decides to increase her jackpot side bet. Two hands later, a full 6-card combination hits, triggering the jackpot. Emma's increased bet pays off as she wins a substantial jackpot amount.

As play continues, Emma notices the indicator has reset to “Cold.” She decides to reduce her jackpot bets temporarily, planning to increase them again when the indicator shows more favorable conditions.

### Example System Procedural Flow

1. The central server initializes the jackpot system with baseline probabilities.
2. As games are played, each ETGT sends hand results to the central server.
3. The server's algorithm analyzes the frequency of partial matching combinations.
4. Based on this analysis, the system adjusts jackpot trigger probabilities in real-time.
5. Updated probability information is sent to all connected ETGTs.
6. ETGTs update their “Hot/Cold” indicators based on the new probabilities.
7. Players place their bets, including jackpot side bets.
8. When a hand is played, the server uses the current adjusted probabilities to determine if a jackpot is triggered.
9. If a jackpot is won, the server resets probabilities to baseline and updates all ETGTs.
10. The system continuously loops through steps 3-9, constantly adapting to gameplay patterns.

Noteworthy Aspects and Features: This Grand Paradise Jackpot™ calculation and distribution technique stands out for its use of advanced algorithms to create a responsive and engaging jackpot experience. The adaptive nature of the system ensures that the jackpot remains exciting and attainable, regardless of short-term fluctuations in card distributions.

The “Hot/Cold” indicator adds a new strategic element to jackpot betting, potentially increasing player engagement and time spent at the ETGTs. This feature also creates talking points among players, enhancing the social aspect of the game.

The system's ability to balance jackpot frequency with pool growth demonstrates a sophisticated approach to jackpot management. This may help casinos optimize their jackpot offerings for both player appeal and financial sustainability.

The use of machine learning algorithms showcases the potential for AI integration in casino games, opening up possibilities for further innovations in game design and player experience optimization.

Grand Paradise Jackpot™ Calculation and Distribution Technique #21—Dealer-Initiated Jackpot Bonus Features to Increase Player Engagement when Certain Ranks or Colors are Prevalent in a Shoe.

Description and Implementation: This technique introduces an interactive element to the Grand Paradise Jackpot™ system by allowing dealers to initiate special bonus features when they notice certain patterns or prevalences of card ranks or colors in a shoe. This human-driven intervention adds an exciting and unpredictable dimension to the jackpot experience.

Implementation may require an enhanced dealer console integrated with the ETGT network and central server. The console includes a secure interface that allows the dealer to trigger various pre-programmed bonus features based on their observation of the cards dealt.

For example, if the dealer notices an abundance of red cards, they may initiate a “Red Rush” bonus where jackpot odds are temporarily increased for red card combinations. Similarly, a prevalence of face cards may trigger a “Royal Flush” bonus with special payouts for face card combinations.

When a dealer activates a bonus feature, all connected ETGTs display animated notifications, and the central server adjusts jackpot calculations accordingly for the duration of the bonus period.

Benefits to Players: This system offers players surprise bonus opportunities that break up the regular flow of gameplay. The dealer-initiated features add a human touch to the electronic system, creating a blend of traditional table game excitement with modern jackpot mechanics. Players also benefit from the dealer's expertise in recognizing potentially favorable shoe compositions.

Benefits to Casinos: For casinos, this technique may significantly boost player engagement and jackpot participation. The unpredictable nature of the bonus features encourages consistent play and attentiveness. It also allows for more dynamic control over the jackpot experience, potentially increasing overall game profitability.

Example Walk-Through Scenario: John is playing at an ETGT when the dealer announces, “I'm seeing a lot of face cards in this shoe. Time for a Royal Flush bonus!” The ETGT screens light up with a crown animation, indicating the bonus is active.

John, excited by the opportunity, increases his jackpot side bet. As play continues, the ETGTs display a timer showing how long the bonus will last. During this period, any jackpot combinations involving face cards offer enhanced payouts.

Near the end of the bonus period, a jackpot combination hits that includes three kings. Thanks to the active bonus, John's payout is significantly higher than it would have been under normal circumstances.

As the bonus ends, players at the ETGTs discuss the excitement and speculate on what pattern the dealer may notice next.

### Example System Procedural Flow

1. Dealer observes a notable pattern in the cards being dealt.
2. Dealer accesses the secure bonus activation interface on their console.
3. Dealer selects the appropriate bonus feature based on the observed pattern.
4. The dealer console sends the bonus activation signal to the central server.
5. The server verifies the dealer's authorization and activates the selected bonus feature.
6. All connected ETGTs are notified of the active bonus, displaying appropriate animations and information.
7. The server adjusts jackpot calculations based on the active bonus parameters.
8. Players are given a short window to adjust their bets in light of the new bonus.
9. Gameplay continues with the bonus active for a predetermined duration or number of hands.
10. The server continuously monitors for qualifying jackpot hits during the bonus period.
11. If a qualifying jackpot is hit, the server calculates the enhanced payout based on bonus rules.
12. At the end of the bonus period, the server resets jackpot calculations to standard parameters.
13. ETGTs display a bonus summary, showing any significant wins during the period.
14. The system logs all bonus activations and results for analysis and auditing purposes.

Noteworthy Aspects and Features: This Grand Paradise Jackpot™ calculation and distribution technique stands out for its blend of human intuition and electronic gaming technology. By allowing dealers to initiate bonus features, it maintains the important human element that many players appreciate in table games.

The system's ability to quickly adjust jackpot calculations and payouts demonstrates sophisticated real-time processing capabilities. This flexibility allows for a diverse range of bonus features that may keep the jackpot experience fresh and exciting for regular players.

The visual feedback on ETGTs, with animations and timers, adds to the excitement and helps create a shared experience among all players at the table. This may enhance the social aspect of the game and encourage discussion and engagement among players.

The logging and analysis of bonus activations provide valuable data for casino management. This information may be used to refine bonus offerings, train dealers on optimal activation timing, and develop marketing strategies around popular bonus features.

Grand Paradise Jackpot™ Calculation and Distribution Technique #22—Progressive Jackpot Tiers that Correspond to Specific Suits within the Red and Black Color Groups.

Description and Implementation: This technique introduces a multi-tiered progressive jackpot system that corresponds to specific suits within the red and black color groups in baccarat. Instead of a single jackpot, players have the opportunity to win different levels of progressives based on the suits of the six-card combinations.

Implementation may require advanced tracking software integrated into each ETGT and the central server. The system maintains four separate progressive pools, one for each suit: Spades, Hearts, Diamonds, and Clubs. Each pool grows independently based on a portion of jackpot side bets placed.

The jackpot tiers are structured as follows:
1. Royal Flush (all cards of the same suit): 100% of that suit's progressive pool
2. Six of a Kind (same rank, mixed suits within a color): 50% of the combined pools for that color
3. Straight Flush (sequential ranks, same suit): 25% of that suit's progressive pool
4. Color Flush (all six cards of the same color): 10% of the combined pools for that color

ETGTs display real-time updates of all four progressive pools, creating a visually engaging interface that showcases the growing jackpot amounts for each suit.

Benefits to Players: This system offers players multiple ways to win substantial jackpots, increasing the overall excitement and potential for payouts. The suit-specific progressives add a new layer of strategy to jackpot betting, as players may favor certain suits based on pool sizes or personal preferences.

Benefits to Casinos: For casinos, this technique may drive higher participation in jackpot side bets due to the multiple winning possibilities. The tiered structure allows for more frequent, smaller payouts alongside the potential for massive wins, helping to maintain player interest and engagement over time.

Example Walk-Through Scenario: Lisa approaches an ETGT and sees four progressive meters displayed, one for each suit. The Spades jackpot is significantly higher than the others, catching her attention. She places her regular baccarat bets and adds a $10 jackpot side bet.

As the game progresses, Lisa watches the progressive meters slowly climbing. Suddenly, the dealer reveals a sequence of six spades. The ETGT erupts with lights and sound, announcing a Royal Flush jackpot in Spades.

Lisa's $10 side bet has won her 100% of the Spades progressive pool, a substantial sum that had been building for weeks. As she celebrates, she notices the Spades meter reset to its base amount, while the other suit progressives continue to grow.

In the next shoe, another player hits a Six of a Kind in red (three hearts and three diamonds). This triggers a payout of 50% of the combined Hearts and Diamonds pools, illustrating the diverse winning possibilities of the system.

### Example System Procedural Flow

1. Player logs into an ETGT, which displays current progressive amounts for all four suits.
2. Player places main game bets and a jackpot side bet.
3. The ETGT sends bet information to the central server.
4. The server allocates a portion of the jackpot bet to each suit's progressive pool.
5. As cards are dealt, the ETGT and central server analyze the combinations for potential jackpot triggers.
6. If a jackpot combination occurs, the server immediately identifies the type and corresponding payout percentage.
7. For Royal Flush or Straight Flush wins, the server calculates the payout from the specific suit's pool.
8. For Six of a Kind or Color Flush wins, the server combines the relevant color pools for calculation.
9. The winning amount is verified and communicated back to the triggering ETGT.
10. All connected ETGTs are updated with the new progressive amounts post-payout.
11. The central accounting system processes the payout to the winning player.
12. Reset amounts are applied to the affected progressive pools.
13. The system logs all jackpot hit details for auditing and analysis purposes.
14. Marketing systems are notified of significant wins for promotional opportunities.

Noteworthy Aspects and Features: This Grand Paradise Jackpot™ calculation and distribution technique stands out for its multi-faceted approach to progressive jackpots. By tying progressives to specific suits, it creates a more nuanced and engaging jackpot experience that goes beyond simple accumulation of a single pool.

The visual representation of four growing jackpots adds excitement to the ETGT interface, potentially drawing more player attention and participation. This constant visual feedback keeps the jackpot at the forefront of the gaming experience.

The tiered payout structure, with different percentages for various combinations, allows for a balance between the frequency of jackpot hits and the potential for massive payouts. This may help maintain player interest over extended periods.

The system's ability to manage and update multiple progressive pools in real-time demonstrates sophisticated processing and networking capabilities. This opens the door for even more complex jackpot structures in future implementations.

The suit-specific nature of the jackpots may be particularly appealing in markets where certain suits or colors hold cultural significance, allowing for targeted marketing and theming opportunities.

### Grand Paradise Jackpot™ Calculation and Distribution Technique #23—Time-Based Jackpot Distribution

Description and Implementation: The Time-Based Jackpot Distribution technique introduces an innovative approach to awarding jackpots in live dealer-controlled multiplayer baccarat games. This system distributes jackpot awards based on specific time intervals or pre-determined time points during gameplay. The Electronic Table Game Terminal (ETGT) or Live Dealer Game Table (LDGT) is equipped with a high-precision timer that is synchronized with the casino's central timekeeping system.

At regular intervals (e.g., every hour) or at pre-set times (e.g., 3:00 PM, 9:00 PM), the system automatically triggers a jackpot award event. When this occurs, all players who have placed a qualifying bet within a specified time window (e.g., the last 5 minutes before the jackpot time) are eligible to win a share of the jackpot. The size of each player's share is proportional to their betting activity during the qualifying period.

This technique may be implemented using a combination of hardware and software components. The ETGT or LDGT includes a dedicated timing module that interfaces with the game logic controller. This module continuously monitors the current time and compares it against the pre-programmed jackpot times. When a match occurs, it signals the game controller to initiate the jackpot distribution process.

The casino's central server maintains a dynamic pool of eligible players, updating it in real-time as bets are placed. When a jackpot event is triggered, the server calculates each eligible player's share based on their betting history and current table stakes. This distribution is then pushed to each relevant ETGT or LDGT for display and payout processing.

### Benefits to Players:

1. Increased excitement and anticipation as jackpot times approach
2. Regular opportunities to win jackpots without needing specific card combinations
3. Rewards consistent play and encourages longer gaming sessions
4. Provides a fair distribution method based on player engagement
5. Offers a unique gaming experience not commonly found in traditional baccarat

### Benefits to Casinos:

1. Encourages more frequent and consistent play, especially around jackpot times
2. Increases player retention and time spent at tables
3. Differentiates the casino's baccarat offering from competitors
4. Provides flexibility in jackpot frequency and size to optimize player engagement and casino profitability
5. Generates additional excitement on the gaming floor, potentially attracting more players

Example Walk-Through Scenario: Sarah enters the casino at 2:30 PM and sits down at a live dealer baccarat ETGT. She notices on the display that the next Time-Based Jackpot will be awarded at 3:00 PM. Excited by this prospect, Sarah begins playing, making sure to place bets consistently.

As 3:00 PM approaches, the ETGT display shows a countdown timer, building anticipation among the players. Sarah continues to place bets, knowing that her recent activity will increase her chances of winning a larger share of the jackpot.

At exactly 3:00 PM, the ETGT emits a celebratory sound and light show. The display announces that the Time-Based Jackpot is being distributed. Sarah watches as her portion of the jackpot is calculated based on her betting activity over the last 30 minutes.

The screen shows that Sarah has won $500 as her share of the $5,000 jackpot. This amount is immediately added to her credit balance on the ETGT. Sarah is thrilled with her win and decides to continue playing, knowing that the next Time-Based Jackpot will be awarded in an hour.

Meanwhile, at other baccarat tables and ETGTs across the casino, other eligible players are also receiving their shares of the jackpot. The casino floor buzzes with excitement as players discuss their winnings and anticipate the next jackpot time.

Sarah's positive experience encourages her to return to the casino regularly, often timing her visits to coincide with the Time-Based Jackpot awards. She appreciates that her consistent play is rewarded, even on days when her luck in the base game isn't as good.

### Example System Procedural Flow

1. Casino management configures jackpot times and frequencies in the central server.
2. Central server synchronizes time and jackpot schedule with all ETGTs and LDGTs.
3. Player Sarah logs into ETGT using her player card or account.
4. ETGT displays current time and next jackpot time to Sarah.
5. Sarah places bets on baccarat games.
6. ETGT records each bet and sends data to central server.
7. Central server continuously updates Sarah's eligibility and potential jackpot share.
8. As jackpot time approaches, ETGT displays countdown timer.
9. At jackpot time, central server freezes the pool of eligible players.
10. Server calculates jackpot shares based on each player's betting activity.
11. Server sends jackpot win data to each eligible ETGT and LDGT.
12. Sarah's ETGT receives her jackpot share information.
13. ETGT displays win animation and adds jackpot amount to Sarah's balance.
14. ETGT sends confirmation of jackpot payment to central server.
15. Central server updates Sarah's player profile with jackpot win data.
16. Casino floor management system updates jackpot signage across the casino.
17. System resets for the next jackpot time period.

Throughout this process, the ETGT and central server exchange encrypted data packets containing bet information, player identification, and jackpot calculations. The system employs redundant checks to ensure accurate timekeeping and fair distribution of jackpot funds.

Noteworthy Aspects and Features: The Time-Based Jackpot Distribution technique introduces several Innovative Elements to live dealer baccarat games. Firstly, it decouples jackpot wins from specific game outcomes, creating a new layer of excitement independent of the base game. This approach is particularly suited to baccarat, where players have limited influence on the game outcome.

The system's real-time tracking and calculation of player eligibility and potential jackpot shares is a technical innovation. It may require high-speed, reliable communication between ETGTs, LDGTs, and the central server, as well as sophisticated algorithms to handle the complex calculations quickly.

The configurable nature of the jackpot times allows casinos to create “hot periods” of increased activity, potentially using this to manage floor traffic during typically slower times. This level of control over player engagement is a unique feature of this system.

Finally, the proportional distribution of the jackpot based on player activity introduces a novel fairness mechanism. It rewards player loyalty and consistent play, potentially increasing player retention and lifetime value. This approach differs significantly from traditional jackpot systems where a single player wins the entire amount, often based on a lucky hand or random selection.

### Grand Paradise Jackpot™ Calculation and Distribution Technique #24—Progressive Betting Multiplier

Description and Implementation: The Progressive Betting Multiplier technique introduces an innovative approach to jackpot distribution in live dealer-controlled multiplayerbaccarat games. This system rewards players for consistently increasing their bets over a series of hands, with larger multipliers applied to their jackpot eligibility based on their betting progression.

Each Electronic Table Game Terminal (ETGT) or Live Dealer Game Table (LDGT) is equipped with a specialized bet tracking module that monitors the player's betting patterns. The system recognizes when a player increases their bet amount from one hand to the next, building a multiplier that enhances their potential jackpot winnings.

For example, if a player starts with a $10 bet and increases to $20 on the next hand, their multiplier may increase to 1.5×. If they further increase to $30 on the third hand, the multiplier may rise to 2×, and so on. This multiplier is then applied to their jackpot eligibility, significantly boosting their potential winnings if a jackpot is triggered.

The implementation involves a combination of hardware and software components. The ETGT or LDGT includes a dedicated bet analysis module that interfaces with the game logic controller. This module tracks bet amounts across consecutive hands and calculates the current multiplier for each player.

The casino's central server maintains a real-time database of each player's current multiplier and jackpot eligibility.

When a jackpot is triggered (either randomly or based on specific card combinations), the server uses these multipliers to calculate each eligible player's share of the jackpot.

### Benefits to Players:

1. Rewards strategic betting behavior and encourages more engaging gameplay
2. Provides a sense of control over jackpot odds, as players may directly influence their potential winnings
3. Adds an extra layer of excitement to each hand as players aim to build their multiplier
4. Offers the potential for significantly larger jackpot shares compared to flat-bet systems
5. Creates a unique, personalized jackpot experience for each player

### Benefits to Casinos:

1. Encourages higher betting amounts and more frequent play
2. Increases player engagement and time spent at tables
3. Differentiates the casino's baccarat offering with a unique jackpot mechanic
4. Potentially increases overall betting volume and, consequently, casino revenue
5. Attracts strategic players who enjoy more complex betting systems

Example Walk-Through Scenario: Michael sits down at a live dealer baccarat ETGT and notices the Progressive Betting Multiplier feature. Intrigued, he begins with a modest $10 bet. The ETGT display shows his current multiplier at 1×.

For the next hand, Michael increases his bet to $20. The system recognizes this increase, and his multiplier jumps to 1.5×. Excited by this, Michael decides to continue increasing his bets gradually.

Over the next few hands, Michael's betting pattern looks like this: Hand 1: $10 bet—1× multiplier Hand 2: $20 bet—1.5× multiplier Hand 3: $30 bet—2× multiplier Hand 4: $50 bet—2.5× multiplier Hand 5: $75 bet—3× multiplier As Michael's bets increase, so does the excitement. He knows that if a jackpot is triggered now, his share would be three times larger than if he had been betting flat amounts.

Suddenly, a jackpot is triggered across all baccarat tables. The ETGT screen lights up, announcing that Michael is eligible for a share of the $100,000 jackpot. Thanks to his 3× multiplier, Michael's base share of $1,000 is tripled to $3,000.

Thrilled with his win, Michael decides to continue playing, now even more aware of the potential benefits of strategic bet increases. He notices other players at nearby tables also adjusting their betting patterns, adding a new layer of strategy to the baccarat game.

### Example System Procedural Flow

1. Casino management configures Progressive Betting Multiplier parameters in the central server.
2. Central server syncs multiplier rules with all ETGTs and LDGTs.
3. Player Michael logs into an ETGT using his player card or account.
4. ETGT displays current multiplier (starting at 1×) to Michael.
5. Michael places his initial $10 bet.
6. ETGT records the bet and sends data to the central server.
7. Central server logs the bet amount for future comparison.
8. On the next hand, Michael increases his bet to $20.
9. ETGT detects the bet increase and calculates the new multiplier (1.5×).
10. ETGT sends updated bet and multiplier data to the central server.
11. Central server verifies the calculation and updates Michael's player profile.
12. ETGT displays the new multiplier to Michael.
13. Steps 8-12 repeat for subsequent hands as Michael continues to increase his bets.
14. A jackpot is triggered by a specific card combination or random event.
15. Central server calculates jackpot shares for all eligible players, applying their current multipliers.
16. Server sends jackpot win data, including multiplier-adjusted amounts, to each eligible ETGT and LDGT.
17. Michael's ETGT receives his jackpot share information, showing both the base amount and the multiplier-adjusted win.
18. ETGT displays win animation and adds the multiplier-adjusted jackpot amount to Michael's balance.
19. ETGT sends confirmation of jackpot payment to the central server.
20. Central server updates Michael's player profile with jackpot win data and resets his multiplier to 1× for the next betting sequence.

Throughout this process, the ETGT and central server exchange encrypted data packets containing bet information, multiplier calculations, player identification, and jackpot distribution details. The system employs redundant checks to ensure accurate multiplier tracking and fair distribution of jackpot funds.

Noteworthy Aspects and Features: The Progressive Betting Multiplier technique introduces several innovative elements to live dealer baccarat games. It creates a direct link between a player's betting strategy and their potential jackpot winnings, adding a new dimension of skill and decision-making to the game.

The real-time tracking and calculation of bet increases and multipliers may require sophisticated algorithms and seamless communication between ETGTs, LDGTs, and the central server. This technical infrastructure allows for immediate updates to a player's jackpot eligibility, maintaining the fast-paced nature of baccarat.

The system's ability to encourage higher bets without forcing players into uncomfortable betting levels is a notable feature. Players may choose their own progression speed, allowing for personalized risk management while still benefiting from the multiplier system.

The flexible nature of the multiplier parameters allows casinos to adjust the system's impact on gameplay and jackpot distribution. This adaptability ensures the feature may be optimized for different player demographics and regulatory environments.

This technique introduces a novel social dynamic to baccarat tables. As players become aware of others' betting patterns and multipliers, it may create a competitive atmosphere and encourage more strategic play, potentially increasing overall engagement and time spent at the tables.

### Grand Paradise Jackpot™ Calculation and Distribution Technique #25—Streak Bonus Jackpot

Description and Implementation: The Streak Bonus Jackpot technique introduces an exhilarating new dimension to jackpot awards in live dealer-controlled multiplayer baccarat games. This system rewards players for achieving consecutive wins or specific patterns in their betting outcomes, with increasing jackpot eligibility for longer streaks.

Each Electronic Table Game Terminal (ETGT) or Live Dealer Game Table (LDGT) is equipped with a sophisticated streak tracking module that monitors each player's betting outcomes. The system recognizes and records winning streaks for both “Player” and “Banker” bets, as well as other patterns such as alternating wins or specific sequences of outcomes.

For example, a player who correctly bets on “Player” three times in a row may receive a 2× multiplier on their jackpot eligibility. If they extend this streak to five consecutive correct “Player” bets, their multiplier may increase to 5×. Similarly, a player who correctly predicts an alternating pattern of “Player-Banker-Player-Banker-Player” may receive a special bonus multiplier.

The implementation involves intricate hardware and software integration. The ETGT or LDGT includes a dedicated streak analysis module that interfaces with the game logic controller. This module tracks betting outcomes across consecutive hands and calculates the current streak bonus for each player.

The casino's central server maintains a real-time database of each player's current streak status and corresponding jackpot eligibility multiplier. When a jackpot is triggered, the server uses these multipliers to calculate each eligible player's share of the jackpot, with longer streaks resulting in larger potential wins.

### Benefits to Players:

1. Adds an extra layer of excitement to each hand as players try to build and maintain streaks
2. Rewards skilled players who may identify and capitalize on trends in the game
3. Provides multiple paths to increased jackpot eligibility through various streak types
4. Creates a sense of achievement separate from individual hand outcomes
5. Offers the potential for dramatically increased jackpot shares for successful streak builders

### Benefits to Casinos:

1. Encourages more consistent play as players try to build and maintain streaks
2. Increases player engagement and time spent at tables
3. Creates a unique selling point for the casino's baccarat offering
4. Potentially increases betting volume as players are motivated to continue their streaks
5. Attracts skilled players who enjoy pattern recognition and strategic betting

Example Walk-Through Scenario: Lisa sits down at a live dealer baccarat ETGT and notices the Streak Bonus Jackpot feature. She decides to focus on “Player” bets to try and build a streak. Her session unfolds as follows:

Hand 1: Lisa bets on “Player” and wins. Streak: 1, Multiplier: 1× Hand 2: Lisa bets on “Player” and wins. Streak: 2, Multiplier: 1.5× Hand 3: Lisa bets on “Player” and wins. Streak: 3, Multiplier: 2× Hand 4: Lisa bets on “Player” and loses. Streak resets to 0, Multiplier returns to 1×

Undeterred, Lisa decides to try for an alternating pattern:

Hand 5: Lisa bets on “Player” and wins. Pattern: P, Multiplier: 1× Hand 6: Lisa bets on “Banker” and wins. Pattern: PB, Multiplier: 1.5× Hand 7: Lisa bets on “Player” and wins. Pattern: PBP, Multiplier: 2× Hand 8: Lisa bets on “Banker” and wins. Pattern: PBPB, Multiplier: 3× Hand 9: Lisa bets on “Player” and wins. Pattern: PBPBP, Multiplier: 5×

As Lisa completes her alternating pattern streak, the ETGT screen flashes excitedly, congratulating her on achieving a special pattern bonus. Her jackpot eligibility is now at a 5× multiplier.

At this moment, a jackpot is triggered across all baccarat tables. Thanks to her impressive streak, Lisa's base share of $1,000 is multiplied by 5, resulting in a $5,000 jackpot win.

Elated by her success, Lisa continues playing, now even more attuned to the patterns emerging in the game. She notices other players at nearby tables also paying close attention to their streaks, adding a new level of strategy and excitement to the baccarat game.

### Example System Procedural Flow

1. Casino management configures Streak Bonus Jackpot parameters in the central server.
2. Central server syncs streak rules and multipliers with all ETGTs and LDGTs.
3. Player Lisa logs into an ETGT using her player card or account.
4. ETGT displays current streak status and multiplier (starting at 0 and 1×) to Lisa.
5. Lisa places her first “Player” bet.
6. ETGT records the bet and sends data to the central server.
7. The hand is played out, resulting in a “Player” win.
8. ETGT detects the win and updates Lisa's streak to 1.
9. ETGT calculates and displays the new multiplier (1×) to Lisa.
10. ETGT sends updated streak and multiplier data to the central server.
11. Central server verifies the calculation and updates Lisa's player profile.
12. Steps 5-11 repeat for subsequent hands as Lisa builds her streak.
13. When Lisa achieves her alternating pattern (PBPBP), the ETGT recognizes this special streak.
14. ETGT applies the enhanced multiplier (5×) and sends this data to the central server.
15. Central server confirms the special streak bonus and updates Lisa's profile.
16. A jackpot is triggered by a specific card combination or random event.
17. Central server calculates jackpot shares for all eligible players, applying their current streak multipliers.
18. Server sends jackpot win data, including multiplier-adjusted amounts, to each eligible ETGT and LDGT.
19. Lisa's ETGT receives her jackpot share information, showing both the base amount and the streak-adjusted win.
20. ETGT displays win animation and adds the streak-adjusted jackpot amount to Lisa's balance.
21. ETGT sends confirmation of jackpot payment to the central server.
22. Central server updates Lisa's player profile with jackpot win data and resets her streak for the next betting sequence.

Throughout this process, the ETGT and central server exchange encrypted data packets containing bet outcomes, streak calculations, player identification, and jackpot distribution details. The system employs redundant checks to ensure accurate streak tracking and fair distribution of jackpot funds.

Noteworthy Aspects and Features: The Streak Bonus Jackpot technique introduces several innovative elements to live dealer baccarat games. It rewards players for consistent performance and pattern recognition, adding a skill-based element to the jackpot feature of a largely luck-based game.

The real-time tracking and calculation of various streak types may require advanced pattern recognition algorithms and instant communication between ETGTs, LDGTs, and the central server. This technical infrastructure allows for immediate updates to a player's jackpot eligibility, maintaining the dynamic nature of baccarat.

The system's ability to recognize and reward different types of streaks (consecutive wins, alternating patterns, etc.) adds depth to the gameplay. It encourages players to adapt their strategies and remain engaged even after a streak is broken, as they may always start building a new type of streak.

The flexibility in defining streak parameters and corresponding multipliers allows casinos to fine-tune the feature's impact on gameplay and jackpot distribution. This adaptability ensures the feature may be optimized for different player preferences and regulatory requirements.

This technique introduces a new level of anticipation and excitement to each hand of baccarat. As players get closer to completing significant streaks, the tension and potential reward grow, creating memorable gaming experiences and potentially increasing player retention.

### Grand Paradise Jackpot™ Calculation and Distribution Technique #26—Community Jackpot Accelerator

Description and Implementation: The Community Jackpot Accelerator technique introduces a collaborative and social dimension to jackpot awards in live dealer-controlled multiplayer baccarat games. This innovative system encourages players to work together to increase the overall jackpot size and their individual chances of winning, creating a unique community-driven jackpot experience.

Each Electronic Table Game Terminal (ETGT) or Live Dealer Game Table (LDGT) is connected to a centralized Community Jackpot Accelerator system. This system tracks the combined betting activity and outcomes across all participating tables and terminals. As more players join and actively participate in the games, the jackpot grows at an accelerated rate, and individual players' chances of winning increase.

The implementation involves sophisticated networking and real-time data processing. Each ETGT or LDGT is equipped with a community contribution module that interfaces with the game logic controller. This module sends data about each player's bets and game outcomes to the central server, which then calculates the current community contribution level and adjusts the jackpot growth rate accordingly.

For example, when the number of active players across all tables reaches certain thresholds (e.g., 50, 100, 200 players), the jackpot contribution rate may increase from 1% to 2%, then 3%, and so on. Additionally, if the community as a whole achieves certain milestones (e.g., 1000 total hands played in an hour), it may trigger jackpot multipliers or bonus contribution periods.

The casino's central server maintains a real-time database of the community's current activity level, jackpot size, and each player's individual contribution. When a jackpot is triggered, the server calculates each eligible player's share based on their individual contribution and the overall community activity level.

### Benefits to Players:

1. Creates a sense of camaraderie and shared purpose among baccarat players
2. Offers the potential for larger jackpots due to accelerated growth rates
3. Provides additional excitement as players work together to reach community milestones
4. Increases the frequency of jackpot triggers as more players participate
5. Allows players to feel that their play contributes to the broader gaming community

### Benefits to Casinos:

1. Encourages higher overall participation in baccarat games
2. Increases player engagement and time spent at tables
3. Creates a unique and socially driven jackpot system that differentiates the casino's offering
4. Potentially increases overall betting volume as players are motivated by the community aspect
5. Attracts social players who enjoy collaborative gaming experiences

Example Walk-Through Scenario: Emma enters the casino and notices the buzzing activity around the baccarat tables. She sees a large display showing the Community Jackpot Accelerator status: currently, there are 87 active players, and the jackpot is growing at a 2% rate.

Excited by the communal atmosphere, Emma sits down at a live dealer baccarat ETGT. As she begins playing, she sees the community player count tick up to 88. The ETGT display shows her personal contribution to the jackpot and the current community milestones.

As more players join the baccarat tables, Emma watches the community counter approach 100. When it hits this threshold, a celebratory animation plays across all ETGTs, announcing that the jackpot growth rate has increased to 3%. Players cheer, knowing their chances for a bigger win have improved.

Emma continues playing, chatting with neighboring players about their shared goal. They discuss strategies to increase the community hand count, aiming for the 1000-hand milestone that will trigger a jackpot multiplier.

After an hour of exciting play, the community achieves the 1000-hand milestone. All ETGTs light up, announcing a 15-minute period where all jackpot contributions are doubled. The energy on the casino floor is palpable as players increase their bets, knowing they're contributing more to the rapidly growing jackpot.

Suddenly, a jackpot is triggered. The central display shows that the final jackpot amount is $500,000, significantly larger than usual due to the community's efforts. Emma's ETGT screen reveals that she's won a $5,000 share based on her individual contribution and the community bonuses.

Thrilled with her win and the exciting communal experience, Emma decides to continue playing. She notices new players being warmly welcomed by others, all keen to work together towards the next community milestone.

### Example System Procedural Flow

1. Casino management configures Community Jackpot Accelerator parameters in the central server.
2. Central server initializes the community jackpot pool and activity trackers.
3. Player Emma logs into an ETGT using her player card or account.
4. ETGT displays current community stats (player count, jackpot size, growth rate) to Emma.
5. Emma places a bet, which is recorded by the ETGT.
6. ETGT sends bet data and Emma's player ID to the central server.
7. Central server updates community stats and Emma's individual contribution.
8. Server checks if new community thresholds have been reached.
9. As the player count reaches 100, server increases jackpot growth rate to 3%.
10. Server sends updated community stats to all ETGTs and LDGTs.
11. All terminals display celebration animation for reached milestone.
12. Emma continues playing, contributing to the hand count milestone.
13. Central server tracks total hands played across all tables.
14. When 1000-hand milestone is reached, server activates double contribution period.
15. Server notifies all ETGTs and LDGTs of the bonus period.
16. Terminals display bonus period animation and update contribution rates.
17. A jackpot is triggered by a specific card combination or random event.
18. Central server calculates final jackpot amount based on community efforts.
19. Server determines individual shares based on player contributions and community bonuses.
20. Server sends jackpot win data to each eligible ETGT and LDGT.
21. Emma's ETGT receives her jackpot share information.
22. ETGT displays win animation and adds jackpot amount to Emma's balance.
23. ETGT sends confirmation of jackpot payment to the central server.
24. Central server updates Emma's player profile and resets community jackpot for the next round.

Throughout this process, the ETGTs, LDGTs, and central server exchange encrypted data packets containing bet information, community stats, player identification, and jackpot calculations. The system employs redundant checks to ensure accurate tracking of community efforts and fair distribution of jackpot funds.

Noteworthy Aspects and Features: The Community Jackpot Accelerator technique introduces several innovative elements to live dealer baccarat games. It transforms the traditionally individual experience of jackpot pursuit into a collaborative effort, fostering a sense of community among players.

The real-time tracking and updating of community statistics across multiple tables and terminals may require advanced networking and data processing capabilities. This infrastructure allows for immediate feedback to players about their collective progress, maintaining engagement and excitement.

The system's ability to dynamically adjust jackpot growth rates and trigger bonus periods based on community activity is a unique feature. It creates a self-reinforcing cycle of participation, where increased play leads to better jackpot conditions, which in turn encourages more play.

The flexible nature of the community milestones and bonuses allows casinos to adjust the system's impact on gameplay and jackpot distribution. This adaptability ensures the feature may be optimized for different player demographics and casino sizes.

This technique introduces a novel social dynamic to baccarat tables. It encourages interaction between players, potentially turning strangers into collaborators and friends. This social aspect may significantly enhance player experience and loyalty, benefiting both players and the casino.

### Grand Paradise Jackpot™ Calculation and Distribution Technique #27—Tiered Jackpot System

Description and Implementation: The Tiered Jackpot System introduces a multi-level approach to jackpot awards in live dealer-controlled multiplayer baccarat games. This innovative system offers players the opportunity to win jackpots of varying sizes, each with its own trigger conditions and payout structure. The tiered approach caters to different player preferences and risk appetites, enhancing the overall gaming experience.

Each Electronic Table Game Terminal (ETGT) or Live Dealer Game Table (LDGT) is connected to a centralized Tiered Jackpot System. This system manages multiple jackpot tiers simultaneously, each with its own prize pool, trigger conditions, and eligibility requirements. Typically, the system may include tiers such as Mini, Minor, Major, and Grand jackpots.

The implementation involves complex software algorithms and real-time data processing. Each ETGT or LDGT is equipped with a jackpot tier module that interfaces with the game logic controller. This module tracks player bets, game outcomes, and other relevant data, sending this information to the central server for jackpot calculations.

For example, the Mini jackpot may be triggered frequently with smaller payouts, perhaps based on specific card combinations. The Minor jackpot may be triggered less often but offer larger prizes, optionally based on consecutive wins. The Major jackpot may require a rare card combination and offer a substantial payout. The Grand jackpot may be a progressive jackpot with an extremely large prize, triggered by an exceptionally rare event.

The casino's central server maintains separate prize pools for each jackpot tier, updating them in real-time based on player contributions and casino-defined parameters. When a jackpot is triggered at any tier, the server calculates the payout based on the specific rules for that tier and the player's eligibility.

### Benefits to Players:

1. Offers multiple chances to win jackpots of varying sizes
2. Caters to different risk preferences and betting styles
3. Provides frequent smaller wins (Mini jackpot) while maintaining the allure of life-changing payouts (Grand jackpot)
4. Adds complexity and excitement to the jackpot aspect of baccarat
5. Allows players to strategize their bets based on preferred jackpot tiers

### Benefits to Casinos:

1. Attracts a wider range of players with diverse jackpot preferences
2. Increases overall player engagement and time spent at tables
3. Offers flexibility in managing jackpot funds and payout frequencies
4. Creates marketing opportunities around different jackpot tiers
5. Potentially increases betting volume as players aim for higher-tier jackpots

Example Walk-Through Scenario: David enters the casino and is drawn to the baccarat tables by the impressive Tiered Jackpot display. He sees four jackpot tiers: Mini ($500), Minor ($5,000), Major ($50,000), and Grand ($1,000,000 and growing).

Intrigued, David sits at a live dealer baccarat ETGT and begins playing. He notices that his bets contribute differently to each jackpot tier. A small percentage goes to the Mini and Minor jackpots, while a larger portion is allocated to the Major and Grand tiers.

As David plays, he witnesses a nearby player win the Mini jackpot with a pair of 8s in their hand. The winner is ecstatic, and the quick payout encourages David to continue playing.

After a few hands, David's ETGT screen alerts him that he's eligible for the Minor jackpot if he may win five hands in a row. Excited by this prospect, David focuses intensely on the next few hands. He manages to win four in a row but loses the fifth. Though disappointed, the experience was thrilling, and David remains engaged in the game.

Suddenly, a commotion erupts at a nearby table. A player has hit a rare card combination, triggering the Major jackpot. The lucky winner receives $50,000, and the celebratory atmosphere energizes all the baccarat players.

As the session continues, David keeps an eye on the growing Grand jackpot. He knows it's a long shot, but the possibility of winning over a million dollars adds an extra layer of anticipation to each hand.

Though David doesn't hit a jackpot during this session, the varied near-misses and the excitement of other players' wins make for an unforgettable gaming experience. He leaves the table already planning his next visit, eager to take another shot at the Tiered Jackpot System.

### Example System Procedural Flow

1. Casino management configures Tiered Jackpot System parameters in the central server.
2. Central server initializes separate prize pools for each jackpot tier.
3. Player David logs into an ETGT using his player card or account.
4. ETGT displays current jackpot amounts for all tiers to David.
5. David places a bet, which is recorded by the ETGT.
6. ETGT calculates contribution to each jackpot tier based on the bet.
7. ETGT sends bet data, tier contributions, and David's player ID to the central server.
8. Central server updates all jackpot tier pools and David's eligibility status.
9. Server continuously checks for jackpot trigger conditions across all tiers.
10. When a Mini jackpot is triggered at a nearby table, server confirms the win.
11. Server sends Mini jackpot win data to the relevant ETGT.
12. All ETGTs and LDGTs display a notification about the Mini jackpot win.
13. David continues playing, becoming eligible for the Minor jackpot challenge.
14. ETGT tracks David's consecutive wins for Minor jackpot eligibility.
15. When David misses the Minor jackpot, ETGT resets his eligibility counter.
16. A Major jackpot is triggered at another table by a rare card combination.
17. Central server verifies the Major jackpot win and calculates the payout.
18. Server sends Major jackpot win data to the relevant ETGT and updates all displays.
19. All ETGTs and LDGTs show celebration animation for the Major jackpot win.
20. Throughout the session, server continuously updates the Grand jackpot pool.
21. At the end of his session, David cashes out, and the ETGT sends final play data to the server.
22. Central server updates David's player profile with his gaming history and jackpot eligibility status.

Throughout this process, the ETGTs, LDGTs, and central server exchange encrypted data packets containing bet information, jackpot contributions, trigger checks, player identification, and win calculations. The system employs redundant checks to ensure accurate tracking of all jackpot tiers and fair distribution of jackpot funds.

Noteworthy Aspects and Features: The Tiered Jackpot System introduces several innovative elements to live dealer baccarat games. It creates a multi-dimensional jackpot experience, catering to various player preferences and adding depth to the traditional baccarat game.

The real-time management of multiple jackpot tiers, each with its own trigger conditions and payout structures, may require sophisticated algorithms and data processing capabilities. This infrastructure allows for a dynamic and engaging jackpot experience that may adapt to player behavior and casino requirements.

The system's ability to allocate different portions of each bet to various jackpot tiers is a unique feature. It allows players to indirectly strategize their jackpot participation based on their betting patterns, adding an extra layer of decision-making to the game.

The flexible nature of the tier structure allows casinos to adjust the system's impact on gameplay and overall jackpot strategy. Casinos may modify tier levels, trigger conditions, and payout structures to optimize player engagement and financial performance.

This technique introduces a new level of anticipation and excitement to each hand of baccarat. With multiple jackpot tiers in play, players have more opportunities for wins and near-misses, creating a consistently engaging gaming experience that may significantly enhance player retention and satisfaction.

### Grand Paradise Jackpot™ Calculation and Distribution Technique #28—Personalized Jackpot Challenges

Description and Implementation: The Personalized Jackpot Challenges technique introduces a highly individualized approach to jackpot awards in live dealer-controlled multiplayer baccarat games. This innovative system offers each player unique, tailored jackpot goals based on their playing history, preferences, and current session performance, creating a personalized and engaging jackpot experience.

Each Electronic Table Game Terminal (ETGT) or Live Dealer Game Table (LDGT) is connected to a sophisticated Personalized Jackpot Challenge system. This system uses advanced data analytics and machine learning algorithms to analyze each player's gaming patterns and generate custom jackpot challenges in real-time.

The implementation involves complex AI-driven software and real-time data processing. Each ETGT or LDGT is equipped with a personalization module that interfaces with the game logic controller. This module tracks detailed player behavior, including bet sizes, frequency, game outcomes, and time spent playing. It then sends this data to the central server for analysis and challenge generation.

For example, if a player typically bets on the banker, the system may challenge them to win five consecutive player bets for a jackpot opportunity. For a player who frequently switches between banker and player bets, the challenge may involve correctly predicting the outcome of the next three hands. High-rollers may receive challenges related to maintaining a certain bet level for a set number of hands.

The casino's central server uses AI algorithms to continuously generate and update these personalized challenges. When a player meets their current challenge, they become eligible for a jackpot win, with the size of the jackpot often correlating to the difficulty of the completed challenge.

### Benefits to Players:

1. Offers a unique, tailored jackpot experience for each player
2. Provides achievable yet exciting goals based on individual play styles
3. Adds an extra layer of engagement and strategy to each gaming session
4. Creates a sense of progression and accomplishment
5. Allows players to indirectly influence their jackpot opportunities through their playing choices

### Benefits to Casinos:

1. Increases player engagement and time spent at tables
2. Encourages players to explore different betting patterns and strategies
3. Provides valuable data on player preferences and behaviors
4. Offers a unique selling point for the casino's baccarat offering
5. Potentially increases overall betting volume as players strive to complete challenges

Example Walk-Through Scenario: Sophia, a regular at the casino's baccarat tables, sits down at a live dealer baccarat ETGT. As she logs in, the system recognizes her and immediately generates a personalized jackpot challenge based on her playing history.

Sophia's ETGT screen displays her custom challenge: “Win 3 consecutive hands with banker bets, followed by 2 consecutive hands with player bets.” The potential jackpot for completing this challenge is $10,000. Excited by this personalized goal, Sophia begins playing with renewed focus.

As Sophia plays, she notices that her challenges dynamically adjust based on her current performance. When she successfully wins two consecutive banker bets, the system increases the potential jackpot to $15,000, adding to the excitement.

Meanwhile, at a nearby table, Robert, a more conservative player, receives a different challenge: “Correctly predict five tie bets within the next 20 hands.” His potential jackpot starts at $5,000 but grows with each correct prediction.

As Sophia nears completion of her challenge, the ETGT screen builds anticipation, with animations and sound effects highlighting her progress. On her final required player bet, the entire table watches in suspense. When she wins, completing the challenge, the screen erupts in celebration.

Sophia's personalized challenge completion triggers a jackpot win. The ETGT screen reveals her payout of $20,000, reflecting the increased jackpot amount from her strong performance. Other players at nearby tables see a notification of Sophia's win, creating a buzz of excitement.

Thrilled with her success, Sophia continues playing, curious to see what new challenge the system will generate next. She notices that her new challenges seem to build upon her recent performance, always pushing her to explore new strategies and betting patterns.

### Example System Procedural Flow

1. Casino management configures Personalized Jackpot Challenge parameters in the central server.
2. Player Sophia logs into an ETGT using her player card or account.
3. Central server retrieves Sophia's playing history and preferences.
4. AI algorithm generates a personalized jackpot challenge for Sophia.
5. ETGT displays the custom challenge and potential jackpot amount to Sophia.
6. Sophia places her first bet, which is recorded by the ETGT.
7. ETGT sends bet data and game outcome to the central server.
8. Server updates Sophia's challenge progress and adjusts the potential jackpot.
9. ETGT displays updated challenge progress and jackpot amount.
10. Steps 6-9 repeat as Sophia continues playing and progressing through her challenge.
11. When Sophia completes her challenge, ETGT sends confirmation to the server.
12. Server verifies the challenge completion and calculates the final jackpot amount.
13. Server sends jackpot win data to Sophia's ETGT.
14. ETGT displays win animation and adds jackpot amount to Sophia's balance.
15. Server broadcasts a notification of Sophia's win to other ETGTs and LDGTs.
16. AI algorithm analyzes Sophia's recent play and generates a new challenge.
17. ETGT displays the new challenge to Sophia.
18. Throughout the session, server continuously updates Sophia's player profile with new data.
19. At the end of her session, Sophia cashes out, and the ETGT sends final play data to the server.
20. Central server updates Sophia's long-term player profile for future challenge generation.

Throughout this process, the ETGTs, LDGTs, and central server exchange encrypted data packets containing bet information, game outcomes, challenge progress, player identification, and jackpot calculations. The system employs redundant checks to ensure accurate tracking of challenge completions and fair distribution of jackpot funds.

Noteworthy Aspects and Features: The Personalized Jackpot Challenges technique introduces several innovative elements to live dealer baccarat games. It creates a highly individualized jackpot experience, transforming the one-size-fits-all approach into a tailored journey for each player.

The use of AI and machine learning algorithms to generate and adjust challenges in real-time is a cutting-edge application of technology in casino gaming. This allows for a dynamic and responsive system that may adapt to a player's evolving skills and preferences within a single gaming session.

The system's ability to create challenges that encourage players to explore new betting strategies adds an educational component to the game. It subtly guides players to become more versatile and knowledgeable baccarat players, potentially increasing their overall enjoyment and engagement with the game.

The flexible nature of the challenge parameters allows casinos to fine-tune the system's impact on gameplay and jackpot distribution. Casinos may adjust the difficulty, frequency, and reward levels of challenges to optimize player engagement and financial performance.

This technique introduces a new level of narrative to each baccarat session. Players are no longer just trying to win individual hands, but are on a personalized quest to complete their unique challenge. This storytelling element may significantly enhance player immersion and emotional investment in the game.

### Grand Paradise Jackpot™ Calculation and Distribution Technique #29—Hybrid Skill-Luck Jackpot

Description and Implementation: The Hybrid Skill-Luck Jackpot technique introduces an innovative approach to jackpot awards in live dealer-controlled multiplayer baccarat games by combining elements of skill and luck. This system rewards players not only for fortunate card outcomes but also for their ability to make strategic decisions and predictions throughout their gaming session.

Each Electronic Table Game Terminal (ETGT) or Live Dealer Game Table (LDGT) is equipped with a sophisticated Hybrid Skill-Luck Jackpot module. This module tracks both traditional game outcomes and player decisions, assigning points for both lucky wins and skilled choices.

The implementation involves complex software algorithms and real-time data processing. The ETGT or LDGT's skill assessment module interfaces with the game logic controller to analyze player decisions. For example, it may award skill points for correctly predicting trend reversals, making mathematically optimal bets, or successfully implementing advanced betting strategies.

Simultaneously, the system tracks lucky events such as natural 8 or 9 hands, long winning streaks, or rare card combinations. Players accumulate both skill and luck points throughout their session, with their jackpot eligibility increasing based on their total point score.

The casino's central server maintains a dynamic jackpot pool, with contributions split between the skill and luck components. When a jackpot is triggered, the payout is calculated based on a combination of the player's skill points, luck points, and the current jackpot pool size.

### Benefits to Players:

1. Rewards both skillful play and lucky outcomes
2. Provides a sense of control over jackpot odds through strategic decision-making
3. Encourages learning and mastery of baccarat strategies
4. Offers a unique gaming experience that goes beyond traditional baccarat
5. Allows players to feel that their skills are recognized and rewarded

### Benefits to Casinos:

1. Attracts both casual players and serious baccarat enthusiasts
2. Increases player engagement and time spent at tables
3. Encourages players to learn more about the game, potentially increasing their overall play
4. Differentiates the casino's baccarat offering from competitors
5. Potentially increases betting volume as players strive to demonstrate skill

Example Walk-Through Scenario: Mark, an experienced baccarat player, sits down at a live dealer baccarat ETGT featuring the Hybrid Skill-Luck Jackpot. As he begins playing, he notices two point counters on his screen: one for skill and one for luck.

In his first few hands, Mark correctly predicts a trend reversal from banker to player wins. The skill counter ticks up, acknowledging his accurate prediction. On the next hand, Mark is dealt a natural 9, causing his luck counter to increase.

As Mark continues to play, he employs a progressive betting strategy. The system recognizes this and awards additional skill points for consistent application of an advanced technique. Meanwhile, Mark also experiences a streak of five consecutive wins, boosting his luck score significantly.

The ETGT screen provides real-time feedback on Mark's decisions, highlighting particularly skillful choices. For example, when Mark correctly decides not to place a tie bet despite several recent ties (a statistically sound decision), he receives a “Smart Choice” notification and extra skill points.

As Mark's session progresses, he sees his overall jackpot eligibility score climbing. The screen shows that he's moved into the “Silver Tier” of jackpot eligibility, increasing his potential payout if he hits the jackpot.

Suddenly, Mark's luck score spikes as he's dealt three consecutive natural 8 hands. Combined with his high skill score, this pushes him into the “Gold Tier” of jackpot eligibility. At this moment, a jackpot is triggered across all baccarat tables.

Thanks to Mark's high combined skill and luck scores, and his Gold Tier status, he wins a substantial jackpot of $50,000. The ETGT screen breaks down his win, showing how both his strategic play and fortunate outcomes contributed to the large payout.

Elated by his win and the recognition of his skills, Mark continues playing, now even more attuned to both the strategic elements of the game and the exciting possibilities of lucky streaks.

### Example System Procedural Flow

1. Casino management configures Hybrid Skill-Luck Jackpot parameters in the central server.
2. Player Mark logs into an ETGT using his player card or account.
3. ETGT initializes skill and luck point counters for Mark's session.
4. Mark places his first bet, which is recorded by the ETGT.
5. ETGT sends bet data and game outcome to the central server.
6. Server analyzes the bet and outcome for both skill and luck components.
7. Server calculates skill points based on the betting decision and game context.
8. Server calculates luck points based on the game outcome.
9. Server sends updated point totals to the ETGT.
10. ETGT displays updated skill and luck scores to Mark.
11. Steps 4-10 repeat as Mark continues playing.
12. Server continuously updates Mark's jackpot eligibility tier based on his combined score.
13. When a jackpot is triggered, server calculates Mark's payout based on his tier and scores.
14. Server sends jackpot win data to Mark's ETGT.
15. ETGT displays win animation, breakdown of skill/luck contributions, and adds jackpot amount to Mark's balance.
16. Server broadcasts a notification of Mark's win to other ETGTs and LDGTs.
17. Throughout the session, server updates Mark's player profile with skill and luck data.
18. At the end of his session, Mark cashes out, and the ETGT sends final play data to the server.
19. Central server updates Mark's long-term player profile for future skill assessment.

Throughout this process, the ETGTs, LDGTs, and central server exchange encrypted data packets containing bet information, game outcomes, skill and luck point calculations, player identification, and jackpot distribution details. The system employs redundant checks to ensure accurate tracking of player performance and fair distribution of jackpot funds.

Noteworthy Aspects and Features: The Hybrid Skill-Luck Jackpot technique introduces several innovative elements to live dealer baccarat games. It creates a more engaging and skill-based experience while maintaining the excitement of chance-based outcomes.

The real-time analysis of player decisions for skill assessment is a technical innovation. It may require sophisticated algorithms capable of contextualizing each bet within the broader game state and player history.

The dual point system, tracking both skill and luck, offers a novel approach to jackpot eligibility. It ensures that both strategic players and fortunate players have pathways to significant wins, broadening the appeal of the game.

The tiered eligibility system adds depth to the jackpot mechanic, creating mini-goals within each session as players strive to reach higher tiers. This may significantly increase player engagement and session length.

This technique introduces an educational aspect to baccarat play. By providing immediate feedback on betting decisions, it encourages players to learn and apply optimal strategies, potentially creating more sophisticated and loyal players over time.

### Grand Paradise Jackpot™ Calculation and Distribution Technique #30—Multi-Table Progressive Challenge

Description and Implementation: The Multi-Table Progressive Challenge technique introduces an expansive and interconnected approach to jackpot awards in live dealer-controlled multiplayer baccarat games. This system creates a dynamic, casino-wide challenge that links multiple baccarat tables and terminals, offering players the opportunity to participate in an overarching game beyond their individual table.

Each Electronic Table Game Terminal (ETGT) or Live Dealer Game Table (LDGT) is connected to a centralized Multi-Table Progressive Challenge system. This system tracks specific events or outcomes across all connected baccarat games in real-time, building towards a casino-wide jackpot trigger.

The implementation involves advanced networking capabilities and real-time data processing across multiple tables. Each ETGT or LDGT is equipped with a challenge contribution module that interfaces with the game logic controller. This module sends data about qualifying events to the central server, which then updates the progress towards the jackpot trigger.

For example, the challenge may require a cumulative total of 100 natural 9s across all tables, or 50 consecutive banker wins, or a combined total of $1 million in player wins. As these events occur at any table, they contribute to the overall progress, which is displayed on all connected terminals and on large screens around the casino floor.

The casino's central server maintains the current challenge status, jackpot pool, and individual player contributions. When the challenge is completed and the jackpot is triggered, the server calculates payouts for all eligible players based on their level of participation throughout the challenge period.

### Benefits to Players:

1. Creates a sense of participation in a larger, shared gaming experience
2. Offers the excitement of contributing to and potentially winning a larger jackpot
3. Provides additional entertainment value beyond individual table outcomes
4. Encourages exploration of different tables and betting strategies
5. Allows players to feel connected to the broader casino ecosystem

### Benefits to Casinos:

1. Increases overall engagement across multiple baccarat tables
2. Encourages players to try different tables, potentially increasing total play time
3. Creates a unique and dynamic atmosphere on the casino floor
4. Offers marketing opportunities around the progressive challenge
5. Potentially increases betting volume as players strive to contribute to the challenge

Example Walk-Through Scenario: Linda enters the casino and notices large displays above the baccarat area showing a Multi-Table Progressive Challenge. The current challenge may require a total of 200 natural 8 or 9 hands across all tables, with the progress currently at 157. The jackpot stands at $500,000 and is growing.

Excited by the prospect of participating in this casino-wide event, Linda sits at a live dealer baccarat ETGT. Her screen shows both her individual game and the overall challenge progress. As she begins playing, she sees the progress tick up to 158 as another table hits a natural 8.

Linda plays several hands, contributing two natural 9s to the overall count. Her ETGT screen congratulates her on her contributions, showing that she's now eligible for 0.5% of the jackpot if it's triggered. This encourages Linda to continue playing.

As the challenge nears completion, excitement builds across the baccarat area. Players cheer with each natural 8 or 9, regardless of which table it occurs on. The shared goal creates a unique, cooperative atmosphere among the players.

With the count at 199, Linda's table is dealt a natural 9, completing the challenge. Celebratory animations and sounds erupt across all ETGTs and on the large displays. The final jackpot amount is revealed to be $750,000.

Linda's ETGT screen shows that based on her contributions, she's won $3,750 (0.5% of the jackpot). While not the largest winner, Linda is thrilled to have participated in and won part of this massive, multi-table event.

As the payouts are distributed, a new Multi-Table Progressive Challenge is immediately announced, encouraging Linda and other players to continue their baccarat play.

### Example System Procedural Flow

1. Casino management configures Multi-Table Progressive Challenge parameters in the central server.
2. Central server initializes the challenge, setting the goal and starting jackpot amount.
3. Player Linda logs into an ETGT using her player card or account.
4. ETGT displays current individual game info and overall challenge progress to Linda.
5. Linda places a bet, which is recorded by the ETGT.
6. ETGT sends bet data and game outcome to the central server.
7. If the outcome contributes to the challenge (e.g., a natural 8 or 9), server updates the overall progress.
8. Server sends updated challenge progress to all connected ETGTs and LDGTs.
9. All terminals and large displays show the new progress count.
10. Server updates Linda's individual contribution record.
11. Steps 5-10 repeat as play continues across all tables.
12. When the challenge goal is reached, server confirms the final hand that completed it.
13. Server calculates the final jackpot amount and determines individual payouts.
14. Server sends jackpot completion data to all ETGTs and LDGTs.
15. All terminals display celebration animations and individual payout amounts.
16. Linda's ETGT adds her jackpot share to her balance.
17. Server broadcasts the jackpot win details to casino management systems.
18. Central server initializes the next Multi-Table Progressive Challenge.
19. All ETGTs and LDGTs update to display the new challenge parameters.

Throughout this process, the ETGTs, LDGTs, and central server exchange encrypted data packets containing game outcomes, challenge contributions, player identification, and jackpot calculations. The system employs redundant checks to ensure accurate tracking of the challenge progress and fair distribution of jackpot funds.

Noteworthy Aspects and Features: The Multi-Table Progressive Challenge technique introduces several innovative elements to live dealer baccarat games. It creates a macro-game layered on top of the traditional baccarat play, linking multiple tables into a cohesive gaming experience.

The real-time tracking and updating of challenge progress across numerous tables may require advanced networking and data processing capabilities. This infrastructure allows for immediate feedback to players about their contributions to the larger goal, maintaining engagement and excitement.

The system's ability to create a cooperative atmosphere in what is traditionally an individual game is a unique feature. It fosters a sense of community among players while still maintaining the competitive aspect of individual table play.

The flexible nature of the challenge parameters allows casinos to craft various types of multi-table events. This adaptability ensures the feature may be optimized for different player demographics, casino layouts, and promotional strategies.

This technique introduces a new level of dynamism to the casino floor. The constantly evolving challenge progress creates a palpable energy and shared focus among players, potentially attracting more participants and spectators to the baccarat area.

### Grand Paradise Jackpot™ Calculation and Distribution Technique #31—Seasonal Jackpot Themes

Description and Implementation: The Seasonal Jackpot Themes technique introduces a dynamic and cyclical approach to jackpot awards in live dealer-controlled multiplayer baccarat games. This system aligns jackpot themes, trigger conditions, and payout structures with various seasons, holidays, or special events throughout the year, creating a constantly evolving and culturally relevant gaming experience.

Each Electronic Table Game Terminal (ETGT) or Live Dealer Game Table (LDGT) is connected to a centralized Seasonal Jackpot Themes system. This system manages the current theme, adjusting jackpot rules, visuals, and payout structures based on the time of year or ongoing events.

The implementation involves a flexible software framework and adaptive user interface. Each ETGT or LDGT is equipped with a theme management module that interfaces with the game logic controller. This module updates the terminal's visual elements, sound effects, and gameplay mechanics to match the current seasonal theme.

For example, during a summer beach theme, the jackpot may be triggered by collecting “sunscreen” symbols on cards. In winter, players may need to build a “snowman” with specific card combinations. During Chinese New Year, the jackpot may revolve around collecting all zodiac animals.

The casino's central server maintains a calendar of themes, automatically transitioning between them at predetermined times. It also manages theme-specific jackpot pools, trigger conditions, and payout structures, ensuring a seamless experience across all connected terminals.

### Benefits to Players:

1. Offers a fresh and exciting jackpot experience throughout the year
2. Aligns gaming experience with current seasons or cultural events
3. Provides variety in gameplay and winning conditions
4. Creates anticipation for upcoming seasonal themes
5. Allows players to engage with culturally relevant content

### Benefits to Casinos:

1. Keeps the baccarat offering fresh and engaging year-round
2. Aligns with marketing and promotional calendars
3. Attracts players during specific seasons or events
4. Offers flexibility in managing jackpot funds and payout frequencies
5. Creates opportunities for themed events and tournaments

Example Walk-Through Scenario: It's December, and Maria enters the casino to find the baccarat area transformed with a winter wonderland theme. The Seasonal Jackpot Themes system is currently running a “Frosty's Fortune” event. Maria sits at a live dealer baccarat ETGT, which displays a whimsical winter scene.

As Maria begins playing, she notices that certain card combinations contribute to building a virtual snowman on her screen. The jackpot will be triggered when a player completes their snowman with a top hat, which is achieved by drawing an Ace of Spades.

Maria's ETGT screen shows her progress in building the snowman, adding body parts with each qualifying hand. She sees that other players at nearby tables are also at various stages of snowman construction, creating a festive and competitive atmosphere.

As she plays, Maria completes the body and head of her snowman. The ETGT congratulates her progress with a shower of virtual snowflakes and a cheerful jingle. She's now only one step away from the jackpot—needing only the Ace of Spades to complete her snowman.

Excitement builds as Maria continues to play. Finally, on a banker hand, the dealer reveals the Ace of Spades. Maria's screen erupts in celebration as her snowman is topped with a hat, triggering the “Frosty's Fortune” jackpot.

The ETGT displays Maria's win—a cool $25,000 jackpot. As part of the winter theme, her winnings are shown as a pile of golden snowballs. The central display above the baccarat area announces Maria's win, sending a flurry of virtual snow across all connected screens.

As Maria basks in her wintery win, she notices a countdown timer indicating when the next seasonal theme will begin—a “Spring Bloom Bonanza” set to start in a few weeks. This anticipation for the upcoming theme encourages Maria to plan future visits to the casino.

### Example System Procedural Flow

1. Casino management configures Seasonal Jackpot Themes parameters in the central server.
2. Central server activates the current seasonal theme (Winter Wonderland) across all ETGTs and LDGTs.
3. Player Maria logs into an ETGT using her player card or account.
4. ETGT initializes the themed interface, displaying the winter scene and snowman-building progress.
5. Maria places a bet, which is recorded by the ETGT.
6. ETGT sends bet data and game outcome to the central server.
7. If the outcome contributes to building the snowman, server updates Maria's progress.
8. ETGT displays updated snowman construction on Maria's screen.
9. Steps 5-8 repeat as Maria continues playing.
10. When Maria's hand includes the Ace of Spades, completing the snowman, ETGT sends a jackpot trigger signal to the server.
11. Server verifies the jackpot trigger and calculates the payout based on the seasonal theme rules.
12. Server sends jackpot win data to Maria's ETGT and a win announcement to all connected terminals.
13. Maria's ETGT displays the themed win animation and adds the jackpot amount to her balance.
14. Central server updates the jackpot pool and resets for the next player.
15. Server continues to track time until the next seasonal theme change.
16. At the designated time, server initiates the transition to the new seasonal theme.
17. All ETGTs and LDGTs update their interfaces and rule sets to match the new theme.

Throughout this process, the ETGTs, LDGTs, and central server exchange encrypted data packets containing bet information, game outcomes, theme-specific progress updates, player identification, and jackpot calculations. The system employs redundant checks to ensure accurate tracking of themed objectives and fair distribution of jackpot funds.

Noteworthy Aspects and Features: The Seasonal Jackpot Themes technique introduces several innovative elements to live dealer baccarat games. It transforms the static jackpot experience into a dynamic, ever-changing journey that keeps players engaged throughout the year.

The system's ability to seamlessly transition between themes without disrupting ongoing gameplay is a technical achievement. It may require a flexible software architecture that may adapt game rules, visuals, and payout structures on the fly.

The alignment of jackpot themes with cultural events and seasons creates marketing synergies and opportunities for cross-promotion within the casino and beyond. It allows the baccarat offering to feel fresh and relevant, even to regular players.

The use of visual storytelling (like building a snowman) within the jackpot mechanism adds a narrative element to the game. This may increase player investment and create more memorable gaming experiences.

This technique introduces a new reason for players to return to the casino regularly. The anticipation of upcoming themes and the limited-time nature of each jackpot event may drive repeat visits and increase player loyalty.

### Grand Paradise Jackpot™ Calculation and Distribution Technique #32—Virtual Reality Jackpot Experience

Description and Implementation: The Virtual Reality Jackpot Experience technique introduces a groundbreaking approach to jackpot awards in live dealer-controlled multiplayer baccarat games by incorporating cutting-edge virtual reality (VR) technology. This system transforms jackpot wins from mere monetary awards into immersive, unforgettable experiences that transport players into fantastical virtual worlds.

Each Electronic Table Game Terminal (ETGT) is equipped with a VR-ready display and a compartment containing a high-end VR headset. The Live Dealer Game Tables (LDGTs) are surrounded by VR-enabled stations for seamless integration. This setup is connected to a powerful Virtual Reality Jackpot Experience system capable of rendering complex 3D environments in real-time.

The implementation involves advanced VR software, high-performance graphics processing, and integration with the existing game logic. Each ETGT or LDGT VR station is equipped with a VR experience module that interfaces with the game controller and the central VR content server.

When a jackpot is triggered, instead of simply displaying a win amount, the system activates the VR component. The winner dons the VR headset and is immediately transported into a virtual environment themed around their win. For example, a player may find themselves on a private yacht, with stacks of virtual cash representing their winnings. They may interact with this environment, perhaps by making it “rain money” or diving into a pool filled with gold coins.

The casino's central server manages a library of VR experiences, each tied to different jackpot tiers or special events. It also tracks players' previous VR jackpot experiences to ensure variety in repeat wins.

### Benefits to Players:

1. Offers an unprecedented, immersive celebration of jackpot wins
2. Creates unforgettable gaming memories beyond monetary value
3. Provides a unique experience that may be shared with friends and on social media
4. Adds an extra layer of anticipation and excitement to jackpot pursuit
5. Allows players to “experience” their winnings in ways not possible in real life

### Benefits to Casinos:

1. Differentiates the casino's baccarat and jackpot offering with cutting-edge technology
2. Creates a strong word-of-mouth marketing tool as players share their VR experiences
3. Attracts tech-savvy and experience-seeking players
4. Offers new sponsorship and branding opportunities within VR environments
5. Provides valuable data on player preferences and behaviors in VR settings

Example Walk-Through Scenario: James, an avid baccarat player, settles in at a VR-enabled ETGT. As he plays, he notices the jackpot amount growing on his screen, accompanied by tantalizing glimpses of potential VR experiences tied to different win tiers.

After several hands, James hits a specific card combination that triggers the jackpot. His screen erupts in celebration, announcing he's won the “Platinum Paradise Jackpot” worth $100,000. But instead of just showing the win amount, the screen prompts James to put on the VR headset for his “Winning Experience.”

As James dons the headset, he finds himself transported to a luxurious private island. A virtual host congratulates him and gestures to a massive pile of gold coins on the beach, representing his $100,000 win. James is invited to interact with his winnings, and he joyfully dives into the pile, feeling the rush of being surrounded by his jackpot prize.

The experience continues as James is offered choices: he may take a virtual yacht tour around his island, go on a shopping spree in a high-end virtual mall where everything “costs” a portion of his winnings, or skydive from a private jet, watching his winnings rain down around him.

Throughout the experience, James may see his actual win amount displayed discretely, ensuring he never loses track of his real prize. He's also given the option to capture photos and videos of his virtual experience to share later.

After about five minutes of VR immersion, James reluctantly returns to reality. His ETGT screen now displays a summary of his win and VR experience, along with options to view and share photos from his virtual celebration.

Excited by both his win and the unforgettable VR experience, James continues playing, eager for a chance to unlock even more elaborate virtual celebrations tied to higher jackpot tiers.

### Example System Procedural Flow

1. Casino management configures Virtual Reality Jackpot Experience parameters in the central server.
2. Player James logs into a VR-enabled ETGT using his player card or account.
3. ETGT displays standard game interface along with jackpot information and VR teasers.
4. James places bets and plays hands, with all data sent to the central server.
5. When James hits the jackpot combination, ETGT sends a jackpot trigger signal to the server.
6. Server verifies the jackpot win and selects an appropriate VR experience based on the win tier.
7. Server sends jackpot win data and VR experience parameters to James's ETGT.
8. ETGT prompts James to put on the VR headset and initiates the VR experience.
9. VR module renders the immersive environment and tracks James's interactions.
10. Throughout the VR experience, the system captures screenshots and video clips.
11. After the VR experience, ETGT returns to standard display, showing win summary and VR highlights.
12. Server updates James's player profile with jackpot win data and VR experience details.
13. ETGT offers James options to view and share his VR experience media.
14. If James continues playing, the system ensures any subsequent jackpot wins trigger different VR experiences.

Throughout this process, the ETGTs, LDGTs, and central server exchange encrypted data packets containing game outcomes, jackpot triggers, VR content instructions, player interactions, and media captures. The system employs redundant checks to ensure smooth VR experiences and accurate jackpot distributions.

Noteworthy Aspects and Features: The Virtual Reality Jackpot Experience technique introduces a revolutionary element to live dealer baccarat games. It transforms the moment of winning from a simple financial transaction into a multi-sensory, immersive event.

The integration of high-end VR technology with traditional casino games represents a significant technical achievement. It may require seamless coordination between game logic, jackpot systems, and VR rendering engines to provide a smooth and lag-free experience.

The system's ability to offer varied experiences based on jackpot tiers and to track player history ensures that the VR component remains fresh and exciting, even for frequent winners. This adaptability is notable to maintaining long-term player engagement.

The capture and sharing capabilities of the VR experiences create powerful marketing opportunities. Players become brand ambassadors as they share their unique virtual celebrations on social media platforms.

This technique opens up new avenues for player rewards and loyalty programs. Exclusive or personalized VR experiences may be offered to high-rollers or as part of promotional events, further enhancing the casino's ability to offer unique and compelling gaming experiences.

### Grand Paradise Jackpot™ Calculation and Distribution Technique #33—Eco-Friendly Jackpot Initiative

Description and Implementation: The Eco-Friendly Jackpot Initiative introduces a socially responsible and environmentally conscious approach to jackpot awards in live dealer-controlled multiplayer baccarat games. This innovative system ties jackpot wins to real-world positive environmental impacts, allowing players to contribute to ecological causes while enjoying their gaming experience.

Each Electronic Table Game Terminal (ETGT) or Live Dealer Game Table (LDGT) is connected to an Eco-Friendly Jackpot Initiative system. This system tracks players' gaming activity and translates it into environmental contributions, such as trees planted, carbon offsets purchased, or clean water provided to communities in need.

The implementation involves partnerships with environmental organizations and real-time impact calculation algorithms. Each ETGT or LDGT is equipped with an eco-impact module that interfaces with the game logic controller. This module calculates the environmental contribution based on the player's betting activity and game outcomes.

For example, each hand played may contribute to planting a fraction of a tree. Winning hands may multiply this contribution. When a player triggers the jackpot, not only do they win a monetary prize, but they also fund a significant ecological project, such as reforesting an acre of land or installing solar panels in a developing community.

The casino's central server maintains records of all eco-contributions and partners with verified environmental organizations to ensure the real-world implementation of these projects. Players may track their individual and collective impact through the ETGT interface and a dedicated mobile app.

### Benefits to Players:

1. Allows players to make a positive environmental impact while gaming
2. Provides a sense of purpose and social responsibility to the gaming experience
3. Offers the excitement of contributing to large-scale ecological projects
4. Creates a feeling of community among players working towards common environmental goals
5. Allows players to track and share their positive impact over time

### Benefits to Casinos:

1. Enhances the casino's corporate social responsibility profile
2. Attracts environmentally conscious players
3. Creates positive publicity and marketing opportunities
4. Differentiates the casino's baccarat offering in a meaningful way
5. Builds community goodwill and strengthens the casino's brand image

Example Walk-Through Scenario: Elena, an environmentally conscious baccarat enthusiast, is drawn to the Eco-Friendly Jackpot Initiative featured at her local casino. She sits down at an ETGT and logs in, immediately seeing her cumulative environmental impact from previous sessions—5 trees planted and 100 gallons of clean water provided.

As Elena begins playing, she notices that each hand contributes to a virtual forest on her screen. Winning hands cause her trees to grow faster. The ETGT display shows both her potential monetary jackpot and her growing environmental impact.

After several hands, Elena hits a lucky streak, causing her virtual forest to flourish. She's excited to see that she's contributed the equivalent of planting 3 more trees in just this session.

Suddenly, Elena hits the jackpot combination. Her screen erupts in celebration, announcing she's won the “Green Paradise Jackpot” worth $50,000. But the excitement doesn't stop there—the screen also reveals that her win has funded the reforestation of an entire acre of rainforest.

Elena is presented with a choice: she may split her jackpot win, taking $40,000 in cash and allocating $10,000 to additional environmental projects, or she may take the full $50,000. Inspired by the impact she's already made, Elena chooses to split her winnings.

The ETGT screen then shows Elena a real-time visualization of the acre of rainforest she's helped restore, complete with native wildlife. She's given the option to name her forest and receive updates on its growth over time.

As Elena continues to play, she's motivated not just by the potential for another jackpot win, but also by the ongoing positive impact she's making with each hand. The ETGT screen continues to update her on her growing environmental contributions, creating a sense of accomplishment beyond monetary gains.

### Example System Procedural Flow

1. Casino management configures Eco-Friendly Jackpot Initiative parameters in the central server.
2. Casino establishes partnerships with verified environmental organizations.
3. Player Elena logs into an ETGT using her player card or account.
4. ETGT displays Elena's cumulative environmental impact from previous sessions.
5. Elena places a bet, which is recorded by the ETGT.
6. ETGT sends bet data and game outcome to the central server.
7. Server calculates the environmental contribution based on the bet and outcome.
8. ETGT updates Elena's virtual forest display and environmental impact metrics.
9. Steps 5-8 repeat as Elena continues playing.
10. When Elena hits the jackpot combination, ETGT sends a jackpot trigger signal to the server.
11. Server verifies the jackpot win and calculates both the monetary prize and the associated large-scale environmental project.
12. Server sends jackpot win data and environmental impact information to Elena's ETGT.
13. ETGT displays win animation, showing both monetary and environmental achievements.
14. Elena chooses to split her jackpot between cash and additional environmental projects.
15. Server records Elena's choice and updates her player profile.
16. Server initiates the process for implementing the real-world environmental projects.
17. ETGT provides Elena with options to name her reforested acre and set up future updates.
18. Throughout the session, server continuously updates Elena's cumulative impact data.
19. At session end, server finalizes Elena's environmental contributions for the day.
20. Data is sent to partner organizations to action the real-world implementations.

Throughout this process, the ETGTs, LDGTs, and central server exchange encrypted data packets containing bet information, game outcomes, environmental impact calculations, player choices, and jackpot distributions. The system employs redundant checks to ensure accurate tracking of eco-contributions and fair distribution of both monetary and environmental rewards.

Noteworthy Aspects and Features: The Eco-Friendly Jackpot Initiative introduces a socially responsible dimension to live dealer baccarat games. It aligns the excitement of gambling with positive real-world impacts, potentially shifting the perception of casino gaming.

The real-time calculation and visualization of environmental impacts may require sophisticated algorithms that may translate gaming activity into meaningful ecological metrics. This technical feature helps players immediately see the positive effects of their play.

The system's ability to partner with and fund legitimate environmental projects represents a logistical innovation in the gaming industry. It may require robust verification processes and ongoing relationships with ecological organizations.

The choice given to players to allocate their winnings between cash and additional environmental projects adds a layer of personalization and engagement. It allows players to feel a sense of control and further investment in the causes they're supporting.

This technique opens up new avenues for long-term player engagement. The ability to name and receive updates on funded projects creates an ongoing connection between the player, the casino, and the environmental cause, potentially increasing player loyalty and repeat visits.

### Grand Paradise Jackpot™ Calculation and Distribution Technique #34—Metamorphic Jackpot System

Description and Implementation: The Metamorphic Jackpot System introduces a dynamic and evolving approach to jackpot awards in live dealer-controlled multiplayer baccarat games. This innovative system features a jackpot that constantly changes its form, trigger conditions, and payout structure based on real-time gaming data and player behaviors.

Each Electronic Table Game Terminal (ETGT) or Live Dealer Game Table (LDGT) is connected to a centralized Metamorphic Jackpot System. This system analyzes vast amounts of game data, player activities, and current casino conditions to continuously reshape the jackpot experience.

The implementation involves advanced machine learning algorithms and predictive analytics. Each ETGT or LDGT is equipped with a metamorphic module that interfaces with the game logic controller. This module sends 40 comprehensive gameplay data to the central server and receives updated jackpot parameters in real-time.

For example, if the system detects a trend of conservative betting, it may morph the jackpot to favor smaller, more frequent payouts. If players are taking more risks, the jackpot may evolve to offer larger, less frequent awards. The trigger conditions may shift from card combinations to betting patterns, or even incorporate elements from recent winners' strategies.

The casino's central server uses AI to constantly evaluate and adjust the jackpot parameters. It balances factors such as player engagement, casino profitability, and game excitement to create an optimal jackpot experience at any given moment.

### Benefits to Players:

1. Offers a constantly fresh and unpredictable jackpot experience
2. Adapts to players' collective preferences and behaviors
3. Provides varied winning opportunities that change over time
4. Creates a sense of urgency to play when favorable jackpot conditions arise
5. Allows players to influence the jackpot system through their gameplay choices

### Benefits to Casinos:

1. Maximizes player engagement by tailoring the jackpot to current trends
2. Optimizes jackpot profitability through real-time adjustments
3. Creates a unique, ever-changing attraction in the casino
4. Generates valuable data on player preferences and behaviors
5. Allows for quick implementation of new jackpot ideas without system overhauls

Example Walk-Through Scenario: Marcus enters the casino and approaches the baccarat area, curious about the Metamorphic Jackpot System he's heard about. He notices a large display showing the current state of the jackpot: “Triple Threat Jackpot—Win by hitting three consecutive banker pairs!”

As Marcus settles in at an ETGT, he sees the jackpot details on his screen. The current form offers three tiers of prizes for achieving the goal, with the top tier at $100,000. Excited by this challenge, Marcus begins playing, focusing on banker bets.

After about 20 minutes, Marcus notices a shift. The jackpot display changes, now reading: “Hot Streak Jackpot—Win by correctly predicting the outcome of 5 hands in a row!” The prize structure has also changed, now offering a single large payout of $150,000.

The ETGT screen informs Marcus that this change was triggered by an increase in player risk-taking behavior across the casino floor. The new jackpot form encourages strategic thinking and rewards confident play.

Marcus adapts his strategy to this new jackpotform, carefully considering each prediction. As he plays, he notices minor tweaks to the jackpot—the required streak length adjusts based on win rates, and the prize amount fluctuates with the betting volume.

Suddenly, the system detects a lull in overall casino activity. The jackpot morphs again, this time into a “Community Jackpot Challenge.” Now, all active players are working together to achieve a casino-wide goal of 1000 total wins within an hour. If achieved, the $200,000 prize will be split among all participants based on their contribution.

This new form energizes the entire baccarat area. Marcus feels a sense of camaraderie with other players as they collectively pursue the goal. The ETGT screens display real-time progress, building excitement as they approach the target.

As the night progresses, Marcus experiences several more jackpot mutations, each offering a unique challenge and reward structure. He's captivated by the ever-changing nature of the game, never knowing what form the jackpot will take next.

### Example System Procedural Flow

1. Casino management initializes the Metamorphic Jackpot System with base parameters.
2. Central server begins analyzing real-time casino data and player behaviors.
3. Player Marcus logs into an ETGT using his player card or account.
4. ETGT displays current jackpot form: “Triple Threat Jackpot.”
5. Marcus places bets, which are recorded by the ETGT.
6. ETGT sends bet data, game outcomes, and player behavior metrics to the central server.
7. Server continuously analyzes incoming data from all ETGTs and LDGTs.
8. Based on analyzed trends, server decides to morph the jackpot.
9. Server generates new jackpot parameters for “Hot Streak Jackpot.”
10. Server sends updated jackpot data to all connected ETGTs and LDGTs.
11. Marcus's ETGT updates to display new jackpot information.
12. Steps 5-11 repeat as gameplay continues and the jackpot keeps evolving.
13. Server detects casino-wide conditions suitable for a community challenge.
14. Server morphs jackpot into “Community Jackpot Challenge” and broadcasts to all terminals.
15. All ETGTs and LDGTs update to show community challenge progress.
16. Server tracks contributions from all players towards the community goal.
17. If community goal is achieved, server calculates individual payouts based on contributions.
18. Server sends payout data to relevant ETGTs and LDGTs.
19. Terminals display winnings and update player balances.
20. System resets and begins analyzing data for the next jackpot mutation.

Throughout this process, the ETGTs, LDGTs, and central server exchange encrypted data packets containing gameplay information, player metrics, jackpot parameters, and payout calculations. The system employs redundant checks to ensure fair and accurate implementation of the constantly changing jackpot conditions.

Noteworthy Aspects and Features: The Metamorphic Jackpot System introduces an unprecedented level of dynamism to live dealer baccarat games. It creates a gaming environment that is responsive to player behaviors and casino conditions in real-time.

The use of advanced AI and machine learning algorithms to analyze complex data sets and make predictive decisions about optimal jackpot forms is a significant technological innovation in the casino industry.

The system's ability to rapidly deploy new jackpot ideas without requiring hardware changes or extensive reprogramming allows for unprecedented flexibility in casino operations. New concepts may be tested quickly and either expanded or discarded based on player response.

The metamorphic nature of the jackpot adds an element of meta-game strategy for players. Observant players may attempt to predict or even influence upcoming jackpot changes through their betting behaviors.

This technique creates a unique narrative for each gaming session. Players experience a journey through various jackpot forms, potentially increasing their engagement and time spent at the tables. The unpredictable nature of the system ensures that no two visits to the casino are ever quite the same.

### Grand Paradise Jackpot™ Calculation and Distribution Technique #35—Holographic Jackpot Spectacular

Description and Implementation: The Holographic Jackpot Spectacular introduces a visually stunning and immersive approach to jackpot celebrations in live dealer-controlled multiplayer baccarat games. This system utilizes cutting-edge holographic technology to create three-dimensional, interactive displays that bring jackpot wins to life in spectacular fashion.

Each Electronic Table Game Terminal (ETGT) is equipped with a compact holographic projector, while the Live Dealer Game Tables (LDGTs) are surrounded by larger, more powerful holographic systems. These are all connected to a central Holographic Jackpot Spectacular control system that manages the content and timing of holographic displays.

The implementation involves advanced 3D rendering technology, real-time animation systems, and precisely calibrated holographic projection hardware. Each ETGT or LDGT area is equipped with a holographic module that interfaces with the game logic controller and the central holographic content server.

When a jackpot is triggered, instead of a simple visual on a 2D screen, the system activates a dazzling holographic show. For example, a cascade of holographic coins may appear to pour out of the ceiling, or a lifelike 3D dragon may swoop down and breathe “fire” (safely created through holographic effects) to reveal the jackpot amount.

The casino's central server maintains a library of holographic celebrations, each tied to different jackpot tiers or special events. It also manages the synchronization of holographic displays across multiple terminals or tables for larger, coordinated shows.

### Benefits to Players:

1. Provides an unparalleled, immersive celebration of jackpot wins
2. Creates unforgettable visual spectacles that enhance the thrill of winning
3. Offers a unique experience that may't be replicated in online gaming
4. Adds an element of anticipation and excitement to potential jackpot triggers
5. Allows players to feel like the star of their own spectacular show upon winning

### Benefits to Casinos:

1. Differentiates the casino's baccarat offering with state-of-the-art visual technology
2. Creates a stunning attraction that draws attention and new players
3. Provides Instagram-worthy moments that players are to share, driving social media engagement
4. Offers new possibilities for themed events and tournaments with custom holographic displays
5. Enhances the overall atmosphere and excitement of the casino floor

Example Walk-Through Scenario: Sophia enters the casino, immediately drawn to the baccarat area where she sees occasional bursts of holographic activity above the tables. Intrigued, she sits at a holographic-enabled ETGT and begins to play.

As Sophia plays, she notices smaller holographic effects tied to game events. When she hits a natural 9, a small fireworks display erupts above her terminal. These minor effects build her anticipation for what a full jackpot celebration may entail.

After several hands, Sophia hits a jackpot-triggering combination. Suddenly, the area above and around her ETGT comes to life. A holographic vortex appears to form in midair, swirling with colors and light. From this vortex, a majestic holographic phoenix emerges, spreading its wings across the baccarat area.

The phoenix flies a circle around Sophia's terminal, leaving a trail of holographic flames. As it completes its circuit, the flames coalesce to form the jackpot amount—$75,000—floating in 3D space above Sophia's head.

Other players gather around, amazed by the spectacle. The holographic phoenix then appears to interact with Sophia, bowing its head towards her in acknowledgment of her win. As a final flourish, it explodes into a shower of holographic feathers that rain down around Sophia before fading away.

The central display area then activates its larger holographic projectors, creating a huge 3D leaderboard that shows Sophia's win at the top, along with other recent jackpot winners. This display is visible across the casino floor, drawing more attention to the baccarat area.

As the celebration concludes, Sophia is presented with a recap of the holographic show on her ETGT screen, along with options to view and share photos captured during the event. She's also given a digital souvenir—a small holographic phoenix she may project from her smartphone as a memento of her win.

Excited by both her win and the unforgettable celebration, Sophia continues playing, eager for a chance to experience another Holographic Jackpot Spectacular.

### Example System Procedural Flow

1. Casino management configures Holographic Jackpot Spectacular parameters in the central server.
2. Player Sophia logs into a holographic-enabled ETGT using her player card or account.
3. ETGT displays standard game interface along with occasional minor holographic effects.
4. Sophia places bets and plays hands, with all data sent to the central server.
5. When Sophia hits the jackpot combination, ETGT sends a jackpot trigger signal to the server.
6. Server verifies the jackpot win and selects an appropriate holographic celebration based on the win tier.
7. Server sends jackpot win data and holographic show parameters to Sophia's ETGT and surrounding projection systems.
8. Holographic modules activate, rendering the 3D phoenix celebration in real-time.
9. Central system coordinates the holographic display across multiple projectors for a seamless experience.
10. Throughout the show, the system captures photos and video from multiple angles.
11. After the main celebration, the central area projectors activate to display the 3D leaderboard.
12. ETGT returns to standard display, showing win summary and holographic show highlights.
13. Server updates Sophia's player profile with jackpot win data and celebration details.
14. ETGT offers Sophia options to view and share media from her holographic celebration.
15. Server adds Sophia's win to the rotation of recent jackpots for future holographic leaderboard displays.

Throughout this process, the ETGTs, LDGTs, holographic modules, and central server exchange encrypted data packets containing game outcomes, jackpot triggers, holographic content instructions, and celebration media. The system employs redundant checks to ensure smooth and synchronized holographic experiences across multiple devices.

Noteworthy Aspects and Features: The Holographic Jackpot Spectacular introduces a revolutionary visual element to live dealer baccarat games. It transforms the moment of winning from a simple announcement into a multi-sensory, immersive event that captivates not just the winner, but everyone in the vicinity.

The integration of advanced holographic technology with traditional casino games represents a significant technical achievement. It may require precise coordination between game logic, jackpot systems, and multiple holographic projectors to provide a seamless and realistic 3D experience.

The system's ability to offer varied holographic celebrations based on jackpot tiers and special events ensures that the visual spectacles remain fresh and exciting. This adaptability is notable to maintaining long-term player engagement and creating a dynamic casino atmosphere.

The capture and sharing capabilities of the holographic celebrations create powerful marketing opportunities. The stunning visuals are to be shared widely on social media, effectively turning players into brand ambassadors for the casino.

This technique opens up new possibilities for immersive storytelling within the casino environment.

### Grand Paradise Jackpot™ Calculation and Distribution Technique #36—Synergistic Multi-Game Jackpot

Description and Implementation: The Synergistic Multi-Game Jackpot technique introduces a revolutionary approach to jackpot awards by interconnecting multiple casino games, including live dealer-controlled multiplayer baccarat, into a single, massive jackpot system. This innovative method creates a symbiotic relationship between different game types, allowing players to contribute to and win from a shared jackpot pool regardless of their preferred game.

Each Electronic Table Game Terminal (ETGT), Live Dealer Game Table (LDGT), and other participating casino games (such as slot machines, roulette, and poker tables) are connected to a centralized Synergistic Multi-Game Jackpot system. This system tracks player activity across all linked games, pooling contributions and calculating win probabilities based on game-specific factors.

The implementation involves complex cross-game algorithms and real-time data processing. Each gaming device is equipped with a synergy module that interfaces with its game-specific logic controller and the central jackpot server. This module translates game-specific events into standardized jackpot contributions and trigger conditions.

For example, in baccarat, a natural 9 may contribute a larger amount to the jackpot pool, while in slots, a near-miss on a high-paying combination may do the same. The jackpot may be triggered by game-specific rare events, like a six-card 21 in blackjack or a specific card sequence in baccarat, but would be winnable by players of any linked game.

The casino's central server manages the unified jackpot pool, dynamically adjusting contribution rates and win probabilities to ensure fairness across different game types. It also coordinates jackpot notifications and payouts across all participating games.

### Benefits to Players:

1. Offers access to larger jackpots than single-game systems may typically support
2. Provides the excitement of jackpot eligibility across multiple game types
3. Allows players to stick with their preferred games while still participating in a massive jackpot
4. Creates a sense of community among players of different casino games
5. Offers the potential for life-changing wins regardless of the specific game being played

### Benefits to Casinos:

1. Increases overall player engagement across multiple game types
2. Encourages players to explore different games within the casino
3. Creates a unique selling point that sets the casino apart from competitors
4. Potentially increases overall betting volume as players are attracted to the large jackpot
5. Provides flexibility in managing jackpot funds across different game types

Example Walk-Through Scenario: Lisa, a baccarat enthusiast, enters the casino and notices promotions for the Synergistic Multi-Game Jackpot. The current jackpot amount, displayed on screens throughout the casino, stands at an impressive $5,000,000.

Excited by the prospect of such a large win, Lisa sits at a live dealer baccarat ETGT. As she begins playing, she sees that certain outcomes in baccarat contribute to the jackpot pool. A side display shows real-time updates of contributions from various games across the casino.

While playing, Lisa witnesses a slot player hit a major combination. The baccarat table's display momentarily shows this event, indicating a significant contribution to the shared jackpot pool. This interconnectedness adds an extra layer of excitement to Lisa's game.

After several hands, Lisa is dealt a rare combination—three consecutive natural 9s. Her ETGT screen erupts in celebration, announcing that this combination has triggered the Synergistic Multi-Game Jackpot. Screens across the casino light up, showing Lisa's win and the final jackpot amount of $5,250,000.

What makes this win particularly special is that as Lisa is celebrating, she sees a notification that a portion of her winnings will be shared with other players currently active on linked games. This creates a casino-wide celebration, with players at slot machines, roulette tables, and poker rooms all receiving a small part of the massive jackpot.

Lisa's main prize is $5,000,000, with the additional $250,000 distributed among active players on other games. This shared win format fosters a sense of community and excitement throughout the entire casino.

As Lisa basks in her win, she notices the jackpot amount quickly beginning to climb again, fueled by contributions from players inspired by her success. The cyclical nature of this system ensures that the excitement and potential for massive wins are always present, regardless of the game being played.

### Example System Procedural Flow

1. Casino management configures Synergistic Multi-Game Jackpot parameters in the central server.
2. Player Lisa logs into a baccarat ETGT using her player card or account.
3. ETGT displays current game interface along with the shared jackpot amount.
4. Lisa places a bet, which is recorded by the ETGT.
5. ETGT sends bet data and game outcome to the central server.
6. Server calculates the jackpot contribution based on the baccarat outcome.
7. Server updates the shared jackpot pool and broadcasts the new amount to all linked games.
8. Steps 4-7 repeat as Lisa continues playing.
9. When Lisa hits the trigger combination (three consecutive natural 9s), ETGT sends a jackpot trigger signal to the server.
10. Server verifies the jackpot trigger and calculates the final payout amount.
11. Server determines the distribution of the shared portion of the jackpot among active players on other games.
12. Server sends jackpot win data to Lisa's ETGT and notification data to all other linked games.
13. All gaming devices display win animations and payout information.
14. Server initiates the payout process for Lisa and the shared winners.
15. ETGT and other gaming devices update player balances accordingly.
16. Server resets the jackpot to its starting amount and immediately begins tracking new contributions.
17. Throughout the session, server continuously updates jackpot amounts and trigger probabilities based on overall gaming activity.

Throughout this process, the ETGTs, LDGTs, other gaming devices, and central server exchange encrypted data packets containing game outcomes, jackpot contributions, trigger events, and payout calculations. The system employs redundant checks to ensure fair and accurate implementation of the jackpot across all game types.

Noteworthy Aspects and Features: The Synergistic Multi-Game Jackpot system introduces an unprecedented level of interconnectedness to casino gaming. It creates a unified jackpot ecosystem that transcends individual game boundaries.

The technical challenge of normalizing contributions and win conditions across diverse game types represents a significant innovation in casino management systems. It may require sophisticated algorithms to ensure that players of all game types have a fair chance at the jackpot relative to their stakes and game odds.

The shared aspect of the jackpot win, where a portion is distributed to active players across the casino, is a unique feature that fosters a sense of community and shared excitement. This may significantly enhance the overall casino atmosphere and player satisfaction.

The system's ability to dynamically adjust contribution rates and trigger probabilities based on real-time gaming data allows for optimal management of the jackpot pool. This ensures that the jackpot remains attractive across all game types and betting levels.

This technique opens up new possibilities for cross-game promotions and player engagement strategies. Casinos may create special events or challenges that span multiple game types, all tied into the shared jackpot system.

### Grand Paradise Jackpot™ Calculation and Distribution Technique #37—Personalized Jackpot Journeys

Description and Implementation: The Personalized Jackpot Journeys technique introduces a highly individualized and narrative-driven approach to jackpot awards in live dealer-controlled multiplayer baccarat games. This innovative system creates unique, long-term jackpot quests for each player, tailored to their playing style, preferences, and history.

Each Electronic Table Game Terminal (ETGT) or Live Dealer Game Table (LDGT) is connected to a sophisticated Personalized Jackpot Journeys system. This system uses advanced AI and data analytics to craft individual “jackpot stories” for each player, complete with chapters, milestones, and a grand finale.

The implementation involves complex player profiling algorithms and dynamic storytelling engines. Each ETGT or LDGT is equipped with a journey module that interfaces with the game logic controller and the central narrative server. This module tracks detailed player behavior and progress through their personalized jackpot journey.

For example, a player may embark on a “Dragon's Treasure” journey, where each milestone represents a dragon they must defeat through specific baccarat achievements. Another player may have a “Time Traveler's Jackpot” theme, where they progress through different historical eras with each milestone.

The casino's central server uses AI to continuously generate and adjust these personalized journeys. As players progress, the system adapts the story and challenges based on their performance and preferences, ensuring an engaging and achievable path to the jackpot.

### Benefits to Players:

1. Offers a unique, personalized jackpot experience for each player
2. Provides a sense of progression and achievement beyond individual gaming sessions
3. Creates an emotional investment in the jackpot pursuit through storytelling
4. Allows players to set long-term goals within their favorite game
5. Offers varied and interesting challenges that go beyond standard gameplay

### Benefits to Casinos:

1. Increases player retention and loyalty through long-term engagement
2. Provides rich data on player preferences and behaviors over time
3. Creates opportunities for targeted marketing and personalized promotions
4. Differentiates the casino's baccarat offering with a unique, story-driven experience
5. Potentially increases overall play time and betting volume as players pursue their journeys

Example Walk-Through Scenario: Michael, a regular at the casino's baccarat tables, sits down at an ETGT. As he logs in, the system recognizes him and resumes his personalized jackpot journey: “The Celestial Concordance.” Michael's journey theme involves aligning mystical constellations through his baccarat play.

The ETGT screen displays Michael's progress: he's currently on Chapter 3—“The Archer's Aim,” with 2 out of 5 stars in the Sagittarius constellation illuminated. The chapter's challenge is to win five hands with a total point value of 6 (representing the archer's arrow).

As Michael plays, each winning 6-point hand illuminates another star in the constellation. The ETGT provides immersive visuals and sound effects tied to his journey theme, with each success accompanied by a celestial chime and a brightening of the starry background.

After several hands, Michael completes the Sagittarius constellation. The ETGT screen erupts in a dazzling display of cosmic imagery, showing the completed constellation shooting an arrow that opens a portal to the next chapter. Michael is awarded a significant credit bonus and sees his overall journey progress bar increase.

The system then introduces Chapter 4—“The Sea-Goat's Tide,” themed around Capricorn. This new chapter adjusts its difficulty based on Michael's recent performance, ensuring an ongoing challenge that's neither too easy nor too hard.

As Michael continues his cosmic journey across multiple sessions, he's periodically offered choices that affect his path. For example, he may choose between focusing on the “Celestial Light” path (emphasizing winning streaks) or the “Cosmic Balance” path (rewarding alternating banker and player wins).

After several weeks of play, Michael reaches his journey's finale. The last chapter, “The Universal Alignment,” may require him to complete a complex series of hands mirroring the positions of all zodiac constellations. Upon completion, Michael is awarded the grand jackpot, accompanied by a spectacular celestial animation showing the entire universe aligning in his favor.

### Example System Procedural Flow

1. Casino management initializes the Personalized Jackpot Journeys system with base parameters.
2. Player Michael logs into an ETGT using his player card or account.
3. System retrieves Michael's journey data and current progress.
4. ETGT displays Michael's personalized journey interface, showing current chapter and goals.
5. Michael places bets and plays hands, with all data sent to the central server.
6. Server analyzes each game outcome in the context of Michael's current journey chapter.
7. ETGT updates journey progress visuals based on server calculations.
8. When Michael completes a constellation, server verifies the achievement.
9. ETGT displays chapter completion animation and awards associated bonus.
10. Server generates the next chapter parameters based on Michael's overall performance.
11. ETGT presents the new chapter introduction to Michael.
12. Steps 5-11 repeat as Michael progresses through his journey across multiple sessions.
13. When Michael reaches the final chapter, server sets up the grand finale challenges.
14. Upon final chapter completion, server calculates the grand jackpot amount.
15. ETGT displays the epic conclusion animation and grand jackpot win.
16. Server updates Michael's player profile with journey completion data.
17. System begins generating parameters for Michael's next potential journey theme.

Throughout this process, the ETGTs, LDGTs, and central server exchange encrypted data packets containing game outcomes, journey progress updates, chapter completions, and jackpot calculations. The system employs redundant checks to ensure accurate tracking of each player's unique journey and fair distribution of rewards and jackpots.

Noteworthy Aspects and Features: The Personalized Jackpot Journeys technique introduces a narrative-driven, long-term engagement model to live dealer baccarat games. It transforms the jackpot from a single event into an epic quest, deeply personalizing the gaming experience.

The use of AI and machine learning to craft and dynamically adjust individual player journeys represents a significant innovation in player engagement technology. It allows for an unprecedented level of personalization in a multiplayer casino environment.

The system's ability to maintain coherent, themed narratives while adapting to player performance and preferences is a unique feature. It may require sophisticated storytelling algorithms that may create compelling and logical progressions regardless of the player's path.

The integration of visual and audio elements tied to each player's unique journey enhances immersion and emotional investment. This multi-sensory approach to jackpot pursuit may significantly increase player satisfaction and loyalty.

This technique opens up new avenues for player retention and reactivation. The long-term nature of the journeys gives players a reason to return to the casino regularly, while the system may use journey progress data to create targeted promotions to re-engage lapsed players.

### Additional Ldgts and Detgs Wagering and Jackpot Techniques

In general, the method for playing live baccarat described herein includes the following steps: dealing cards to a player's hand and a banker's hand according to a set of conventional baccarat rules, allowing at least a first player to place a bet on live baccarat, allowing at least a second player to place a bet on jackpot where the second player can be the same as or different from the first player, determining the outcome of the live baccarat game according to the set of conventional baccarat rules, and determining the outcome of the jackpot according to a combination of cards defined below.

The method described herein also provides an option for insurance betting. As an example, the method includes the following steps: dealing first two cards to a player's hand and two cards to a banker's hand according to a set of conventional baccarat rules, allowing at least a player to place a bet on live baccarat on either the banker's hand to win or the player's hand to win, determining (1) that an insurance bet for the banker's hand is available for the player to place the insurance bet if the sum of the first two cards of the banker's hand is larger than that of a player's hand; and/or (2) that an insurance bet for the player's hand is available for the player to place the insurance bet if the sum of the first two cards of the player's hand is larger than that of a banker's hand, allowing the first player to place (1) the insurance bet for the banker's hand if the first player has betted on the banker's hand to win on live baccarat; or (2) the insurance bet for the player's hand if the first player has betted on the player's hand to win on live baccarat, determining (1) the outcome of the insurance bet for the banker's hand according to a payout ratio for the insurance bet for the banker's hand if the player's hand wins on live baccarat after a third card is dealt on the banker's hand and/or the player's hand; and/or (2) the outcome of the insurance bet for the player's hand according to a payout ratio for the insurance bet for the player's hand if the banker's hand wins on live baccarat after a third card is dealt on the banker's hand, and determining the outcome of the live baccarat game according to the set of conventional baccarat rules.

As another example, the method that provides for an option for insurance betting includes the steps of: dealing first three cards to a player's according to a set of conventional baccarat rules, allowing at least a player to place a bet on live baccarat on either the banker's hand to win or the player's hand to win, determining that an insurance bet for the player's hand is available for the player to place the insurance bet if the sum of the three cards of the player's hand is larger than the sum of the first two cards of the banker's hand, allowing the first player to place the insurance bet for the player's hand if the first player has betted on the player's hand to win on live baccarat, determining the outcome of the insurance bet for the player's hand according to a payout ratio for the insurance bet for the player's hand if the banker's hand wins on live baccarat after a third card is dealt on the banker's hand, and determining the outcome of the live baccarat game according to the set of conventional baccarat rules.

The present application also provides a software program or a set of software programs for carrying out any or all steps of the betting method described herein. The baccarat game can also be incorporated into an electronic device or an entertainment gaming machine. Representative electronic devices include, but are not limited to, laptop computers or desktop computers.

The object of baccarat is for the bettor to successfully wager on whether the banker's hand or the player's hand is going to win. The bettor receives even money for his wager if he selects the winning hand and loses his wager if he selects the losing hand. Because of the rules of play of baccarat, the banker's hand has a slightly higher chance of winning than does the player's hand. Therefore, if the bettor wagers on the banker's hand, the bettor is required to pay to the gaming establishment a commission (typically 5%) of the amount the bettor wins. No commission is paid if the bettor successfully wagers on the player's hand. The term “wager”, as used herein, can be used interchangeably with the term “bet.” The term “wagering” is used interchangeably with the term “betting.” The term “bettor”, as used herein, is used interchangeably with the term “gambler” or “player”.

Conventional methods of playing baccarat are described as follows: A multiple number of decks of standard playing cards, 52 in number, are used; typically six to twelve decks are shuffled together and placed in a shoe from which the cards are dealt during the play of the game.

Each bettor makes a wager on whether the banker's hand or the player's hand will win. After all wagers are made, two cards are dealt from the shoe to the bank position and two cards are dealt from the shoe to the player's position on the table layout. The cards are turned face up and the value of the banker's hand and the player's hand is determined.

Aces count as one; kings, queens, jacks and tens count as zero and the other cards count as their respective face value. The suits (hearts, diamonds, spades and clubs) have no meaning in baccarat. The highest hand value in baccarat is nine. All hand values range from a low of zero to a high of nine. If when the cards are added together, the total of the hand exceeds nine, then the hand value is determined by subtracting ten from the total of the hand. For example, a seven and nine total sixteen, but the hand value is six. An Ace and a nine total ten, but the hand value is zero.

A two card total of eight or nine is called a “natural”; a two card total of zero is called a “baccarat”. As will be explained hereafter, in certain situations in the play of the game, a third card will be dealt. The value of this third card is added to the total of the first two cards and a new hand value is established. Again, if the new hand total exceeds nine, the hand value is determined by subtracting ten from the total of the hand. Wagering locations are provided on the baccarat table layout. Whichever of the banker's hand or the player's hand is closest to a total of nine is the winner.

The way of betting may differ in different gaming establishments. In the U.S., for example, prior to the deal, each bettor can make one of three wagers: 1) that the banker's hand will win, 2) that the player's hand will win, or 3) that the banker's hand and the player's hand will tie. In Macau, for example, one can make one of five wagers: 1) that the banker's hand will win, 2) that the player's hand will win, 3) that the banker's hand and the player's hand will tie, 4) that the first two cards in the banker's hand are of the same kind, regardless of the type of suit, forming a Bank Pair, or (5) that the first two cards in the player's hand are of the same kind, regardless of the type of suit, forming a Player Pair.

All winning banker's hand wagers in scenario 1) in both the U.S. and Macau are paid off at odds of one-to-one and the house charges a five percent (5%) commission on the amount won by the bettor. For example, if a bettor wagers $100 on the banker's hand and the banker's hand wins, the bettor wins $100 and is charged a $5 commission on the amount that the bettor won. The bettor is not charged any commission on the amount of his wager.

All wagers that select winning player's hand in scenario 2) in both the U.S. and Macau are paid off at odds of one-to-one and the bettor is not charged any commission on the amount of his winnings or his wager.

All winning wagers on the tie in scenario 3) in both the U.S. and Macau can be paid off at odds of eight-to-one (depending on the gaming establishment) and the bettor is not charged any commission on the amount of his winnings or his wager. If a tie hand occurs, all wagers on the banker's hand and all wagers on the player's hand are “pushes” and the amount wagered is returned to the bettor.

All winning wagers on the Bank Pair bet in scenario 4) in Macau can be paid off at odds of eleven-to-one (depending on the gaming establishment) and the bettor is not charged any commission on the amount of his winnings or his wager.

All winning wagers on the Player Pair bet in scenario 5) in Macau can be paid off at odds of eight-to-one (depending on the gaming establishment) and the bettor is not charged any commission on the amount of his winnings or his wager.

The play of baccarat typically uses three casino dealers to operate the game. The casino dealers jointly participate in the shuffling of the decks of cards. After the shuffle is completed, one of the players is typically asked to cut the decks using a plastic cut card. The dealer then separates and restacks the cards from the point of the cut and the dealer or a player then inserts the plastic cut card no less than fifteen cards (in Las Vegas, U.S.) or no less than twelve cards (in Macau) from the ends of the stacked decks and the entire stacked decks are placed into a shoe from which the cards are dealt during the play of the game. When the inserted plastic cut card appears during play, the hand in progress is completed and that round of play then ends. The cards are reshuffled to prepare for the next round of baccarat.

In conventional baccarat, the bettors deal the cards used in the game. Initially, one of the casino dealers (called the “caller”) passes the shoe to the bettor sitting in seat number “1” at the baccarat table. After all wagers have been made, the caller tells the bettor with the shoe to begin the deal. The bettor deals a first card to the caller, a first card to himself, a second card to the caller and a second card to himself. All cards are dealt face down. The two cards given to the caller represent the player's hand and the two cards kept by the bettor who is dealing the cards represent the banker's hand.

The caller than allows one of the other bettors to turn up the player's hand. Traditionally, this honor is given to the bettor who has made the largest wager. The bettor turns up the two cards of the player's hand and tosses them to the caller. The caller places these two cards face up in the table location designated for the “player's hand” and the caller announces the point total of the player's hand.

The bettor who has the shoe then turns over the cards of the banker's hand and tosses these two cards to the caller. The caller places these two cards face up in the table location designated for the “banker's hand” and the caller announces to point total of the banker's hand. Depending on the point total of the player's hand and the banker's hand, one more card may be dealt to either the player's hand, the banker's hand, or both, The rules for determining whether a third card is dealt are fixed rules, there is no discretion for either the player's hand or the banker's hand on whether a third card is dealt.

If either the player's hand or the banker's hand has a point total of eight or nine on the first two cards, no third card is dealt to either hand and the hand with the highest point total is the winner (or the hand is a tie, as the case may be). If none of the player's hand or the banker's hand has a point total of eight or nine, then there is a possibility of a third card draw.

The third card draw rules are as follows: Rule #1: If the initial two card player's hand has a point total of 0, 1, 2, 3, 4 or 5, draws a third card. If the initial two card player's hand has a point total of 6 or 7, the player's hand stands and does not receive a third card. Rule #2: If the player's hand stands and does not draw a third card, then the banker's hand follows Rule #1. In other words, if the player's hand has a point total of 6 or 7, the banker's hand draws a third card on a point total of 0, 1, 2, 3, 4 or 5 and the banker's hand stands on a point total of 6 or 7. Rule #3: If the player's hand draws a third card, the banker's hand must draw or stand as described in Table 3.

TABLE 3

| Bank hand two | Bank hand draws when the | Bank hand stands when the |
|---|---|---|
| card point total | player's hand third card is: | player's hand third card is: |
| 0, 1 or 2 | Bank always draws | — |
| 3 | 0, 1, 2, 3, 4, 5, 6, 7 or 9 | 8 |
| 4 | 2, 3, 4, 5, 6 or 7 | 0, 1, 8 or 9 |
| 5 | 4, 5, 6 or 7 | 0, 1, 2, 3, 8 or 9 |
| 6 | 6 or 7 | 0, 1, 2, 3, 4, 5, 8 or 9 |
| 7 | — | Bank always stands |

All third card draw determinations are autonomically made by the caller who is skilled in the game of baccarat. When the rules of baccarat require a third card for the player's hand, the caller will request a card for the player's hand. After the player's hand is completed, the banker's hand is completed in the same fashion. The caller then declares which hand has the highest point total and declares that hand the winner (or the caller declares a tie hand as the case may be).

In conventional baccarat the bettor who acts as the dealer continues to deal the cards until the player's hand wins. As soon as the player's hand wins, it is customary to pass the shoe counterclockwise around the baccarat table to the next bettor so that each bettor has the opportunity to deal the cards. Any bettor may decline to deal the cards. The fact that one of the bettors is physically dealing the cards has no affect on the outcome of the game because the rules for drawing and standing do not allow any discretion on the part of the players.

The players can play the game according to conventional baccarat rules, which may vary from place to place. In one embodiment, the baccarat game is played according to the U.S. rules as used in Las Vegas. In another embodiment, the baccarat game is played according to the baccarat rules promulgated by the government of Macau Special Administration Region.

In some embodiments, there is a maximum limit on the total bet can be made through a single betting terminal for the live baccarat game. In one embodiment, the maximum bet can be made through one terminal for live baccarat is, for example, HK$20,000.

In some embodiments, the outcome of the jackpot betting is determined by the combination of cards that includes zero-point cards. The combination includes at least one zero-point cards, which are 10, J, Q and K. In one embodiment, the rules for playing Paradise Jackpot™ are described below: (1) The gaming system provides a jackpot. Players who wish to bet on the Paradise Jackpot™ can place a separate bet, e.g. HKD 20 per game in minimum, which will be referred to as bet unit. The maximum number of bet units will not be restricted. (2) Players can bet in Paradise Jackpot™ without placing bet in the same live baccarat game. Each player can place more than one bet unit in one game. When the Paradise Jackpot™ is won, the payout for each bet unit will be equal to the money in the Paradise Jackpot™ pool divided by the total number of bet unit. (3) If the first 5 cards drawn in one baccarat game resulting in A, K, Q, J, 10 in spade, regardless of the sequence, then 100% of the Paradise Jackpot™ is won. (4) If the first 5 cards drawn in one baccarat game resulting in K, Q, J, 10 in spade and A in either heart, club or diamond, regardless of the sequence, then 10% of the Paradise Jackpot™ is won.

In some other embodiments, the Paradise Jackpot™ can be played according to Rules (I)-(III), defined below: (I) The Paradise Jackpot™ is won if any of the following is met: 1) any five cards forming a sequence, regardless of the order they are drawn, e.g., A, 2, 3, 4, 5 or 9, 10, J, Q, K; 2) five cards of a kind, e.g. A, A, A, A, A or K, K, K, K, K; 3) four cards of a kind, regardless of the order they are drawn, e.g., K, K, K, K, 2 or 2, K, K, K, K; 4) three cards of a kind plus a pair, regardless of the order they are drawn, e.g., 10, 10, 10, 2, 2; 5) three cards of a kind, regardless of the order they are drawn, e.g., 2, 2, 2, 10, J; 6) two pairs, regardless of the order they are drawn, e.g., Q, Q, 2, K, K; 7) all the 5 cards of the same symbols (same suit): spade, heart, club or diamond, e.g., A (spade), 10 (spade), J (spade), K (spade), Q (spade); or 8) any specific combination of five cards as specified from time to time.
(II). The Paradise Jackpot™ is won by any specific combination of the first four, three or two cards drawn in a live baccarat game, with regard to/regardless of the drawn sequence. Specifically, the Paradise Jackpot™ is won if any of the following is met: (A) if the first four cards that are drawn form a combination as defined below: 1) the first four cards forming a sequence, with regard to/regardless of the order they are drawn, e.g., A, 2, 3, 4, or 10, J, Q, K; 2) the first four cards of a kind, e.g. A, A, A, A or J, J, J, J; 3) three cards of a kind, with regard to/regardless of the order they are drawn, e.g., K, K, K, 2 or 10, 10, 10, 2; 4) two cards of a kind plus a pair, with regard to/regardless of the order they are drawn, e.g., 2, 2, J, J, which is a two pair sequence; 5) two cards of a kind, with regard to/regardless of the order they are drawn, e.g., 10, 10, Q, Q; 6) all the four cards of the same symbols (same suit): spade, heart, club or diamond, e.g., A (spade), 10 (spade), J (spade), K (spade); or 7) any specific combination of the first four cards as specified from time to time, (B) if the first three cards that are drawn form a combination as defined below: 1) the first three cards forming a sequence, with regard to/regardless of the order they are drawn, e.g., A, 2, 3, or 10, J, K; 2) the first three cards of a kind, e.g. A, A, A or 2, 2, 2; 3) two cards of a kind, with regard to/regardless of the order they are drawn, e.g., K, K, 2 or 10, 10, 2; 4) two cards forming a pair, with regard to/regardless of the order they are drawn, e.g., 2, J, J or J, J, 2; 5) all the three cards of the same symbols (same suit): spade, heart, club or diamond, e.g., A (spade), J (spade), K (spade); or 6) any other specific combination of the first four cards as specified from time to time, or (C) if the first two cards that are drawn form a combination as defined below: 1) the first two cards forming a sequence, with regard to/regardless of the order they are drawn, e.g., A, 2, or J, Q; 2) the first two cards of a kind, e.g. A, A or 10, 10, which is also a pair; 3) the first two cards of the same symbols (same suit): spade, heart, club or diamond, e.g., A (spade), 1 O (spade); or 4) any other specific combination of the first four cards as specified from time to time.
(III) The Paradise Jackpot™ is won by any specific combination of the last six, five, four, three, and two cards drawn in a live baccarat game, with regard to/regardless of the drawn sequence. Specifically, the Paradise Jackpot™ is won if any of the following is met: (A) if the last six cards that are drawn form a combination as defined below: 1) the last six cards forming a sequence, with regard to/regardless of the drawn sequence they are drawn, e.g., A, 2, 3, 4, 5, 6 or 8, 9, 10, J, Q, K; 2) six cards of a kind, e.g. A, A, A, A, A, A or 2, 2, 2, 2, 2, 2; 3) five cards of a kind, with regard to/regardless of the order they are drawn, e.g., K, K, K, K, K, 2 or 2, 10, 10, 10, 10, 10; 4) four cards of a kind, with regard to/regardless of the order they are drawn, e.g., K, K, K, K, 2, 10 or 2, A, J, J, J, J; 5) four cards of a kind plus a pair, with regard to/regardless of the order they are drawn, e.g., K, K, K, K, 2, 2 or 2, 2, J, J, J, J; 6) three cards of a kind plus a pair, with regard to/regardless of the order they are drawn, e.g., 2, 2, 2, J, J, A or J, J, 2, 2, 2, K; 7) three cards of a kind, with regard to/regardless of the order they are drawn, e.g., A, A, A, 10, J, K or 10, J, K, 2, 2, 2; 8) three pairs, with regard to/regardless of the order they are drawn, e.g., Q, Q, K, K, J, J or 2, 2, 10, 10, K, K; 9) all the six cards of the same symbols (same suit): spade, heart, club or diamond, e.g., A (spade), 10 (spade), J (spade), K (spade), Q (spade), 2 (spade); or 10) any other specific combination of six cards as specified from time to time. (B) if the last five cards that are drawn form a combination as defined below: 1) the last five cards forming a sequence, with regard to/regardless of the order they are drawn, e.g., A, 2, 3, 4, 5 or 9, 10, J, Q, K; 2) five cards of a kind, e.g. A, A, A, A, A or 2, 2, 2, 2, 2; 3) four cards of a kind, with regard to/regardless of the order they are drawn, e.g., K, K, K, K, 2 or 2, 10, 10, 10, 10; 4) three cards of a kind plus a pair, regardless of the order they are drawn, e.g., 2, 2, 2, J, J; 5) three cards of a kind, regardless of the order they are drawn, e.g., 2, 2, 2, 10, Q; 6) two pairs, regardless of the order they are drawn, e.g., Q, Q, A, 10, 10; 7) all the 5 cards of the same symbols (same suit): spade, heart, club or diamond; e.g., A (spade), 10 (spade), J (spade), K (spade), Q (spade); or 8) any other specific combination of five cards as specified from time to time, (C) if the last four cards that are drawn form a combination as defined below: 1) the last four cards forming a sequence, with regard to/regardless of the order they are drawn, e.g., A, 2, 3, 4, or 10, J, Q, K; 2) the last four cards of a kind, e.g. A, A, A, A or 10, 10, 10, 10; 3) three cards of a kind, with regard to/regardless of the order they are drawn, e.g., K, K, K, 2 or 10, 10, 10, 2; 4) two cards of a kind plus a pair, regardless of the order they are drawn, e.g., A, A, J, J, which is a two pair sequence; 5) two cards of a kind, regardless of the order they are drawn, e.g., 2, 2, Q, Q; 6) all the four cards of the same symbols (same suit): spade, heart, club or diamond, e.g., A (spade), 10 (spade), K (spade), Q (spade); or 7) any other specific combination of the first four cards as specified from time to time, (D) if the last three cards that are drawn form a combination as defined below: 1) the last three cards forming a sequence, with regard to/regardless of the order they are drawn, e.g., A, 2, 3, or J, Q, K; 2) the last three cards of a kind, e.g. A, A, A or Q, Q, Q; 3) two cards of a kind, with regard to/regardless of the order they are drawn, e.g., K, K, 2 or 10, 10, 2; 4) two cards forming a pair, with regard to/regardless of the order they are drawn, e.g., 2, J, J or J, J, 2; 5) all the last three cards of the same symbols (same suit): spade, heart, club or diamond, e.g., A (spade), J (spade), K (spade); or 6) any other specific combination of the first four cards as specified from time to time, (E) if the last two cards that are drawn form a combination as defined below: 1) the last two cards forming a sequence, with regard to/regardless of the order they are drawn, e.g., A, 2, or 10, J; 2) the last two cards of a kind, e.g. A, A or 2, 2, which is also a pair; 3) the last two cards of the same symbols (same suit): spade, heart, club or diamond, e.g., A (spade), 10 (spade); or 4) any other specific combination of the first four cards as specified from time to time.

In some embodiments, the method and system described herein provided for options for insurance bet for Banker's hand and/or Player's hand. For example, in some embodiments, the insurance options can be available after the first 2 cards have been distributed to each of the Banker's hand and the Player's hand, respectively. In some embodiments, the rules for insurance option for Banker's hand are as follows: An insurance bet for Banker's hand can be only available to the gambler who has already betted on the Banker's hand to win in the same baccarat game. If the sum of the first two cards of Banker's hand is larger than that of Player's hand, the insurance betting option button for Banker's hand will flash on the screen (e.g., flashing for 15 seconds), indicating the insurance betting option for Banker's hand is available for players to put the insurance bets according to the insurance betting rules. The insurance betting option button for Banker's hand will flash on the screen with a payout ratio, which can be, for example, one according to the table below (Table 4) for betting on the winning of Player's hand after a third card is/are dealt on either/both hand(s).

TABLE 4

| Sum of first | Sum of first | Payout ratio if the Player |
|---|---|---|
| 2 cards of | 2 cards of | wins after a third card is/ |
| Banker's hand | Player's hand | are dealt on either/both hand(s) |
| 4 | 0 to 3 | 1.5x |
| 5 | 0 to 4 | 2x |
| 5 | 5 | 1x |
| 6 | 0 to 5 | 3x |
| 7 | 0 to 5 | 4.5x |

In some embodiments, the rules for insurance option or Player's hand are as follows: An insurance bet for Player's hand can be only available to the gambler who has already betted on Player's hand to win in the same baccarat game. If the sum of the first two cards of Player's hand is larger than that of Banker's hand, the insurance betting option button for Player's hand will flash on the screen (for example, flashing for 15 seconds), indicating the insurance betting option for Player's hand is available for players to put the insurance bets according to the insurance betting rules. The insurance betting option button for Player's hand will flash on the screen with a payout ratio, which can be, for example, one according to the table below (Table 5) for betting on the winning of Banker's hand after a third card is dealt on Banker's hand:

TABLE 5

| Sum of first | Sum of first | Payout ratio if the Banker |
|---|---|---|
| 2 cards of | 2 cards of | wins after a third card is |
| Player's hand | Banker's hand | dealt on the Banker's hand |
| 6 | 0 to 5 | 3x |
| 7 | 0 to 5 | 4.5x |

In some embodiments, an insurance bet for Player's hand can be available after the first 3 cards have been distributed to Player. This insurance bet can be only available to the gambler who has already betted on Player's hand to win in the same baccarat game. If the sum of the three cards of Player's hand is larger than the sum of the first two cards of Banker's hand, the insurance betting option button for Player's hand will flash on the screen (e.g., flashing for 15 seconds), indicating the insurance betting option for Player's hand is available for players to put the insurance bets according to the insurance betting rules. The insurance betting option button for Player's hand will flash on the screen with a payout ratio, which can be, for example, one according to the table below (Table 6) for betting on the winning of Banker's hand after a third card is dealt on Banker's hand:

TABLE 6

| Sum of first | Sum of first | Payout ratio if the Banker |
|---|---|---|
| 3 cards of | 2 cards of | wins after a third card is |
| Player's hand | Banker's hand | dealt on the Banker's hand |
| 4 | 0 to 3 | 1x |
| 5 | 0 to 4 | 2x |
| 8 | 0 to 5 | 9x |
| 9 | 0 to 5 | 11x |

In some embodiments, the embodiments of the insurance betting described above and the various embodiments of jackpot described previously can be combined.

The combinations of cards not defined above can be readily derived from time to time with or without the assistance of a computer following established rules of forming combinations of a set of defined members. The amount of Paradise Jackpot™ award can be determined by and distributed according to, e.g., the probability of a combination of cards as defined above or otherwise specified from time to time.

There may be more than one live baccarat game going on simultaneously in different casinos in Macau. In some embodiments, all Paradise Jackpot™ bets from different live baccarat tables will contribute to one grand Paradise Jackpot™ pool. If the Paradise Jackpot™ is won in anyone live baccarat table, all players who place Paradise Jackpot™ bets, regardless of the live baccarat table they bet, will share the grand Paradise Jackpot™ pool according to the bet units that each player placed in the jackpot betting.

Paradise Jackpot™ can be played with bets from players as the sole source of the jackpot pool or with bets and an initial contribution from the banker. The term “banker” generally refers to the owner of a gaming establishment operating the live baccarat defined herein or one who operates the live baccarat game. In one embodiment, the banker contributes a sum of money as the initial Paradise Jackpot™ (e.g., HKD 50,000). A certain percentage, e.g., 55%, of the Paradise Jackpot™ bets from the players will be contributed towards the Paradise Jackpot™ pool, a certain percentage (e.g., 40%) of the bets will be collected by the banker as profit, and the remaining portion (e.g., 5%) of the bets will be accumulated as the seed for the next game.

### Wager-Based Gaming Devices, Systems, and Networks

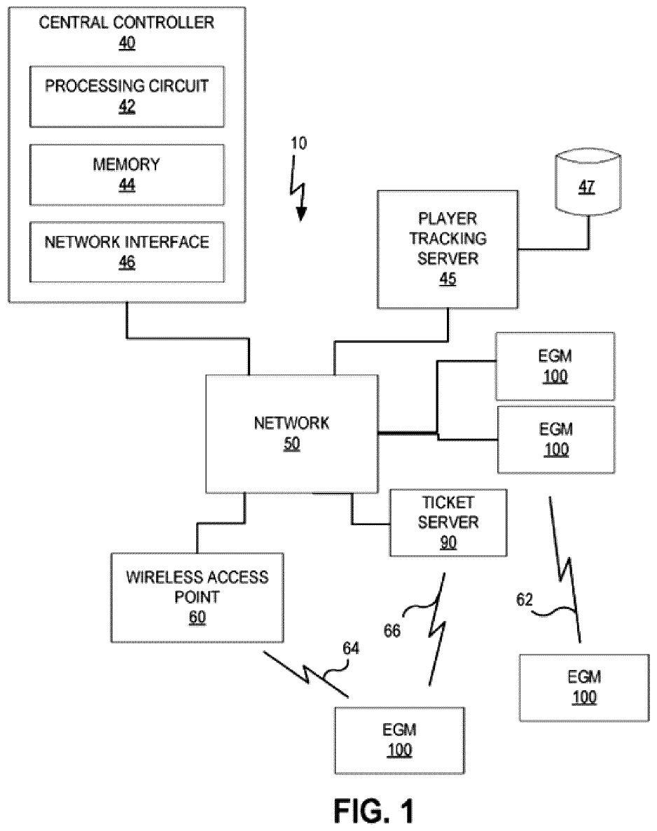

FIG. 1 illustrates a gaming system 10 including a plurality of gaming devices 100. As discussed above, the gaming devices 100 may be one type of a variety of different types of electronic wager-based gaming devices (EGDs), such as, for example, electronic gaming machines (EGMs), electronic table game terminals (ETGTs), mobile devices, or other devices. Collectively, such electronic wager-based gaming devices are referred to herein as electronic gaming devices (EGDs).

The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processor circuit and at least one memory or storage device. Each gaming device 100 may include a processor circuit that transmits and receives events, messages, commands or any other suitable data or signal between the gaming device 100 and the central controller 40. The gaming device processor circuit is operable to execute such communicated events, messages or commands in conjunction with the operation of the gaming device 100. Moreover, the processor circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processor circuits. Moreover, in some embodiments, one or more of the functions of one or more gaming device processor circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processor circuit that transmits and receives events, messages, commands or any other suitable data or signal between the ticket server 90 and the central controller 40. The ticket server 90 processor circuit may be operable to execute such communicated events, messages or commands in conjunction with the operation of the ticket server 90. Moreover, in some embodiments, one or more of the functions of one or more ticket server 90 processor circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, an NFC link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

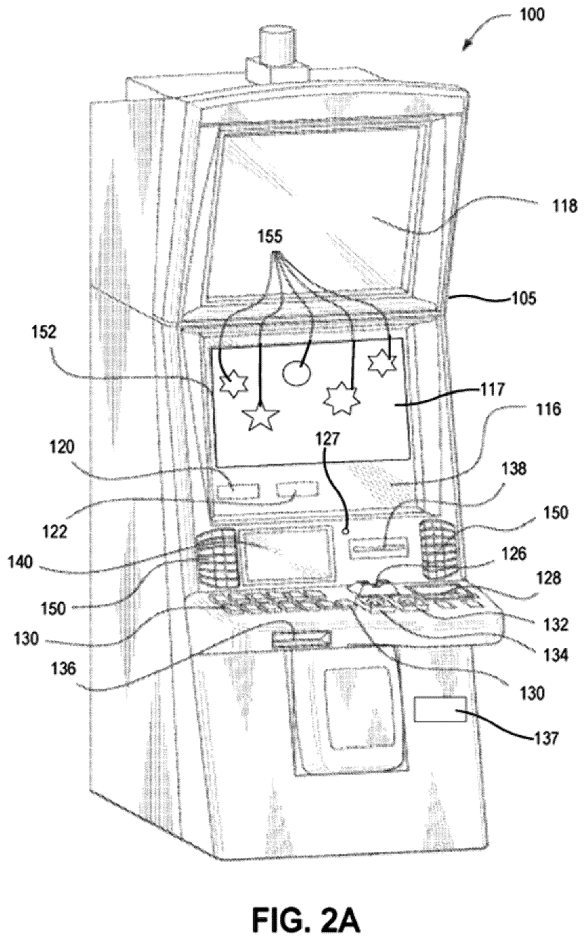

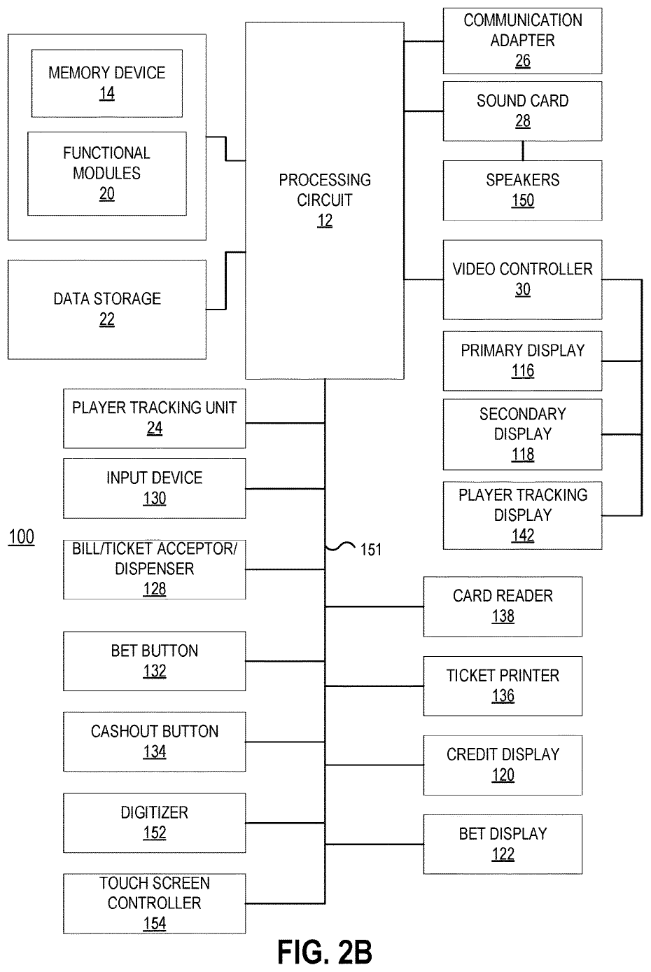

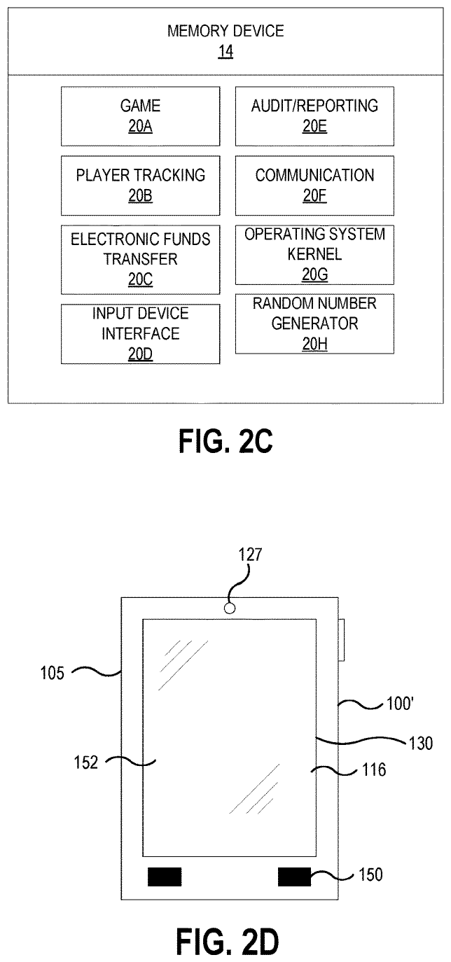

Embodiments herein may include different types of gaming devices. Various embodiments are illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A-C are provided as examples for illustrative purposes only. It will be appreciated that gaming devices may come in many different shapes, sizes, layouts, form factors, and configurations, and with varying numbers and types of input and output devices, and that embodiments of the inventive concepts are not limited to the particular gaming device structures described herein.

Gaming devices 100 typically include a number of standard features, many of which are illustrated in FIGS. 2A-B. For example, referring to FIG. 2A, a gaming device 100 may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processor circuit 12 or directly from a memory device 14 and displays the video data on the display screen. The credit display 120 and the bet display 122 are typically implemented as simple LCD or LED displays that display a number of credits available for wagering and a number of credits being wagered on a particular game. Accordingly, the credit display 120 and the bet display 122 may be driven directly by the processor circuit 12. In some embodiments however, the credit display 120 and/or the bet display 122 may be driven by the video controller 30.

The gaming device 100 may also include a player tracking unit 24 for managing communications and functionality between the processor circuit 12 and certain peripherals and components. Player tracking units 24 may be standardized across machine types to operate interchangeably across a manufacturer's lineup.

Referring again to FIG. 2A, the display devices 116, 118, 140 may include, without limitation: a cathode ray tube, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket printer 136, a bill/ticket acceptor/dispenser 128, that allows the player to deposit and/or receive tickets and/or currency into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processor circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processor circuit 12 that controls operations of the gaming device 100. Although illustrated as a single processor circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processor circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processor circuit 12. It will be appreciated that the components may be connected to the processor circuit 12 through a system bus 151, a communication bus and controller, such as a USB controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processor circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EE PROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, DVD or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network.

The communication adapter 26 may further include circuitry for supporting short range wireless communication protocols, such as Bluetooth and/or near field communications (NFC) that enable the gaming device 100 to communicate, for example, with a mobile communication device operated by a player.

The gaming device 100 may include one or more internal or external communication ports that enable the processor circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumb drives, ticket readers, touch screens, trackballs, touchpads, wheels, and wireless communication devices. In some embodiments, internal or external peripheral devices may communicate with the processor circuit through a universal serial bus (USB) hub (not shown) connected to the processor circuit 12.

In some embodiments, the gaming device 100 may include a sensor, such as a camera 127, in communication with the processor circuit 12 (and possibly controlled by the processor circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processor circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

Many embodiments described herein employ gaming devices 100 that are land-based EGDs, such as banks of slot machines in a casino environment, but in some embodiments, a gaming device 100 may additionally or alternatively include a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

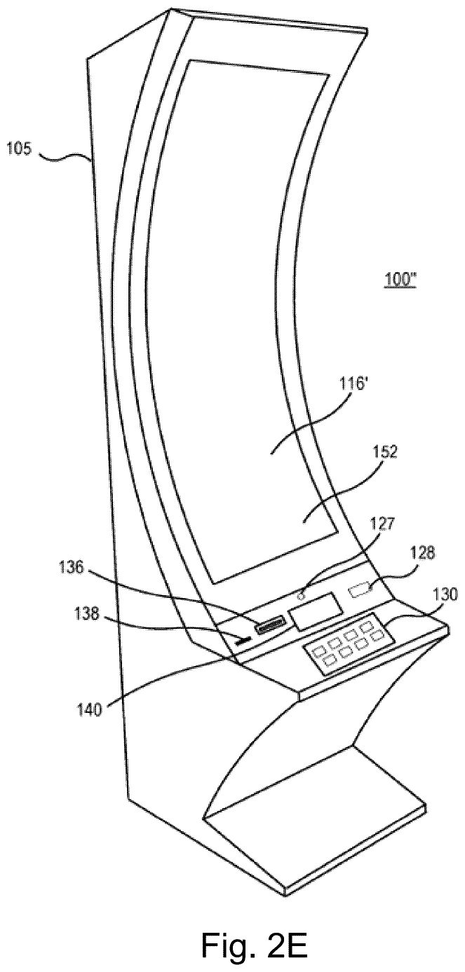

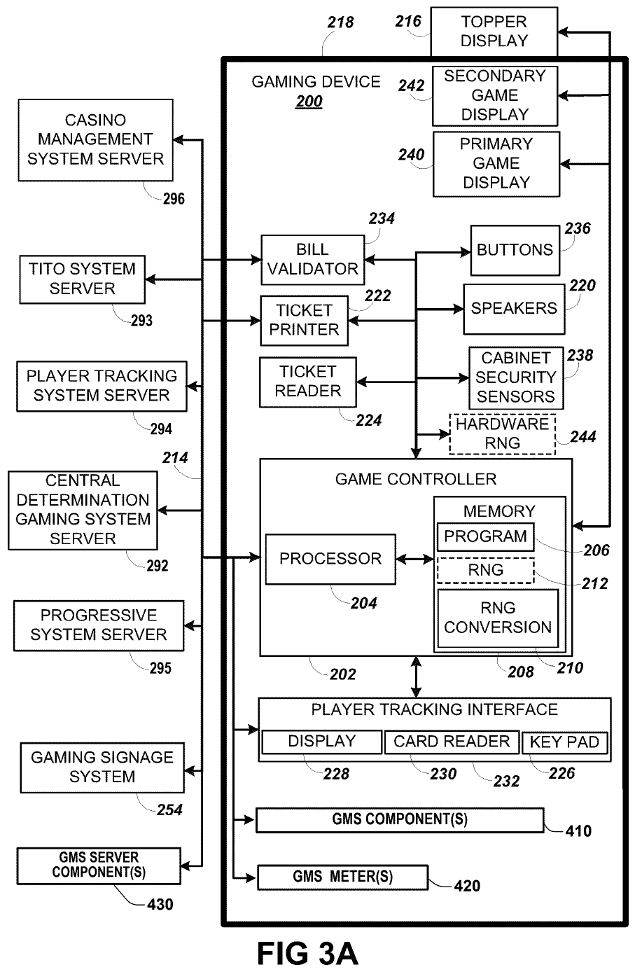

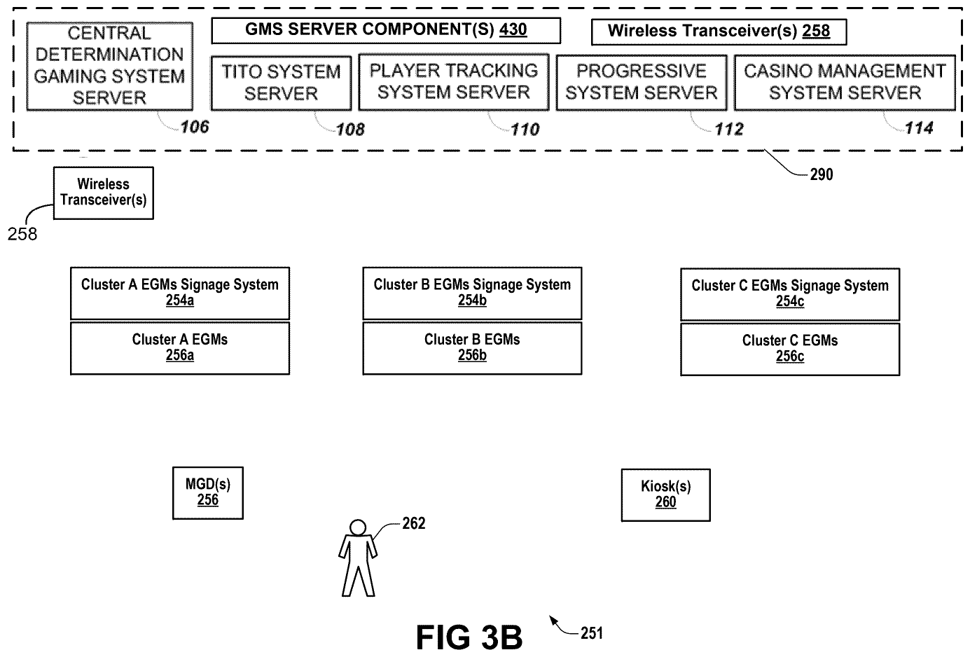

For example, referring to FIG. 2D, a gaming device 100′ may be implemented as a handheld device including a compact housing 105 on which is mounted a touchscreen display device 116 including a digitizer 152. As described in greater detail with respect to FIG. 3 below, one or more input devices 130 may be included for providing functionality of for embodiments described herein. A camera 127 may be provided in a front face of the housing 105. The housing 105 may include one or more speakers 150. In the gaming device 100′, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100′ may omit certain features, such as a bill acceptor, a ticket generator, a coin acceptor or dispenser, a card reader, secondary displays, a bet display, a credit display, etc. Credits can be deposited in or transferred from the gaming device 100′ electronically.

FIG. 2E illustrates a standalone gaming device 100″, i.e., an EGD in this example, having a different form factor from the gaming device 100 illustrated in FIG. 2A. In particular, the gaming device 100″ is characterized by having a large, high aspect ratio, curved primary display device 116′ provided in the housing 105, with no secondary display device. The primary display device 116′ may include a digitizer 152 to allow touchscreen interaction with the primary display device 116′. The gaming device 100″ may further include a player tracking display 142, an input device 130, a bill/ticket acceptor 128, a card reader 138, and a bill/ticket dispenser 136. The gaming device 100″ may further include one or more cameras 127 to enable facial recognition and/or motion tracking.

Although illustrated as certain gaming devices, such as electronic gaming machines (EGDs) and mobile devices, similar functions and/or operations as described herein may include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

In some embodiments, in response to receiving a wager from a user of a gaming device, a gaming system displays, on a display device of the gaming device, a graphical interface for a wagering game. The graphical interface includes a plurality of game symbols arranged in an array (also referred to herein as a grid) of a plurality of lines (also referred to herein as rows) of game symbols. Based on the array, a game result for the wagering game is determined. A game award is provided to the user in response to the game result indicating a winning game result. In some examples, a winning game result occurs when the grid of game symbols includes a winning shape formed by a combination of game symbols.

In additional or alternative embodiments, subsequent play (or subsequent stages) of the wagering game includes generating a new array based on the array. For example, the winning combination of game symbols can be removed and replaced (e.g., the previously displayed symbols can cascade down to fill the removed slots in the array). These and other aspects will be described in greater detail below.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 3A is a block diagram depicting various functional elements of a gaming device 200 (e.g., an EGD) in an example embodiment. All or parts of gaming device 200 shown could be used to implement any one of the example gaming devices depicted in FIGS. 1 and 2A-E.

Communication between or among the gaming devices and/or the server computers 290, may be direct or indirect using one or more communication protocols. As an example, gaming devices 100 and the server computers 290 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices to communicate with one another and/or the server computers 290 using a variety of communication-based technologies, such as radio frequency (RF) (e.g., wireless fidelity (WiFi®) and Bluetooth®), cable TV, satellite links and the like.

In some implementation, server computers 290 may not be necessary and/or preferred. For example, in one or more implementations, a stand-alone gaming device can implement one or more aspects of the present disclosure. However, it is typical to find multiple EGDs connected to networks implemented with one or more of the different server computers 290 described herein.

The server computers 290 may include a central determination gaming system server 292, a ticket-in-ticket-out (TITO) system server 293, a player tracking system server 294, a progressive system server 295, and/or a casino management system server 296. Gaming devices may include features to enable operation of any or all servers for use by the player and/or operator (e.g., the casino, resort, gaming establishment, tavern, pub, etc.). For example, game outcomes may be generated on a central determination gaming system server 292 and then transmitted over the network to any of a group of remote terminals or remote gaming devices that utilize the game outcomes and display the results to the players.

As shown in FIG. 3A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 3A also depicts utilizing a ticket printer 222 to print tickets for a TITO system server 293. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-specific processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 3A illustrates that game controller 202 includes a single processor 204, game controller 202 is not limited to this representation and instead can include multiple processors 204 (e.g., two or more processors).

FIG. 3A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 3A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 292. For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 292 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGD. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 3A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 3A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 3A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 3A also depicts that gaming device 200 is connected over network 214 to player tracking system server 294. Player tracking system server 294 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel.

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, at least some gaming devices may include or be coupled to one or more wireless transmitters, receivers, and/or transceivers that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between one or more gaming devices and a mobile device. After establishing a secure wireless connection between the gaming device and the mobile device, the wireless transmitter or transceiver does not send and/or receive application data to and/or from the mobile device. Rather, the mobile device communicates with gaming devices using another wireless connection (e.g., WiFi® or cellular network). In another implementation, a wireless transceiver establishes a secure connection to directly communicate with the mobile device. The mobile device and/or gaming device(s) send and receive data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

The GMS Component(s) 410 represent the client-side software module and logic components that reside within the local Electronic Gaming Device (EGD) 200. The primary purpose of this component is to act as the terminal-side interface for the central Game Management System (GMS) (680), enabling the EGD to participate in the advanced, server-driven jackpot network. This component is responsible for rendering all specialized user interfaces required for the Grand Paradise Jackpot features and managing the bi-directional communication with the GMS server. Its operations include rendering the Player-Selectable Jackpot Interface, which presents a graphical menu of all available jackpot tiers (e.g., 36 tiers) and allows the player to select a unique subset they wish to be eligible for, subsequently transmitting this selection map to the GMS server. It also receives the continuous, real-time broadcast of dynamically adjusted jackpot multipliers from the GMS and updates the EGD's display accordingly, creating the live market feel of the jackpot. This component is important for enabling the Real-Time Personalized Jackpot Engine, as it receives and renders the unique, player-specific UI elements, such as VIP 2×Multiplier!banners or the Jackpot Journey challenge modules, based on commands from the GMS. Furthermore, it receives Start Bonus commands from the GMS—which may be initiated by the Secure Dealer Console (689)—and launches the corresponding client-side interactive mini-game. This component represents a significant technical improvement over conventional EGDs, which function as self-contained, static game terminals. It transforms the EGD into an intelligent, dynamic, and personalized client-server terminal, solving the technical problem of a one-size-fits-all, static player interface by enabling real-time data display, player-level customization, and server-driven interactive bonus events.

The GMS Meter(s) 420 are specialized virtual or soft meters implemented within the EGD's graphical user interface, as illustrated in the block diagram of the gaming device 200. Their specific function is to track and display accumulated credits, points, or other game-specific metrics related directly to the Grand Paradise Jackpot system, separate from the EGD's main credit and win meters. This component is managed by the local GMS Component(s) (410) and provides the player with clear, immediate, and dedicated feedback on their status within the jackpot meta-game. These meters update in real-time, reflecting credits or points earned through gameplay events, such as completing a milestone in a Personalized Jackpot Journey (Tech #37), or deductions when GMS-specific credits are utilized. One aspect of novelty of this meter lies in its specialization; unlike conventional EGD meters that only track monetary-based credits for the base game, the GMS Meter(s) provide a visual representation of a player's progress and standing within the long-term, narrative, or challenge-based aspects of the jackpot system. This provides a direct technical solution to the problem of ambiguous player feedback, where points or progress for a bonus system may be confusingly co-mingled with standard game wins. By providing this dedicated, real-time feedback, the GMS Meter(s) 420 significantly enhance player engagement, encourage strategic gameplay, and make the abstract progress of a jackpot journey a tangible, viewable asset for the player.

The GMS Server Component(s) 430 represent the server-side modules and logic that form the specific of the central Game Management System (GMS) (680), as shown in the overall network context of FIG. 3A and FIG. 3B. This component is the brain of the entire Grand Paradise Jackpot system, architected as a high-availability, fault-tolerant server that coordinates all other components and executes all specific game logic. Its primary function is to transform the Baccarat jackpot from a static prize into a dynamic, live, and personalized event, embodying the system's specific novelties. It continuously receives a real-time stream of card data from the Real-Time Card Recognition System (686) and uses this data to maintain a Shoe Composition Dataset in its active memory. After every card deal, it queries the Probability Calculation Engine (688) with this dataset to get the true, real-time odds for all 36+ jackpot tiers, which it then uses to dynamically adjust and broadcast the jackpot multipliers to all connected EGDs. This component also manages the Rolling Window trigger logic, maintaining a 6-card buffer to detect consecutive card combinations independent of hand boundaries. It bridges the digital and human worlds by detecting near-miss events and sending alerts to the Secure Dealer Console (689), while also receiving and validating manual activation signals from the dealer to trigger electronic bonus rounds. This server component is also the hub for personalization; it interfaces with the Player Tracking System (682) to retrieve player profiles, passes them to the AI/ML Personalization Engine (687) for analysis, and applies the resulting personalized rules (e.g., custom multipliers or challenges) to the player's session and win-verification logic. This component is a non-obvious technical improvement over prior art, changing the function of a gaming server from a static lookup table to a dynamic, real-time analysis and personalization engine.

It will be appreciated that the present disclosure is not limited only to those implementations shown in the Figures. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices may also include other processors that are not separately shown. Using FIG. 3A as an example, gaming device 200 could include display controllers (not shown in FIG. 3A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 3B depicts a casino gaming environment in an example embodiment. In this example, the casino 251 includes banks (e.g., 252a, 252b, 252c) of EGDs. In this example, each bank 252 of EGDs includes a corresponding gaming signage system (e.g., 254a, 254b, 254c). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 290, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 292, one of the EGDs, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 293. For example, the TITO system server 293 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 294. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

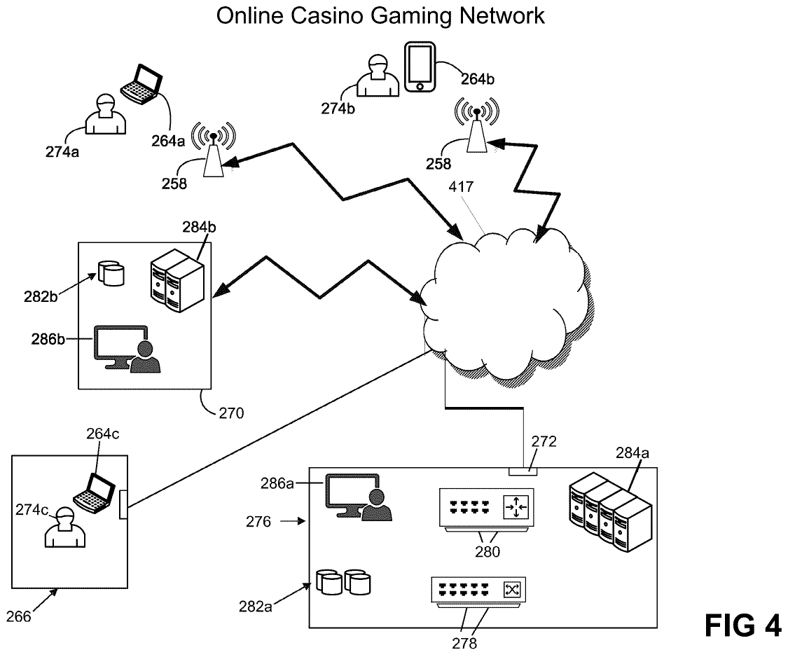

FIG. 4 is a diagram of components of a system for providing online gaming in an example embodiment. As with other Figures presented in this disclosure, the numbers, types and arrangements of gaming devices shown in FIG. 4 are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 4. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 4, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

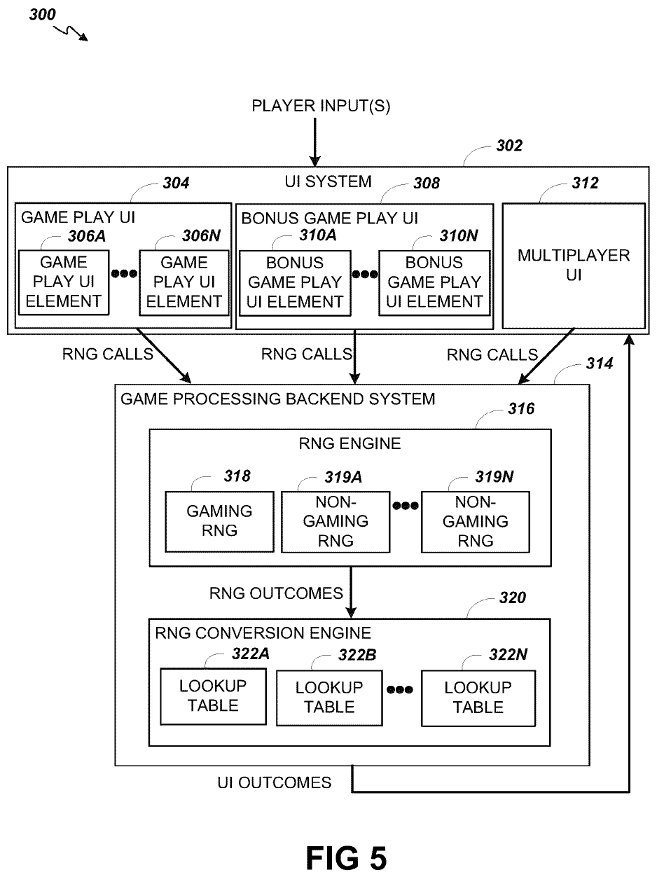

FIG. 5 illustrates, in block diagram form, an implementation of a game processing architecture 300 that implements a game processing pipeline for the play of a game in accordance with various implementations described herein. As shown in FIG. 5, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming device 200 of FIG. 3A. Alternatively, portions of the gaming processing architecture 300 can implement the game processing pipeline using a gaming device and one or more remote gaming devices, such as central determination gaming system server 292 shown in FIG. 3B.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 5 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 5 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switchback the gaming device from tournament mode to a primary game mode to present the base game. Although FIG. 5 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 3A. As previously discussed with reference to FIG. 3A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 3A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 3A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

Further described herein are network-based systems and methods for seamlessly operating multi-vendor gaming devices and management systems within a casino.

Electronic gaming machines (EGDs), electronic gaming tables (EGTs), or other types of gaming devices provide a variety of wagering games such as slot games, video poker games, video blackjack games, roulette games, video bingo games, keno games and other types of games that are frequently offered at casinos and other locations. EGDs and EGTs are made by a variety of different manufactures, including but not limited to Aristocrat (ATI), Light and Wonder (LNW), International Game Technology (IGT), Konami Gaming, etc. Many EGDs/EGTs communicate with slot machine interface boards (SMIBs) via the slot accounting system (SAS) or the game to system (G2S) protocol. Further, there are a number of different casino monitoring/management systems (CMS) that are provided by the different EGD/EGT manufactures. The result of the incompatible frontend and backend is that when a casino buys EGDs/EGTs from vendor A, and installs the CMS system from vendor A to manage and control the casino's various EGDs/EGTs, then the casino may be locked into vendor A's solution, as interoperability between the gaming machines, their SMIBs, and management solutions from different vendors is generally non-existent. This limits the options that casinos have regarding management system solutions that deviate from the already installed base of vendor A's management solution.

Gaming devices (e.g., EGDs, EGTs, bar tops, gaming servers, mobile devices, mobile game devices, etc.), may be a device located in a physical casino and/or at remote locations for online gaming. Gaming devices are made by a variety of different vendors, with the different vendors typically providing a closed management system for monitoring and controlling that vendor's gaming device. A SMIB is used within an EGD/Ts to allow the EGD/Ts to connect to a system server. However, SMIBs made by different vendors are proprietary, and may use different controllers, power supplies, connectors, hardware, board sizes, and proprietary communication protocols. Each vendor's SMIB is designed to connect its proprietary management system to its EGD/Ts and to all other manufacturers' EGD/Ts. For instance, there is a SMIB from supplier A designed to connect to supplier A's machines, and to supplier B's, C's, and D's machines, a SMIB from supplier B designed to connect to supplier B's machines as well as to supplier A's, C's, and D's machines, etc. Once a casino decides to network its casino floor, it is locked into one vendor's hardware and software solutions.

For example, a casino may initially select an implementation from supplier A, with supplier A's SMIBs installed in the EGD/Ts that communicate with supplier A's CMS. As used herein, a CMS refers to any backend system or software service designed to operate with a casino's gaming device network such as a casino accounting system, a ticket voucher system, a player account system, a social network system, a responsible gaming system, a marketing system, abonus system, aprogressive system, a concierge system, and/or a Remote Gaming System (RGS). Generally, RGS is a solution for vendors and operators that enables implementation and distribution of online, mobile, and server-based gaming content.

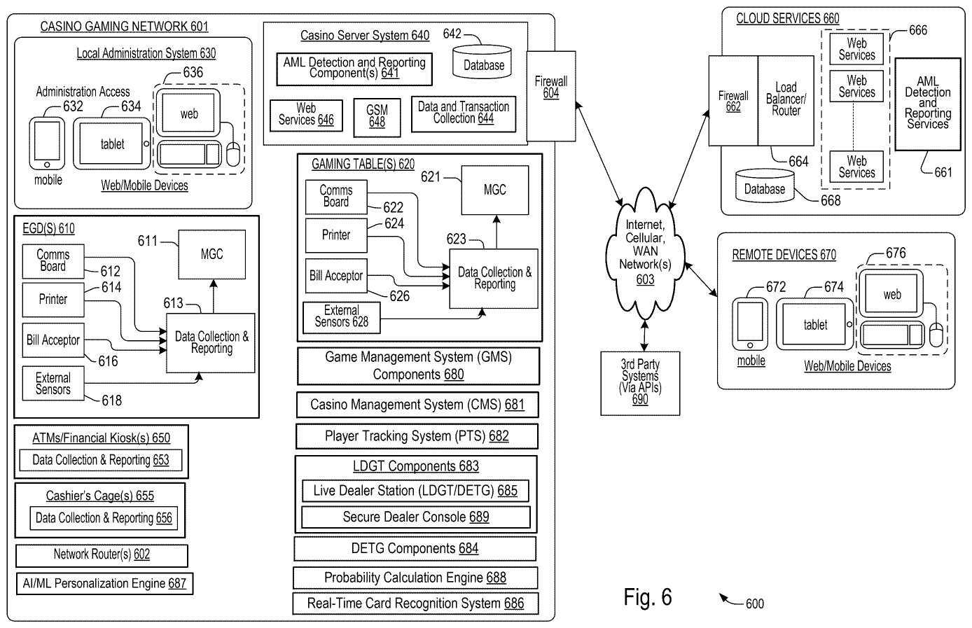

FIG. 6 illustrates a simplified block diagram of a specific example embodiment of a Gaming Network 600 which may be configured or designed to implement various automated money laundering detection and reporting techniques described and/or referenced herein. As described in greater detail herein, different embodiments of gaming networks may be configured, designed, and/or operable to provide various different types of operations, functionalities, and/or features generally relating to automated money laundering detection and reporting techniques. Further, as described in greater detail herein, many of the various operations, functionalities, and/or features of the Gaming Network(s) and/or Gaming System(s) disclosed herein may provide may enable or provide different types of advantages and/or benefits to different entities interacting with the Gaming Network(s).

According to different embodiments, the Gaming Network 600 may include a plurality of different types of components, devices, modules, processes, systems, etc., which, for example, may be implemented and/or instantiated via the use of hardware and/or combinations of hardware and software. For example, as illustrated in the example embodiment of FIG. 6, the Gaming Network may include one or more of the following types of systems, components, devices, processes, etc. (or combinations thereof):
Casino Gaming Network(s) 601. In at least one embodiment, the Casino Gaming Network 601 may include or may correspond to one or more gaming network(s), systems, components, devices, etc., which are associated with one or more casino gaming establishments such as, for example, Harrah's Casino (Las Vegas), Caesars Palace (Las Vegas), The Palazzo (Las Vegas), etc. In at least one embodiment, a Casino Gaming Network may be associated with a real-world, physical casino which is located at a particular geographic location. In some embodiments, the Casino Gaming Network may include multiple gaming networks associated with multiple casino gaming establishments at different physical locations (such as, for example, Harrah's Casino Las Vegas, Harrah's Casino New Orleans, Harrah's Casino Atlantic City, etc.).
Internet, Cellular, and WAN Network(s) 603.
3rd Party Systems 690. In at least one embodiment, one or more 3rd Party Systems may include remote server system(s)/service(s), which, for example, may be configured or designed to provide various types of services described and/or referenced herein. In at least one embodiment, one or more 3rd Party Systems may communicate with other components, devices, systems of the Gaming Network via APIs and/or other types of standardized (and/or proprietary) communication protocols. Examples of various types of 3^{rd} Party Systems may include, but are not limited to, one or more of the following (or combinations thereof):
   Content provider servers/services
   Media Streaming servers/services
   Database storage/access/query servers/services
   Financial transaction servers/services
   Payment gateway servers/services
   Electronic commerce servers/services
   Event management/scheduling servers/services
   Automated money laundering detection and reporting services;
   Remote Database System(s) which, for example, may be operable to store and provide access to various types of information and data described herein.
Remote Device(s) 670—In at least one embodiment, the Remote Device(s) may be operable to provide administration and customer remote access to other components, devices, systems of the Gaming Network. According to different embodiments, one or more Remote Device may be configured or designed to perform and/or implement various types of functions, operations, actions, and/or other features such as those described or referenced herein (e.g., such as those illustrated and/or described with respect to FIG. 6).
Cloud Services 660—In at least one embodiment, Cloud Services may include a plurality of different public and/or provide computing clouds which, for example, may reside at different physical and/or geographic locations, and which may each be configured or designed to provide different types of services. For example, as illustrated in the example embodiment of FIG. 6, Cloud Services 660 may include functionality for performing and/or implementing ML Analysis, Detection and Reporting Services such as one or more of those described herein.

According to specific embodiments, the at least some of the computing clouds may include several different types of local area networks such as, for example, a backbone LAN which may be utilized for providing localized communication between various local network elements within a given computing cloud, and an internet LAN which, for example, may be utilized for providing WAN or Internet access to various local network elements within the computing cloud. In at least one embodiment, one or more of the computing clouds may be operable to host a variety of different types of applications and/or other software for performing various types of services such as, for example, one or more of those described herein. Additionally, in at least one embodiment, one or more of the computing clouds may be operable to provide various types of database services such as, for example, data storage, database queries, data access, etc. As illustrated in the example embodiment of FIG. 6, cloud services network 660 may include one or more of the following components, devices, and/or systems (or combinations thereof): firewall components 662, load balancer and router components 664, Web services components 666, database components 668, AML detection and reporting components 661.

As illustrated in the example embodiment of FIG. 6, the Casino Gaming Network 601 may include a plurality of different types of components, devices, modules, processes, systems, etc., which, for example, may be implemented and/or instantiated via the use of hardware and/or combinations of hardware and software. In at least one embodiment, the Casino Gaming Network 601 may include various types of systems, components, devices, processes, etc., such as one or more of those described below.
Casino Server System(s) 640
DETG Components 684
Electronic Gaming Device(s) (EGDs) 610
Wager-based Gaming Table(s) 620
Local Administration System(s) 630
ATMs/Financial Kiosk(s) 650
Cashiers Cage(s) 655
Casino Management System (CMS) 681
Game Management System (GMS) 680
LDGT Components 683
Live Dealer Station (LDGT/DETG) 685
Secure Dealer Console 689
Player Tracking System (PTS) 682
Probability Calculation Engine 688
Real-Time Card Recognition System 686
AI/ML Personalization Engine 687
Network Router(s) 602

FIG. 6 illustrates an example embodiment of a block diagram of a Gaming Network 600. As illustrated in the example embodiment of FIG. 6, the Gaming Network 600 may include a plurality of different types of components, devices, modules, processes, systems, etc., which, for example, may be implemented and/or instantiated via the use of hardware and/or combinations of hardware and software. In at least one embodiment, the Gaming Network 600 may include various types of systems, components, devices, processes, etc., such as one or more of those described below.

The Casino Server System(s) 640 represents the centralized command and data processing hub of the Casino Gaming Network 601. Its primary purpose is to host, manage, and execute the high-level logic, data storage, and communication services required to operate the entire gaming environment. This system is comprised of several critical sub-components, including a central Database 642 that stores all persistent data, such as historical game information, player account details, gaming device configurations, and a comprehensive log of all financial transactions. A key module is the Data and Transaction Collection component 644, which is specifically designed to aggregate financial transaction events from all connected endpoints, including EGDs 610, Gaming Table(s) 620, ATMs 650, and Cashier's Cage(s) 655. The system also integrates Web Services 646 for managing web-based communications, GSM 648 components for transporting data to external systems like Cloud Services 660, and a Firewall 604 for network security. A novel and critical function of this server is hosting the AML Detection and Reporting Component(s) 641, which leverages the centrally collected transaction data to perform sophisticated, automated analysis. This centralized architecture provides a significant technical improvement over traditional, siloed systems by creating a single, unified data repository, enabling holistic, real-time analysis of all casino activities, which is essential for both operational intelligence and advanced regulatory compliance functions like automated AML monitoring.

The DETG Components 684 include the components, devices, and specialized hardware and software modules specifically configured or designed to implement one or more Dealer-controlled Electronic Table Game (DETG) systems. A DETG system comprises a live dealer at a central Dealing Table who performs the physical actions of the game (e.g., dealing cards from a shuffle master). These actions are processed by a Control Unit (CU) and a Betting Central Processing Unit (BCPU). The BCPU then determines the game outcome and communicates it over a Local LAN to multiple, individual Betting Terminals (BTs) where players have placed their wagers. Therefore, DETG Components 684 encompasses this entire architecture: the dealer's Dealing Table with its controls (which is an instance of Live Dealer Station 685), the central BCPU for game logic and wager resolution, and the network of player-facing Electronic Table Game Terminals (ETGTs), which are a form of EGD 610. This system functions as a highly scalable version of a Wager-based Gaming Table 620, and its BCPU would be responsible for reporting all aggregated financial transaction and wagering data from its terminals to the Casino Server System 640. This component group also includes the Real-Time Card Recognition System 686 and Secure Dealer Console 689 needed to operate the inventive system.

The Electronic Gaming Device(s) (EGDs) 610, which include Electronic Table Game Terminals (ETGTs), represent the primary player-facing client interfaces within the gaming network. Their core function is to provide the user interface for participating in wager-based games, accepting player wagers for the main game and the optional jackpot side bets. A key function of this terminal is to display a wide range of dynamic game information, most notably the constantly changing jackpot multipliers that are broadcast in real-time from the Game Management System (GMS) 680. The terminals are also configured to display the jackpot status, including near-miss events related to the rolling window trigger. This component is critically enhanced to enable player agency, solving the technical problem of rigid, one-size-fits-all wagering. It achieves this by implementing a Player-Selectable Jackpot Interface. This interface is rendered as a graphical menu, typically at the start of a new shoe, which displays all available jackpot tiers (e.g., 36 tiers) and allows the player to select a unique subset of tiers they wish to be eligible for. The terminal transmits this per-player eligibility map to the GMS, where it is stored for win verification. Furthermore, the ETGT's software is enhanced to render a fully personalized User Interface (UI) based on commands from the GMS. After a player logs in with their loyalty card, the ETGT may display unique, personalized jackpot multipliers (e.g., VIP 2× Ace Jackpots!) or customized jackpot journey challenges (e.g., Win 3 Banker bets in a row) that are specific to that player and invisible to others. This transforms the terminal from a generic display into a one-to-one engagement tool. Internally, each EGD 610 includes a Master Gaming Controller (MGC) 611, a Comms Board 612 for networking, and a Data Collection & Reporting module 613, which reports all financial transaction events and wagers to the central server system.

The Wager-based Gaming Table(s) 620 represents the hardware and software systems used to monitor and manage live, wager-based table games such as baccarat, blackjack, or roulette. These may be traditional tables augmented with technology (like the LDGT/DETG 685) or fully electronic tables. Similar to EGDs, these tables are equipped with their own Master Gaming Controller (MGC) 621, Comms Board 622, Printer 624, Bill Acceptor 626, and External Sensors 628 (which may include chip readers or other tracking devices). The most critical component within this system is the Data Collection & Reporting module 623. This module's function is to capture all game-related information, player tracking data, and wager information, including all financial transaction events that occur at the table, such as cash buy-ins or voucher redemptions. This data is then reported to the central Casino Server System 640.

The integration of this component provides an important technical advancement by bringing live table games-which are often ablind spot for automated systems-into the same unified data collection network as electronic games. This allows the central AML Detection and Reporting Component(s) 641 to monitor and analyze financial activities from the gaming tables with the same level of scrutiny as EGDs, providing a complete, casino-wide view of all wagering and financial movements.

The Local Administration System(s) 630 provides on-premises administrative access and control over the Casino Gaming Network 601. This system is composed of various user-facing devices, such as mobile devices 632, tablets 634, and web-based computer systems 636, enabling casino administrators and managers to perform their duties from anywhere within the establishment. Its specific function is to provide the necessary interfaces for configuring, registering, monitoring, and analyzing the performance and status of network components, such as EGDs and servers. A particularly important feature of this system is its ability to provide local administrative access for configuring and monitoring Anti-Money Laundering (AML) and suspicious activity alerts. This allows managers to receive real-time notifications, generate reports, and analyze potential ML activities as they are detected by the central AML Detection and Reporting Component(s) 641. This direct, local administrative layer represents a significant operational improvement, enhancing security and responsiveness by empowering staff to act on important alerts immediately, rather than waiting for reports from a remote or back-office-only system. The integration of mobile and web-based access points ensures that administrative control is both flexible and powerful, directly supporting the network's advanced monitoring and reporting capabilities.

The ATMs/Financial Kiosk(s) 650 component represents non-gaming financial transaction points located within the casino environment. The primary function of these devices is to provide patrons with financial services, such as cash withdrawals, credit/debit card advances, and potentially TITO (Ticket-In, Ticket-Out) voucher redemption. A critical element of this component, and a significant technical improvement for the network, is its integrated Data Collection & Reporting 653 module. Unlike standard ATMs that report only to a banking network, this module is specifically configured to capture and report all financial transaction events (e.g., cash withdrawal amounts, times, frequencies) directly to the Casino Server System 640's Data and Transaction Collection 644 component. This integration is novel because it brings third-party financial hardware into the unified casino monitoring ecosystem. This allows the AML Detection and Reporting Component(s) 641 to correlate kiosk activity with a patron's gaming and on-property behavior, identifying patterns such as a player frequently withdrawing cash at a kiosk and immediately buying in at a table, which is an important piece of information for suspicious activity analysis.

The Cashier's Cage(s) 655 component represents the central banking and financial hub of the casino, managed by casino personnel. This is the location where patrons conduct high-value transactions, including cashing large TITO vouchers, redeeming chips, processing credit lines (markers), exchanging foreign currency, and performing large cash buy-ins. The most important piece of this component is the Data Collection & Reporting 656 system, which is integrated into the cashier's terminal. This system is designed to electronically capture and report all financial transaction events—particularly those involving large sums of cash or complex financial instruments—to the Casino Server System 640 in real-time. This represents a technical advancement over traditional, manual, or end-of-day paper-based reporting. By feeding this data directly into the Data and Transaction Collection 644 module, the AML Detection and Reporting Component(s) 641 gains complete visibility into the largest and most important financial movements within the casino. This enables the automated system to immediately flag and analyze transactions that meet or exceed regulatory reporting thresholds, significantly enhancing the casino's compliance capabilities.

The Casino Management System (CMS) 681 is a high-level, comprehensive software and hardware platform that represents the overarching backend system for managing the entire casino floor. Its primary function is to provide a centralized suite of tools for operators to manage slot accounting, financial transactions, machine performance, security monitoring, and regulatory compliance reporting. Within the inventive system, the CMS (681) serves as the secure, authoritative backend for all financial and player authentication operations. The Game Management System (GMS) 680 is communicatively coupled with the CMS, interfacing with it for several critical functions: secure player authentication (when a player logs into an ETGT), processing wagers from player accounts, and, most importantly, executing verified payouts. The CMS's role in payouts is enhanced by the invention's novel features. The GMS (680) is responsible for all the complex win-verification logic, and the CMS (681) acts as the secure bank that executes the GMS's instructions. This is particularly important for the Player-Selectable Jackpot Interface. When a jackpot is hit, the GMS performs its multi-layered verification, which includes checking the winner's per-player eligibility map. The GMS then instructs the CMS to process a payout only for the specific player(s) who were validated as having selected that winning tier, a level of individualized payout instruction not found in conventional systems. The CMS (681) also often works in conjunction with, or includes the functionality of, the Player Tracking System (PTS) 682. In this capacity, it serves as the backend database of record that provides the player's historical profile and loyalty data to the GMS, which is the foundational input required by the AI/ML Personalization Engine (687) to generate its personalized jackpot rules.

The Game Management System (GMS) 680 is the central server and processing hub of the entire inventive system, architected as a high-availability, fault-tolerant server with multi-specific processing and high-speed RAM. Its core function is to coordinate all components, manage all specific game logic, and execute the novel jackpot features. The GMS is technically improved from a conventional static lookup table into a dynamic, real-time analysis engine. It receives a constant stream of card data from the Real-Time Card Recognition System (686) and uses it to maintain a Shoe Composition Dataset in its active memory, which tracks the remaining cards in the physical shoe. After every card deal, it queries the Probability Calculation Engine (688) to get the real-time odds for all jackpot tiers, applies a configurable perceived card value weighting, and then broadcasts the final, dynamically adjusted multipliers to all ETGTs (610). The GMS logic is further enhanced to provide a rolling window jackpot trigger, maintaining a FIFO queue of the last six consecutive cards dealt, independent of hand boundaries, and checking this buffer for a win after every card deal. It also handles all edge cases, such as purging the buffer on a NEW_SHOE signal and using timestamp validation to manage mid-shoe bets fairly. The GMS functions as a human-digital bridge by detecting near-miss events and sending alerts to the Secure Dealer Console (689), while also receiving and validating manual activation signals from the dealer's console to trigger bonus rounds. Simultaneously, it receives and stores per-player eligibility maps from each ETGT, enabling A la carte wagering. Furthermore, the GMS is the core of the personalization engine, interfacing with the Player Tracking System (682) to retrieve a player's profile, passing it to the AI/ML Personalization Engine (687), and receiving back a personalization rule (e.g., a custom multiplier or challenge). This culminates in a novel, multi-layered win verification process, where the GMS must check the general bet, the player's individualized tier map, and any active personalization rules before calculating and authorizing a final payout.

The LDGT Components 683 include the components, devices, and specialized hardware and software modules specifically configured or designed to operate Live Dealer Gaming Table (LDGT) systems. An LDGT system typically involves a live dealer conducting a game (e.g., baccarat, roulette) in a studio or on the casino floor, with the game being video-streamed to numerous players at remote electronic betting terminals (which are a type of EGD 610). These components would therefore include high-definition cameras, audio equipment, video encoding and streaming servers, and the networking infrastructure to broadcast the live feed with minimal latency. It would also include the specific game server logic (as part of the GMS 680) to manage the game state (e.g., no more bets), read game outcomes from the Real-Time Card Recognition System 686, and communicate these outcomes to the connected player terminals to resolve wagers. Within the Gaming Network 600, these components function as a specialized, stream-based version of a Wager-based Gaming Table 620, integrating with the Data Collection & Reporting module to ensure that all wagers and financial transactions from the associated remote terminals are captured and forwarded to the Casino Server System 640 for processing and AML analysis.

The Live Dealer Station (LDGT/DETG) 685 represents the physical location and specialized hardware where the live Baccarat game is conducted. This component, which may be part of a broader set of LDGT Components 683 (for streamed games) or DETG Components 684 (for locally networked tables), includes the human dealer, the physical Baccarat table, and the shoe containing the physical playing cards. Its primary purpose within the inventive system is to serve as the originating source of all real-time, physical game events. This station is an advanced apparatus, not a traditional felt table, and is critically integrated with two other novel components: the Real-Time Card Recognition System (686) and the Secure Dealer Console (689). The card recognition system (e.g., an optical scanner or RFID reader built into the dealing shoe) is responsible for digitizing the physical game by identifying the rank and suit of every card as it is dealt. This hardware integration transforms the physical action of dealing a card into a digital data event, which is the foundational input for the entire dynamic jackpot system. The Secure Dealer Console (689) is an authenticated interface that provides a novel human-digital bridge. It allows the GMS (680) to send game-state intelligence, such as near-miss alerts, directly to the dealer. In response, the dealer can use the console to provide a manual activation signal, a secure input that triggers electronic bonus rounds across all player terminals, turning the dealer into an active participant in the electronic bonusing. Thus, the LDGT/DETG (685) is the nexus of the physical game and the digital system, housing the specialized hardware required to capture live game events and enable dealer agency.

The Secure Dealer Console 689 is a specialized, dedicated hardware and software interface located at the Live Dealer Station (685). It is a critical component of the Integrated Dealer and Player Agency Interface (Innovative Element 3). Its specific function is to act as a secure human-digital bridge, technically empowering the live dealer to become an active participant in the electronic jackpot system. This is not a generic tablet but an industrial-grade, hardened touchscreen terminal that requires mandatory dealer authentication (e.g., via an integrated RFID card reader for staff IDs or a biometric scanner) to prevent unauthorized access or fraudulent bonus activation. It is connected directly to the GMS (680) via an encrypted, wired network connection. The console has two primary, novel functions. First, it receives real-time game intelligence from the GMS. When the GMS's logic detects a near-miss event (e.g., 5 of 6 matching cards), it sends an alert that is displayed on the console's screen, (e.g., NEAR MISS: 5/6 RED KINGS). Second, it transmits secure commands to the GMS. After receiving an alert or sensing player excitement, the dealer can physically press an Activation Button (e.g., Initiate Bonus Round) on the console. This manual activation signal is a secure API call that the GMS uses as the primary trigger for a system-wide electronic event, such as launching a bonus mini-game on all player ETGTs (610). This provides a specific technical solution to the problem of a passive and monotonous dealer role, transforming the dealer from a simple card turner into an integral showman who can directly influence the electronic game.

The Player Tracking System (PTS) 682 is a specialized backend server system dedicated to managing all aspects of player loyalty, marketing, and identification. Its primary function is to identify and track player activity across the casino by linking play to a unique player account, typically via a loyalty card or mobile device. The PTS (682) manages all player loyalty data, including play history, game preferences, average bet size, session duration, and loyalty tier status, and it awards comps or points based on this activity. Within the context of the inventive system, the PTS (682) provides the foundational data that enables the entire Real-Time Personalized Jackpot Engine (Innovative Element 4). It serves as the primary data source for the detailed player profiles that are essential for personalization. When a player logs into an ETGT (610) with their loyalty card, the GMS (680) initiates a real-time API call to the PTS (682) to retrieve that player's complete profile. This profile data (e.g., loyalty tier, play history) is then passed by the GMS (680) to the AI/ML Personalization Engine (687). This integration represents a significant technical improvement over conventional systems where loyalty data is siloed and used only for abstract, out-of-game rewards (like comp points). This invention's architecture technically improves the GMS's function by allowing it to use this PTS data as a real-time, in-game logic parameter. The GMS can now use the patron identity layer to move from an anonymous, one-to-many jackpot system to a player-centric, one-to-one engagement engine, applying personalized multipliers or challenges directly to the player's active jackpot session.

The Probability Calculation Engine 688 is a specialized, high-availability software component, which may be implemented as an integrated module within the GMS (680) or as a separate, dedicated microservice. Its specific function is to perform the complex, real-time mathematical computations that enable the Dynamic Probability-Based Jackpot Engine. This engine is not a static lookup table; it is a real-time computational engine. After every card deal, the GMS provides this engine with the Shoe Composition Dataset, which represents the exact finite population of remaining cards in the shoe. The engine's algorithm is based on the hypergeometric distribution, which is the correct mathematical model for calculating probabilities without replacement. For each of the 36+ jackpot tiers, the engine calculates the probability P(X=k) of achieving k successes (e.g., 6 Red Aces) in n draws (e.g., the 6-card rolling window) from the remaining population N (total cards left) which contains K total successes (e.g., 11 Red Aces left). This complex calculation is performed simultaneously for all tiers after every single card deal, providing a true, real-time probability for each jackpot. This engine provides a tangible improvement to the gaming computer's functionality. A conventional GMS functions as a simple, static database lookup. This invention's engine transforms the computer's function from a static, memory-lookup tool to a dynamic, processing-based generation tool. This is a more efficient and flexible architecture; new jackpot tiers can be added as mathematical rules rather than as massive, pre-calculated static tables, representing a clear technical improvement in scalability and computer resource utilization. This modular, algorithmic approach also makes the engine game-agnostic, allowing it to be adapted to other games like Blackjack (using shoe depletion) or Poker (using intra-hand conditional probability) by simply loading a different set of rules.

The Real-Time Card Recognition System 686 is a critical hardware and software component integrated directly into the Live Dealer Station (685). Its specific function is to identify the rank and suit of each physical playing card in real-time as it is dealt from the shoe by the live dealer. This system serves as the primary, high-integrity data input source for the entire Game Management System (680). It is the technical bridge that converts physical game actions into the digital data stream necessary to power the dynamic jackpot logic, including the rolling window trigger and the probability calculations. The implementation of this system is a specific and non-trivial technical apparatus, which can be embodied in several ways: an optical scanner integrated into the dealing shoe that reads custom, machine-readable barcodes on the card edges; an advanced RFID-based system where each physical card contains an embedded RFID chip and the dealing shoe is equipped with an RFID antenna for 100% accurate, instantaneous identification; or an overhead high-definition camera paired with a dedicated image processing unit running a computer vision (CV) model. This component provides a tangible technical improvement over conventional systems by guaranteeing an accurate, near-instantaneous (e.g., sub-100 ms) data feed to the GMS. This high-speed, high-integrity input is a crucial technical prerequisite that enables the GMS and Probability Calculation Engine (688) to perform their real-time functions; without it, the dynamic probability calculations would be based on garbage data, rendering the invention non-functional. The data from this system is used by the GMS to detect all game events, from jackpot-winning combinations to the near-miss events that are sent as alerts to the Secure Dealer Console (689).

The AI/ML Personalization Engine 687 is a specialized, advanced software component, which may be implemented as an integrated module within the GMS (680) or as a dedicated microservice. It is the core brain of the Real-Time Personalized Jackpot Engine (Innovative Element 4). Its specific function is to analyze a player's historical profile and output a unique, actionable personalization rule that the GMS (680) applies to that player's active jackpot session. The operational flow begins when the GMS (680) retrieves a player's profile from the Player Tracking System (682). This profile, containing data like loyalty tier, play history, and chum risk score, is passed as an input vector to the AI/ML Personalization Engine (687). The engine processes this vector using its trained models to generate and return a specific rule to the GMS, such as a personalized multiplier (e.g., {type: multiplier, target: Aces, value: 2.0}) or a dynamic challenge (e.g., {type: challenge, goal: BANKER_STREAK_3}). The engine's architecture (DG 5.2) can utilize a Reinforcement Learning (RL) model, such as a Q-learning or DQN model, trained to optimize for a business goal like maximize player session duration. In real-time, this model takes the player's current state and outputs the optimal challenge it predicts will achieve that goal. Alternatively, for long-term jackpot journeys (Tech #37), the engine may use a predictive classifier model (e.g., a Random Forest) to predict a player's archetype (like Grinder or High-Roller), allowing the GMS to assign a pre-designed narrative quest tailored to that archetype. This provides a specific technical solution to the problem of generic, impersonal, and inefficient blanket bonusing. It improves the GMS's functionality by transforming it from a one-to-many broadcast system into a one-to-one personalization engine, enabling algorithmic, surgical bonusing and creating persistent, narrative jackpotjourneys to solve the problem of high player chum.

The Network Router(s) 602 component represents the specialized networking hardware responsible for directing and managing data traffic within the private Casino Gaming Network 601. This component is a fundamental enabler of the entire system, providing the essential, high-speed connectivity between all other components. It physically and logically links the distributed endpoints—such as the EGDs 610, Wager-based Gaming Table(s) 620, and Local Administration System 630—to the centralized Casino Server System 640. Its function is to reliably and securely route data packets, ensuring the timely and uninterrupted flow of information. This is particularly critical for the system's novel features, as it must handle the constant stream of real-time data from the Data Collection & Reporting modules at every gaming position, delivering it to the Data and Transaction Collection 644 module for immediate analysis. The router's performance (e.g., low-latency), security (e.g., managing VLANs, access control lists), and reliability are foundational to the integrity and real-time nature of the network's dynamic jackpot, personalization, and AML detection capabilities.

According to different embodiments, the Casino Server System(s) may include various systems, components, and/or devices for facilitating, initiating, and/or performing various operation(s), action(s), feature(s), and/or other functionality, such as, for example, one or more of the following (or combinations thereof):
Database components 642, which, for example, may be configured or designed to include functionality for storing and/or providing access to various types of information, events, and/or conditions such as, for example, one or more of the following (or combinations thereof): historical game-related information, ML information, ML rules, player ID information, gaming device ID information, location maps of gaming devices, casino-related information, historical financial transaction information, and/or other types of information described and/or referenced herein.
Web Services components 646, which, for example, may be configured or designed to include functionality for facilitating, aggregating gaming data, enabling, initiating, and/or performing various types of web-based services and communications.
Cellular (GSM/CDMA) Communication components 648, which, for example, may be configured or designed to include functionality for facilitating, enabling, initiating, and/or performing various types of cellular-based and/or wireless communications such as transporting gaming data to/from the Cloud Services 660.
Data And Transaction Collection components 644, which, for example, may be configured or designed to include functionality for facilitating, enabling, initiating, and/or performing collection of data and transactions (e.g., financial transaction events) occurring at various components and/or devices of the casino gaming network such as, for example, one or more of the following (or combinations thereof): EGD(s), gaming table(s), ATMs, financial kiosks, casino token storage tray(s), cashier cage component(s), wireless gaming devices, end user mobile device(s), remote devices (e.g., 670), etc.
Firewall component(s) 604.
AML Detection and Reporting Component(s) 641 is a specialized, software-based system hosted within the Casino Server System 640. Its specific purpose is to automate the process of detecting, analyzing, and reporting suspicious financial activities consistent with money laundering (ML). This component's functionality is a significant technical improvement over traditional, manual reporting. It operates by directly consuming the unified, real-time data stream from the Data and Transaction Collection 644 module, which aggregates financial events from all casino endpoints: EGDs 610, Gaming Table(s) 620, ATMs 650, and the Cashier's Cage(s) 655. The component then applies sophisticated rules and analytical models to this holistic dataset to identify suspicious patterns (e.g., structuring transactions to avoid thresholds, minimal-play wagering, chip passing). By integrating with the Player Tracking System 682, it may link activities across different devices to a single patron. This component is also designed to interface with e-Filing and Report Component(s) (1254), enabling the automated generation and electronic filing of suspicious activity reports (SARs) to the appropriate governmental agencies, thereby enhancing compliance, reducing manual overhead, and improving the speed and accuracy of regulatory reporting.

According to different embodiments, Electronic Game Device(s) (EGDs) may include one or more of the following (or combinations thereof): mechanical slot machines, electronic slot machines, electronic gaming machines (EGMs), electronic table game terminals (ETGTs), mobile gaming devices, video gaming machines, server-based gaming machines, and/or other types of devices or components which provide capabilities for enabling casino patrons to participate in gaming and/or wagering activities. In some embodiments, at least some mobile gaming devices may be implemented using personal mobile computing devices such as tablets, smartphones, laptops, PC's, and the like. As illustrated in the example embodiment of FIG. 6, one or more EGDs may be configured or designed to include one or more of the following components (or combinations thereof): at least one master gaming controller (MGC) 611, communication components 612, printer components 614, Bill/coin acceptor components 616, sensor components 618, data collection and reporting components 613.

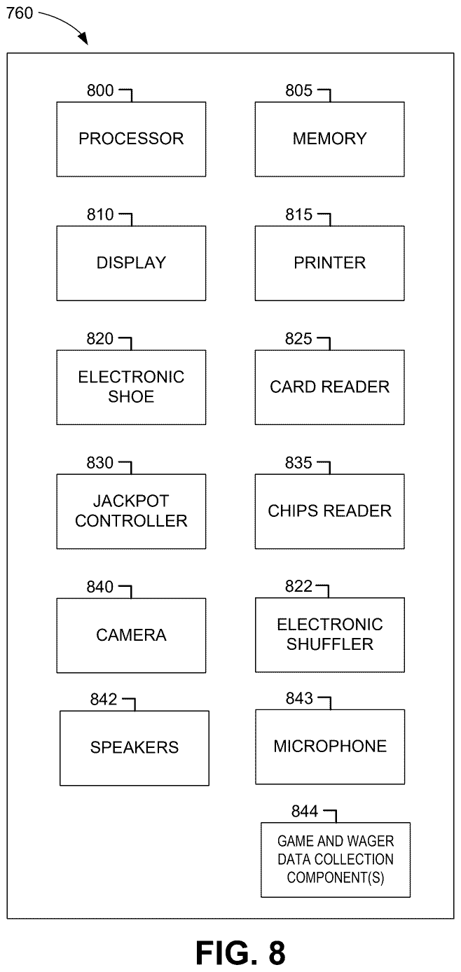

According to different embodiments, Gaming Tables(s) may include one or more of the following (or combinations thereof): traditional casino gaming tables (e.g., craps, baccarat at, blackjack, roulette, etc.), electronic gaming tables, server-based gaming tables, and/or other types of devices or components which provide capabilities for enabling two or more casino patrons to concurrently participate in gaming and/or wagering activities. As illustrated in the example embodiment of FIG. 6, one or more gaming tables may be configured or designed to include one or more of the following components (or combinations thereof): at least one master gaming controller (MGC) 621, communication components 622, printer components 624, Bill/voucher/coin acceptor components 626, sensor components 628, data collection and reporting components 623. In at least one embodiment data collection and reporting components 623 may include functionality for facilitating, enabling, initiating, and/or performing collection and reporting of game-related information and/or wager-related information (e.g., including financial transaction events) occurring at that gaming table. Additional gaming table features and functionalities are illustrated and described with respect to FIG. 8.

In at least one embodiment data collection and reporting components (e.g., 613, 623, 653, 656) may include functionality for facilitating, aggregating, enabling, initiating, and/or performing collection and reporting of various types of information relating to conditions and/or events occurring at an associated gaming device and/or gaming table game, such as, for example: game-related information, player tracking information, wager-related information (e.g., including financial transaction events), and the like.

In at least one embodiment, Local Administration System 630 may include various types of devices or components (such as, for example, mobile devices 632, tablets 634, computer systems 636, etc.) which provide capabilities for enabling casino administrators to implement or perform administration of one or more aspects, components, systems, operations, and/or activities relating to a casino gaming network (e.g., 601). Additionally, local administrative access can be provided for the casino manager for configuring, registering, monitoring, analyzing, sending alerts, generating reports, etc., relating to ML and suspicious activities.

According to different embodiments, Remote Devices 670 may include various types of devices or components (such as, for example, smart phones 672, tablets 674, computer systems 676, etc.) which provide capabilities for enabling a remote user to remotely participate in gaming and/or wagering activities at a casino gaming network (e.g., 601). In at least one embodiment, one or more remote device components may also be used by remote casino administrators to implement or perform remote administration of one or more aspects, components, systems, operations, and/or activities relating to a casino gaming network (e.g., 601).

In at least one embodiment, the Gaming Network may be operable to utilize and/or generate various different types of data and/or other types of information when performing specific tasks and/or operations. This may include, for example, input data/information and/or output data/information. For example, in at least one embodiment, the Gaming Network may be operable to access, process, and/or otherwise utilize information from one or more different types of sources, such as, for example, one or more local and/or remote memories, devices and/or systems. Additionally, in at least one embodiment, the Gaming Network may be operable to generate one or more different types of output data/information, which, for example, may be stored in memory of one or more local and/or remote devices and/or systems. Examples of different types of input data/information and/or output data/information which may be accessed and/or utilized by the Gaming Network may include, but are not limited to, one or more of those described and/or referenced herein. According to specific embodiments, multiple instances or threads of the Gaming Network processes and/or procedures may be concurrently implemented and/or initiated via the use of one or more processors and/or other combinations of hardware and/or hardware and software.

According to different embodiments, various different types of encryption/decryption techniques may be used to facilitate secure communications between devices, systems, and/or components of the Gaming Network(s). Examples of the various types of security techniques which may be used may include, but are not limited to, one or more of the following (or combinations thereof): random number generators, SHA-1 (Secured Hashing Algorithm), MD2, MD5, DES (Digital Encryption Standard), 3DES (Triple DES), RC4 (Rivest Cipher), ARC4 (related to RC4), TKIP (Temporal Key Integrity Protocol, uses RC4), AES (Advanced Encryption Standard), RSA, DSA, DH, NTRU, and ECC (elliptic curve cryptography), PKA (Private Key Authentication), Device-Unique Secret Key and other cryptographic key data, SSL, etc. Other security features contemplated may include use of well-known hardware-based and/or software-based security components, and/or any other known or yet to be devised security and/or hardware and encryption/decryption processes implemented in hardware and/or software.

It will be appreciated that the Gaming Network of FIG. 6 is but one example from a wide range of Gaming Network embodiments which may be implemented. Other embodiments of the Gaming Network (not shown) may include additional, fewer and/or different components/features that those illustrated in the example Gaming Network embodiment of FIG. 6.

Generally, the automated money laundering detection and reporting techniques described herein may be implemented in hardware and/or hardware+ software. Hardware and/or software+ hardware hybrid embodiments of the automated money laundering detection and reporting techniques described herein may be implemented on a general-purpose programmable machine selectively activated or reconfigured by a computer program stored in memory. Such programmable machine may include, for example, mobile or handheld computing systems, PDA, smart phones, notebook computers, tablets, netbooks, desktop computing systems, server systems, cloud computing systems, network devices, etc.

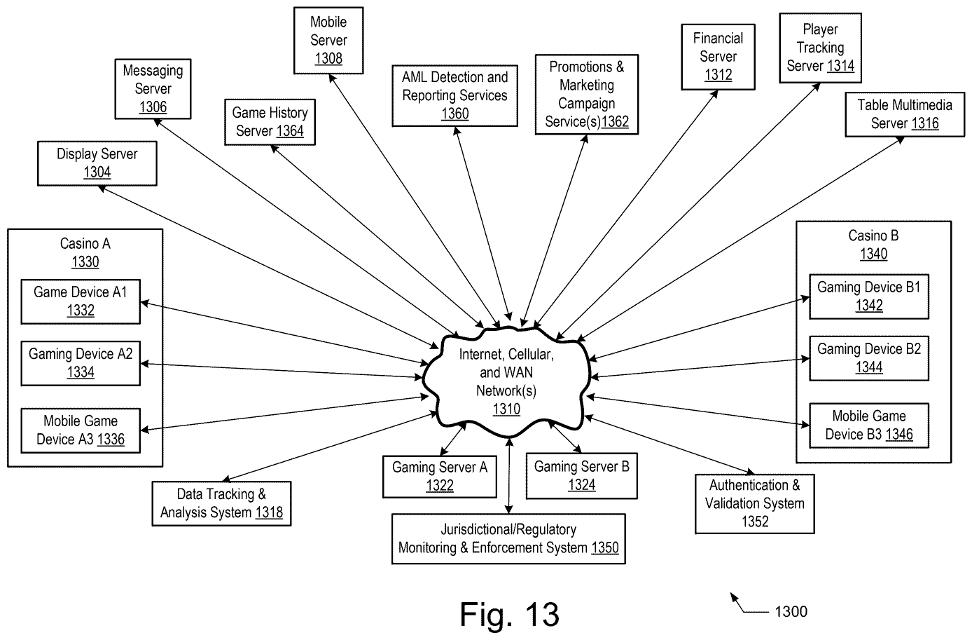

FIG. 13 illustrates an alternate example embodiment of a Gaming Network 1300 which may be configured or designed to implement various automated money laundering detection and reporting techniques described and/or referenced herein. As described in greater detail herein, different embodiments of Gaming Networks may be configured, designed, and/or operable to provide various different types of operations, functionalities, and/or features generally relating to Gaming Network technology. Further, as described in greater detail herein, many of the various operations, functionalities, and/or features of the Gaming Network(s) and/or Gaming System(s) disclosed herein may provide may enable or provide different types of advantages and/or benefits to different entities interacting with the Gaming Network(s).

According to different embodiments, the Gaming Network 1300 may include a plurality of different types of components, devices, modules, processes, systems, etc., which, for example, may be implemented and/or instantiated via the use of hardware and/or combinations of hardware and software. For example, as illustrated in the example embodiment of FIG. 13, the Gaming Network may include one or more of the following types of systems, components, devices, processes, etc. (or combinations thereof):
Display Server System(s) 1304. Table Multimedia Server System(s) 1316.
Messaging Server System(s) 1306.
Mobile Server System(s) 1308.
AML Detection and Reporting Services 1360.
Promotions & Marketing Campaign Service(s) 1362.
Financial Server System(s) 1312.
Player Tracking Server System(s) 1314.
Data Tracking & Analysis System(s) 1318.
Gaming Server System(s) (922, 1324).
Jurisdictional/Regulatory Monitoring & Enforcement System(s) 1350.
Authentication & Validation System(s) 1352.
Casino Venues (930, 1340).
Electronic Game Devices (EGDs) 1332, 1334, 1336, 1342, 1344, 1346.
Internet, Cellular, and WAN Network(s) 1310.
Game History Server(s) 1364.
Remote Database System(s).
Remote Server System(s)/Service(s).
Mobile Device(s).
Etc.
Display Server System(s) (e.g., 1304). In at least one embodiment, the Display Server System(s) may be configured or designed to implement and/or facilitate management of content (e.g., graphics, images, text, video fees, etc.) to be displayed and/or presented at one or more EGDs (or at one or more groups of EGDs), dealer displays, administrator displays, etc.
Table Multimedia Server System(s) (e.g., 1316). In at least one embodiment, the Table Multimedia Server System(s) may be configured or designed to generate, implement and/or facilitate management of content (e.g., graphics, images, text, video fees, audio feeds, etc.), which, for example, is to be streamed or provided to one or more EGDs (or to one or more groups of EGDs).
Messaging Server System(s) (e.g., 1306). In at least one embodiment, the Messaging Server System(s) may be configured or designed to implement and/or facilitate management of messaging and/or other communications among and between the various systems, components, devices, EGDs, players, dealers, administrators, and/or other personnel of the gaming network.
Mobile Server System(s) (e.g., 1308). In at least one embodiment, the Mobile Server System(s) may be configured or designed to implement and/or facilitate management of communications and/or data exchanged with various types of mobile devices, including for example: player-managed mobile devices (e.g., smart phones, PDAs, tablets, mobile computers), casino-managed mobile devices (e.g., mobile gaming devices), etc.
AML Detection and Reporting Service(s) (e.g., 1360). In at least one embodiment, the AML Detection and Reporting Service(s) may be configured or designed to include functionality for facilitating, enabling, initiating, and/or performing various types of AML Detection and Reporting operation(s), action(s), and/or feature(s) such as one or more of those described herein.
Financial Server System(s) (e.g., 1312). In at least one embodiment, the Financial Server System(s) may be configured or designed to implement and/or facilitate tracking, management, reporting, and storage of financial data and financial transactions relating to one or more wager-based gaming sessions. For example, at least some Financial Server System(s) may be configured or designed to track of the game accounting (money in, money out) for a virtual table game being played, and may also be configured or designed to handle various financial transactions relating to player wagers and payouts. For example, in at least one embodiment, Financial Servers may be configured or designed to monitor each remote player's account information, and may also manage or handle funds transfers between each player's account and the active game server (e.g., associated with the player's game session).
Player Tracking Server System(s) (e.g., 1314). In at least one embodiment, the Player Tracking Server System(s) may be configured or designed to implement and/or facilitate management and exchange of player tracking information associated with one or more EGDs, gaming sessions, etc. In at least one embodiment, a Player Tracking Server System may include at least one database that tracks each player's hands, wins/losses, bet amounts, player preferences, etc., in the network. In at least one embodiment, the presenting and/or awarding of promotions, bonuses, rewards, achievements, etc., may be based on a player's play patterns, time, games selected, bet amount for each game type, etc. A Player Tracking Server System may also help establish a player's preferences, which assists the casino in their promotional efforts to: award player comps (loyalty points); award free game play credits, free/additional reel spin opportunities; decide which promotion(s) are appropriate; generate bonuses; etc.
Data Tracking & Analysis System(s) (e.g., 1318). In at least one embodiment, the Data Tracking & Analysis System(s) may be configured or designed to implement and/or facilitate management and analysis of game data. For example, in one embodiment the Data Tracking & Analysis System(s) may be configured or designed to aggregate multisite virtual game table trends, local wins, jackpots, etc.
Gaming Server System(s) (922, (e.g., 1324). In at least one embodiment, different game servers may be configured or designed to be dedicated to one or more specifically designated type(s) of game(s) (e.g., Baccarat, Black Jack, Poker, Mahjong, Pai-gow, Chess, etc.). Each game server has game logic to host one of more virtual table game sessions. At least some game server(s) may also capable of keeping track of the game accounting (money in, money out, games won, game lost, etc.) for a virtual table game being played, and/or for updating the Financial Servers at the end of each game. The game servers may also operable to generate the virtual table graphics primitives (e.g., game pieces and game states), and may further be operable to update the remote EGDs when a game state change (e.g., new card dealt, player upped the ante, player folds/busts, etc.) has been detected.
Jurisdictional/Regulatory Monitoring & Enforcement System(s) (e.g., 1350). In at least one embodiment, the Jurisdictional/Regulatory Monitoring & Enforcement System(s) may be configured or designed to handle tracking, monitoring, reporting, and enforcement of specific regulatory requirements relating to wager-based gameplay activities in one or more jurisdictions.
Authentication & Validation System(s) (e.g., 1352). According to different embodiments, the Authentication & Validation System(s) may be configured or designed to determine and/or authenticate the identity of the current player at a given EGD. For example, in one embodiment, the current player may be required to perform a log in process at the EGD in order to access one or more features. Alternatively, the EGD may be adapted to automatically determine the identity of the current player based upon one or more external signals such as, for example, scanning of a barcode of a player tracking card, an RFID tag or badge worn by the current player which provides a wireless signal to the EGD for determining the identity of the current player. In at least one implementation, various security features may be incorporated into the EGD to prevent unauthorized players from engaging in certain types of activities at the EGD. In some embodiments, the Authentication & Validation System(s) may be configured or designed to authenticate and/or validate various types of hardware and/or software components, such as, for example, hardware/software components residing at a remote EGDs, game play information, wager information, player information and/or identity, etc. Examples of various authentication and/or validation components are described in U.S. Pat. No. 6,620,047, titled, “ELECTRONIC GAMING APPARATUS HAVING AUTHENTICATION DATA SETS,” incorporated herein by reference in its entirety for all purposes.
Game History Server(s) (e.g., 1364). In at least one embodiment, the Game History Server(s) may be configured or designed to track all (or selected) game types and game play history for all (or selected) virtual game tables. In at least one embodiment, a Game History Server may be configured or designed to assists the remote players in selecting a table by, for example, displaying the win/loss statistics of the tables selected by the player as potential candidates to participate. In some embodiments, a Game History Server may also assist the casino manager in case of disputes between players and the casino by, for example, providing the ability to “replay” (e.g., by virtually recreating the game events) the game in dispute, step by step, based on previously stored game states.

Promotions & Marketing Campaign Service(s) 1362 are integral to the casino's strategy for attracting and retaining patrons by offering a dynamic range of incentives and personalized marketing communications. These services leverage data analytics to understand patron behavior and preferences, enabling the creation of targeted promotions that resonate with specific customer segments. By offering tailored rewards, bonuses, and special events, these services enhance player satisfaction and loyalty, encouraging repeat visits and increased play. The services also encompass digital and traditional marketing campaigns, utilizing various channels to engage potential and existing customers effectively. The ability to dynamically adjust promotions in response to customer feedback and changing market conditions ensures that the casino remains competitive and responsive to player needs. Furthermore, these services provide desirable tools for measuring the effectiveness of marketing strategies, offering insights that drive continuous improvement and strategic decision-making in promotional activities.

The functionality of the various systems and components of FIG. 13 may be similar to those described previously with respect to the description of FIG. 6, and therefore need not be repeated.

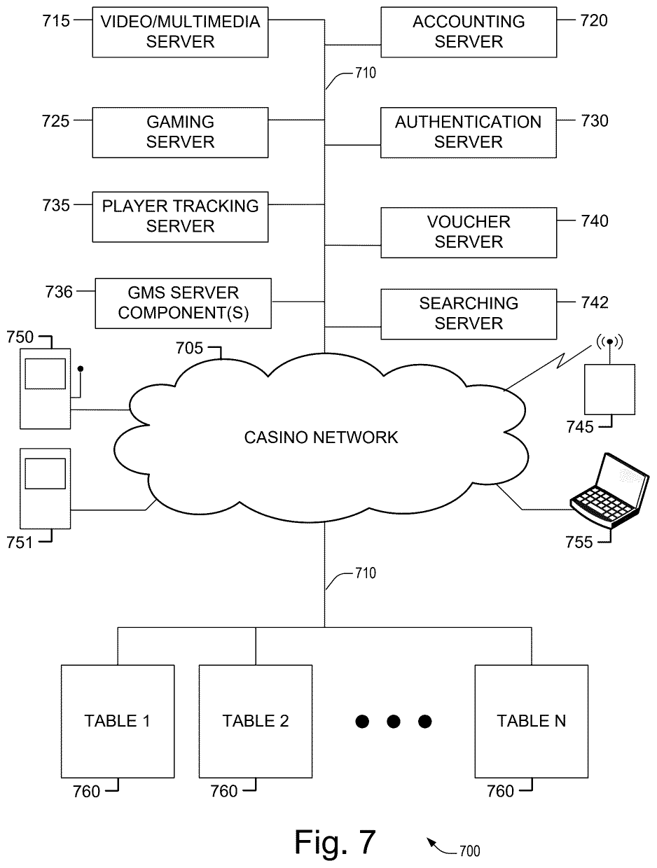

FIG. 7 shows an example block diagram of an electronic gaming system 700 in accordance with a specific embodiment. Electronic gaming system 700 may include electronic gaming tables 760, which may be coupled to network 705 via a network link 710. Electronic gaming tables 760 may be normal gaming tables with enhanced electronic capabilities. Network 705 may be the internet or a private network. One or more video streams may be received at video/multimedia server 715 from gaming tables 760. Video/Multimedia server 715 may transmit one or more of these video streams to a mobile device 745, a gaming device 750, an EGD 751, a laptop 755, and/or any other remote electronic device. Video/Multimedia server 715 may transmit these video streams via network link 710 and network 705.

Electronic gaming system 700 may include an accounting/transaction server 720, a gaming server 725, an authentication server 730, a player tracking server 735, a voucher server 740, and a searching server 742.

Accounting/transaction server 720 may compile, track, store, and/or monitor cash flows, voucher transactions, winning vouchers, losing vouchers, and/or other transaction data for the casino operator and for the players. Transaction data may include the number of wagers, the size of these wagers, the date and time for these wagers, the identity of the players making these wagers, and the frequency of the wagers. Accounting/transaction server 720 may generate tax information relating to these wagers. Accounting/transaction server 720 may generate profit/loss reports for predetermined gaming options, contingent gaming options, predetermined betting structures, and/or outcome categories.

Gaming server 725 may generate gaming options based on predetermined betting structures and/or outcome categories. These gaming options may be predetermined gaming options, contingent gaming options, and/or any other gaming option disclosed in this disclosure.

Authentication server 730 may determine the validity of vouchers, players' identity, and/or an outcome for a gaming event.

Player tracking server 735 may track a player's betting activity, a player's preferences (e.g., language, drinks, font, sound level, etc.). Based on data obtained by player tracking server 735, a player may be eligible for gaming rewards (e.g. free play), promotions, and/or other awards (e.g., complimentary food, drinks, lodging, concerts, etc.).

Voucher server 740 may generate a voucher, which may include data relating to gaming options. For example, data relating to the structure (e.g., 6 out of the next 10 rolls at craps table 4 will be a 7 or 11) may be generated. If there is a time deadline, that information may be generated by voucher server 740. Vouchers may be physical (e.g., paper) or digital.

The GMS Server Component(s) 736 represents the centralized server-side logic, data storage, and processing modules that constitute the specific Game Management System (GMS) (680) within the casino network 705. This component is the definitive command and control hub for the entire Grand Paradise Jackpot ecosystem, coordinating all real-time activities between the gaming tables 760, various specialized servers (like Player Tracking 735), and all connected gaming devices (750, 751, 755). Its primary function is to execute the novel jackpot logic that transforms the game from a static-prize experience into a dynamic, live, and personalized event. This component is responsible for implementing the Dynamic Probability-Based Jackpot Engine; it maintains the Shoe Composition Dataset based on card data received from the tables, queries the Probability Calculation Engine (688) for real-time odds after each card deal, and broadcasts the dynamically adjusted multipliers to all player terminals. It also manages the Rolling Window Consecutive Card Trigger, tracking the last six cards dealt, independent of hand boundaries, to identify winning combinations. Furthermore, this server component is the hub for Dealer/Player Agency features and Personalization features. It receives and stores the player tier selection maps from each terminal, enabling customized wagering. It also interfaces with the Player Tracking Server 735 to retrieve player profiles, passes them to the AI/ML Personalization Engine (687), and applies the resulting unique multipliers or challenges to a player's specific session. This GMS Server Component is a significant technical improvement over prior art, changing the function of a gaming server from a passive lookup table to a dynamic, stateful, and computational analysis engine that personalizes payouts in real-time.

Searching server 742 may implement a search on one or more gaming devices to obtain gaming data. Searching server 742 may implement a messaging function, which may transmit a message to a third party (e.g., a player) relating to a search, a search status update, a game status update, a wager status update, a confirmation of a wager, a confirmation of a money transfer, and/or any other data relating to the player's account. The message can take the form of a text display on the gaming device, a pop up window, a text message, an email, a voice message, a video message and the like. Searching server 742 may implement a wagering function, which may be an automatic wagering mechanism. These functions of searching server 742 may be integrated into one or more servers.

Searching server 742 may include one or more searching structures, one or more searching algorithms, and/or any other searching mechanisms. In general, the search structures may cover which table games paid out the most money during a time period, which table games kept the most money from players during a time period, which table games are most popular (top games), which table games are least popular, which table games have the most amount of money wager during a period, which table games have the highest wager volume, which table games are more volatile (volatility, or deviation from the statistical norms, of wager volume, wager amount, pay out, etc.) during a time period, and the like. Search may also be associated with location queries, time queries, and/or people queries (e.g., where are the table games that most of my friends wager on, where are my favorite dealers, what do players wager on the most today, when are most wagers placed, etc.).

The searching structures may be predetermined searching structures. For example, the method may start searching a first device, then a second device, then a third device, up to an N^{th} device based on one or more searching parameters (e.g., triggering event). In one example, the search may end once one or more triggering events are determined. In another example, the search may end once data has been received from a predetermined number (e.g., one, two, ten, one hundred, all) of the devices. In another example, the search may be based on a predetermined number of devices to be searched in combination with a predetermined number of search results to be obtained. In this example, the search structure may be a minimum of ten devices to be searched, along with a minimum of five gaming options to be determined.

In another example, the searching structures may be based on one or more specific games (e.g., baccarat tables, roulette tables, blackjack tables, poker tables, craps tables, Sic Bo tables, etc.). Searching structure may search one or more of these games.

In another example, the searching structure may be based on a player's preferences, past transactional history, player input, a particular table, a particular game, a particular dealer, a particular casino, a particular location within a casino, game outcomes over a time period, payout over a time period, and/or any other criteria.

Searching algorithms may be dynamic searching programs, which may be modified based on one or more past results. For example, a search algorithm may be based on searching blackjack tables. The search algorithm may initially search blackjack tables 1-10 to determine whether any triggering events have occurred. Based on one or more previous searches, the search algorithm may determine: (1) that blackjack tables 1-4 are only opened from 7 pm to 3 am; (2) that blackjack tables 5-7 are opened twenty-four hours a day; and (3) that blackjack tables 8-10 are only opened from 7 am to 5 pm. The search algorithm may then modify the search parameters utilized based on this data. For example, if the search algorithm is initiated at 6 pm to determine blackjack triggering events, then the search algorithm may only search blackjack tables 5-7 because these blackjack tables are the only blackjack tables operating at that specific time.

In another example, the search algorithm may determine that a specific triggering event occurs with a ninety percent success rate on a first table, a ten percent success rate on a second table, a fifty percent success rate on a third table, and a seventy percent success rate on a fourth table. The search algorithm may generate a search priority based on the probability of success, which may lead to the first table being searched first, the fourth table being searched second, the third table being searched third, and the second table being searched fourth. Search algorithm may utilize any dynamic feedback procedure to enhance current and/or future searching results

FIG. 8 shows electronic gaming table 760 with various features, in accordance with a specific embodiment. Various different embodiments of the electronic gaming table 760 may be used as a live game table for conducting gameplay relating to one or more gaming sessions.

Electronic gaming table 760 may include a processor 800, a memory 805, a display 810, a printer 815, an electronic shoe 820, an electronic shuffler 822, a smart card reader 825, a jackpot controller 830, a chips reader 835, and a camera 840.

Processor 800 may be communicatively coupled to any other device in electronic gaming table 760. Processor 800 via an interface may communicate wired or wireless, with any of the elements of electronic gaming device 900 and/or electronic gaming table system 700.

Memory 805 may include data relating to gaming events, video streams transmitted from electronic gaming table 760, winning and losing percentages for gaming options relating to electronic gaming table 760, and game management data (e.g., dealer schedule, chip refills, etc.).

Display 810 may show previous game results, a betting structure, outstanding wagers, transaction volume, present value of betting options, a table minimum wager, a table maximum wager, wager and/or game play instructions input by one or more remote players (e.g., via their respective EGDs), instructions to the live dealer/attendant relating to game play activities to be performed by the dealer/attendant, video data, and/or any other type of data or content.

Printer 815 may generate vouchers, promotional items, food tickets, event tickets, and/or lodging tickets. Vouchers may be physical (e.g., paper) or digital.

Electronic shuffler 822 may be configured or designed to automatically shuffle multiple decks of cards, and to track the relative order of each of the cards of the shuffled decks of cards. The electronic shuffler can include an off the shelf unit. A dealer can use the electronic shuffler to shuffle the decks of cards before dealing the required hands, and place the shuffled decks of cards into the electronic shoe 820. In this way, the electronic gaming table may determine the relative order of all cards in the card shoe at the start of one or more game session(s), and/or at all other times of game play.

Electronic shoe 820 may obtain data and/or images of gaming objects utilized with gaming table 760. This data and/or images maybe transmitted to electronic gaming device and displayed as images from table games. For example, on a blackjack table a ten of spades may be dealt to a player. This information is obtained via electronic shoe 820 and utilized to generate an image and/or illustration of a ten of spades card on an electronic gaming device. In another example, electronic shoe 820 may receive data relating to the numbers on dice, transmit this data to electronic gaming device, which may be utilized to generate an image/illustration of the dice on electronic gaming device.

In at least one embodiment, the electronic shoe can include an electronic reading system, such as an optical reader for recognizing the face value of each card. The electronic shoe can be designed to communicate directly with the card dealing/shuffling system to read or otherwise obtain the value of each card being dealt by the dealer as the card leaves the card dealing/shuffling system. For example, an optical reader or similar device can be attached to the card dealing/shuffling system, and the electronic shoe can obtain the scanned value of cards in the card dealing/shuffling system. In some implementations, the electronic shoe can interface with the table to read the value of each card being dealt by the dealer. For example, the table can include one or more scanning interfaces to scan each card before or after the card is dealt by the dealer. The electronic shoe can communicate with the one or more scanning interfaces to obtain the value of each card before or after the card is dealt by the dealer.

Card reader 825 may provide identification, authentication, and application processing functions. Card reader 825 may interface with smart cards, magnetic striped card, bar code reader, RFID card, and the like.

Jackpot controller 830 may track and compile data associated with a jackpot. Jackpot controller 830 may award the jackpot on a specific occurrence (e.g., blackjack event, dealing a royal flush, etc.) and/or randomly award a jackpot.

Chips reader 835 may compile and track data associated with the amount of chips one or more players possesses, the amount of chips won/lost at gaming table 760, the amount of chips in the dealer's rack at gaming table 760, an amount of chips wager by one or more players, amount of chips in the betting pool, and/or any combination thereof.

Camera 840 may obtain data from gaming table 760. Camera 840 may be one or more cameras located to view the gaming objects (e.g., cards, dice, dominos, ball, wheel, etc.), the dealer, the shoe, the players' hands, the players, and/or any combination thereof. Camera 840 may transmit this data to gaming table, which may be utilized to generate an image/illustration of the gaming objects.

Speakers 842 may be used to provide audio information to the game table dealer/attendant. Examples of different types of audio information may include, for example, audio instructions and/or other audio/verbal communications from one or more remote players, computer-generated audio instructions/content, sound effects, and/or other types of audio content.

Microphone 843 may be used to capture, record, and/or stream audio information from the electronic gaming table region, which, for example, may include verbal communications from the table game dealer/attendant.

Game And Wager Data Collection Component(s) 844 may include functionality for facilitating, enabling, initiating, and/or performing collection and reporting of various types of information relating to conditions and/or events occurring at an associated gaming device and/or gaming table game, such as, for example: game-related information, player tracking information, wager-related information (e.g., including financial transaction events), and/or other types of data/information described and/or referenced herein.

According to specific embodiments, a variety of different game states may be used to characterize the state of current and/or past events which are occurring (or have occurred) at a given live gaming table. For example, in one embodiment, at any given time in a game, a valid current game state may be used to characterize the state of game play (and/or other related events, such as, for example, mode of operation of the gaming table, etc.) at that particular time. In at least one embodiment, multiple different states may be used to characterize different states or events which occur at the gaming table at any given time. In one embodiment, when faced with ambiguity of game state, a single state embodiment forces a decision such that one valid current game state is chosen. In a multiple state embodiment, multiple possible game states may exist simultaneously at any given time in a game, and at the end of the game or at any point in the middle of the game, the gaming table may analyze the different game states and select one of them based on certain criteria. Thus, for example, when faced with ambiguity of game state, the multiple state embodiment(s) allow all potential game states to exist and move forward, thus deferring the decision of choosing one game state to a later point in the game. The multiple game state embodiment(s) may also be more effective in handling ambiguous data or game state scenarios.

According to specific embodiments, a variety of different entities may be used (e.g., either singly or in combination) to track the progress of game states which occur at a given gaming table. Examples of such entities may include, but are not limited to, one or more of the following (or combination thereof): master controller system, display system, gaming system, local game tracking component(s), remote game tracking component(s), etc. Examples of various game tracking components may include, but are not limited to: automated sensors, manually operated sensors, video cameras, intelligent playing card shoes, RFID readers/writers, RFID tagged chips, objects displaying machine readable code/patterns, etc.

According to a specific embodiment, local game tracking components at the gaming table may be operable to automatically monitor game play activities at the gaming table, and/or to automatically identify key events which may trigger a transition of game state from one state to another as a game progresses. For example, in the case of Blackjack, a key event may include one or more events which indicate a change in the state of a game such as, for example: a new card being added to a card hand, the split of a card hand, a card hand being moved, a new card provided from a shoe, removal or disappearance of a card by occlusion, etc.

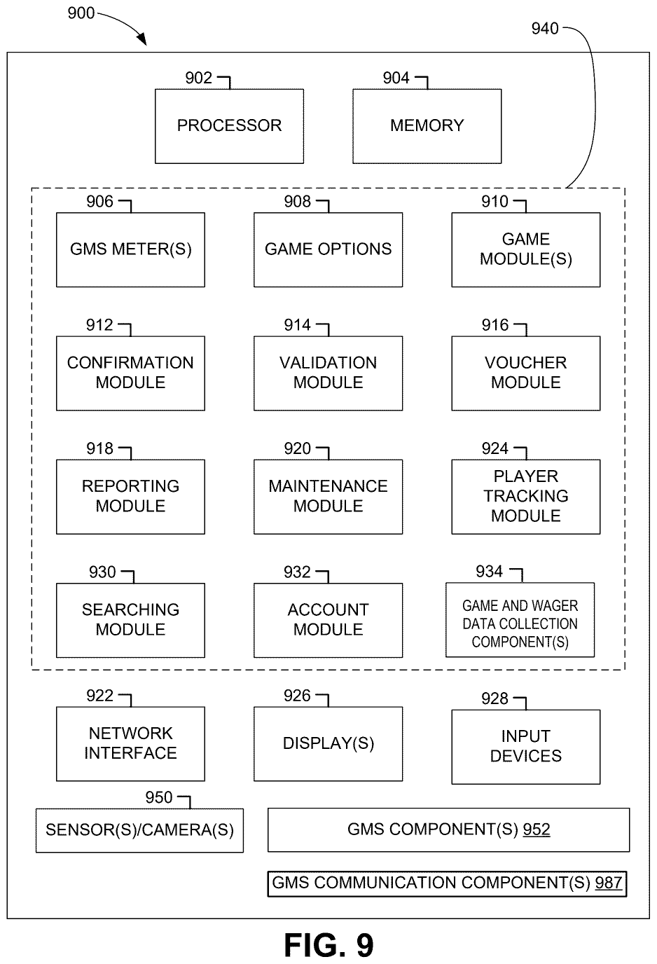

FIG. 9 shows a block diagram 900 of electronic gaming device 900, in accordance with a specific embodiment. Electronic gaming device 900 may include a processor 902, a memory 904, a network interface 922, input devices 928, and a display 926.

Processor 902 may generate gaming options based on predetermined betting structures and/or outcome categories. As previously discussed in the craps example above, predetermined betting structures may include outcome categories. In that example, there were three outcome categories (e.g., outcome equaling a seven, outcome not equaling a hard number, and outcome not equaling a craps). Predetermined betting structures may utilize one outcome category (e.g., win, lose, hard number, craps, etc.) to generate via processor 902 gaming options. Predetermined betting structures may utilize more than one outcome category to generate via processor 902 gaming options. Predetermined betting structures may combine any outcome category with any other outcome category to gaming options.

Processor 902 may generate gaming options 908, which, for example, may include contingent gaming options and/or predetermined gaming options. Contingent gaming options may be structures such that when a triggering event occurs over one or more than one gaming event, racing event, and/or sporting event, the wager is activated. Processor 902 may offer a gaming option which is structured so that the gaming option relates to more than one gaming table. The gaming option structure may be that for the next five baccarat games the dealer will win three of these five games and three of the next five roulette games red will be the winning spot.

In at least some embodiments, a predetermined game options module may store data relating to predetermined gaming options, which may be offered to a player, and a contingent game options module may store data relating to continent gaming options, which may be offered to a player.

Network interface 922 may be configured or designed to enable the electronic gaming device 900 to communicate with video/multimedia server(s), accounting/transaction server(s), gaming server(s), authentication server(s), player tracking server(s), voucher server(s), and gaming table(s).

Input devices 928 may be mechanical buttons, electronic buttons, a touchscreen, a microphone, cameras, an optical scanner, or any combination thereof. Input devices 928 may be utilized to make a wager, to make an offer to buy or sell a voucher, to determine a voucher's worth, to cash in a voucher, to modify (e.g., change sound level, configuration, font, language, etc.) electronic gaming device 900, to select a movie or music, to select live video streams (e.g., table 1, table 2, table 3), to request services (e.g., drinks, manager, etc.), or any combination thereof.

Display 926 may show video streams from one or more gaming tables 260, gaming objects from one or more gaming tables 260, computer generated graphics, predetermined gaming options 106, and/or contingent gaming options 108.

Memory 904 may include various memory modules 940. Memory 904 via various memory modules 940 may include a future betting module 906, a predetermined game options module 908, a contingent game options module 910, a confirmation module 912, a validation module 914, a voucher module 916, a reporting module 918, a maintenance module 920, a player tracking preferences module 924, a searching module 930, and an account module 932.

Confirmation module 912 may utilize data received from a voucher, the transaction history of the voucher (e.g., the voucher changed hands in a secondary market), and/or the identity of the player to confirm the value of the voucher. In another example, confirmation module 912 may utilize game event data, along with voucher data to confirm the value of the voucher.

Validation module 914 may utilize data received from a voucher to confirm the validity of the voucher.

Voucher module 916 may store data relating to generated vouchers, redeemed vouchers, bought vouchers, and/or sold vouchers.

Game And Wager Data Collection Component(s) 934 may include functionality for facilitating, enabling, initiating, and/or performing collection and reporting of various types of information relating to conditions and/or events occurring at an associated gaming device and/or gaming table game, such as, for example: game-related information, player tracking information, wager-related information (e.g., including financial transaction events), and/or other types of data/information described and/or referenced herein.

Sensor(s)/Camera(s) 950 may be configured or designed to detect and capture external data, events, and/or conditions including, for example, biometric information (e.g., facial images, facial features, fingerprints, voice recordings, etc.) relating to the player(s) or user(s) interacting with the gaming device. In some embodiments, the camera and/or other sensor(s) of the electronic gaming device may be remotely controlled and actuated. For example, in one embodiment, if it is determined that suspicious ML activities may be occurring at a given electronic gaming device, the camera of the electronic gaming device may be caused to be remotely actuated in order to capture a facial image of the person(s) who is/are interacting with the electronic gaming device.

Reporting module 918 may generate reports related to a performance of electronic gaming device 900, electronic gaming system, table game, video streams, gaming objects, credit device, and/or identification device.

In one implementation, reporting module 918 may reside on a central server and can aggregate and generate real time statistics on betting activities at one or more table games at one or more participating casino's. The aggregate betting statistics may include trends (e.g., aggregate daily wager volume and wager amount by game types, by casinos, and the like), top games with the most payouts, top tables with the most payouts, top search structures used by players, most popular dealers by wager volume, most searched for game, tables with least payouts, weekly trends, monthly trends, and other statistics related to game plays, wagers, people, location, and searches.

The information and statistics generated by the server-based reporting module 918 can be displayed publicly or privately. For example, popular trending and statistical information on wager volume and wager amount for the top ten table games can be publicly displayed in a casino display system so that players can study and decide what game to play, where, when, etc. Such a public display of general statistics can also be posted on the Internet, sent out as a text, an email, or multimedia message to the player's smart phones, tablets, desktop computer, etc. In another example, the trending and statistical information can also be distributed privately to privileged players such as casino club members.

Maintenance module 920 may track any maintenance that is implemented on electronic gaming device 900 and/or electronic gaming system 200. Maintenance module 920 may schedule preventative maintenance and/or request a service call based on a device error.

The Player Tracking Module 924 is a sophisticated component within the gaming system that monitors and records player activity during gaming sessions. This module is desirable for gathering data on player behavior, preferences, and gaming patterns. By tracking such activities, casinos may tailor their offerings and promotions to better suit individual player preferences, thereby enhancing the overall gaming experience. This module often works in conjunction with player loyalty programs, awarding points or credits based on gaming frequency, duration, and wager amounts. The insights gained from the Player Tracking Module 924 enable casinos to deliver personalized gaming experiences, incentivize repeat visits, and foster a deeper engagement with players. Moreover, this data is invaluable for optimizing game floor management, marketing strategies, and customer service initiatives, ultimately contributing to improved customer satisfaction and loyalty.

Player tracking module 924 may be configured or designed to communicate with the Casino's network-based player tracking system to retrieve player tracking data associated with the identified player and/or compile and track player tracking-related data including, for example, one or more of the following (or combinations thereof):
data associated with a players preferences;
game play activity
wagering activity;
earned rewards;
comps;
free game play opportunities;
free spin (and respin) opportunities;
GMS-related opportunities;
promotional offers;
non-game play activities conducted by that player/patron at the casino property such as, for example:
   shopping activities;
   dining activities;
   purchasing/spending activities;
   entertainment activities;
etc.

The GMS Meter(s) 906 are specialized virtual or soft meters implemented within the Electronic Gaming Device's 900 display system 926. These meters are distinct from the EGD's main credit and win meters. Their specific function is to track and display accumulated credits, points, or other game-specific metrics related directly to the Grand Paradise Jackpot system and its associated features. Managed by the local GMS Component(s) (952), this meter provides the player with clear, immediate, and dedicated feedback on their status within the jackpot meta-game. For example, the meter may update in real-time to show progress towards a Personalized Jackpot Journey (Tech #37), such as Quest Progress: 3/5 Stars, or display points accumulated from completing Personalized Jackpot Challenges (Tech #28). This provides a direct technical solution to the problem of ambiguous player feedback, where bonus system progress is often abstract and not clearly visualized. By providing this dedicated, real-time feedback, the GMS Meter(s) 906 significantly enhance player engagement, create a tangible sense of progression, and encourage strategic, long-term play as players may visually track their progress toward the next jackpot milestone.

The GMS Component(s) 952 represents the client-side software module and logic components that reside within the local Electronic Gaming Device (EGD) 900. This component's primary purpose is to act as the terminal-side interface and logic handler for the central Game Management System (GMS) (680). It is responsible for all GMS-related functionality on the EGD, differentiating it from the base Game Module(s) (910). This component works via the GMS Communication Component(s) (987) to receive real-time data broadcasts from the GMS server, such as the dynamically adjusted jackpot multipliers, and renders this information on the EGD's Display(s) (926). It is also the component that enables player agency by rendering the Player-Selectable Jackpot Interface, which is a graphical menu allowing the player to choose a unique subset of jackpot tiers. It then transmits this selection back to the GMS server for win verification. Furthermore, this component is the client-side execution engine for Personalization features. It receives and interprets personalized data from the GMS, such as commands to display a VIP 2× Multiplier banner or to render the entire Jackpot Journey quest interface, including challenge descriptions and progress bars (managed by the GMS Meter(s) (906)). This component transforms the EGD from a static, self-contained terminal into an intelligent, dynamic, and personalized client, solving the technical problem of a generic, one-size-fits-all player interface.

The GMS Communication Component(s) 987 is a specialized hardware and/or software module within the Electronic Gaming Device (EGD) 900, distinct from the general Network Interface (922). Its specific function is to establish, manage, and secure the persistent, low-latency data connection between the client-side GMS Component(s) (952) and the central, server-side GMS Server Component(s) (e.g., 430, 680). This component is a technical prerequisite for the Grand Paradise Jackpot system's real-time features. It is implemented not as a standard, high-latency HTTP polling mechanism, but as a continuous, bi-directional communication tunnel, such as a WebSocket or gRPC stream. This is a non-trivial technical solution required to solve the problem of data staleness and game-state synchronization. This component is responsible for transmitting client-to-server data, including player jackpot bets and, notably, the Player-Selectable Jackpot Interface tier selections. Critically, it is optimized to receive high-frequency, server-to-client data pushes, such as the constantly updating dynamic jackpot multipliers, real-time Rolling Window buffer updates, personalized challenge/journey data, and instant Start Bonus commands. This component's ability to facilitate the sub-500 ms card-to-screen data loop is a tangible technical improvement in network functionality, ensuring all players are synchronized and that the dynamic jackpot data they see is accurate and fair.

Game Options 908 encompasses the variety of selectable settings and choices presented to players within a gaming machine. This component allows players to customize their gaming experience according to personal preferences, including adjusting bet amounts, selecting pay lines, and activating various game features relating to one or more of the GMS features disclosed herein. The availability of these options plays a notable role in enhancing player engagement by offering a sense of control over the game mechanics and outcomes. By enabling players to tailor the gameplay to their liking, Game Options 908 fosters a more immersive and enjoyable gaming environment. This customization feature is designed with the player in mind, ensuring that the gaming experience may be as dynamic and interactive as possible, thus encouraging prolonged play and increased satisfaction with the gaming experience.

Game Modules 910 refer to the specific components of the gaming system that execute the various games available on an Electronic Gaming Machine (EGD). These modules encompass the software and hardware elements necessary for the operation of games, including game logic, graphics, sound, and interactive features such as touch screen controls. Each module is responsible for delivering a distinct gaming experience, complete with unique themes, pay tables, bonus rounds, and, where applicable, GMS features. The modularity of these systems allows for a diverse gaming portfolio within a single EGD, offering players a wide range of entertainment options. Game Modules 910 are notable in maintaining player interest and engagement by providing fresh and varied gaming content. Additionally, they facilitate easy updates and integration of new games or features, ensuring that the gaming experience remains current and appealing to players.

Searching module 930 may include one or more searching structures, one or more searching algorithms, and/or any other searching mechanisms. The searching structures may be predetermined searching structures. For example, the method may start searching a first device, then a second device, then a third device, up to an N^{th} device based on one or more searching parameters (e.g., triggering event). In one example, the search may end once one or more triggering events are determined. In another example, the search may end once data has been received from a predetermined number (e.g., one, two, ten, one hundred, all) of the devices. In another example, the search may be based on a predetermined number of devices to be searched in combination with a predetermined number of search results to be obtained. In this example, the search structure may be a minimum of ten devices to be searched, along with a minimum of five gaming options to be determined.

In another example, the searching structures may be based on one or more specific games (e.g., baccarat tables, roulette tables, blackjack tables, poker tables, craps tables, Sic Bo tables, etc.). Searching structure may search one or more of these games.

In another example, the searching structure may be based on a player's preferences, past transactional history, player input, a particular table, a particular game, a particular dealer, a particular casino, a particular location within a casino, game outcomes over a time period, payout over a time period, and/or any other criteria. Searching algorithms may be dynamic searching programs, which may be modified based on one or more past results, as described previously.

In another example, the search algorithm may generate a search priority based on the probability of success various events and/or conditions, as described previously. In some embodiments, the search algorithm may utilize any dynamic feedback procedure to enhance current and/or future searching results.

Account module 932 may include data relating to an account balance, a wager limit, a number of wagers placed, credit limits, any other player information, and/or any other account information.

Data from account module 932 may be utilized to determine whether a wager may be accepted. For example, when a search has determined a triggering event, the device and/or system may determine whether to allow this wager based on one or more of a wager amount, a number of wagers, a wager limit, an account balance, and/or any other criteria.

For example, the system and/or device determines via searching function that a triggering event has occurred. Based on this triggering event, the player would like to make a $400 wager, however, the player's account balance is only $50. In this case, the system and/or device may not accept the wager, modify the wager to the account balance (e.g., $50), send a notice to the player, modify the wager to some percentage (e.g., 10%, 25%, 50%, 75%, etc.) of the account balance (e.g., $5, $12.50, $25, $37.5, etc.), send a notice to the gaming entity, make a flat wager (e.g., $10), and/or any combination thereof.

In another example, the system and/or device determines via searching function that a triggering event has occurred. Based on this triggering event, the player would like to make a $400 wager and the player's account balance is $150. However, the system and/or device may not accept the wager because one betting parameter may be that no one wager may be more than a certain percentage (e.g., fifty percent) of a player's account balance. In this case, the system and/or device may not accept the wager, modify the wager to the predetermined limit (e.g., $75), send a notice to the player, modify the wager to some other percentage (e.g., 5%, 10%, 25%, 90%, etc.) of the account balance, send a notice to the gaming entity, make a flat wager (e.g., $10), and/or any combination thereof.

In another example, the gaming jurisdiction, the casino, the system and/or device may not allow an individual to place a wager over a specific value (e.g., $25, $400, $1,000, $10,000, $400,000, $1,000,000, etc.).

In another example, the system and/or device may not allow an individual to lose more than a specific amount of money in a predetermined timeframe. An individual may only be allowed to lose $200 (or any other number) over a two hour period (or any other time period).

In another example, based on this triggering event, the player would like to make a $400 wager and the player has a $200 balance. However, the player has made a predetermined number of wagers within a predetermined time frame. For example, the system and/or device may not allow an individual to make more than 5 wagers a day, 25 wagers a week, 1,000 wagers a year, etc.

Any of these betting parameters may be combined by the system and/or device.

In at least one embodiment, at least a portion of the modules discussed in block diagram 900 may reside locally in gaming terminal 900. However, In at least some embodiments, the functions performed by these modules may be implemented in one or more remote servers. For instance, modules 906-420 and 924 may each be on a remote server, communicating with gaming terminal 900 via a network interface such as Ethernet in a local or a wide area network topology. In some implementations, these servers may be physical servers in a data center. In some other implementations, these servers may be virtualized. In yet some other implementations, the functions performed by these modules may be implemented as web services. For example, the predetermined game options module 908 may be implemented in software as a web service provider. Gaming terminal 900 would make service requests over the web for the available predetermined wager options to be displayed. Regardless of how the modules and their respective functions are implemented, the interoperability with the gaming terminal 900 is seamless.

In one implementation, reporting module 918 may reside on a central server and can aggregate and generate real time statistics on betting activities at one or more table games at one or more participating casino's. The aggregate betting statistics may include trends (e.g., aggregate daily wager volume and wager amount by game types, by casinos, and the like), top games with the most payouts, top tables with the most payouts, top search structures used by players, most popular dealers by wager volume, most searched for game, tables with least payouts, weekly trends, monthly trends, and other statistics related to game plays, wagers, people, location, and searches.

The information and statistics generated by the server-based reporting module 918 can be displayed publicly or privately. For example, popular trending and statistical information on wager volume and wager amount for the top ten table games can be publicly displayed in a casino display system so that players can study and decide what game to play, where, when, etc. Such a public display of general statistics can also be posted on the Internet, sent out as a text, an email, or multimedia message to the player's smart phones, tablets, desktop computer, etc. In another example, the trending and statistical information can also be distributed privately to privileged players such as casino club members.

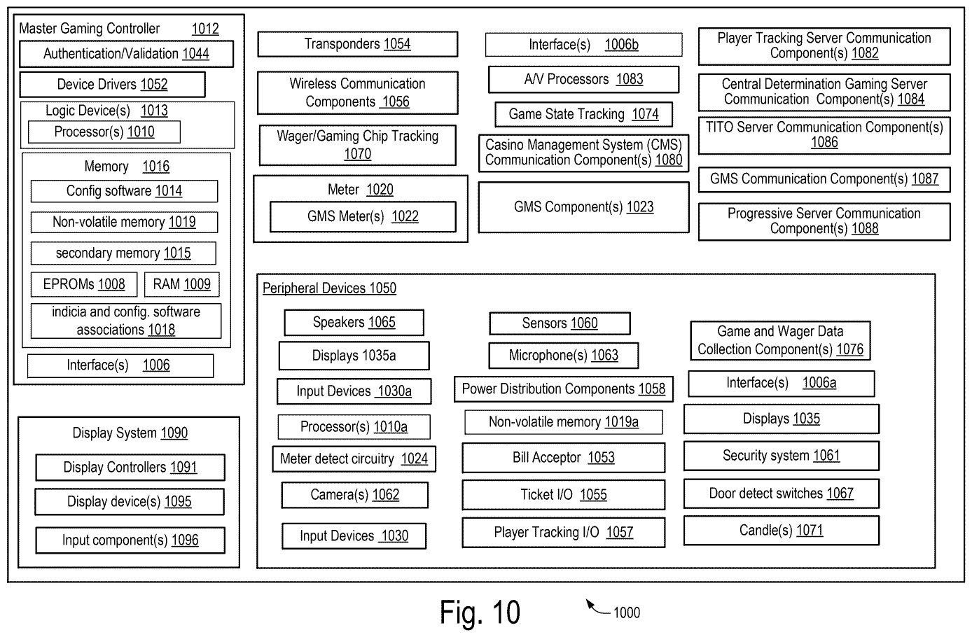

FIG. 10 is a simplified block diagram of an exemplary intelligent multi-player electronic gaming system 1000 in accordance with a specific embodiment. In some embodiments, gaming system by hundred may be implemented as a gaming server. In other embodiments, gaming system 1000 may be implemented as an electronic gaming machine (EGD) or electronic gaming device (EGD) or electronic gaming terminal (EGT).

As illustrated in the embodiment of FIG. 10, gaming system 1000 includes at least one processor 1010, at least one interface 1006, and memory 1016. Additionally, as illustrated in the example embodiment of FIG. 10, gaming system 1000 includes at least one master gaming controller 1012, a multi-touch sensor and display system 1090, a plurality of peripheral device components 1050, and various other components, devices, systems such as, for example, one or more of the following (or combinations thereof):
Transponders 1054;
Wireless communication components 1056;
Gaming chip/wager token tracking components 1070;
Games state tracking components 1074;
Audio/video processors 1083 which, for example, may include functionality for detecting, analyzing and/or managing various types of audio and/or video information relating to various activities at the gaming system;
Various interfaces 1006 (e.g., for communicating with other devices, components, systems, etc.);
Sensors 1060;
One or more cameras 1062;
One or more microphones 1063;
Input devices 1030a;
Peripheral Devices 1050;
Game and Wager Data Collection Component(s) 1076

One or more cameras (e.g., 1062) may be used to monitor, stream and/or record image content and/or video content relating to persons or objects within each camera's view. For example, in at least one embodiment where the gaming system is implemented as an EGD, camera 1062 may be used to generate a live, real-time video feed of a player (or other person) who is currently interacting with the EGD. In some embodiments, camera 1062 may be used to verify a user's identity (e.g., by authenticating detected facial features), and/or may be used to monitor or tract facial expressions and/or eye movements of a user or player who is interacting with the gaming system.

In at least one embodiment, display system 1090 may include one or more of the following (or combinations thereof):
Display controllers 1091;
Multipoint sensing device(s) (e.g., multi-touch surface sensors/components);
Display device(s) 1095;
Input/touch surface 1096;
Etc.

According to various embodiments, display device(s) 1095 may include one or more display screens utilizing various types of display technologies such as, for example, one or more of the following (or combinations thereof): LCDs (Liquid Crystal Display), Plasma, OLEDs (Organic Light Emitting Display), TOLED (Transparent Organic Light Emitting Display), Flexible (F)OLEDs, Active matrix (AM) OLED, Passive matrix (PM) OLED, Phosphorescent (PH) OLEDs, SEDs (surface-conduction electron-emitter display), EPD (ElectroPhoretic display), FEDs (Field Emission Displays) and/or other suitable display technology. EPD displays may be provided by E-ink of Cambridge, MA. OLED displays of the type list above may be provided by Universal Display Corporation, Ewing, NJ.

In at least one embodiment, master gaming controller 1012 may include one or more of the following (or combinations thereof):
Authentication/validation components 1044;
Device drivers 1042;
Logic devices 1013, which may include one or more processors 1010;
Memory 1016, which may include one or more of the following (or combinations thereof): configuration software 1014, non-volatile memory 1015, EPROMS 1008, RAM 1009, associations 1018 between indicia and configuration software, etc.;
Interfaces 1006;

In at least one embodiment, Peripheral Devices 1050 may include one or more of the following (or combinations thereof):
Power distribution components 1058;
Non-volatile memory 1019a (and/or other types of memory);
Bill acceptor 1053;
Ticket I/O 1055;
Player tracking I/O 1057;
Meter detect circuitry 1024;
Processor(s) 1010a;
Interface(s) 1006a;
Display(s) 1035;
Security system 1061;
Door detect switches 1067;
Input devices 1030;
Etc.

EGD Meters 1020 provide real-time tracking and display of various game metrics such as credits, bets, wins, and more. These meters serve a dual purpose: offering players transparent insights into their current game status and enabling operators to monitor machine performance and compliance with gaming regulations. By presenting information clearly, EGD Meters help players make informed decisions about their gameplay, such as managing their bets and understanding their winnings. For operators, these meters facilitate efficient management of gaming operations by ensuring accuracy in transactions and gameplay integrity. The data collected through EGD Meters are also notable for analytical purposes, allowing for the optimization of game offerings and the enhancement of player experiences based on actual usage patterns and preferences.

The GMS Meter(s) 1022 are specialized virtual or soft meters, distinct from the main EGD Meters (1020), and are displayed on the gaming system's Display(s) (1035). Their specific function is to track and display metrics related exclusively to the Grand Paradise Jackpot (GMS) features. This component is managed by the local GMS Component(s) (1023) and provides the player with clear, immediate, and dedicated feedback on their status within the jackpot meta-game. Instead of just tracking monetary credits, these meters are designed to represent a player's progress in challenge-based or narrative-driven jackpot mechanics, which are notable to the invention's personalization features. For example, a GMS Meter may be rendered as a progress bar for a Personalized Jackpot Challenge (Tech #28) (e.g., Banker Streak: 2/3) or as a points system for a long-term Personalized Jackpot Journey (Tech #37). This provides a direct technical solution to the problem of abstract or non-existent feedback for bonus systems. By providing a dedicated, real-time, visual representation of their progress, the GMS Meter(s) 1022 enhance player engagement, create a tangible sense of progression, and encourage strategic, long-term play.

The GMS Component(s) 1023 represent the client-side software module and logic components that reside within the local intelligent electronic gaming system 1000. This component acts as the terminal-side interface for the central Game Management System (GMS) (680), enabling the gaming system to execute the advanced, server-driven jackpot features. It is responsible for rendering all specialized user interfaces required for the Grand Paradise Jackpot and managing bi-directional communication with the GMS server via the GMS Communication Component(s) (1087). Its notable operations include rendering the Player-Selectable Jackpot Interface, which presents a graphical menu of all available jackpot tiers (e.g., 36 tiers) and allows the player to select a unique subset they wish to be eligible for, subsequently transmitting this selection map to the GMS server. It also receives the continuous, real-time broadcast of dynamically adjusted jackpot multipliers from the GMS and updates the gaming system's display 1035 accordingly. Critically, this component is the client-side engine for the Real-Time Personalized Jackpot Engine. It receives and renders unique, player-specific UI elements, such as VIP 2× Multiplier! banners or the Jackpot Journey challenge module, based on commands from the GMS server. This component transforms the EGD from a static terminal into an intelligent, dynamic, and personalized client, solving the technical problem of a generic, one-size-fits-all player interface.

The GMS Communication Component(s) 1087 is a specialized hardware and/or software module within the intelligent electronic gaming system 1000, distinct from other communication components like the CMS Communication Component (1080) or Player Tracking Server Communication Component (1082). Its specific function is to establish, manage, and secure the persistent, low-latency data connection between the client-side GMS Component(s) (1023) and the central GMS Server Component(s) (e.g., 680). This component is a technical prerequisite for the Grand Paradise Jackpot system's real-time features, as it must solve the problem of data latency that would invalidate a live odds system. It is implemented as a continuous, bi-directional communication tunnel (e.g., a WebSocket) rather than a standard polling mechanism. This component is responsible for transmitting client-to-server data, including player jackpotbets and the Player-Selectable Jackpot Interface tier selections. Critically, it is optimized to receive high-frequency, server-to-client data pushes, such as the constantly updating dynamic jackpot multipliers, real-time personalized challenge/journey data, and instant Start Bonus commands. This component's ability to facilitate the sub-500 ms card-to-screen data loop is a tangible technical improvement in network functionality, ensuring all players are synchronized and that the dynamic jackpot data they see is accurate and fair.

The Casino Management System (CMS) Communication Component(s) 1080 are notable in ensuring seamless interaction between gaming machines and the broader casino management infrastructure. These components facilitate the exchange of notable data regarding game performance, player activity, and machine status, enabling the CMS to effectively oversee and optimize the gaming floor. Through this communication, the CMS may implement changes in game configurations, update promotional offers, and monitor compliance with gaming regulations. Moreover, the data flow allows for the personalization of player experiences through targeted marketing and loyalty rewards, enhancing player satisfaction and retention. These components are desirable for maintaining the operational efficiency of casino operations, providing the backbone for real-time analytics, machine maintenance, and customer service initiatives, ultimately contributing to a superior gaming environment and improved profitability.

Player Tracking Server Communication Component(s) 1082 facilitate the notable exchange of data between gaming machines and the player tracking server, desirable for the implementation of loyalty programs and personalized gaming experiences. These components capture and transmit player activity data, including game play duration, bet amounts, and winnings, to the tracking server, which then analyzes this information to tailor rewards, offers, and communications to individual player preferences and behaviors. This targeted approach not only enhances player engagement by rewarding loyalty and encouraging repeat visits but also allows casinos to optimize their marketing strategies and improve overall customer satisfaction. By ensuring accurate and secure data transmission, these components play a notable role in maintaining the integrity of player tracking systems, supporting the delivery of customized gaming experiences that meet the unique needs and expectations of each player.

Central Determination Gaming Server Communication Component(s) 1084 are desirable for ensuring that Electronic Gaming Machines (EGDs) operate in compliance with gaming regulations that mandate centralized game outcome determination. These components enable secure and reliable communication between EGDs and the central determination gaming server, which is responsible for generating game outcomes based on a predetermined pool of results. This system ensures fairness and transparency in gaming by centralizing the outcome determination process, removing the randomness from individual machines, and complying with regulatory requirements. The communication components are notable for the seamless operation of this system, providing real-time connectivity that allows for immediate game outcome delivery to EGDs, ensuring a smooth and uninterrupted player experience. By facilitating this notable communication, these components uphold the integrity of the gaming operation and maintain player trust in the fairness of the game.

TITO Server Communication Component(s) 1086 play a notable role in the gaming ecosystem by enabling seamless interaction between Electronic Gaming Machines (EGDs) and the Ticket-In, Ticket-Out (TITO) server. These components ensure efficient and secure processing of TITO transactions, allowing players to easily cash out their winnings or move credits between machines. By facilitating the accurate exchange of data related to ticket validations, redemptions, and issuances, these communication components enhance the player experience by providing convenience and reducing wait times for ticket transactions. Furthermore, the integrity of the TITO system is maintained through the secure and reliable communication provided by these components, ensuring that all transactions are processed accurately, thereby preventing fraud and maintaining the trust of players in the gaming operation.

Progressive Server Communication Component(s) 1088 are desirable in linking Electronic Gaming Machines (EGDs) with the progressive server, which manages the accumulation and payout of progressive jackpots. These components ensure real-time, secure communication of data related to jackpot contributions and awards, enabling the seamless update and display of progressive jackpot values across the networked machines. By facilitating accurate and timely information exchange, these communication components play a notable role in maintaining the excitement and attractiveness of progressive jackpot games, where the potential for life-changing wins adds a significant draw for players. Moreover, the integrity of the progressive jackpot system is upheld through the reliable operation of these components, ensuring that jackpots are awarded correctly and transparently, thereby fostering player confidence in the fairness and reliability of the gaming operation.

In one implementation, processor 1010 and master gaming controller 1012 are included in a logic device 1013 enclosed in a logic device housing. The processor 1010 may include any conventional processor or logic device configured to execute software allowing various configuration and reconfiguration tasks such as, for example: a) communicating with a remote source via communication interface 1006, such as a server that stores authentication information or games; b) converting signals read by an interface to a format corresponding to that used by software or memory in the gaming system; c) accessing memory to configure or reconfigure game parameters in the memory according to indicia read from the device; d) communicating with interfaces, various peripheral devices and/or I/O devices; e) operating peripheral devices such as, for example, card readers, paper ticket readers, etc.; f) operating various I/O devices such as, for example, displays 1035, input devices 1030; etc. For instance, the processor 1010 may send messages including game play information to the displays 1035 to inform players of cards dealt, wagering information, and/or other desired information.

In at least one implementation, the gaming system may include card readers such as used with credit cards, or other identification code reading devices to allow or require player identification in connection with play of the card game and associated recording of game action. Such a player identification interface can be implemented in the form of a variety of magnetic card readers commercially available for reading a player-specific identification information. The player-specific information can be provided on specially constructed magnetic cards issued by a casino, or magnetically coded credit cards or debit cards frequently used with national credit organizations such as VISA, MASTERCARD, AMERICAN EXPRESS, or banks and other institutions.

The gaming system may include other types of participant identification mechanisms which may use a fingerprint image, eye blood vessel image reader, or other suitable biological information to confirm identity of the player. Still further it is possible to provide such participant identification information by having the dealer manually code in the information in response to the player indicating his or her code name or real name. Such additional identification could also be used to confirm credit use of a smart card, transponder, and/or player's personal player input device (UID).

The gaming system 1000 also includes memory 1016 which may include, for example, volatile memory (e.g., RAM 1009), non-volatile memory 1019 (e.g., disk memory, FLASH memory, EPROMs, etc.), unalterable memory (e.g., EPROMs 1008), etc. The memory may be configured or designed to store, for example: 1) configuration software 1014 such as all the parameters and settings for a game playable on the gaming system; 2) associations 1018 between configuration indicia read from a device with one or more parameters and settings; 3) communication protocols allowing the processor 1010 to communicate with peripheral devices and I/O devices 1011; 4) a secondary memory storage device 1015 such as a non-volatile memory device, configured to store gaming software related information (the gaming software related information and memory may be used to store various audio files and games not currently being used and invoked in a configuration or reconfiguration); 5) communication transport protocols (such as, for example, TCP/IP, USB, Firewire, IEEE1394, Bluetooth, IEEE 802.11x (IEEE 802.11 standards), hiperlan/2, HomeRF, etc.) for allowing the gaming system to communicate with local and non-local devices using such protocols; etc. In one implementation, the master gaming controller 1012 communicates using a serial communication protocol. A few examples of serial communication protocols that may be used to communicate with the master gaming controller include but are not limited to USB, RS-232 and Netplex (a proprietary protocol developed by IGT, Reno, NV).

A plurality of device drivers 1042 may be stored in memory 1016. Example of different types of device drivers may include device drivers for gaming system components, device drivers for gaming system components, etc. Typically, the device drivers 1042 utilize a communication protocol of some type that enables communication with a particular physical device. The device driver abstracts the hardware implementation of a device. For example, a device drive may be written for each type of card reader that may be potentially connected to the gaming system. Examples of communication protocols used to implement the device drivers include Netplex, USB, Serial, Ethernet 1075, Firewire, I/O debouncer, direct memory map, serial, PCI, parallel, RF, Bluetooth™, near-field communications (e.g., using near-field magnetics), 802.11 (WiFi), etc. Netplex is a proprietary IGT standard while the others are open standards. According to a specific embodiment, when one type of a particular device is exchanged for another type of the particular device, a new device driver may be loaded from the memory 1016 by the processor 1010 to allow communication with the device. For instance, one type of card reader in gaming system 1000 may be replaced with a second type of card reader where device drivers for both card readers are stored in the memory 1016.

In some embodiments, the software units stored in the memory 1016 may be upgraded as needed. For instance, when the memory 1016 is a hard drive, new games, game options, various new parameters, new settings for existing parameters, new settings for new parameters, device drivers, and new communication protocols may be uploaded to the memory from the master gaming controller 1012 or from some other external device. As another example, when the memory 1016 includes a CD/DVD drive including a CD/DVD designed or configured to store game options, parameters, and settings, the software stored in the memory may be upgraded by replacing a first CD/DVD with a second CD/DVD. In yet another example, when the memory 1016 uses one or more flash memory 1019 or EPROM 1008 units designed or configured to store games, game options, parameters, settings, the software stored in the flash and/or EPROM memory units may be upgraded by replacing one or more memory units with new memory units which include the upgraded software. In another embodiment, one or more of the memory devices, such as the hard-drive, may be employed in a game software download process from a remote software server.

In some embodiments, the gaming system 1000 may also include various authentication and/or validation components 1044 which may be used for authenticating/validating specified gaming system components such as, for example, hardware components, software components, firmware components, information stored in the gaming system memory 1016, etc. Examples of various authentication and/or validation components are described in U.S. Pat. No. 6,620,047, entitled, “ELECTRONIC GAMING APPARATUS HAVING AUTHENTICATION DATA SETS,” incorporated herein by reference in its entirety for all purposes.

Sensors 1060 may include, for example, optical sensors, pressure sensors, RF sensors, Infrared sensors, motion sensors, audio sensors, image sensors, thermal sensors, biometric sensors, etc. As mentioned previously, such sensors may be used for a variety of functions such as, for example: detecting the presence and/or monetary amount of gaming chips which have been placed within a player's wagering zone; detecting (e.g., in real time) the presence and/or monetary amount of gaming chips which are within the player's personal space; etc.

In one implementation, at least a portion of the sensors 1060 and/or input devices 1030 may be implemented in the form of touch keys selected from a wide variety of commercially available touch keys used to provide electrical control signals. Alternatively, some of the touch keys may be implemented in another form which are touch sensors such as those provided by a touchscreen display. For example, in at least one implementation, the gaming system player may include input functionality for enabling players to provide their game play decisions/instructions (and/or other input) to the dealer using the touch keys and/or other player control sensors/buttons. Additionally, such input functionality may also be used for allowing players to provide input to other devices in the casino gaming network (such as, for example, player tracking systems, side wagering systems, etc.)

Wireless communication components 1056 may include one or more communication interfaces having different architectures and utilizing a variety of protocols such as, for example, 802.11 (WiFi), 802.15 (including Bluetooth™, 802.16 (WiMax), 802.22, Cellular standards such as CDMA, CDMA2000, WCDMA, Radio Frequency (e.g., RFID), Infrared, Near Field Magnetic communication protocols, etc. The communication links may transmit electrical, electromagnetic or optical signals which carry digital data streams or analog signals representing various types of information.

An example of a near-field communication protocol is the ECMA-340 “Near Field Communication—Interface and Protocol (NFCIP-1)”, published by ECMA International (www.ecma-international.org), herein incorporated by reference in its entirety for all purposes. It will be appreciated that other types of Near Field Communication protocols may be used including, for example, near field magnetic communication protocols, near field RF communication protocols, and/or other wireless protocols which provide the ability to control with relative precision (e.g., on the order of centimeters, inches, feet, meters, etc.) the allowable radius of communication between at least two devices using such wireless communication protocols.

Power distribution components 1058 may include, for example, components or devices which are operable for providing wireless power to other devices. For example, in one implementation, the power distribution components 1058 may include a magnetic induction system which is adapted to provide wireless power to one or more portable UIDs at the gaming system. In one implementation, a UID docking region may include a power distribution component which is able to recharge a UID placed within the UID docking region without requiring metal-to-metal contact.

In at least one embodiment, motion/gesture detection component(s) 1051 may be configured or designed to detect player (e.g., player, dealer, and/or other persons) movements and/or gestures and/or other input data from the player. In some embodiments, each gaming system may have its own respective motion/gesture detection component(s). In other embodiments, motion/gesture detection component(s) 1051 may be implemented as a separate sub-system of the gaming system which is not associated with any one specific gaming system or device.

Game And Wager Data Collection Component(s) 1076 may include functionality for facilitating, enabling, initiating, and/or performing collection and reporting of various types of information relating to conditions and/or events occurring at an associated gaming device and/or gaming table game, such as, for example: game-related information, player tracking information, wager-related information (e.g., including financial transaction events), and/or other types of data/information described and/or referenced herein.

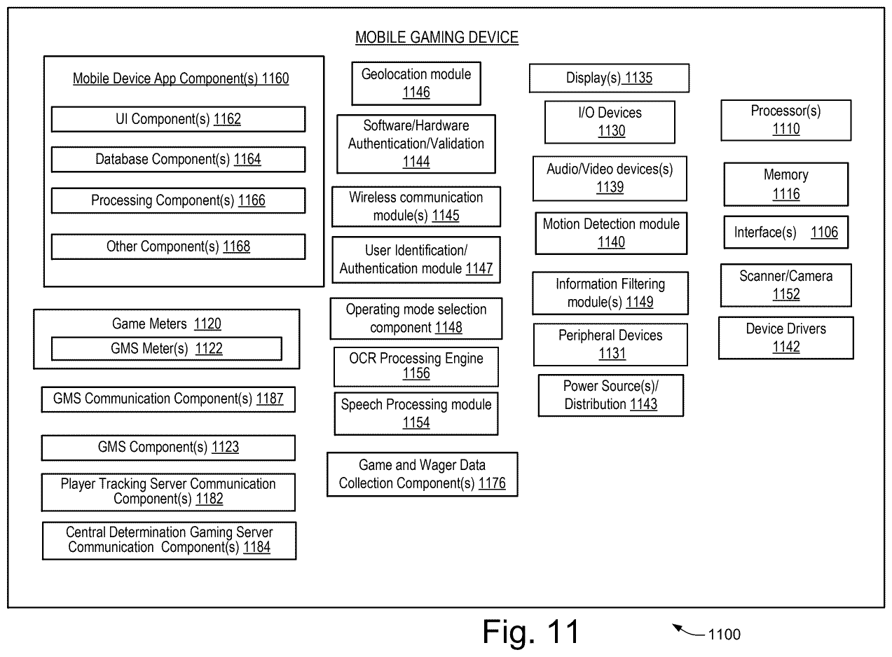

FIG. 11 is a simplified block diagram of an example mobile gaming device 1100 in accordance with a specific embodiment. In at least one embodiment, one or more players may participate in a live, multiplayer, wager-based, virtual table game session using mobile gaming devices. In at least some embodiments, the mobile gaming device may be configured or designed to include or provide functionality which is similar to that of an electronic gaming device (EGD) such as that described, for example, in FIGS. 9 and 10.

As illustrated in the example of FIG. 11, mobile gaming device 1100 may include a variety of components, modules and/or systems for providing various functionality. For example, as illustrated in FIG. 11, mobile gaming device 1100 may include Mobile Device Application components (e.g., 1160), which, for example, may include, but are not limited to, one or more of the following (or combinations thereof):
UI Components 1162 such as those illustrated, described, and/or referenced herein.
Database Components 1164 such as those illustrated, described, and/or referenced herein.
Processing Components 1166 such as those illustrated, described, and/or referenced herein.
Other Components 1168 which, for example, may include components for facilitating and/or enabling the mobile gaming device to perform and/or initiate various types of operations, activities, functions such as those described herein.

In at least one embodiment, the mobile gaming device may include Mobile Device App Component(s) which have been configured or designed to provide functionality for enabling or implementing at least a portion of the various automated money laundering detection and reporting techniques at the mobile gaming device.

According to specific embodiments, various aspects, features, and/or functionalities of the mobile gaming device may be performed, implemented and/or initiated by one or more of the following types of systems, components, systems, devices, procedures, processes, etc. (or combinations thereof):
Processor(s) 1110
Device Drivers 1142
Memory 1116
Interface(s) 1106
Power Source(s)/Distribution 1143
Geolocation module 1146
Display(s) 1135
I/O Devices 1130
Audio/Video devices(s) 1139
Peripheral Devices 1131
Motion Detection module 1140
User Identification/Authentication module 1147
Client App Component(s) 1160
Other Component(s) 1168
UI Component(s) 1162
Database Component(s) 1164
Processing Component(s) 1166
Software/Hardware Authentication/Validation 1144
Wireless communication module(s) 1145
Information Filtering module(s) 1149
Operating mode selection component 1148
Speech Processing module 1154
Scanner/Camera 1152
OCR Processing Engine 1156
Game and Wager Data Collection Component(s) 1176

Game Meters 1120 are notable display components within Electronic Gaming Machines (EGDs), tasked with presenting various game-related statistics such as current credit balance, bet amounts, winnings, and more. These meters provide players with immediate, clear information about their game status, facilitating informed gaming decisions. The transparency afforded by these meters is desirable for a trustworthy gaming experience, allowing players to monitor their progress and manage their resources effectively. Beyond player benefits, Game Meters 1120 assist casino operators in ensuring gaming integrity and regulatory compliance by accurately tracking and reporting desirable game metrics. The real-time data captured by these meters also offer valuable insights for casino management, enabling the optimization of gaming operations and the tailoring of promotions to player behaviors and preferences. Essentially, Game Meters 1120 bridge the information gap between the gaming machine's internal mechanics and the player's understanding, enhancing the gaming experience for all parties involved.

The GMS Meter(s) 1122 are specialized virtual or soft meters, distinct from the main Game Meters (1120), and are displayed on the mobile gaming device's Display(s) (1135). Their specific function is to track and display metrics related exclusively to the Grand Paradise Jackpot (GMS) features, adapted for a mobile platform. This component is managed by the local GMS Component(s) (1123) and provides the player with clear, immediate, and dedicated feedback on their status within the jackpot meta-game. These meters are not limited to tracking monetary credits; they are designed to represent a player's progress in the challenge-based or narrative-driven jackpot mechanics central to the invention's personalization features. For example, a GMS Meter on the mobile UI may be rendered as a progress bar for a Personalized Jackpot Challenge (Tech #28) (e.g., Banker Streak: 2/3) or as a points system or chapter tracker for a long-term Personalized Jackpot Journey (Tech #37). This provides a direct technical solution to the problem of abstract or non-existent feedback for bonus systems. By providing a dedicated, real-time, visual representation of their progress, the GMS Meter(s) 1122 enhance player engagement, create a tangible sense of progression, and encourage strategic, long-term play.

The GMS Component(s) 1123 represents the client-side software module and logic components that reside within the Mobile Device App Component(s) (1160) on the mobile gaming device 1100. This component's primary purpose is to act as the terminal-side interface for the central Game Management System (GMS) (680), enabling the mobile device to execute the advanced, server-driven jackpot features. It is responsible for rendering all specialized user interfaces required for the Grand Paradise Jackpot on the device's Display(s) (1135) and managing bi-directional communication with the GMS server via the GMS Communication Component(s) (1187). Its notable operations include rendering the Player-Selectable Jackpot Interface, a graphical menu allowing the player to select a unique subset of jackpot tiers, and transmitting this selection map to the GMS server. It also receives the continuous, real-time broadcast of dynamically adjusted jackpot multipliers from the GMS and updates the mobile device's display. Critically, this component is the client-side engine for the Real-Time Personalized Jackpot Engine. It receives and renders unique, player-specific UI elements, such as VIP 2× Multiplier! banners or the Jackpot Journey challenge module, based on commands from the GMS server. This component transforms the mobile device from a simple game client into an intelligent, dynamic, and personalized terminal, solving the technical problem of a generic, one-size-fits-all player interface.

The GMS Communication Component(s) 1187 is a specialized software module within the mobile gaming device 1100, operating as part of the Mobile Device App Component(s) (1160). It is distinct from other communication components, such as the Player Tracking Server Communication Component (1182). Its specific function is to establish, manage, and secure the persistent, low-latency data connection between the client-side GMS Component(s) (1123) and the central GMS Server Component(s) (e.g., 680), utilizing the device's Wireless communication module(s) (1145). This component is a technical prerequisite for the Grand Paradise Jackpot system's real-time features on a mobile platform, as it must solve the problem of data latency and unreliability inherent in wireless networks. It is implemented as a continuous, bi-directional communication tunnel (e.g., a WebSocket) rather than a standard polling mechanism. This component is responsible for transmitting client-to-server data, including player jackpot bets and the Player-Selectable Jackpot Interface tier selections. Critically, it is optimized to receive high-frequency, server-to-client data pushes, such as the constantly updating dynamic jackpot multipliers, real-time personalized challenge/journey data, and instant Start Bonus commands. This component's ability to facilitate a rapid, synchronized data loop is a tangible technical improvement, ensuring game fairness and enabling a live market feel even on a mobile device.

Player Tracking Server Communication Component(s) 1182 are desirable for the efficient and secure exchange of data between gaming machines and the player tracking server. This communication is notable for implementing sophisticated player loyalty programs and delivering a personalized gaming experience. By accurately capturing and transmitting detailed information on player behavior, preferences, and activities at the gaming machines, these components enable the player tracking server to analyze data and tailor rewards, promotions, and communications to individual player profiles. The result is a highly engaging and rewarding casino experience that encourages player loyalty and repeat visits. The reliability and security of these communication components ensure that player data is handled with the utmost integrity, maintaining player trust and compliance with data protection regulations. Through the facilitation of targeted rewards and personalized gaming experiences, Player Tracking Server Communication Component(s) 1182 play a notable role in enhancing player satisfaction and casino profitability.

Central Determination Gaming Server Communication Component(s) 1184 ensure the flawless and secure transmission of game outcome data between the central determination gaming server and individual gaming machines. This system, notable for jurisdictions that may require game outcomes to be determined centrally rather than by the individual machine, guarantees fairness and compliance with gaming regulations. These communication components are notable for the integrity of the gaming experience, as they allow for real-time delivery of predetermined game outcomes to machines, ensuring that each player's experience is both random and compliant with regulatory standards. By maintaining a consistent and secure line of communication, these components ensure that the gaming experience remains seamless for players, without noticeable delays or discrepancies in game play. The Central Determination Gaming Server Communication Component(s) 1184 thus play a notable role in upholding the trust and confidence of players in the fairness and reliability of the gaming operation.

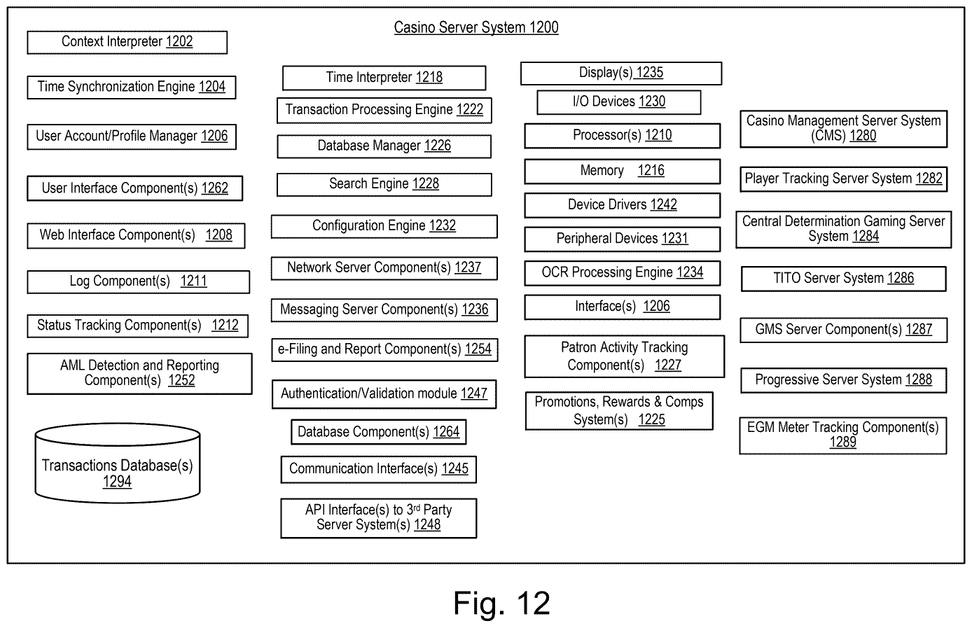

FIG. 12 illustrates an example of a functional block diagram of a Casino Server System in accordance with a specific embodiment. In at least one embodiment, the Casino Server System may be operable to perform and/or implement various types of functions, operations, actions, and/or other features, such as, for example, one or more of those described and/or referenced herein.

In at least one embodiment, the Casino Server System may include a plurality of components operable to perform and/or implement various types of functions, operations, actions, and/or other features such as, for example, one or more of the following (or combinations thereof):
Context Interpreter (e.g., 1202) which, for example, may be operable to automatically and/or dynamically analyze contextual criteria relating to a detected set of event(s) and/or condition(s), and automatically determine or identify one or more contextually appropriate response(s) based on the contextual interpretation of the detected event(s)/condition(s). According to different embodiments, examples of contextual criteria which may be analyzed may include, but are not limited to, one or more of the following (or combinations thereof):
   location-based criteria (e.g., geolocation of mobile gaming device, geolocation of EGD, etc.)
   time-based criteria
   identity of user(s)
   user profile information
   transaction history information
   recent user activities
   etc.
Time Synchronization Engine (e.g., 1204) which, for example, may be operable to manages universal time synchronization (e.g., via NTP and/or GPS)
Search Engine (e.g., 1228) which, for example, may be operable to search for transactions, logs, game history information, player information, automated money laundering detection and reporting information, etc., which may be accessed from one or more local and/or remote databases.
Configuration Engine (e.g., 1232) which, for example, may be operable to determine and handle configuration of various customized configuration parameters for one or more devices, component(s), system(s), process(es), etc.
Time Interpreter (e.g., 1218) which, for example, may be operable to automatically and/or dynamically modify or change identifier activation and expiration time(s) based on various criteria such as, for example, time, location, transaction status, etc.
Authentication/Validation Component(s) (e.g., 1247) (password, software/hardware info, SSL certificates) which, for example, may be operable to perform various types of authentication/validation tasks such as one or more of those described and/or referenced herein.
Transaction Processing Engine (e.g., 1222) which, for example, may be operable to handle various types of transaction processing tasks such as, for example, one or more of those described and/or referenced herein.
OCR Processing Engine (e.g., 1234) which, for example, may be operable to perform image processing and optical character recognition of images such as those captured by a gaming device camera, for example.
Database Manager (e.g., 1226) which, for example, may be operable to handle various types of tasks relating to database updating, database management, database access, etc. In at least one embodiment, the Database Manager may be operable to manage game history databases, player tracking databases, etc.
Log Component(s) (e.g., 1211) which, for example, may be operable to generate and manage transactions history logs, system errors, connections from APIs, etc.
Status Tracking Component(s) (e.g., 1212) which, for example, may be operable to automatically and/or dynamically determine, assign, and/or report updated transaction status information based, for example, on the state of the transaction.
Gateway Component(s) (e.g., 1214) which, for example, may be operable to facilitate and manage communications and transactions with external Payment Gateways.
Web Interface Component(s) (e.g., 1208) which, for example, may be operable to facilitate and manage communications and transactions with virtual live game table web portal(s).
API Interface(s) to Casino Server System(s) (e.g., 1246) which, for example, may be operable to facilitate and manage communications and transactions with API Interface(s) to Server System(s) of various casino networks.
API Interface(s) to 3rd Party Server System(s) (e.g., 1248) which, for example, may be operable to facilitate and manage communications and transactions with API Interface(s) to 3rd Party Server System(s)
At least one processor 1210. In at least one embodiment, the processor(s) 1210 may include one or more commonly known CPUs which are deployed in many of today's consumer electronic devices, such as, for example, CPUs or processors from the Motorola or Intel family of microprocessors, etc. In an alternative embodiment, at least one processor may be specially designed hardware for controlling the operations of a gaming system. In a specific embodiment, a memory (such as non-volatile RAM and/or ROM) also forms part of CPU. When acting under the control of appropriate software or firmware, the CPU may be responsible for implementing specific functions associated with the functions of a desired network device. The CPU preferably accomplishes all these functions under the control of software including an operating system, and any appropriate applications software.
Memory 1216, which, for example, may include volatile memory (e.g., RAM), non-volatile memory (e.g., disk memory, FLASH memory, EPROMs, etc.), unalterable memory, and/or other types of memory. In at least one implementation, the memory 1216 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the mobile gaming system and/or other information relating to the functionality of the various Mobile Transaction techniques described herein. The program instructions may control the operation of an operating system and/or one or more applications, for example. The memory or memories may also be configured to store data structures, metadata, identifier information/images, and/or information/data relating to other features/functions described herein.
Interface(s) 1206 which, for example, may include wired interfaces and/or wireless interfaces. In at least one implementation, the interface(s) 1206 may include functionality similar to at least a portion of functionality implemented by one or more computer system interfaces such as those described herein and/or generally known to one having ordinary skill in the art.
Device driver(s) 1242. In at least one implementation, the device driver(s) 1242 may include functionality similar to at least a portion of functionality implemented by one or more computer system driver devices such as those described herein and/or generally known to one having ordinary skill in the art.
One or more display(s) 1235.
Messaging Server Component(s) 1236, which, for example, may be configured or designed to provide various functions and operations relating to messaging activities and communications.
Network Server Component(s) 1237, which, for example, may be configured or designed to provide various functions and operations relating to network server activities and communications.
AML Detection and Reporting Component(s) 1252. In at least one embodiment, the AML Detection and Reporting components may be configured or designed to include functionality for facilitating, aggregating data, enabling, initiating, and/or performing various types of financial transaction analysis, AML analysis and detection, and reporting operation(s), action(s), and/or feature(s) such as one or more of those described herein.
E-Filing and Report Component(s) 1254. In at least one embodiment, the e-Filing and Report Component(s) may be configured or designed to include functionality for facilitating, enabling, initiating, and/or performing various types of reporting and notification activities such as, for example:
automated electronic filing of detected suspicious ML activities at appropriate governmental agencies;
automated generation and/or transmission of notifications and alerts (e.g., such as those relating to detected suspicious ML activities) to appropriate authorities (e.g., police, Federal agencies, local law enforcement, casino security personnel, casino employees, etc.);
and/or other types of types of reporting and notification activities such as those described herein.
Suspicious Activity/ML Activity Pattern Database(s). In at least one embodiment, the Suspicious Activity/ML Activity Pattern Database(s) may be configured or designed to include functionality for storing and/or providing access to various types of information relating to suspicious activity pattern and ML pattern analysis and detection, and/or other types of information described and/or referenced herein.
Transactions Database(s) 1294. In at least one embodiment, the Transactions Database(s) may be configured or designed to include functionality for storing and/or providing access to various types of information, events, and/or conditions such as, for example, one or more of the following (or combinations thereof): casino-related information, game play information, wager information, financial transaction information, and/or other types of information described and/or referenced herein.

Patron Activity Tracking Component(s) 1227 are notable for casinos aiming to offer a personalized and engaging gaming experience. These components meticulously collect data on every aspect of a patron's activities within the casino, from gaming habits to transaction history and participation in promotional events. This comprehensive data collection allows for deep insights into patron preferences and behavior, enabling casinos to tailor services, offers, and communications effectively. The utilization of this data significantly enhances customer relationship management strategies, promoting increased customer loyalty and satisfaction. By identifying trends and preferences, casinos may optimize their gaming floor, adjust their marketing strategies, and develop targeted promotions that resonate with their patrons. Furthermore, these tracking components are desirable for responsible gaming initiatives, allowing casinos to monitor player behavior for signs of problematic gaming patterns and intervene when necessary.

Promotions, Rewards & Comps System(s) 1225 are designed to enrich the casino experience for patrons by offering a variety of incentives that reward gaming activity and loyalty. These systems manage the distribution of promotions, rewards, and complimentary services or items to patrons based on their level of engagement and play. Through a strategic blend of immediate rewards, tiered loyalty programs, and targeted promotions, these systems encourage continued patronage by enhancing the perceived value of gaming and visits. The dynamic nature of these systems allows for customization and adaptation to patron preferences, ensuring that offers remain relevant and appealing. Additionally, they serve as a powerful marketing tool, driving foot traffic, increasing play time, and promoting higher spending. Effective management of these systems fosters a sense of appreciation among patrons, bolstering loyalty, and creating a competitive edge in the gaming and entertainment industry.

The Casino Management Server System (CMS) 1280 is the technological backbone of modem casino operations, orchestrating the seamless integration of gaming machines, patron management, financial transactions, and regulatory compliance. This centralized system provides a comprehensive suite of tools for managing every aspect of the casino floor, including game monitoring, accounting, security, and customer relations. By aggregating data from various sources, the CMS offers valuable insights into operational efficiency, player behavior, and revenue generation. This enables casino operators to make informed decisions, optimize game offerings, and personalize player experiences. The CMS also plays a notable role in ensuring compliance with gaming regulations, facilitating audits, and maintaining data security. Its scalable and modular design allows for flexibility and growth, ensuring that casinos may adapt to evolving market demands and technological advancements, thereby maintaining operational excellence and competitive advantage.

The Player Tracking Server System 1282 is a dedicated platform that centralizes the collection, analysis, and application of data related to casino patrons' gaming behaviors and preferences. This system is instrumental in supporting loyalty programs, enabling casinos to recognize and reward frequent players with offers tailored to their interests and play patterns. By leveraging detailed analytics, the Player Tracking Server System enhances customer engagement strategies, driving repeat business and increasing player satisfaction. It allows casinos to segment their customer base effectively, delivering personalized promotions, events invitations, and comps that resonate with individual preferences. Additionally, this system provides notable insights for optimizing game floor layouts, promotional offerings, and operational strategies. Its role in fostering strong customer relationships and loyalty is invaluable, directly impacting the casino's bottom line by promoting a loyal and engaged patron base.

The Central Determination Gaming Server System 1284 is a specialized server that centralizes the outcome determination for gaming machines, ensuring fairness and compliance with regulatory standards that mandate central random number generation. This system is notable in jurisdictions where gaming outcomes must not be determined by the individual machines but instead by a centralized, secure, and auditable source. By pooling the outcomes, the Central Determination Gaming Server System guarantees that each play is random and unbiased, reinforcing the integrity of the gaming experience. This system supports a variety of games and may be dynamically updated to introduce new content, maintaining player interest and engagement. Additionally, it provides casinos with the ability to monitor and manage the performance of games in real-time, optimizing their offerings and maximizing revenue while ensuring compliance with gaming regulations.

The TITO (Ticket-In, Ticket-Out) Server System 1286 is an desirable component of casino operations, facilitating the efficient and secure handling of paper-based transactions within the gaming environment. This system manages the issuance, acceptance, and validation of TITO vouchers, streamlining the process for both patrons and casino staff. By eliminating the need for physical coins or tokens, the TITO Server System enhances the customer experience, reducing wait times for machine refills and cashier interactions. It also improves operational efficiency by automating cash flow management and reducing machine downtime. The system's robust security features prevent fraud and duplication of vouchers, ensuring the integrity of transactions. Additionally, the TITO Server System collects transactional data, providing valuable insights into player behavior and machine performance, which may be used to optimize floor operations and marketing strategies.

The GMS Server Component(s) 1287 represents the centralized server-side logic, data storage, and processing modules that constitute the specific Game Management System (GMS) (680), shown here as an integral part of the overall Casino Server System 1200. This component is the definitive command and control hub for the entire Grand Paradise Jackpot ecosystem, coordinating all real-time activities between the various server systems (e.g., Player Tracking Server System 1282, TITO Server System 1286) and all connected EGDs. Its primary function is to execute the novel jackpot logic that transforms the game from a static-prize experience into a dynamic, live, and personalized event. This component is responsible for implementing the Dynamic Probability-Based Jackpot Engine; it maintains the Shoe Composition Dataset based on card data received from gaming tables, queries the Probability Calculation Engine (688) for real-time odds after each card deal, and broadcasts the dynamically adjusted multipliers to all player terminals. It also manages the Rolling Window Consecutive Card Trigger, tracking the last six cards dealt, independent of hand boundaries, to identify winning combinations. Furthermore, this server component is the hub for the Dealer/Player Agency features and Personalization features described herein. It receives and stores the player tier selection maps from each terminal, enabling customized wagering. It also interfaces with the Player Tracking Server System 1282 to retrieve player profiles, passes them to the AI/ML Personalization Engine (687), and applies the resulting unique multipliers or challenges to a player's specific session. This GMS Server Component is a non-obvious technical improvement over prior art, changing the function of a gaming server from a static lookup table to a dynamic, stateful, and computational analysis engine that personalizes payouts in real-time.

The Progressive Server System 1288 manages the accumulation and distribution of progressive jackpots across a network of gaming machines. This system is central to the operation of progressive games, which offer increasing jackpot amounts that grow with each wager until won. By pooling contributions from multiple machines, the Progressive Server System may offer significantly larger jackpots, enhancing the attractiveness of the games and driving player interest and engagement. The system ensures the accurate and timely update of jackpot amounts displayed to players, maintaining excitement and anticipation. It also guarantees the integrity and fairness of jackpot awards, with robust security measures to prevent tampering and ensure compliance with regulatory standards. The data collected by the Progressive Server System provides casinos with insights into the performance of progressive games, enabling strategic decisions about game placement and promotional activities to maximize player attraction and retention.

The EGD Meter Tracking Component(s) 1289 within the Casino Server System are configured or designed for monitoring and management of data and metrics from electronic gaming machines (EGDs). EGD Meter Tracking Component(s) 1289 may collect a comprehensive range of EGD meter data, including metrics such as coin-in (total amount wagered), coin-out (total winnings paid), total bets placed, and the overall number of games played. Additionally, it tracks GPJ-specific metrics, which are integral to understanding the engagement and performance of GPJ related features. These may include data on multiplayer interactions, progressive jackpot contributions from each linked game, and usage statistics of unique game features like multi-game and dynamic game allocation. This tracking facilitates precise financial accounting, regulatory compliance, and effective game management by providing insights into player behavior and machine performance, which are critical for optimizing the gaming floor layout and enhancing player engagement strategies.

In at least one embodiment, the server system includes at least one network device, and at least one storage device (such as, for example, a direct attached storage device). In one embodiment, server system may be suitable for implementing at least some of the automated money laundering detection and reporting techniques described herein.

In according to one embodiment, network device may include a master central processing unit (CPU), interfaces, and a bus (e.g., a PCI bus). When acting under the control of appropriate software or firmware, the CPU may be responsible for implementing specific functions associated with the functions of a desired network device. For example, when configured as a server, the CPU may be responsible for analyzing packets; encapsulating packets; forwarding packets to appropriate network devices; instantiating various types of virtual machines, virtual interfaces, virtual storage volumes, virtual appliances; etc. The CPU preferably accomplishes at least a portion of these functions under the control of software including an operating system (e.g. Linux), and any appropriate system software (such as, for example, AppLogic™ software).

CPU may include one or more processors such as, for example, one or more processors from the AMD, Motorola, Intel and/or MIPS families of microprocessors. In an alternative embodiment, processor may be specially designed hardware for controlling the operations of server system. In a specific embodiment, a memory (such as non-volatile RAM and/or ROM) also forms part of CPU. However, there may be many different ways in which memory could be coupled to the system. Memory block may be used for a variety of purposes such as, for example, caching and/or storing data, programming instructions, etc.

The interfaces may be typically provided as interface cards (sometimes referred to as “line cards”). Alternatively, one or more of the interfaces may be provided as on-board interface controllers built into the system motherboard. Generally, they control the sending and receiving of data packets over the network and sometimes support other peripherals used with the server system. Among the interfaces that may be provided may be FC interfaces, Ethernet interfaces, frame relay interfaces, cable interfaces, DSL interfaces, token ring interfaces, Infiniband interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like. Other interfaces may include one or more wireless interfaces such as, for example, 802.11 (WiFi) interfaces, 802.15 interfaces (including Bluetooth™), 802.16 (WiMax) interfaces, 802.22 interfaces, Cellular standards such as CDMA interfaces, CDMA2000 interfaces, WCDMA interfaces, TDMA interfaces, Cellular 3G/4G/5G interfaces, etc.

Generally, one or more interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor to efficiently perform routing computations, network diagnostics, security functions, etc.

In at least one embodiment, some interfaces may be configured or designed to allow the server system to communicate with other network devices associated with various local area network (LANs) and/or wide area networks (WANs). Other interfaces may be configured or designed to allow network device to communicate with one or more direct attached storage device(s).

In at least one embodiment, an architecture having a single processor that handles communications as well as routing computations, etc. may be used. Further, other types of interfaces and media could also be used with the network device.

Regardless of network device's configuration, it may employ one or more memories or memory modules (such as, for example, memory block, which, for example, may include random access memory (RAM)) configured to store data, program instructions for the general-purpose network operations and/or other information relating to the functionality of the various automated money laundering detection and reporting techniques described herein. The program instructions may control the operation of an operating system and/or one or more applications, for example. The memory or memories may also be configured to store data structures, and/or other specific non-program information described herein.

Because such information and program instructions may be employed to implement the systems/methods described herein, one or more embodiments relates to machine readable media that include program instructions, state information, etc. for performing various operations described herein. Examples of machine-readable storage media include, but are not limited to, magnetic media such as hard disks, floppy disks, and magnetic tape; optical media such as CD-ROM disks; magneto-optical media such as floptical disks; and hardware devices that may be specially configured to store and perform program instructions, such as read-only memory devices (ROM) and random access memory (RAM). Some embodiments may also be embodied in transmission media such as, for example, a carrier wave travelling over an appropriate medium such as airwaves, optical lines, electric lines, etc. Examples of program instructions include both machine code, such as produced by a compiler, and files containing higher level code that may be executed by the computer using an interpreter.

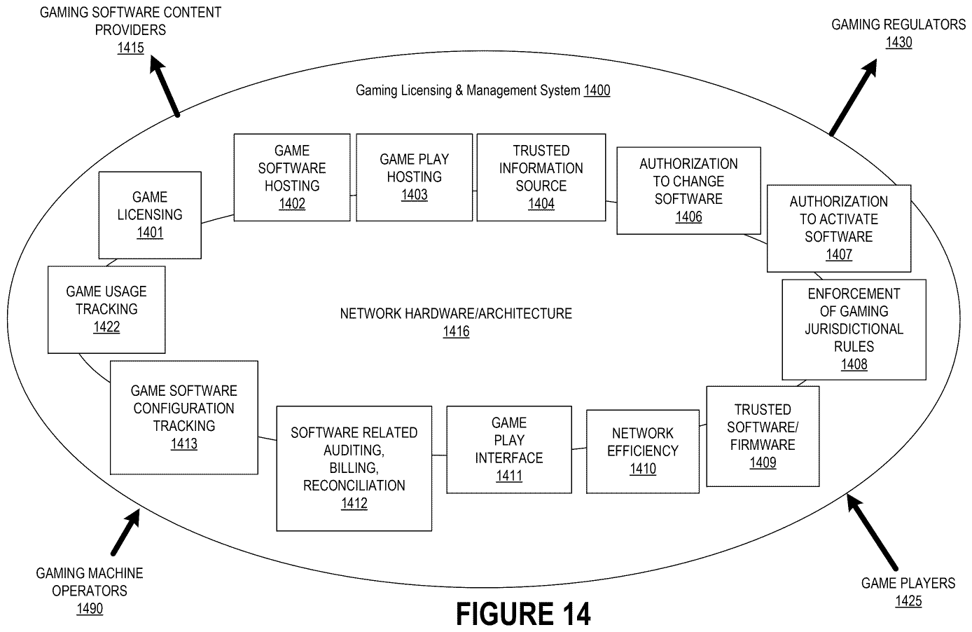

FIG. 14 shows a block diagram illustrating components of a gaming system which may be used for implementing various aspects of example embodiments. In FIG. 14, the components of a gaming system for providing game software licensing and downloads are described functionally. The described functions may be instantiated in hardware, firmware and/or software and executed on a suitable device. In the system, there may be many instances of the same function, such as multiple game play interfaces 1411. Nevertheless, in FIG. 14, only one instance of each function is shown. The functions of the components may be combined. For example, a single device may comprise the game play interface and include trusted memory devices or sources 1409.

The gaming system may receive inputs from different groups/entities and output various services and or information to these groups/entities. For example, game players primarily input cash or indicia of credit into the system, make game selections that trigger software downloads, and receive entertainment in exchange for their inputs. Game software content providers provide game software for the system and may receive compensation for the content they provide based on licensing agreements with the gaming machine operators. Gaming machine operators select game software for distribution, distribute the game software on the gaming devices in the system, receive revenue for the use of their software and compensate the gaming machine operators. The gaming regulators may provide rules and regulations that must be applied to the gaming system and may receive reports and other information confirming that rules are being obeyed.

In the following paragraphs, details of each component and some of the interactions between the components are described with respect to FIG. 14. The game software license host may be a server connected to a number of remote gaming devices that provides licensing services to the remote gaming devices. For example, in other embodiments, the license host may 1) receive token requests for tokens used to activate software executed on the remote gaming devices, 14) send tokens to the remote gaming devices, 3) track token usage and 4) grant and/or renew software licenses for software executed on the remote gaming devices. The token usage may be used in utility based licensing schemes, such as a pay-per-use scheme.

In another embodiment, a game usage-tracking host may track the usage of game software on a plurality of devices in communication with the host. The game usage-tracking host may be in communication with a plurality of game play hosts and gaming machines. From the game play hosts and gaming machines, the game usage tracking host may receive updates of an amount that each game available for play on the devices has been played and on amount that has been wagered per game. This information may be stored in a database and used for billing according to methods described in a utility based licensing agreement.

The game software host may provide game software downloads, such as downloads of game software or game firmware, to various devious in the game system 1400. For example, when the software to generate the game is not available on the game play interface, the game software host may download software to generate a selected game of chance played on the game play interface. Further, the game software host may download new game content to a plurality of gaming machines via a request from a gaming machine operator.

In one embodiment, the game software host may also be a game software configuration-tracking host 1413. The function of the game software configuration-tracking host is to keep records of software configurations and/or hardware configurations for a plurality of devices in communication with the host (e.g., denominations, number of paylines, paytables, max/min wagers). Details of a game software host and a game software configuration host that may be used with example embodiments are described in co-pending U.S. Pat. No. 6,645,077, by Rowe, titled, “Gaming Terminal Data Repository and Information System,” filed Dec. 12, 2000, which is incorporated herein in its entirety and for all purposes.

A game play host device may be a host server connected to a plurality of remote clients that generates games of chance that are displayed on a plurality of remote game play interfaces 1411. For example, the game play host device may be a server that provides central determination for a bingo game play played on a plurality of connected game play interfaces 1411. As another example, the game play host device may generate games of chance, such as slot games or video card games, for display on a remote client. A game player using the remote client may be able to select from a number of games that are provided on the client by the host device 1403. The game play host device may receive game software management services, such as receiving downloads of new game software, from the game software host and may receive game software licensing services, such as the granting or renewing of software licenses for software executed on the device, from the game license host 1401.

In particular embodiments, the game play interfaces or other gaming devices in the gaming system may be portable devices, such as electronic tokens, cell phones, smart cards, tablet PC's and PDA's. The portable devices may support wireless communications and thus, may be referred to as wireless mobile devices. The network hardware architecture may be enabled to support communications between wireless mobile devices and other gaming devices in gaming system. In one embodiment, the wireless mobile devices may be used to play games of chance.

The gaming system may use a number of trusted information sources. Trusted information sources may be devices, such as servers, that provide information used to authenticate/activate other pieces of information. CRC values used to authenticate software, license tokens used to allow the use of software or product activation codes used to activate software are examples of trusted information that might be provided from a trusted information source 1404. Trusted information sources may be a memory device, such as an EPROM, that includes trusted information used to authenticate other information. For example, a game play interface may store a private encryption key in a trusted memory device that is used in a private key-public key encryption scheme to authenticate information from another gaming device.

When a trusted information source is in communication with a remote device via a network, the remote device will employ a verification scheme to verify the identity of the trusted information source. For example, the trusted information source and the remote device may exchange information using public and private encryption keys to verify each other's identities. In another example of an embodiment, the remote device and the trusted information source may engage in methods using zero knowledge proofs to authenticate each of their respective identities. Details of zero knowledge proofs that may be used with example embodiments are described in U.S. Pat. No. 6,962,530, by Jackson, filed on Apr. 25, 2002 and titled, “Authentication in a Secure Computerized Gaming System, which is incorporated herein in its entirety and for all purposes.

Gaming devices storing trusted information might utilize apparatus or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

The gaming system of example embodiments may include devices that provide authorization to download software from a first device to a second device and devices that provide activation codes or information that allow downloaded software to be activated. The devices, and, may be remote servers and may also be trusted information sources. One example of a method of providing product activation codes that may be used with example embodiments is describes in previously incorporated U.S. Pat. No. 6,264,561.

A device that monitors a plurality of gaming devices to determine adherence of the devices to gaming jurisdictional rules may be included in the system 1400. In one embodiment, a gaming jurisdictional rule server may scan software and the configurations of the software on a number of gaming devices in communication with the gaming rule server to determine whether the software on the gaming devices is valid for use in the gaming jurisdiction where the gaming device is located. For example, the gaming rule server may request a digital signature, such as CRC's, of particular software components and compare them with an approved digital signature value stored on the gaming jurisdictional rule server.

Further, the gaming jurisdictional rule server may scan the remote gaming device to determine whether the software is configured in a manner that is acceptable to the gaming jurisdiction where the gaming device is located. For example, a maximum wager limit may vary from jurisdiction to jurisdiction and the rule enforcement server may scan a gaming device to determine its current software configuration and its location and then compare the configuration on the gaming device with approved parameters for its location.

A gaming jurisdiction may include rules that describe how game software may be downloaded and licensed. The gaming jurisdictional rule server may scan download transaction records and licensing records on a gaming device to determine whether the download and licensing was carried out in a manner that is acceptable to the gaming jurisdiction in which the gaming device is located. In general, the game jurisdictional rule server may be utilized to confirm compliance to any gaming rules passed by a gaming jurisdiction when the information needed to determine rule compliance is remotely accessible to the server.

Game software, firmware or hardware residing a particular gaming device may also be used to check for compliance with local gaming jurisdictional rules. In one embodiment, when a gaming device is installed in a particular gaming jurisdiction, a software program including jurisdiction rule information may be downloaded to a secure memory location on a gaming machine or the jurisdiction rule information may be downloaded as data and utilized by a program on the gaming machine. The software program and/or jurisdiction rule information may check the gaming device software and software configurations for compliance with local gaming jurisdictional rules. In another embodiment, the software program for ensuring compliance and jurisdictional information may be installed in the gaming machine prior to its shipping, such as at the factory where the gaming machine is manufactured.

The gaming devices in game system may utilize trusted software and/or trusted firmware. Trusted firmware/software is trusted in the sense that is used with the assumption that it has not been tampered with. For instance, trusted software/firmware may be used to authenticate other game software or processes executing on a gaming device. As an example, trusted encryption programs and authentication programs may be stored on an EPROM on the gaming machine or encoded into a specialized encryption chip. As another example, trusted game software, e.g., game software approved for use on gaming devices by a local gaming jurisdiction may be required on gaming devices on the gaming machine.

In example embodiments, the devices may be connected by a network with different types of hardware using different hardware architectures. Game software can be quite large and frequent downloads can place a significant burden on a network, which may slow information transfer speeds on the network. For game-on-demand services that require frequent downloads of game software in a network, efficient downloading is essential for the service to viable.

Thus, in example embodiments, network efficient devices may be used to actively monitor and maintain network efficiency. For instance, software locators may be used to locate nearby locations of game software for peer-to-peer transfers of game software. In another example, network traffic may be monitored and downloads may be actively rerouted to maintain network efficiency.

One or more devices in example embodiments may provide game software and game licensing related auditing, billing and reconciliation reports to server 1412. For example, a software licensing billing server may generate a bill for a gaming device operator based upon a usage of games over a time period on the gaming devices owned by the operator. In another example, a software auditing server may provide reports on game software downloads to various gaming devices in the gaming system and current configurations of the game software on these gaming devices.

At particular time intervals, the software auditing server may also request software configurations from a number of gaming devices in the gaming system. The server may then reconcile the software configuration on each gaming device. In one embodiment, the software auditing server may store a record of software configurations on each gaming device at particular times and a record of software download transactions that have occurred on the device. By applying each of the recorded game software download transactions since a selected time to the software configuration recorded at the selected time, a software configuration is obtained. The software auditing server may compare the software configuration derived from applying these transactions on a gaming device with a current software configuration obtained from the gaming device. After the comparison, the software-auditing server may generate a reconciliation report that confirms that the download transaction records are consistent with the current software configuration on the device. The report may also identify any inconsistencies. In another embodiment, both the gaming device and the software auditing server may store a record of the download transactions that have occurred on the gaming device and the software auditing server may reconcile these records.

There are many possible interactions between the components described with respect to FIG. 14. Many of the interactions are coupled. For example, methods used for game licensing may affect methods used for game downloading and vice versa. For the purposes of explanation, details of a few possible interactions between the components of the system relating to software licensing and software downloads have been described. The descriptions are selected to illustrate particular interactions in the game system 1400. These descriptions are provided for the purposes of explanation only and are not intended to limit the scope of example embodiments described herein.

### Electronic Table Game Terminal (Etgt) Devices and Dealer-Controlled Electronic Table Game (Detg) System(S)

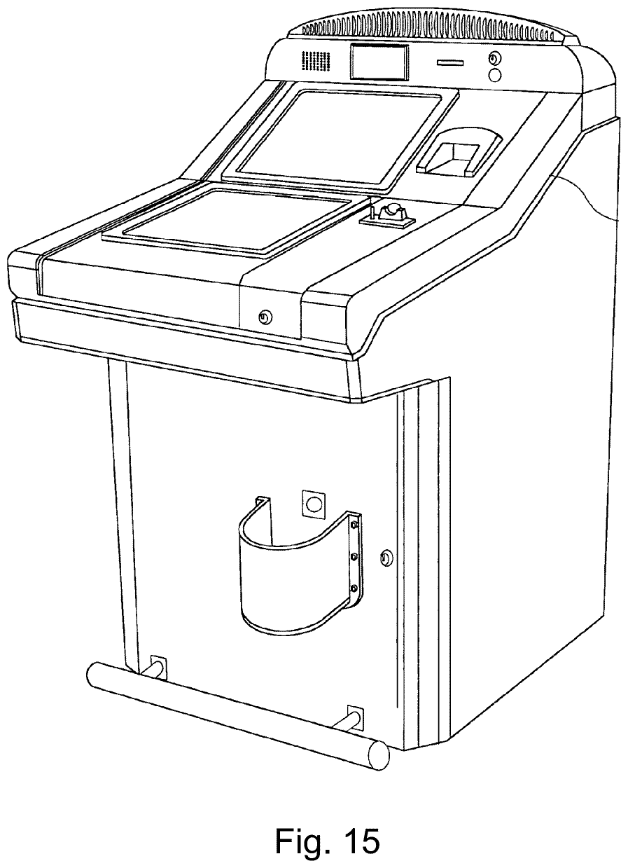

FIG. 15 shows an embodiment of the overall design of a baccarat Dealer-controlled Electronic Table Game (“DETG” or betting terminal).

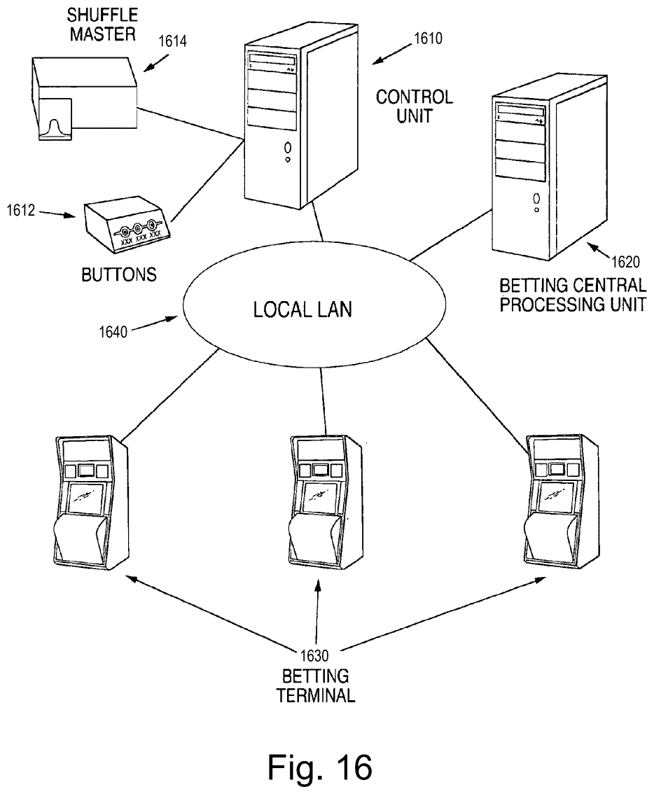

One aspect of the present invention provides a wager-based table gaming system that allows one to play the live baccarat jackpot described herein. One embodiment of the present invention is shown in FIG. 16. Referring FIG. 16, the baccarat gaming system includes three members: (1) the control unit for automatic shuffle mechanism (CU) (1610), (2) betting computation and tract record central processing unit (BCPU) (1620), and (3) betting terminal for players (BT) (1630) (FIG. 16). The control unit 1610 may further contain control buttons (1612) that allows the dealer to control the shuffling mechanism, which can be manual or automatic, and/or a shuffle master (1614), which can be manual or automatic, for shuffling the cards. The CU 1610 can include any or all of the components which may include control buttons that allow input from dealer and/or capable of (1) receiving the shuffle mechanism input, (2) sending visual output to a screen, and/or (3) sending card results in the player hand and/or bank hand to BCPU 1620. The BCPU 1620 has components or members capable of performing any or all of (1) receiving betting from BT (1630), (2) receiving card results from CU 1610, (3) sending betting results to BT 1630, and/or (4) sending credit to BT 1630.

The betting terminal for players, BT 1630, has components or members capable of performing any or all of (1) sending betting to BCPU 1620, (2) receiving betting results from BCPU 1620, and/or (3) receiving credit from BCPU 1620. Note, the baccarat gaming system can have a number of betting terminals, depending on the need of a gaming establishment. For example, if desirable, the baccarat gaming system can have 1, 2, 3, 4, 5, 6, 7, 8, 9, or 10, up to, e.g., 50 or 250 BTs. CU 1610, BCPU 1620, and BT 1630 can be linked together via a local area network (LAN) (1640) to form a baccarat gaming network between one, two, three or several gaming establishments.

The live baccarat game can have different variations. For example, the game can be played separately as a single live baccarat game. In some embodiments, the individual baccarat games as played in each betting terminal can be linked together. The individual games can all be played in a casino or gaming establishment or in several casino or gaming establishments. The individual games played in different betting terminals can be the same or different. Therefore, some or all of the baccarat games played in individual betting terminals, which can be the same or different baccarat games, can be linked together for a single jackpot.

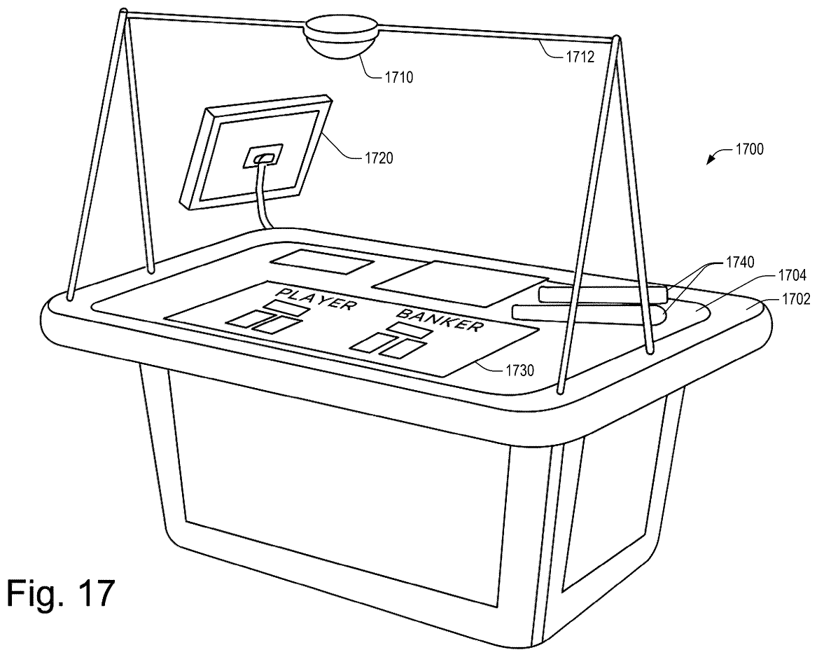

In some embodiments, the gaming system includes a dealing table. An embodiment of the dealing table is shown in FIG. 17, which includes a mainbody 1700, an overheadvideo camera 1710 supportedby a handle 1712, a signaling mechanism (e.g., a touch screen) 1720 for prompting the dealer of the dealing process, a lighting mechanism 1730 for indication of the order the card dealing process, and rings 1740 marking the space for placing the card shuffle master and box for disposal of played cards. The main body 1700 has an outer rim 1702 and inner rim 1704.

In at least one embodiment, the dealing table has a main body, a touch screen that includes a screen and a pop up mechanism for the touch screen, a lighting mechanism. and rings marking the space for placing the card shuffle master and box for disposal of played cards. The main body has an outer rim and inner rim.

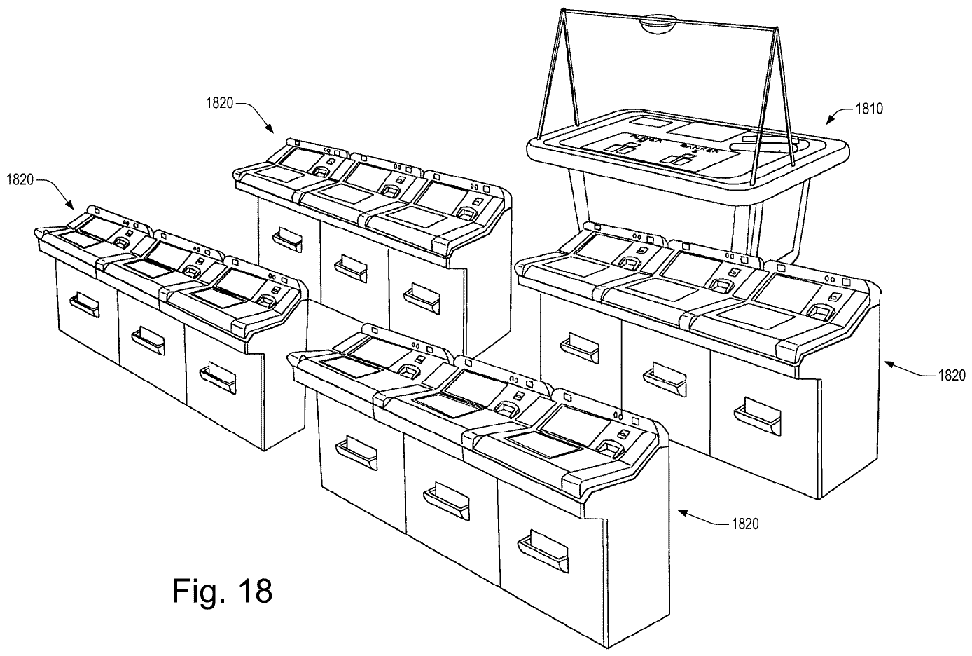

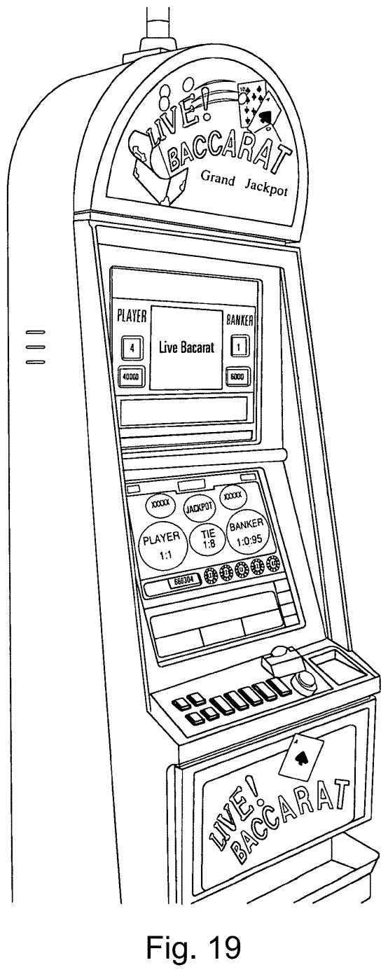

At least one embodiment of the gaming system of the present invention includes a dealing table and a betting terminal. FIG. 18 shows the overall layout of an embodiment of the gaming system of the present invention, which includes a dealing table (“DT”) 1810 and a plurality of betting terminals (“BTs”) 1820. FIG. 19 shows the overall layout of a further embodiment of the gaming system of the present invention.

In some other embodiments, the baccarat jackpot game canbe played in an entertainment setting, e.g., in the form of game device such as laptop or desktop computers. In a further embodiment, the baccarat jackpot game canbe played in a non-baccarat game, e.g., blackjack, or showhand.

### Application to Various Wager-Based Gaming Environments

In at least some other embodiments (not illustrated), the Electronic Gaming Machine(s) (EGDs), Electronic Gaming Terminal(s) (EGTs), Electronic Table Game Terminal(s) (ETGT), and Dealer-controlled Electronic Table Game (DETG) system(s) of the present invention may be configured or designed to host wager-based gameplay relating to various other types of wager-based casino table games. While many examples provided herein relate to Baccarat, the fundamental architecture of the modular widget interface and data intelligence framework is game-agnostic and may be readily adapted. The system's power lies in this inherent flexibility, allowing operators to deploy a consistent, yet highly specialized, user experience across their entire gaming floor. Such other popular casino wager-based table games may include, for example, blackjack, sic bo, poker, craps, roulette, pai gow poker, three card poker, Caribbean stud poker, casino war, Texas hold'em, etc.

The modular nature of the CoralDesk™ system, which allows for the dynamic selection and arrangement of multiple mini-applications, is particularly well-suited for this adaptability. The various different embodiments of the widget applications and AI-assisted analytic GUIs described herein may be specifically configured or designed for use with one or more particular types of wager-based casino table games. The system's ability to bind a live game data feed—containing game-specific events, outcomes, and player actions—to each widget and process that data through the AI Insight Module enables the creation of highly specialized analytical tools for any game with a structured stream of event data. This allows for the development of “game packs,” where a new set of tailored widgets and AI models may be deployed to the system for a new game type without altering the specific software.

For example, in an embodiment configured for a blackjack table game, the widgets may be specialized to provide insights relevant to blackjack strategy and outcomes. A “Basic Strategy Assist” widget may receive data on the player's current card total and the dealer's visible up-card. In response, it may display a graphical highlight, such as a subtle glowing border, around the mathematically optimal action on the betting interface (Hit, Stand, Double Down, Split), guiding less experienced players. An AI-powered “Shoe Composition” widget may analyze the history of cards dealt from the shoe, transforming this raw data into a simplified, real-time classification of the shoe's state (e.g., a visual gauge moving from “Cold” to “Hot”). This provides players with a simplified, actionable insight for bet sizing strategies without requiring them to learn complex card counting systems. Furthermore, a “Side Bet Interval Map,” similar to the one described for Baccarat, may track the frequency and distribution of outcomes for popular blackjack side bets like “21+3” or “Perfect Pairs,” helping players identify when these side bets may be statistically overdue.

In another example, for an embodiment configured for a craps table game, the widget framework may be adapted to help players navigate the game's notorious complexity and track its dynamic state. A “Dice Roll History” widget may provide a heat map or frequency chart of the last 50 dice roll outcomes, visually highlighting “hot” or “cold” numbers and comparing their frequency to the statistical probability. An “AI Trend Alarm” widget may be specifically configured to analyze roll sequences for statistically significant patterns, such as an unusually long duration without a “seven-out,” and provide a real-time alert for a potential “hot shooter.” Additionally, a “Player Bet Dashboard” widget would solve a major usability problem by receiving data about a player's multiple active bets (e.g., Pass Line with odds, Come bets, Place bets). It would then display a clear, consolidated graphical summary of the total amount at risk and the specific potential payout for each possible dice outcome on the next roll, dramatically simplifying the complex betting landscape for novice and expert players alike.

In yet another example, for an embodiment configured for a roulette table game, the widgets may be designed to provide deep statistical analysis of wheel spin outcomes. A “Smart Scoreboard” widget may display not only the sequence of the last 20 winning numbers but also dynamically updated statistical charts showing the real-time frequency of Red/Black, Odd/Even, and High/Low outcomes, flagging any statistically significant deviations from the norm. A “Wheel Zone Tracker” widget may provide a graphical representation of the physical roulette wheel and use the history of winning numbers to highlight which sections of the wheel (e.g., Voisins du Zero, Tiers du Cylindre, Orphelins) have been most active, a feature invaluable for players employing section-based betting strategies. The AI Insight Module may be configured to analyze the long-term distribution of winning numbers to identify statistically significant biases, providing an alert to the player when a particular dozen or column shows a non-random frequency of hits over a large sample of spins. A “Neighbor Bet Assist” widget may further enhance usability, allowing a player to select a number on the betting layout and having the widget automatically highlight the corresponding adjacent numbers on the wheel for quick and easy betting.

### Gpj Flow Procedures

### Example Procedures and Flow Diagrams

The Figures illustrate various example embodiments of different procedures and/or procedural flows which may be used for facilitating activities relating to one or more of the GPJ aspects disclosed herein.

According to different embodiments, at least a portion of the various types of functions, operations, actions, and/or other features provided by the GPJ Procedures of the Figures may be implemented at one or more client systems(s), at one or more System Servers (s), and/or combinations thereof.

In at least one embodiment, one or more of the GPJ procedures may be operable to utilize and/or generate various different types of data and/or other types of information when performing specific tasks and/or operations. This may include, for example, input data/information and/or output data/information. For example, in at least one embodiment, the GPJ procedures may be operable to access, process, and/or otherwise utilize information from one or more different types of sources, such as, for example, one or more local and/or remote memories, devices and/or systems. Additionally, in at least one embodiment, the GPJ procedures may be operable to generate one or more different types of output data/information, which, for example, may be stored in memory of one or more local and/or remote devices and/or systems. Examples of different types of input data/information and/or output data/information which may be accessed and/or utilized by the GPJ procedures may include, but are not limited to, one or more of those described and/or referenced herein.

In at least one embodiment, a given instance of the GPJ procedures may access and/or utilize information from one or more associated databases. In at least one embodiment, at least a portion of the database information may be accessed via communication with one or more local and/or remote memory devices. Examples of different types of data which may be accessed by the GPJ procedures may include, but are not limited to, one or more of those described and/or referenced herein.

According to specific embodiments, multiple instances or threads of the GPJ procedures may be concurrently implemented and/or initiated via the use of one or more processors and/or other combinations of hardware and/or hardware and software. For example, in at least some embodiments, various aspects, features, and/or functionalities of the GPJ procedures may be performed, implemented and/or initiated by one or more of the various systems, components, systems, devices, procedures, processes, etc., described and/or referenced herein.

According to different embodiments, one or more different threads or instances of the GPJ procedures may be initiated in response to detection of one or more conditions or events satisfying one or more different types of minimum threshold criteria for triggering initiation of at least one instance of the GPJ procedures. Various examples of conditions or events which may trigger initiation and/or implementation of one or more different threads or instances of the GPJ procedures may include, but are not limited to, one or more of those described and/or referenced herein.

According to different embodiments, one or more different threads or instances of the GPJ procedures may be initiated and/or implemented manually, automatically, statically, dynamically, concurrently, and/or combinations thereof. Additionally, different instances and/or embodiments of the GPJ procedures may be initiated at one or more different time intervals (e.g., during a specific time interval, at regular periodic intervals, at irregular periodic intervals, upon demand, etc.).

In at least one embodiment, initial configuration of a given instance of the GPJ procedures may be performed using one or more different types of initialization parameters. In at least one embodiment, at least a portion of the initialization parameters may be accessed via communication with one or more local and/or remote memory devices.

In at least one embodiment, at least a portion of the initialization parameters provided to an instance of the GPJ procedures may correspond to and/or may be derived from the input data/information.

It will be appreciated that the procedural diagrams of the Figures are merely specific examples of procedural flows and/or other activities which may be implemented to achieve one or more aspects of the GPJ techniques described herein. Other embodiments of procedural flows (not shown) may include additional, fewer and/or different steps, actions, and/or operations than those illustrated in the example procedural diagrams of the Figures.

This application incorporates by reference in its entirety and for all purposes U.S. Pat. No. 8,182,321, titled “Methods and Systems for Playing Baccarat Jackpot,” by Chun et al., issued May 22, 2012.

This application incorporates by reference in its entirety and for all purposes U.S. Pat. No. 8,956,210, titled “Methods and Systems for Playing Baccarat Jackpot,” by Chun et al., issued Feb. 17, 2015.

This application incorporates by reference in its entirety and for all purposes U.S. Pat. No. 10,198,893, titled “Methods and Systems for Playing Baccarat Jackpot,” by Chun et al., issued Feb. 5, 2019.

This application incorporates by reference in its entirety and for all purposes U.S. Pat. No. 10,702,763, titled “Methods and Systems for Playing Baccarat Jackpot,” by Chun et al., issued Jul. 7, 2020.

This application incorporates by reference in its entirety and for all purposes U.S. Pat. No. 7,922,587, titled “Betting Terminal and System,” by Chun et al., issued Apr. 12, 2011.

This application incorporates by reference in its entirety and for all purposes U.S. Pat. No. 7,918,723, titled “Methods and Systems for Playing Baccarat Jackpot,” by Chun et al., issued Apr. 5, 2011.

Although several example embodiments of one or more aspects and/or features have been described in detail herein with reference to the accompanying drawings, it is to be understood that aspects and/or features are not limited to these precise embodiments, and that various changes and modifications may be effected therein by one skilled in the art without departing from the scope of spirit of the invention(s) as defined, for example, in the appended claims.

1. A first server system for managing a dynamic jackpot for a live Baccarat game, the Baccarat game utilizing a physical shoe containing a plurality of playing cards, the first server system comprising:
a network interface;
a non-transient memory storing a stateful shoe composition dataset representing a quantity of cards remaining in the physical shoe; and
a processor communicatively coupled to the network interface and the memory, the processor being operable for:
receiving, via the network interface, real-time card data from a card recognition system, the real-time card data identifying a rank and a suit of a physical card dealt from the physical shoe;
atomically updating the stateful shoe composition dataset in the non-transient memory by decrementing a count associated with the identified rank and suit of the physical card;
executing a combinatorial probability calculation algorithm against the updated stateful shoe composition dataset to calculate a real-time probability of a specific, predefined rare card combination occurring in a finite remaining population of the physical shoe;
generating a dynamically adjusted jackpot multiplier for a jackpot tier corresponding to the specific, predefined rare card combination based on the calculated real-time probability, wherein the jackpot multiplier is inversely proportional to the calculated real-time probability; and
broadcasting, via the network interface, the dynamically adjusted jackpot multiplier to a plurality of electronic table game terminals to update a graphical user interface of the electronic table game terminals in real-time.

2. The first server system of 1, wherein executing the combinatorial probability calculation algorithm comprises calculating a hypergeometric distribution for at least thirty-six distinct jackpot tiers simultaneously upon receipt of the real-time card data.

3. The first server system of 2, wherein the at least thirty-six distinct jackpot tiers comprise a first subset of tiers requiring cards of a same suit and a second subset of tiers requiring cards of mixed suits.

4. The first server system of 1, wherein generating the dynamically adjusted jackpot multiplier further comprises applying a configurable weighting factor to the calculated real-time probability, wherein the weighting factor is defined by a perceived card value associated with the rank of the cards in the specific, predefined rare card combination.

5. The first server system of 1, wherein the processor is further operable for:
detecting that the real-time probability of the specific, predefined rare card combination has decreased based on the updating of the stateful shoe composition dataset; and
programmatically increasing the jackpot multiplier in response to the decrease in the real-time probability.

6. The first server system of 1, wherein the processor is further operable for:
receiving a jackpot wager data packet from a specific electronic table game terminal;
storing a timestamp associated with the jackpot wager data packet;
identifying an occurrence of the specific, predefined rare card combination;
retrieving the dynamically adjusted jackpot multiplier that was active at the timestamp of the jackpot wager data packet; and
calculating a jackpot payout amount by applying the retrieved dynamically adjusted jackpot multiplier to the jackpot wager.

7. The first server system of 1, wherein the processor is further operable for:
allocating a portion of a received side bet wager to a progressive jackpot pool; and
calculating a payout amount by multiplying a current value of the progressive jackpot pool by the dynamically adjusted jackpot multiplier.

8. The first server system of 1, wherein the processor is further operable for:
comparing the updated stateful shoe composition dataset against a set of near-miss criteria;
detecting a near-miss combination corresponding to the specific, predefined rare card combination; and
authorizing a partial jackpot award to the plurality of electronic table game terminals in response to detecting the near-miss combination.

9. A first server system for managing a longitudinal jackpot for a live Baccarat game played in a series of discrete game hands, the first server system comprising:
a network interface;
a non-transient memory configured to store a First-In-First-Out (FIFO) rolling data buffer having a fixed capacity of data objects; and
a processor communicatively coupled to the network interface and the memory, the processor being operable for:
receiving, via the network interface, a continuous stream of card data packets from a card recognition system, each card data packet corresponding to a physical card dealt consecutively from a shoe;
executing a push operation to add a new card data packet to the FIFO rolling data buffer and a pop operation to remove an oldest card data packet from the FIFO rolling data buffer to maintain a stateful history of a predefined number of last consecutive cards dealt, wherein the predefined number is six;
executing the push and pop operations continuously across the series of discrete game hands such that the FIFO rolling data buffer comprises card data packets dealt in different game hands;
executing a pattern-matching algorithm after each push operation to compare the six card data packets in the FIFO rolling data buffer against a predefined jackpot combination; and
transmitting, via the network interface, a jackpot trigger signal to an electronic table game terminal in response to the pattern-matching algorithm identifying a match, thereby enabling a jackpot event spanning multiple discrete game hands.

10. The first server system of 9, wherein the processor is further operable for:
receiving a new shoe signal indicating a start of a new physical shoe; and
executing a purge command to clear all data objects from the FIFO rolling data buffer in response to the new shoe signal.

11. The first server system of 9, wherein the processor is operable for analyzing the FIFO rolling data buffer independent of whether the card data packets contained therein were assigned to a Player hand or a Banker hand in the live Baccarat game.

12. The first server system of 9, wherein the predefined jackpot combination is selected from a set of thirty-six distinct jackpot tiers defined by a specific rank and a specific color of the six cards.

13. The first server system of 9, wherein the processor is further operable for:
receiving a single jackpot side bet transaction from a player terminal at a beginning of a new shoe;
logging a bet active status for the player terminal; and
maintaining the bet active status for all executions of the pattern-matching algorithm for a duration of the new shoe.

14. The first server system of 9, wherein the processor is further operable for:
querying a probability engine to determine a real-time probability of the predefined jackpot combination occurring based on a set of cards remaining in the shoe; and
adjusting a payout multiplier associated with the predefined jackpot combination based on the determined real-time probability.

15. The first server system of 9, wherein the processor is further operable for:
detecting a partial match within the FIFO rolling data buffer, wherein the partial match comprises five of the six card data packets matching the predefined jackpot combination; and
transmitting a partial win signal to the electronic table game terminal in response to the partial match.

16. A first server system for managing a jackpot for a live Baccarat game administered by a live dealer, the first server system comprising:
a secure network interface;
a dealer console interface configured to communicate with a secure, authenticated dealer console located at a live dealer station; and
a processor communicatively coupled to the secure network interface and the dealer console interface, the processor being operable for:
analyzing real-time game data to detect a near-miss jackpot condition;
transmitting an alert signal via the dealer console interface to the secure, authenticated dealer console to display a notification of the near-miss jackpot condition;
receiving, via the dealer console interface, a secure manual activation signal initiated by a physical input on the secure, authenticated dealer console;
validating the secure manual activation signal against an authentication credential associated with the live dealer;
changing a state of the first server system to enable a special jackpot eligibility period for a predefined duration in response to validating the secure manual activation signal; and
processing jackpot wagers received from a plurality of electronic table game terminals according to an enhanced payout rule set during the special jackpot eligibility period.

17. The first server system of 16, wherein the predefined duration is defined as a predetermined quantity of subsequent game hands dealt by the live dealer.

18. The first server system of 16, wherein the predefined duration is defined as a timer initiated upon validation of the secure manual activation signal.

19. The first server system of 16, wherein the enhanced payout rule set comprises applying a temporary multiplier to all winning jackpot combinations during the special jackpot eligibility period.

20. The first server system of 16, wherein detecting the near-miss jackpot condition comprises identifying that a rolling card buffer contains five out of six cards required for a jackpot combination.

21. The first server system of 16, wherein enabling the special jackpot eligibility period comprises transmitting a start bonus command to the plurality of electronic table game terminals, the start bonus command causing the terminals to display an interactive mini-game.

22. The first server system of 16, wherein the processor is further operable for:
receiving a manual bonus selection signal from the secure, authenticated dealer console, the manual bonus selection signal identifying a specific card trend observed by the live dealer; and
modifying the enhanced payout rule set to increase multipliers specifically for jackpot combinations matching the observed trend.

23. A first server system for managing a personalized jackpot for a Baccarat game, the first server system comprising:
a network interface;
an Application Programming Interface (API) configured to communicate with an external player tracking database;
an active session memory cache; and
a processor communicatively coupled to the network interface, the API, and the active session memory cache, the processor being operable for:
receiving a player login request comprising a player identifier from an electronic table game terminal (ETGT);
executing an API query to the external player tracking database using the player identifier to retrieve a historical player profile comprising loyalty tier data;
generating a specific in-game personalization rule object based on the retrieved historical player profile, the rule object defining a personalized multiplier value for a specific jackpot tier;
storing the generated in-game personalization rule object in the active session memory cache associated with the player identifier;
detecting a jackpot-triggering event corresponding to the specific jackpot tier for the ETGT;
retrieving the in-game personalization rule object from the active session memory cache; and
executing a modified payout calculation algorithm that applies the personalized multiplier value from the retrieved rule object to a base jackpot amount to determine a final payout for the ETGT.

24. The first server system of 23, wherein the processor is further operable for:
transmitting a personalized user interface data packet to the ETGT, the data packet causing the ETGT to render a graphical indicator of the personalized multiplier value unique to the player.

25. The first server system of 23, wherein the historical player profile further comprises a preferred wager history, and wherein generating the specific in-game personalization rule object comprises selecting a target jackpot tier that matches the preferred wager history.

26. The first server system of 23, wherein generating the specific in-game personalization rule object comprises generating a personalized challenge object defining a specific gameplay goal, and wherein the processor is further operable for:
tracking gameplay data from the ETGT against the specific gameplay goal; and
triggering a jackpot award in response to the gameplay data satisfying the specific gameplay goal.

27. The first server system of 23, wherein the processor is further operable for:
monitoring a sequence of game outcomes for the ETGT;
identifying a consecutive winning streak; and
dynamically updating the personalized multiplier value in the active session memory cache based on a length of the consecutive winning streak.

28. The first server system of 23, wherein the processor is further operable for:
tracking a sequence of wager amounts received from the ETGT;
identifying a progressive betting pattern wherein the wager amounts increase in a predefined sequence; and
applying the personalized multiplier value only upon confirmation of the progressive betting pattern.

29. The first server system of 23, wherein the processor is further operable for:
analyzing betting decisions received from the ETGT against a set of optimal strategy rules;
calculating a skill score for the player based on the analysis; and
adjusting the personalized multiplier value stored in the active session memory cache based on the calculated skill score.
